(19) United States
(12) Patent Application Publication
(10) Pub. No.: US 2014/0066307 A1
(43) Pub. Date: Mar. 6, 2014

(54) USE OF N-(1,2,5-OXADIAZOL-3-YL)BENZAMIDES FOR CONTROLLING UNWANTED PLANTS IN AREAS OF TRANSGENIC CROP PLANTS BEING TOLERANT TO HPPD INHIBITOR HERBICIDES

(71) Applicants: Fabien Poree, Frankfurt (DE); Andreas Van Almsick, Karben (DE); Arnim Köhn, Klein-Winternheim (DE); Bernd Laber, Idstein (DE); Ruediger Hain, Frankfurt (DE)

(72) Inventors: Fabien Poree, Frankfurt (DE); Andreas Van Almsick, Karben (DE); Arnim Köhn, Klein-Winternheim (DE); Bernd Laber, Idstein (DE); Ruediger Hain, Frankfurt (DE)

(73) Assignee: Bayer Intellectual Property GmbH, Monheim (DE)

(21) Appl. No.: 14/006,282

(22) PCT Filed: Mar. 21, 2012
(86) PCT No.: PCT/EP2012/054978

§ 371 Date: Nov. 23, 2013

Related U.S. Application Data
(60) Provisional application No. 61/467,631, filed on Mar. 25, 2011.

(30) Foreign Application Priority Data
Mar. 25, 2011 (EP) 11159750.6

(51) Int. Cl. A01N 43/82

(52) U.S. Cl. CPC A01N 43/82
USPC 504/139; 548/125; 504/265

(57) ABSTRACT

Use of N-(1,2,5-Oxadiazol-3-yl)benzamides of formula (I) or salts thereof

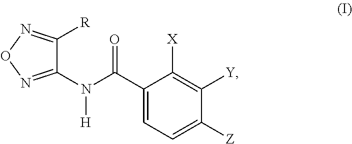

for controlling unwanted plants in areas of transgenic crop plants being tolerant to HPPD inhibitor herbicides by containing one or more chimeric gene(s) comprising (I) a DNA sequence encoding hydroxyphenylpyruvate dioxygenase (HPPD) derived from a member of a group of organisms consisting of (a) Avena, (b) Pseudomonas, (c) Synechococcoideae, (d) Blepharismidae, (e) Rhodococcus, (f) Picrophilaceae, (g) Kordia, or (II) comprising one or more mutated DNA sequences of HPPD encoding genes of the before defined organisms.

The invention relates to the use of N-(1,2,5-oxadiazol-3-yl)benzamides for controlling unwanted plants in areas of transgenic crop plants being tolerant to HPPD inhibitor herbicides.

WO2011/035874 (being filed under PCT/EP2010/005739 in the name of Bayer CropScience AG on Sep. 18, 2010) discloses several new N-(1,2,5-oxadiazol-3-yl)benzamides whose phenyl ring is substituted in the 2-, 3- and 4-position by selected radicals and their use as HPPD inhibitor herbicides for weed control.

However, the herbicidal activity of N-(1,2,5-oxadiazol-3-yl)benzamides whose phenyl ring is substituted in the 2-, 3- and 4-position by selected radicals might cause damages on several crop plants which limit their use in such crop growing areas as herbicides for weed control.

HPPD inhibitor herbicides can be used against grass and/or broad leaf weeds in crop plants that display metabolic tolerance, such as maize (Zea mays) in which they are rapidly degraded (Schulz et al., (1993). FEBS letters, 318, 162-166; Mitchell et al., (2001) Pest Management Science, Vol 57, 120-128; Garcia et al., (2000) Biochem., 39, 7501-7507; Pallett et al., (2001) Pest Management Science, Vol 57, 133-142). In order to extend the scope of these HPPD inhibitor herbicides, several efforts have been developed in order to confer to plants, particularly plants without or with an underperforming metabolic tolerance, a tolerance level acceptable under agronomic field conditions.

Meanwhile transgeninc plants have been engineered by by-passing HPPD-mediated production of homogentisate (U.S. Pat. No. 6,812,010), overexpressing the sensitive enzyme so as to produce quantities of the target enzyme in the plant which are sufficient in relation to the herbicide has been performed (WO96/38567).

Alternatively, transgenic plants have been generated expressing HPPD proteins that have been mutated at various positions in order to obtain a target enzyme which, while retaining its properties of catalysing the transformation of HPP into homogentisate, is less sensitive to HPPD inhibitor herbicides than is the native HPPD before mutation (for example see at EP496630, WO 99/24585).

More recently, the introduction of a Pseudomonas HPPD gene into the plastid genome of tobacco and soybean has shown to be more effective than nuclear transformation, conferring even tolerance to post-emergence application of at least one HPPD inhibitor (Dufourmantel et al., 2007, Plant Biotechnol J.5(1):118-33).

In WO 2009/144079, a nucleic acid sequence encoding a mutated hydroxyphenylpyruvate dioxygenase (HPPD) at position 336 of the Pseudomonas fluorescens HPPD protein and its use for obtaining plants which are tolerant to HPPD inhibitor herbicides is disclosed.

In WO 04/024928, the inventors have sought to increase the prenylquinone biosynthesis (e.g., synthesis of plastoquinones, tocopherols) in the cells of plants by increasing the flux of the HPP precursor into the cells of these plants. This has been done by connecting the synthesis of said precursor to the “shikimate” pathway by overexpression of the prephenate-dehydrogenase (PDH). They have also noted that the transformation of plants with a gene encoding a PDH enzyme makes it possible to increase the tolerance of said plants to HPPD inhibitors.

In WO 2002/046387, an gene obtained from Avena sativa encoding an HPPD was described to generate plants overexpressing such gene and thereby causing tolerance to various HPPD-inhobitor herbicides.

In WO 2008/150473, the combination of two distinct tolerance mechanisms—a modified Avena sativa gene coding for a mutant HPPD enzyme and a CYP450 Maize monooxygenase (nsf1 gene)—was exemplified in order to obtain an improved tolerance to HPPD inhibitor herbicides, but no data have been disclosed demonstrating the synergistic effects based on the combination of both proteins.

In WO 2010/085705, several mutants of the Avena sativa HPPD were described as well as plants comprising genes encoding such mutated HPPD and thereby causing an increased tolerance to various HPPD-inhibitor herbicides compared to non-mutated HPPD.

Recently, several new genes encoding HPPD enzymes from various organisms have been identified and employed for obtaining crop plants that show an agronomically useful level of tolerance concerning the application of various HPPD inhibitor herbicides.

The work concerning the implementation of such tolerance against HPPD inhibitor herbicides have extensively been described in the PCT-applications being filed in the name of Bayer CropScience AG on Dec. 22, 2010, having the filing numbers PCT/EP2010/070561 (published as WO 2011/076877; relates to nucleic acid sequences encoding a hydroxyphenylpyruvate dioxygenase (HPPD) obtained from bacteria belonging to the subfamily Synechococcoideae and certain mutants thereof); PCT/EP2010/070567 (published as WO 2011/076882; encoding a hydroxyphenylpyruvate dioxygenase obtained from protists belonging to the family Blepharismidae); PCT/EP2010/070578 (published as WO 2011/076892; encoding a hydroxyphenylpyruvate dioxygenase obtained from bacteria belonging to the genus Rhodococcus and certain mutants thereof); PCT/EP2010/070570 (published as WO 2011/076885; encoding a hydroxyphenylpyruvate dioxygenase obtained from Euryarchaeota belonging to the family Picrophilaceae and certain mutants thereof); PCT/EP2010/070575 (published as WO 2011/076889; encoding a hydroxyphenylpyruvate dioxygenase obtained from bacteria belonging to the genus Kordia and certain mutants thereof) and which are hereby incorporated by reference concerning the production of the respective transgenic plants conferring tolerance to HPPD inhibitor herbicides.

It has now been found that N-(1,2,5-oxadiazol-3-yl)benzamides whose phenyl ring is substituted in the 2-, 3- and 4-position by selected radicals can be employed on transgenic crop plants being tolerant to HPPD inhibitor herbicides by containing one or more genes conferring tolerance to HPPD inhibitor herbicides.

Subject matter of the present invention is the use of N-(1,2,5-oxadiazol-3-yl)benzamides of the formula (I) or their salts

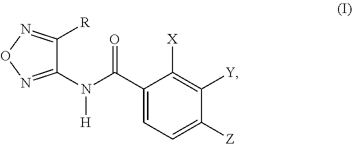

in which
R is hydrogen, (C₁-C₆)-alkyl, (C₃-C₇)-cycloalkyl, halo-(C₁-C₆)-alkyl, (C₁-C₆)-alkoxy, halo-(C₁-C₆)-alkoxy, (C₂-C₆)-alkenyl, (C₂-C₆)-alkenyloxy, (C₂-C₆)-haloalkenyl, (C₂-C₆)-alkynyl, (C₂-C₆)-alkynyloxy, (C₂-C₆)-haloalkynyl, cyano, nitro, methylsulfenyl, methylsulfinyl, methylsulfonyl, acetylamino, benzoylamino, methoxycarbonyl, ethoxy-carbonyl, methoxycarbonylmethyl, ethoxycarbonylmethyl, benzoyl, methylcarbonyl, piperidinylcarbonyl, trifluoromethylcarbonyl, halogen, amino, aminocarbonyl, methyl-aminocarbonyl, dimethylaminocarbonyl, methoxymethyl or heteroaryl, heterocyclyl or phenyl, each of which is substituted by s radicals selected from the group consisting of methyl, ethyl, methoxy, trifluoromethyl and halogen,
X and Z independently of one another are in each case nitro, halogen, cyano, formyl, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, OR¹, OCOR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², NR₁, R₂, P(O)(OR⁵)₂, or heteroaryl, heterocyclyl or phenyl, each of which is substituted by s radicals selected from the group consisting of methyl, ethyl, methoxy, nitro, trifluoromethyl and halogen,
Y is nitro, halogen, cyano, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, CO₂R¹, OR¹, OCOR¹, OSO₂R², S(O)ₙR², SO₂OR¹, SO₂N(R¹)₂, NR¹SO₂R², NR¹COR¹, (C₁-C₆)-alkyl-heteroaryl, O—(C₁-C₆)-alkyl-heterocyclyl, O—(C₁-C₆)-alkyl-heteroaryl, (C₁-C₆)-alkyl-heterocyclyl, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-CN, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², NR¹R², P(O)(OR⁵)₂, tetrahydrofuranyloxymethyl, tetrahydrofuranylmethoxymethyl, O(CH₂)-3,5-dimethyl-1,2-oxazol-4-yl, O(CH₂)₂—O(3,5-dimethoxypyrimidin-2-yl, O(CH₂)-5-pyrrolidin-2-one, O(CH₂)-5-2,4-dimethyl-2,4-dihydro-3H-1,2,4-triazol-3-one, or heteroaryl or heterocyclyl, each of which is substituted by s radicals selected from the group consisting of methyl, ethyl, methoxy, halogen and cyanomethyl,
R¹ is hydrogen, (C₁-C₆)-alkyl, (C₁-C₆)-haloalkyl, (C₂-C₆)-alkenyl, (C₂-C₆)-haloalkenyl, (C₂-C₆)-alkynyl, (C₂-C₆)-haloalkynyl, (C₃-C₆)-cycloalkyl, (C₃-C₆)-halo-cycloalkyl, (C₁-C₆)-alkyl-O—(C₁-C₆)-alkyl, (C₃-C₆)-cycloalkyl-(C₁-C₆)-alkyl, phenyl or phenyl-(C₁-C₆)-alkyl, where the 12 last-mentioned radicals are substituted by s radicals selected from the group consisting of cyano, halogen, nitro, rhodano, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R² is (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by s radicals from the group consisting of cyano, halogen, nitro, thiocyanato, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R³ is hydrogen, (C₁-C₆)-alkyl, (C₂-C₆)-alkenyl or (C₂-C₆)-alkynyl,
R⁴ is (C₁-C₆)-alkyl, (C₂-C₆)-alkenyl or (C₂-C₆)-alkynyl,
R⁵ is methyl or ethyl,
n is 0, 1 or 2,
s is 0, 1, 2 or 3,
for controlling unwanted plants in areas of transgenic crop plants being tolerant to HPPD inhibitor herbicides by containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No. 12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

In formula (I) and all the formulae below, alkyl radicals having more than two carbon atoms can be straight-chain or branched. Alkyl radicals are, for example, methyl, ethyl, n- or isopropyl, n-, iso-, t- or 2-butyl, pentyls, hexyls, such as n-hexyl, isohexyl and 1,3-dimethylbutyl. Halogen is fluorine, chlorine, bromine or iodine.

Heterocyclyl is a saturated, partially saturated or fully unsaturated cyclic radical which contains from 3 to 6 ring atoms, of which 1 to 4 are from the group consisting of oxygen, nitrogen and sulfur, and which radical can additionally be fused by a benzo ring. For example, heterocyclyl is piperidinyl, pyrrolidinyl, tetrahydrofuranyl, dihydrofuranyl, 4,5-dihydro-1,2-oxazol-3-yl and oxetanyl.

Heteroaryl is an aromatic cyclic radical which contains 3 to 6 ring atoms, of which 1 to 4 are from the group consisting of oxygen, nitrogen and sulfur, and which radical can additionally be fused by a benzo ring. For example, heteroaryl is benzimidazol-2-yl, furanyl, imidazolyl, isoxazolyl, isothiazolyl, oxazolyl, pyrazinyl, pyrimidinyl, pyridazinyl, pyridinyl, benzisoxazolyl, thiazolyl, pyrrolyl, pyrazolyl, thiophenyl, 1,2,3-oxadiazolyl, 1,2,4-oxadiazolyl, 1,2,5-oxadiazolyl, 1,3,4-oxadiazolyl, 1,2,4-triazolyl, 1,2,3-triazolyl, 1,2,5-triazolyl, 1,3,4-triazolyl, 1,2,4-triazolyl, 1,2,4-thiadiazolyl, 1,3,4-thiadiazolyl, 1,2,3-thiadiazolyl, 1,2,5-thiadiazolyl, 2H-1,2,3,4-tetrazolyl, 1H-1,2,3,4-tetrazolyl, 1,2,3,4-oxatriazolyl, 1,2,3,5-oxatriazolyl, 1,2,3,4-thiatriazolyl and 1,2,3,5-thiatriazolyl.

Where a group is substituted by a plurality of radicals, this means that this group is substituted by one or more identical or different representatives of the radicals mentioned.

Depending on the nature and the attachment of the substituents, the compounds of the formula (I) may be present as stereoisomers. If, for example, one or more asymmetric carbon atoms are present, there may be enantiomers and diastereomers. There may also be stereoisomers if n is 1 (sulfoxides). Stereoisomers may be obtained from the mixtures resulting from the preparation using customary separation methods, for example by chromatographic separation techniques. It is also possible to prepare stereoisomers selectively by using stereoselective reactions employing optically active starting materials and/or auxiliaries. The invention also relates to all stereoisomers and mixtures thereof embraced by the general formula (I) but not specifically defined.

Preference is given to the inventive use of compounds of the general formula (I) in which

R is hydrogen, (C₁-C₆)-alkyl, (C₃-C₇)-cycloalkyl, halo-(C₁-C₆)-alkyl, (C₁-C₆)-alkoxy, halo-(C₁-C₆)-alkoxy, cyano, nitro, methylsulfenyl, methylsulfinyl, methylsulfonyl, acetylamino, benzoylamino, methoxycarbonyl, ethoxycarbonyl, benzoyl, methylcarbonyl, piperidinylcarbonyl, trifluoromethylcarbonyl, halogen, amino, aminocarbonyl, methylaminocarbonyl, dimethylaminocarbonyl, methoxymethyl,
a heterocycle selected from the group consisting of pyridin-2-yl, pyridin-3-yl, pyridin-4-yl, piperidin-2-yl, piperidin-3-yl, piperidin-4-yl, benzisoxazol-2-yl, 1,2,4-oxadiazol-3-yl, 1,2,4-triazol-3-yl, 1-ethylbenzimidazol-2-yl, 4-methylthiazol-2-yl, thiophen-2-yl, furan-2-yl, furan-3-yl, tetrahydrofuran-2-yl, tetrahydrofuran-3-yl, isoxazol-2-yl, isoxazol-3-yl, oxazol-2-yl, oxazol-3-yl, pyrrol-2-yl, pyrrol-3-yl, imidazol-2-yl, imidazol-5-yl, imidazol-4-yl, pyrazol-3-yl, pyrazol-5-yl, pyrazol-4-yl, isoxazol-3-yl, isoxazol-4-yl, isoxazol-5-yl, oxazol-2-yl, oxazol-4-yl, oxazol-5-yl, isothiazol-3-yl, isothiazol-4-yl, isothiazol-5-yl, thiazol-2-yl, thiazol-4-yl, thiazol-5-yl, 1,2,3-triazol-4-yl, 1,2,3-triazol-5-yl, 1,2,5-triazol-3-yl, 1,3,4-triazol-2-yl, 1,2,4-triazol-3-yl, 1,2,4-triazol-5-yl, 1,2,4-oxadiazol-3-yl, 1,2,4-oxadiazol-5-yl, 1,3,4-oxadiazol-2-yl, 1,2,3-oxadiazol-4-yl, 1,2,3-oxadiazol-5-yl, 1,2,5-oxadiazol-3-yl, 1,2,4-thiadiazol-3-yl, 1,2,4-thiadiazol-5-yl, 1,3,4-thiadiazol-2-yl, 1,2,3-thiadiazol-4-yl, 1,2,3-thiadiazol-5-yl, 1,2,5-thiadiazol-3-yl, 2H-1,2,3,4-tetrazol-5-yl, 1H-1,2,3,4-tetrazol-1-yl, 1,2,3,4-oxatriazol-5-yl, 1,2,3,5-oxatriazol-4-yl, 1,2,3,4-thiatriazol-5-yl, 1,2,3,5-thiatriazol-4-yl, pyrazin-2-yl, pyrazin-3-yl, pyrimidin-2-yl, pyrimidin-4-yl, pyrimidin-5-yl, pyridazin-3-yl and pyridazin-4-yl, which heterocycle is substituted by s radicals selected from the group consisting of methyl, methoxy, trifluoromethyl and halogen, or phenyl which is substituted by s radicals selected from the group consisting of methyl, methoxy, trifluoromethyl and halogen,
X and Z independently of each other are in each case nitro, halogen, cyano, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, OR¹, OCOR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², benzoxazol-2-yl, 1-ethylbenzimidazol-2-yl, piperidin-1-yl or 1,2,4-triazol-1-yl,
Y is nitro, halogen, cyano, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, OR¹, OCOR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², tetrahydrofuranyloxymethyl, tetrahydrofuranylmethoxymethyl, O(CH₂)-3,5-dimethyl-1,2-oxazol-4-yl, O(CH₂)₂—O(3,5-dimethoxypyrimidin-2-yl, O(CH₂)-5-pyrrolidin-2-one or O(CH₂)-5-2,4-dimethyl-2,4-dihydro-3H-1,2,4-triazol-3-one,
R¹ is hydrogen, (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by s radicals selected from the group consisting of cyano, halogen, nitro, thiocyanato, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R² is (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by s radicals selected from the group consisting of cyano, halogen, nitro, thiocyanato, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R³ is hydrogen, (C₁-C₆)-alkyl, (C₂-C₆)-alkenyl or (C₂-C₆)-alkynyl,
R⁴ is (C₁-C₆)-alkyl, (C₂-C₆)-alkenyl or (C₂-C₆)-alkynyl,
n is 0, 1 or 2,
s is 0, 1, 2 or 3,
for controlling unwanted plants in areas of transgenic crop plants being tolerant to HPPD inhibitor herbicides by containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No. 12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

Particular preference is given to the inventive use of compounds of the general formula (I) in which

R is hydrogen, (C₁-C₆)-alkyl, (C₃-C₇)-cycloalkyl, halo-(C₁-C₆)-alkyl, (C₁-C₆)-alkoxy, halo-(C₁-C₆)-alkoxy, cyano, nitro, methylsulfenyl, methylsulfinyl, methylsulfonyl, acetylamino, benzoylamino, methoxycarbonyl, ethoxycarbonyl, benzoyl, methylcarbonyl, piperidinylcarbonyl, trifluoromethylcarbonyl, halogen, amino, aminocarbonyl, methylaminocarbonyl, dimethylaminocarbonyl, methoxymethyl,
a heterocycle selected from the group consisting of pyridin-2-yl, pyridin-3-yl, pyridin-4-yl, piperidin-2-yl, piperidin-3-yl, piperidin-4-yl, benzisoxazol-2-yl, 1,2,4-oxadiazol-3-yl, 1,2,4-triazol-3-yl, 1-ethylbenzimidazol-2-yl, 4-methylthiazol-2-yl, thiophen-2-yl, furan-2-yl, furan-3-yl, tetrahydrofuran-2-yl, tetrahydrofuran-3-yl, isoxazol-2-yl, isoxazol-3-yl, oxazol-2-yl, oxazol-3-yl, pyrrol-2-yl, pyrrol-3-yl, imidazol-2-yl, imidazol-5-yl, imidazol-4-yl, pyrazol-3-yl, pyrazol-5-yl, pyrazol-4-yl, isoxazol-3-yl, isoxazol-4-yl, isoxazol-5-yl, oxazol-2-yl, oxazol-4-yl, oxazol-5-yl, isothiazol-3-yl, isothiazol-4-yl, isothiazol-5-yl, thiazol-2-yl, thiazol-4-yl, thiazol-5-yl, 1,2,3-triazol-4-yl, 1,2,3-triazol-5-yl, 1,2,5-triazol-3-yl, 1,3,4-triazol-2-yl, 1,2,4-triazol-3-yl, 1,2,4-triazol-5-yl, 1,2,4-oxadiazol-3-yl, 1,2,4-oxadiazol-5-yl, 1,3,4-oxadiazol-2-yl, 1,2,3-oxadiazol-4-yl, 1,2,3-oxadiazol-5-yl, 1,2,5-oxadiazol-3-yl, 1,2,4-thiadiazol-3-yl, 1,2,4-thiadiazol-5-yl, 1,3,4-thiadiazol-2-yl, 1,2,3-thiadiazol-4-yl, 1,2,3-thiadiazol-5-yl, 1,2,5-thiadiazol-3-yl, 2H-1,2,3,4-tetrazol-5-yl, 1H-1,2,3,4-tetrazol-1-yl, 1,2,3,4-oxatriazol-5-yl, 1,2,3,5-oxatriazol-4-yl, 1,2,3,4-thiatriazol-5-yl, 1,2,3,5-thiatriazol-4-yl, pyrazin-2-yl, pyrazin-3-yl, pyrimidin-2-yl, pyrimidin-4-yl, pyrimidin-5-yl, pyridazin-3-yl and pyridazin-4-yl, which heterocycle is substituted by s radicals selected from the group consisting of methyl, methoxy, trifluoromethyl and halogen, or phenyl which is substituted by s radicals selected from the group consisting of methyl, methoxy, trifluoromethyl and halogen,
X and Z independently of each other are in each case nitro, halogen, cyano, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR′, OR¹, OCOR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², benzoxazol-2-yl, 1-ethylbenzimidazol-2-yl, piperidin-1-yl or 1,2,4-triazol-1-yl,
Y is nitro, halogen, cyano, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, OR¹, OCOR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², tetrahydrofuranyloxymethyl, tetrahydrofuranylmethoxymethyl, O(CH₂)-3,5-dimethyl-1,2-oxazol-4-yl, O(CH₂)₂—O(3,5-dimethoxypyrimidin-2-yl, O(CH₂)-5-pyrrolidin-2-one or O(CH₂)-5-2,4-dimethyl-2,4-dihydro-3H-1,2,4-triazol-3-one,
R¹ is hydrogen, (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by s radicals selected from the group consisting of cyano, halogen, nitro, thiocyanato, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R² is (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by s radicals selected from the group consisting of cyano, halogen, nitro, thiocyanato, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R³ is hydrogen, (C₁-C₆)-alkyl, (C₂-C₆)-alkenyl or (C₂-C₆)-alkynyl,
R⁴ is (C₁-C₆)-alkyl, (C₂-C₆)-alkenyl or (C₂-C₆)-alkynyl,
n is 0, 1 or 2,
s is 0, 1, 2 or 3
for controlling unwanted plants in areas of transgenic crop plants being tolerant to HPPD inhibitor herbicides by containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No. 12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

Very particular preference is given to the inventive use of compounds of the general formula (I) in which

R is hydrogen, (C₁-C₆)-alkyl, (C₃-C₇)-cycloalkyl, halo-(C₁-C₆)-alkyl, (C₁-C₆)-alkoxy, halogen-(C₁-C₆)-alkoxy, cyano, nitro, methylsulfenyl, methylsulfinyl, methylsulfonyl, acetylamino, benzoylamino, methoxycarbonyl, ethoxycarbonyl, benzoyl, methylcarbonyl, piperidinylcarbonyl, trifluoromethylcarbonyl, halogen, amino, aminocarbonyl, methylaminocarbonyl, dimethylaminocarbonyl, methoxymethyl,
X and Z independently of one another are in each case nitro, halogen, cyano, (C₁-C₆)-alkyl, (C₁-C₆)-haloalkyl, (C₃-C₆)-cycloalkyl, OR¹, S(O)ₙR², (C₁-C₆)-alkyl-S(O)ₙR², (C₁-C₆)-alkyl-OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R² or 1,2,4-triazol-1-yl,
Y is S(O)ₙR², 4,5-dihydro-1,2-oxazol-3-yl, 5-cyanomethyl-4,5-dihydro-1,2-oxazol-3-yl or 5-methoxymethyl-4,5-dihydro-1,2-oxazol-3-yl,
R¹ is hydrogen, (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by s radicals selected from the group consisting of halogen and OR³,
R² is (C₁-C₆)-alkyl, (C₃-C₆)-cycloalkyl or (C₃-C₆)-cycloalkyl-(C₁-C₆)-alkyl, where the three last-mentioned radicals are substituted by s radicals selected from the group consisting of halogen and OR³,
R³ is hydrogen or (C₁-C₆)-alkyl,
n is 0, 1 or 2,
s is 0, 1, 2 or 3,
for controlling unwanted plants in areas of transgenic crop plants being tolerant to

HPPD inhibitor herbicides by containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No. 12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

In all of the formulae below, the substituents and symbols have the same definition as described under formula (I), unless otherwise defined.

Compounds to be used according to the invention can be prepared for example by the method specified in scheme 1 by reacting, with base catalysis, a benzoyl chloride (II) with a 4-amino-1,2,5-oxadiazole (III):

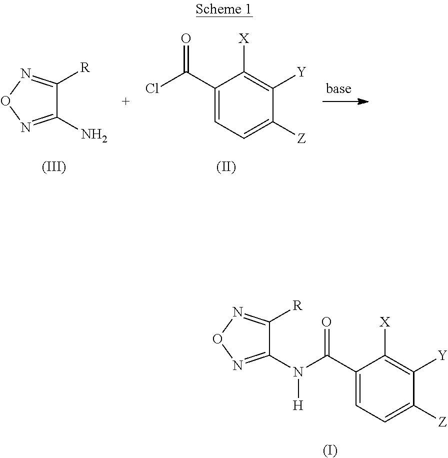

The benzoyl chlorides of the formula (II), or the benzoic acids on which they are based, are known in principle and can be prepared for example according to the methods described in U.S. Pat. No. 6,376,429 B1, EP 1 585 742 A1, and EP 1 202 978 A1.

Compounds according to the invention can also be prepared by the method specified in scheme 2 by reacting a benzoic acid of the formula (IV) with a 4-amino-1,2,5-oxadiazole (III):

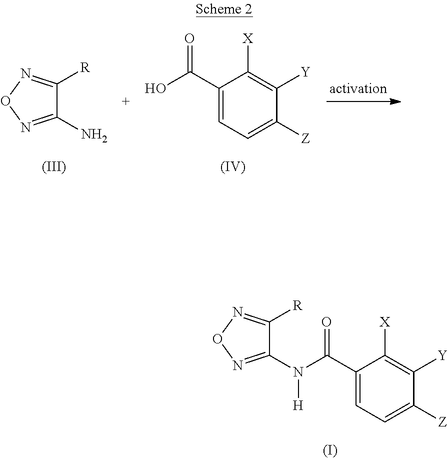

Dehydrating reagents which are conventionally used for amidation reactions, such as, for example, 1,1′-carbonyldiimidazole (CD), dicyclohexylcarbodiimide (DCC), 2,4,6-tripropyl-1,3,5,2,4,6-trioxatriphosphinane 2,4,6-trioxide (T3P) and the like may be employed for the activation.

In detail, the synthesis of specific compounds belonging to the class of N-(1,2,5-oxadiazol-3-yl)benzamides whose phenyl ring is substituted in the 2-, 3- and 4-position is exemplified in PCT/EP2010/005739, which is hereby incorporated by reference.

The compounds listed in the tables hereinbelow are very specially preferred to be used for controlling unwanted plants in areas of transgenic plants containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7 (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No. 12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

The abbreviations used are:

| | | | |
|---|---|---|---|
| Et = ethyl | Me = methyl | n-Pr = n-propyl | i-Pr = isopropyl |
| Pen = pentyl | Ph = phenyl | Ac = acetyl | Bz = benzoyl |
| c-Pr = cyclopropyl | | | |

TABLE 1
Compounds of the general formula (I) according to the invention in
which R is methyl

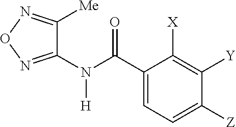

| No. | X | Y | Z |
|---|---|---|---|
| 1-1 | CF₃ | OCH₂CON(Me)Et | SO₂Me |
| 1-2 | CF₃ | OCH₂CON(Me)Et | SO₂Et |
| 1-4 | CF₃ | 2-(1H-pyrazol-1-yl)ethoxyl | SO₂Me |
| 1-5 | CF₃ | 2-(1H-pyrazol-1-yl)ethoxyl | SO₂Et |
| 1-6 | CF₃ | tetrahydrofuran-2-yl- | SO₂Me |
| | | methoxy | |
| 1-7 | CF₃ | tetrahydrofuran-2-yl- | SO₂Et |
| | | methoxy | |
| 1-8 | CF₃ | OH | SO₂Me |
| 1-9 | CF₃ | OH | SO₂Et |
| 1-10 | CF₃ | SH | SO₂Me |
| 1-11 | CF₃ | SH | SO₂Et |
| 1-15 | CF₃ | SMe | SO₂Me |
| 1-16 | CF₃ | SMe | SO₂Et |
| 1-17 | CF₃ | S(O)Me | SO₂Me |
| 1-24 | CF₃ | S(O)Me | SO₂Et |
| 1-25 | CF₃ | S(O)₂Me | SO₂Me |
| 1-26 | CF₃ | S(O)₂Me | SO₂Et |
| 1-27 | CF₃ | 2-[(methylsulfonyl) | SO₂Me |
| | | amino]ethoxy | |
| 1-28 | CF₃ | 2-[(methylsulfonyl)- | SO₂Me |
| | | amino]ethyl}sulfanyl | |
| 1-29 | CF₃ | 2-[(methylsulfonyl)- | SO₂Et |
| | | amino]ethyl}sulfanyl | |
| 1-30 | NO₂ | O(CH₂)₂OMe | OMe |
| 1-31 | NO₂ | OMe | Me |
| 1-32 | NO₂ | NH₂ | OMe |
| 1-33 | NO₂ | NH₂ | SO₂Et |
| 1-34 | NO₂ | NH₂ | Cl |
| 1-35 | NO₂ | NHMe | Cl |
| 1-36 | NO₂ | NMe₂ | Cl |
| 1-37 | NO₂ | NH₂ | Br |
| 1-38 | NO₂ | NHMe | Br |
| 1-39 | NO₂ | NMe₂ | Br |
| 1-40 | NO₂ | NH₂ | F |
| 1-41 | NO₂ | NHMe | F |
| 1-42 | NO₂ | NMe₂ | F |
| 1-43 | NO₂ | NH₂ | SO₂Me |
| 1-44 | NO₂ | NHMe | SO₂Me |
| 1-45 | NO₂ | NMe₂ | SO₂Me |
| 1-46 | NO₂ | NH₂ | 1H-1,2,4- |
| | | | triazol-1-yl |
| 1-47 | NO₂ | NHMe | 1H-1,2,4- |
| | | | triazol-1-yl |
| 1-48 | NO₂ | NMe₂ | 1H-1,2,4- |
| | | | triazol-1-yl |
| 1-49 | Me | F | F |
| 1-50 | Me | F | Cl |
| 1-51 | Me | SMe | CF₃ |
| 1-52 | Me | Cl | SO₂Me |
| 1-53 | Me | SO₂Me | SO₂Me |
| 1-54 | Me | SO₂Me | CF₃ |
| 1-55 | Me | Cl | CF₃ |
| 1-56 | Me | S(O)Me | CF₃ |
| 1-57 | Me | SEt | OMe |
| 1-58 | Me | NMe₂ | SO₂Me |
| 1-59 | Me | NH(CH₂)₂OMe | SO₂Me |
| 1-60 | Me | O(CH₂)₄OMe | SO₂Me |
| 1-61 | Me | NH₂ | SO₂Me |
| 1-62 | Me | O(CH₂)₂—O(3,5-di- | SO₂Me |
| | | methoxypyrimidin-2-yl | |
| 1-63 | Me | O(CH₂)₂—O—NMe₂ | Cl |
| 1-64 | Me | O(CH₂)₂—NH(CO)NMe₂ | Cl |
| 1-65 | Me | O(CH₂)-5-pyrrolidin-2-one | Br |
| 1-66 | Me | O(CH₂)₂—NH(CO)NHCO₂Et | Cl |
| 1-67 | Me | O(CH₂)—(CO)NEt₂ | Br |
| 1-68 | Me | O(CH₂)-5-2,4-dimethyl-2,4- | Cl |
| | | dihydro-3H-1,2,4- | |
| | | triazol-3-one | |
| 1-69 | Me | O(CH₂)-3,5-dimethyl- | Cl |
| | | 1,2-oxazol-4-yl | |
| 1-70 | Me | O(CH₂)₂—NHCO₂Me | Cl |
| 1-71 | Me | 4,5-dihydro-1,2-oxazol-3-yl | SO₂Me |
| 1-72 | Me | Me | SO₂Me |
| 1-73 | Me | OH | SO₂Me |
| 1-74 | Me | O—CH₂—NHSO₂cPr | Cl |
| 1-75 | Me | O(CH₂)₂NHSO₂Me | SO₂Me |
| 1-76 | Me | S(O)Me | SO₂Me |
| 1-77 | Me | SMe | SO₂Me |
| 1-78 | Me | SMe | OMe |
| 1-79 | Me | S(O)Me | OMe |
| 1-80 | Me | SO₂Me | OMe |
| 1-81 | Me | SMe | Cl |
| 1-82 | Me | S(O)Me | Cl |
| 1-83 | Me | SO₂Me | Cl |
| 1-84 | Me | [1,4]dioxan-2-yl-methoxy | SO₂Me |
| 1-85 | Me | [1,4]dioxan-2-yl-methoxy | SO₂Et |
| 1-86 | Me | O(CH₂)₄OMe | SO₂Et |
| 1-87 | Me | O(CH₂)₃OMe | SO₂Me |
| 1-88 | Me | O(CH₂)₃OMe | SO₂Et |
| 1-89 | Me | O(CH₂)₂OMe | SO₂Me |
| 1-90 | Me | O(CH₂)₂OMe | SO₂Et |
| 1-91 | Me | S(O)Me | SO₂Me |
| 1-92 | Me | SMe | SO₂Me |
| 1-93 | Me | SMe | OMe |
| 1-94 | Me | S(O)Me | OMe |
| 1-95 | Me | SO₂Me | OMe |
| 1-96 | Me | SMe | Cl |
| 1-97 | Me | S(O)Me | Cl |
| 1-98 | Me | SO₂Me | Cl |
| 1-99 | Me | SMe | Br |
| 1-100 | Me | SOMe | Br |
| 1-101 | Me | SO₂Me | Br |
| 1-102 | Me | SMe | I |
| 1-103 | Me | SOMe | I |
| 1-104 | Me | SO₂Me | I |
| 1-105 | Me | SEt | Cl |
| 1-106 | Me | SOEt | Cl |
| 1-107 | Me | SO₂Et | Cl |
| 1-108 | Me | SEt | Br |
| 1-109 | Me | SOEt | Br |
| 1-110 | Me | SO₂Et | Br |
| 1-111 | Me | SEt | I |
| 1-112 | Me | SOEt | I |
| 1-113 | Me | SO₂Et | I |
| 1-114 | Me | SEt | F |
| 1-115 | Me | SOEt | F |
| 1-116 | Me | SO₂Et | F |
| 1-117 | Cl | OCH₂(CO)NMe₂ | Cl |
| 1-119 | Cl | CH₂OCH₂CF₃ | SO₂Me |
| 1-120 | Cl | 5-cyanomethyl-4,5- | SO₂Et |
| | | dihydro-1,2-oxazol-3-yl | |
| 1-121 | Cl | CH₂O-tetrahydro-furan-3-yl | SO₂Me |
| 1-122 | Cl | CH₂O-tetrahydrofuran-2-yl | SO₂Me |
| 1-123 | Cl | SMe | SO₂Me |
| 1-124 | Cl | F | SMe |
| 1-125 | Cl | CH₂OCH₂- | SO₂Me |
| | | tetrahydrofuran-2-yl | |
| 1-126 | Cl | CH₂OCH₂- | SO₂Et |
| | | tetrahydrofuran-3-yl | |
| 1-127 | Cl | O(CH₂)-5-pyrrolidin-2-one | Cl |
| 1-128 | Cl | SMe | Cl |
| 1-129 | Cl | S(O)Me | SO₂Me |
| 1-130 | Cl | CH₂O-tetrahydrofuran-3-yl | SO₂Et |
| 1-131 | Cl | O(CH₂)₂OMe | Cl |
| 1-132 | Cl | O(CH₂)₂OMe | SO₂Me |
| 1-133 | Cl | O(CH₂)₄OMe | SO₂Me |
| 1-134 | Cl | O(CH₂)₄OMe | SO₂Et |
| 1-135 | Cl | O(CH₂)₃OMe | SO₂Me |
| 1-136 | Cl | O(CH₂)₃OMe | SO₂Et |
| 1-137 | Cl | O(CH₂)₂OMe | SO₂Me |
| 1-138 | Cl | O(CH₂)₂OMe | SO₂Et |
| 1-139 | Cl | [1,4]dioxan-2-yl-methoxy | SO₂Me |
| 1-140 | Cl | [1,4]dioxan-2-yl-methoxy | SO₂Et |
| 1-141 | Cl | SO₂Me | Me |
| 1-142 | Cl | SEt | Me |
| 1-143 | Cl | SOEt | Me |
| 1-144 | Cl | SO₂Et | Me |
| 1-145 | Cl | 4,5-dihydro-1,2-oxazol-3-yl | SO₂Me |
| 1-146 | Cl | Cl | SO₂Me |
| 1-147 | F | SMe | CF₃ |
| 1-148 | F | S(O)Me | CF₃ |
| 1-149 | OMe | SMe | CF₃ |
| 1-150 | OMe | S(O)Me | CF₃ |
| 1-151 | OMe | SO₂Me | CF₃ |
| 1-152 | Et | NH(CH₂)₂OMe | SO₂Me |
| 1-153 | Et | F | SO₂Me |
| 1-154 | Et | SMe | CF₃ |
| 1-155 | CF₃ | F | SO₂Me |
| 1-156 | CF₃ | F | SO₂Et |
| 1-157 | CF₃ | O(CH₂)₂OMe | SO₂Et |
| 1-158 | CF₃ | O(CH₂)₃OMe | SO₂Et |
| 1-159 | CF₃ | O(CH₂)₂OMe | SO₂Me |
| 1-160 | CF₃ | O(CH₂)₃OMe | SO₂Me |
| 1-161 | CF₃ | OCH₂CONMe₂ | SO₂Me |
| 1-162 | CF₃ | OCH₂CONMe₂ | SO₂Et |
| 1-163 | CF₃ | OCH₂CONMe₂ | Cl |
| 1-164 | CF₃ | OCH₂CONMe₂ | Br |
| 1-165 | CF₃ | OCH₂CONMe₂ | I |
| 1-166 | CF₃ | OCH₂CONMe₂ | F |
| 1-167 | CF₃ | O(CH₂)₂OMe | Cl |
| 1-168 | CF₃ | O(CH₂)₃OMe | Cl |
| 1-169 | CF₃ | O(CH₂)₂OMe | Br |
| 1-170 | CF₃ | O(CH₂)₃OMe | Br |
| 1-171 | CF₃ | O(CH₂)₂OMe | I |
| 1-172 | CF₃ | O(CH₂)₃OMe | I |
| 1-173 | CF₃ | O(CH₂)₂OMe | F |
| 1-174 | CF₃ | O(CH₂)₃OMe | F |
| 1-175 | CF₃ | [1,4]dioxan-2-yl-methoxy | SO₂Me |
| 1-176 | CF₃ | [1,4]dioxan-2-yl-methoxy | SO₂Et |
| 1-177 | CF₃ | [1,4]dioxan-2-yl-methoxy | Cl |
| 1-178 | CF₃ | [1,4]dioxan-2-yl-methoxy | Br |
| 1-179 | CF₃ | [1,4]dioxan-2-yl-methoxy | I |
| 1-180 | CF₃ | [1,4]dioxan-2-yl-methoxy | F |
| 1-181 | Br | OMe | Br |
| 1-182 | Br | O(CH₂)₂OMe | Br |
| 1-183 | Br | O(CH₂)₄OMe | SO₂Me |
| 1-184 | Br | O(CH₂)₄OMe | SO₂Et |
| 1-185 | Br | O(CH₂)₃OMe | SO₂Me |
| 1-186 | Br | O(CH₂)₃OMe | SO₂Et |
| 1-187 | Br | O(CH₂)₂OMe | SO₂Me |
| 1-188 | Br | O(CH₂)₂OMe | SO₂Et |
| 1-189 | Br | [1,4]dioxan-2-yl-methoxy | SO₂Me |
| 1-190 | Br | [1,4]dioxan-2-yl-methoxy | SO₂Et |
| 1-191 | Br | SMe | Me |
| 1-192 | Br | SOMe | Me |
| 1-193 | Br | SO₂Me | Me |
| 1-194 | Br | SEt | Me |
| 1-195 | Br | SOEt | Me |
| 1-196 | Br | SO₂Et | Me |
| 1-197 | I | O(CH₂)₄OMe | SO₂Me |
| 1-198 | I | O(CH₂)₄OMe | SO₂Et |
| 1-199 | I | O(CH₂)₃OMe | SO₂Me |
| 1-200 | I | O(CH₂)₃OMe | SO₂Et |
| 1-201 | I | O(CH₂)₂OMe | SO₂Me |
| 1-202 | I | O(CH₂)₂OMe | SO₂Et |
| 1-203 | I | [1,4]dioxan-2-yl-methoxy | SO₂Me |
| 1-204 | I | [1,4]dioxan-2-yl-methoxy | SO₂Et |
| 1-205 | I | SMe | Me |
| 1-206 | I | SOMe | Me |
| 1-207 | I | SO₂Me | Me |
| 1-208 | I | SEt | Me |
| 1-209 | I | SOEt | Me |
| 1-210 | I | SO₂Et | Me |
| 1-211 | CH₂SMe | OMe | SO₂Me |
| 1-212 | CH₂OMe | OMe | SO₂Me |
| 1-213 | CH₂O(CH₂)₂OMe | NH(CH₂)₂OEt | SO₂Me |
| 1-214 | CH₂O(CH₂)₂OMe | NH(CH₂)₃OEt | SO₂Me |
| 1-215 | CH₂O(CH₂)₃OMe | OMe | SO₂Me |
| 1-216 | CH₂O(CH₂)₂OMe | NH(CH₂)₂OMe | SO₂Me |
| 1-217 | CH₂O(CH₂)₂OMe | NH(CH₂)₃OMe | SO₂Me |
| 1-218 | SO₂Me | NH₂ | CF₃ |
| 1-219 | SO₂Me | F | CF₃ |
| 1-220 | SO₂Me | NHEt | Cl |
| 1-221 | SMe | SEt | F |
| 1-222 | SMe | SMe | F |
| 1-223 | Me | NH₂ | Cl |
| 1-224 | Me | NH₂ | Br |
| 1-225 | Me | NHMe | Cl |
| 1-226 | Me | NHMe | Br |
| 1-227 | Me | NMe₂ | Cl |
| 1-228 | Me | NMe₂ | Br |
| 1-227 | Me | NMe₂ | Cl |
| 1-228 | Me | NMe₂ | Br |
| 1-229 | NO₂ | O(CH₂)₂OMe | Me |
| 1-230 | CF₃ | S(O)₂Et | SO₂Me |
| 1-231 | CF₃ | S(O)₂Et | SO₂Et |
| 1-232 | CF₃ | SCH₂CONMe₂ | SO₂Me |
| 1-233 | CF₃ | SCH₂CONMe₂ | SO₂Et |
| 1-234 | CF₃ | SCH₂COOH | SO₂Me |
| 1-235 | CF₃ | SCH₂COOH | SO₂Et |
| 1-236 | Me | SO₂—CH₂—CH₂—CH═CH₂ | CF₃ |
| 1-237 | Cl | Me | SO₂Et |
| 1-238 | CF₃ | SEt | SO₂Me |
| 1-239 | OMe | NO2 | Cl |
| 1-240 | OMe | NH(CO)i-Pr | Cl |
| 1-241 | OMe | NH(CO)CH₂Ph | Cl |
| 1-242 | CF₃ | SEt | SO₂Et |
| 1-243 | CF₃ | S(O) Et | SO₂Me |
| 1-244 | Cl | Me | Cl |
| 1-245 | Me | 3,5-dimethyl-pyrazol-1-yl | SO₂Me |
| 1-247 | Me | 1,2,3-triazol-1-yl | SO₂Me |
| 1-248 | Me | Me | SMe |
| 1-249 | Me | pyrrolidin-2-on-1-yl | SO₂Me |
| 1-250 | CF₃ | S(O)Et | SO₂Et |
| 1-251 | Cl | pyrazol-1-yl | SO₂Me |
| 1-252 | Me | 3-methylpyrazol-1-yl | SO₂Me |
| 1-253 | Cl | CH₂—N(Et)OMe | SO₂Me |
| 1-254 | Me | Me | Cl |
| 1-255 | OH | Cl | Cl |
| 1-256 | Me | 1,2,4-triazol-1-yl | SO₂Me |
| 1-257 | Me | 4-methoxypyrazol-1-yl | SO₂Me |
| 1-258 | Me | 1,2,4-triazol-1-yl | CF₃ |
| 1-259 | Me | tetrahydro-pyrimidin- | SO₂Me |
| | | 2-(1H)-on-1-yl | |
| 1-260 | Me | NH—(CH₂)₂—O(CO)Et | SO₂Me |
| 1-261 | Me | NH-iPr | SO₂Me |
| 1-262 | Cl | NH—CH₂—(CO)NHEt | Cl |
| 1-263 | Me | NH—CH₂—(CO)NMe₂ | SO₂Me |
| 1-264 | Me | NH—CH₂-furan-2-yl | SO₂Me |
| 1-265 | Me | NH—CH₂—(CO)NHEt | SO₂Me |
| 1-266 | Me | F | SO₂Me |
| 1-267 | F | SO₂Me | SO₂Me |
| 1-268 | Cl | (4-cyclopropyl-3-methyl- | Cl |
| | | 5-oxo-4,5-dihydro-1H- | |
| | | 1,2,4-triazol-1-yl)methyl | |
| 1-269 | Cl | [4-methyl-5-oxo-3-(2,2,2- | Cl |
| | | trifluoro-ethoxy)-4,5- | |
| | | dihydro-1H-1,2,4-triazol- | |
| | | 1-yl]methyl | |
| 1-270 | Cl | (3-isopropoxy-4-methyl- | Cl |
| | | 5-oxo-4,5-dihydro-1H- | |
| | | 1,2,4-triazol-1-yl]methyl | |
| 1-271 | Cl | (4-methyl-5-oxo-4,5- | Cl |
| | | dihydro-1H-1,2,4-triazol- | |
| | | 1-yl)methyl | |
| 1-272 | Me | Cl | SO₂Et |
| 1-273 | SO₂Me | F | Cl |
| 1-274 | Me | 1,2,3-triazol-1-yl | SO₂Me |
| 1-275 | Me | isobutyl(methyl) | SO₂Me |
| | | carbamoylamino | |
| 1-276 | Me | 3-oxomorpholin-4-yl | SO₂Me |
| 1-277 | OMe | [ethyl(methylsulfonyl) | Cl |
| | | amino]-methyl | |
| 1-278 | F | SO₂Me | CF₃ |
| 1-279 | OMe | benzoylamino | Cl |
| 1-280 | OMe | cyclopropylcarbonylamino | Cl |
| 1-281 | OMe | propionylamino | Cl |
| 1-282 | NO₂ | SO₂Me | SO₂Me |
| 1-283 | NO₂ | SO₂Me | Cl |
| 1-284 | NO₂ | SOMe | SO₂Me |
| 1-285 | NO₂ | SOMe | Br |
| 1-286 | NO₂ | SOMe | Cl |
| 1-287 | NO₂ | SMe | SO₂Me |
| 1-288 | NO₂ | SMe | Br |
| 1-289 | NO₂ | SMe | Cl |
| 1-290 | Cl | CH₂OCH(CH₃)₂ | SO₂Et |
| 1-291 | Cl | CH₂OEt | SO₂Et |
| 1-292 | Cl | CH₂OMe | SO₂Et |
| 1-293 | Cl | CH₂OCH₂C₂F₅ | SO₂Me |
| 1-294 | Cl | CH₂OCH₂CHF₂ | SO₂Me |
| 1-295 | Cl | CH₂OCH₂CCH | SO₂Et |
| 1-296 | Cl | CH₂OC₂H₄OMe | SO₂Me |
| 1-297 | Cl | CH₂(OC₂H₄)₂OMe | SO₂Me |
| 1-298 | Cl | 5-ethoxymethyl-4,5-dihydro- | SO₂Et |
| | | 1,2-oxazol-3-yl | |
| 1-299 | Cl | 5-methoxymethyl-4,5- | SO₂Et |
| | | dihydro-1,2-oxazol-3-yl | |
| 1-300 | Et | SOMe | CF₃ |
| 1-301 | iPr | SMe | CF₃ |
| 1-302 | Et | SMe | CF₃ |
| 1-303 | Et | SO₂Me | CF₃ |
| 1-304 | cPr | SOMe | CF₃ |
| 1-305 | CH═CH₂ | SMe | CF₃ |
| 1-306 | Et | SMe | Cl |
| 1-307 | Et | SO₂Me | Cl |
| 1-308 | Cl | NMe₂ | Cl |
| 1-309 | CH₂O(CH₂)₂OMe | NH(CH₂)₃OMe | SO₂Me |
| 1-313 | Me | SO₂(CH₂)₂OMe | CF₃ |
| 1-314 | Me | SOEt | SO₂Me |
| 1-315 | Me | SO₂Et | SO₂Me |
| 1-316 | Me | SMe | 1,2,4-triazol- |
| | | | 1-yl |
| 1-317 | OEt | SMe | CF₃ |
| 1-318 | Me | S(CH₂)₂OMe | CF₃ |
| 1-319 | Me | SOMe | 1,2,4-triazol- |
| | | | 1-yl |
| 1-320 | OEt | SOMe | CF₃ |
| 1-321 | Me | SO(CH₂)₂OMe | CF₃ |
| 1-322 | Me | SCH₂CCMe | SO₂Me |
| 1-323 | Me | S-c-Pen | SO₂Me |
| 1-324 | OMe | SMe | OMe |
| 1-325 | Me | SCH₂CH═CHCH₃ | SO₂Me |
| 1-326 | Me | SOCH₂CCMe | SO₂Me |
| 1-327 | Me | SO₂-c-Pen | SO₂Me |
| 1-328 | Me | SO-c-Pen | SO₂Me |
| 1-329 | Me | S(CH₂)₃Cl | SO₂Me |
| 1-330 | Me | SCH₂(4-F-Ph) | SO₂Me |
| 1-331 | Me | SO₂CH₂CCMe | SO₂Me |
| 1-332 | Me | SO₂CH₂CH═CHCH₃ | SO₂Me |
| 1-333 | Me | SOCH₂CH═CHCH₃ | SO₂Me |
| 1-334 | Me | SOCH₂-epoxy-Me | SO₂Me |
| 1-335 | Me | SO₂(CH₂)₃Cl | SO₂Me |
| 1-336 | Me | SO(CH₂)₃Cl | SO₂Me |
| 1-337 | Me | SOCH₂(4-F-Ph) | SO₂Me |
| 1-338 | Me | SO₂CH₂(4-F-Ph) | SO₂Me |
| 1-339 | Me | SO₂Me | C₂F₅ |
| 1-340 | O(CH₂)₂OMe | SMe | CF₃ |
| 1-341 | O(CH₂)₂OMe | SO₂Me | CF₃ |
| 1-342 | O(CH₂)₂OMe | SOMe | CF₃ |
| 1-343 | Me | S(CH₂)₂OCH₂CF₃ | SO₂Me |
| 1-344 | Me | SO(CH₂)₂OCH₂CF₃ | SO₂Me |
| 1-345 | Me | SO₂(CH₂)₂OCH₂CF₃ | SO₂Me |
| 1-346 | OEt | SEt | CF₃ |
| 1-347 | O—CH₂-c-Pr | SMe | CF₃ |
| 1-348 | OMe | SEt | CF₃ |
| 1-349 | OMe | SO₂Et | CF₃ |
| 1-350 | OMe | SOEt | CF₃ |
| 1-351 | OEt | SO₂Et | CF₃ |
| 1-352 | OEt | SOEt | CF₃ |
| 1-353 | O—CH₂-c-Pr | SOMe | CF₃ |
| 1-354 | O—CH₂-c-Pr | SO₂Me | CF₃ |
| 1-355 | Me | SEt | SO₂Me |

TABLE 2
Compounds of the general formula (I) according to the invention in
which R is ethyl

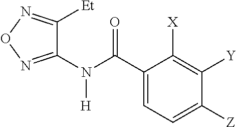

| No. | X | Y | Z |
|---|---|---|---|
| 2-1 | CF₃ | OCH₂CON(Me)Et | SO₂Me |
| 2-2 | CF₃ | OCH₂CON(Me)Et | SO₂Et |
| 2-4 | CF₃ | 2-(1H-pyrazol-1-yl)ethoxyl | SO₂Me |
| 2-5 | CF₃ | 2-(1H-pyrazol-1-yl)ethoxyl | SO₂Et |
| 2-6 | CF₃ | tetrahydrofuran-2- | SO₂Me |
| | | ylmethoxy | |
| 2-7 | CF₃ | tetrahydrofuran-2- | SO₂Et |
| | | ylmethoxy | |
| 2-8 | CF₃ | OH | SO₂Me |
| 2-9 | CF₃ | OH | SO₂Et |
| 2-10 | CF₃ | SH | SO₂Me |
| 2-11 | CF₃ | SH | SO₂Et |
| 2-15 | CF₃ | SMe | SO₂Me |
| 2-16 | CF₃ | SMe | SO₂Et |
| 2-17 | CF₃ | S(O)Me | SO₂Me |
| 2-24 | CF₃ | S(O)Me | SO₂Et |
| 2-25 | CF₃ | S(O)₂Me | SO₂Me |
| 2-26 | CF₃ | S(O)₂Me | SO₂Et |
| 2-27 | CF₃ | 2-[(methylsulfonyl) | SO₂Me |
| | | amino]ethoxy | |
| 2-28 | CF₃ | 2-[(methylsulfonyl)- | SO₂Me |
| | | amino]ethyl}sulfanyl | |
| 2-29 | CF₃ | 2-[(methylsulfonyl)- | SO₂Et |
| | | amino]ethyl}sulfanyl | |
| 2-30 | NO₂ | O(CH₂)₂OMe | OMe |
| 2-31 | NO₂ | OMe | Me |
| 2-32 | NO₂ | NH₂ | OMe |
| 2-33 | NO₂ | NH₂ | SO₂Et |
| 2-34 | NO₂ | NH₂ | Cl |
| 2-35 | NO₂ | NHMe | Cl |
| 2-36 | NO₂ | NMe₂ | Cl |
| 2-37 | NO₂ | NH₂ | Br |
| 2-38 | NO₂ | NHMe | Br |
| 2-39 | NO₂ | NMe₂ | Br |
| 2-40 | NO₂ | NH₂ | F |
| 2-41 | NO₂ | NHMe | F |
| 2-42 | NO₂ | NMe₂ | F |
| 2-43 | NO₂ | NH₂ | SO₂Me |
| 2-44 | NO₂ | NHMe | SO₂Me |
| 2-45 | NO₂ | NMe₂ | SO₂Me |
| 2-46 | NO₂ | NH₂ | 1H-1,2,4- |
| | | | triazol-1-yl |
| 2-47 | NO₂ | NHMe | 1H-1,2,4- |
| | | | triazol-1-yl |
| 2-48 | NO₂ | NMe₂ | 1H-1,2,4- |
| | | | triazol-1-yl |
| 2-49 | Me | F | F |
| 2-50 | Me | F | Cl |
| 2-51 | Me | SMe | CF₃ |
| 2-52 | Me | Cl | SO₂Me |
| 2-53 | Me | SO₂Me | SO₂Me |
| 2-54 | Me | SO₂Me | CF₃ |
| 2-55 | Me | Cl | CF₃ |
| 2-56 | Me | S(O)Me | CF₃ |
| 2-57 | Me | SEt | OMe |
| 2-58 | Me | NMe₂ | SO₂Me |
| 2-59 | Me | NH(CH₂)₂OMe | SO₂Me |
| 2-60 | Me | O(CH₂)₄OMe | SO₂Me |
| 2-61 | Me | NH₂ | SO₂Me |
| 2-62 | Me | O(CH₂)₂—O(3,5-di- | SO₂Me |
| | | methoxypyrimidin-2-yl | |
| 2-63 | Me | O(CH₂)₂—O—NMe₂ | Cl |
| 2-64 | Me | O(CH₂)₂—NH(CO)NMe₂ | Cl |
| 2-65 | Me | O(CH₂)-5-pyrrolidin-2-one | Br |
| 2-66 | Me | O(CH₂)₂—NH(CO)NHCO₂Et | Cl |
| 2-67 | Me | O(CH₂)—(CO)NEt₂ | Br |
| 2-68 | Me | O(CH₂)-5-2,4-dimethyl-2,4- | Cl |
| | | dihydro-3H-1,2,4- | |
| | | triazol-3-one | |
| 2-69 | Me | O(CH₂)-3,5-dimethyl- | Cl |
| | | 1,2-oxazol-4-yl | |
| 2-70 | Me | O(CH₂)₂—NHCO₂Me | Cl |
| 2-71 | Me | 4,5-dihydro-1,2-oxazol-3-yl | SO₂Me |
| 2-72 | Me | Me | SO₂Me |
| 2-73 | Me | OH | SO₂Me |
| 2-74 | Me | O—CH₂—NHSO₂cPr | Cl |
| 2-75 | Me | O(CH₂)₂NHSO₂Me | SO₂Me |
| 2-76 | Me | S(O)Me | SO₂Me |
| 2-77 | Me | SMe | SO₂Me |
| 2-78 | Me | SMe | OMe |
| 2-79 | Me | S(O)Me | OMe |
| 2-80 | Me | SO₂Me | OMe |
| 2-81 | Me | SMe | Cl |
| 2-82 | Me | S(O)Me | Cl |
| 2-83 | Me | SO₂Me | Cl |
| 2-84 | Me | [1,4]dioxan-2-yl-methoxy | SO₂Me |
| 2-85 | Me | [1,4]dioxan-2-yl-methoxy | SO₂Et |
| 2-86 | Me | O(CH₂)₄OMe | SO₂Et |
| 2-87 | Me | O(CH₂)₃OMe | SO₂Me |
| 2-88 | Me | O(CH₂)₃OMe | SO₂Et |
| 2-89 | Me | O(CH₂)₂OMe | SO₂Me |
| 2-90 | Me | O(CH₂)₂OMe | SO₂Et |
| 2-91 | Me | S(O)Me | SO₂Me |
| 2-92 | Me | SMe | SO₂Me |
| 2-93 | Me | SMe | OMe |
| 2-94 | Me | S(O)Me | OMe |
| 2-95 | Me | SO₂Me | OMe |
| 2-96 | Me | SMe | Cl |
| 2-97 | Me | S(O)Me | Cl |
| 2-98 | Me | SO₂Me | Cl |
| 2-99 | Me | SMe | Br |
| 2-100 | Me | SOMe | Br |
| 2-101 | Me | SO₂Me | Br |
| 2-102 | Me | SMe | I |
| 2-103 | Me | SOMe | I |
| 2-104 | Me | SO₂Me | I |
| 2-105 | Me | SEt | Cl |
| 2-106 | Me | SOEt | Cl |
| 2-107 | Me | SO₂Et | Cl |
| 2-108 | Me | SEt | Br |
| 2-109 | Me | SOEt | Br |
| 2-110 | Me | SO₂Et | Br |
| 2-111 | Me | SEt | I |
| 2-112 | Me | SOEt | I |
| 2-113 | Me | SO₂Et | I |
| 2-114 | Me | SEt | F |
| 2-115 | Me | SOEt | F |
| 2-116 | Me | SO₂Et | F |
| 2-117 | Cl | OCH₂(CO)NMe₂ | Cl |
| 2-118 | Cl | CH₂OCH₂CF₃ | SO₂Me |
| 2-119 | Cl | 5-cyanomethyl-4,5- | SO₂Et |
| | | dihydro-1,2-oxazol-3-yl | |
| 2-120 | Cl | CH₂O-tetrahydro-furan-3-yl | SO₂Me |
| 2-121 | Cl | CH₂O-tetrahydrofuran-2-yl | SO₂Me |
| 2-122 | Cl | SMe | SO₂Me |
| 2-123 | Cl | F | SMe |
| 2-124 | Cl | CH₂OCH₂- | SO₂Me |
| | | tetrahydrofuran-2-yl | |
| 2-125 | Cl | CH₂OCH₂- | SO₂Et |
| | | tetrahydrofuran-3-yl | |
| 2-126 | Cl | O(CH₂)-5-pyrrolidin-2-one | Cl |
| 2-127 | Cl | SMe | Cl |
| 2-128 | Cl | S(O)Me | SO₂Me |
| 2-129 | Cl | CH₂O-tetrahydrofuran-3-yl | SO₂Et |
| 2-130 | Cl | O(CH₂)₂OMe | Cl |
| 2-131 | Cl | O(CH₂)₂OMe | SO₂Me |
| 2-132 | Cl | O(CH₂)₄OMe | SO₂Me |
| 2-133 | Cl | O(CH₂)₄OMe | SO₂Et |
| 2-134 | Cl | O(CH₂)₃OMe | SO₂Me |
| 2-135 | Cl | O(CH₂)₃OMe | SO₂Et |
| 2-136 | Cl | O(CH₂)₂OMe | SO₂Me |
| 2-137 | Cl | O(CH₂)₂OMe | SO₂Et |
| 2-138 | Cl | [1,4]dioxan-2-yl-methoxy | SO₂Me |
| 2-139 | Cl | [1,4]dioxan-2-yl-methoxy | SO₂Et |
| 2-140 | Cl | SO₂Me | Me |
| 2-141 | Cl | SEt | Me |
| 2-142 | Cl | SOEt | Me |
| 2-143 | Cl | SO₂Et | Me |
| 2-144 | Cl | 4,5-dihydro-1,2-oxazol-3-yl | SO₂Me |
| 2-145 | Cl | Cl | SO₂Me |
| 2-146 | F | SMe | CF₃ |
| 2-147 | F | S(O)Me | CF₃ |
| 2-148 | OMe | OMe | OMe |
| 2-149 | OMe | SMe | CF₃ |
| 2-150 | OMe | S(O)Me | CF₃ |
| 2-151 | OMe | SO₂Me | CF₃ |
| 2-152 | Et | NH(CH₂)₂OMe | SO₂Me |
| 2-153 | Et | F | SO₂Me |
| 2-154 | Et | SMe | CF₃ |
| 2-155 | CF₃ | F | SO₂Me |
| 2-156 | CF₃ | F | SO₂Et |
| 2-157 | CF₃ | O(CH₂)₂OMe | SO₂Et |
| 2-158 | CF₃ | O(CH₂)₃OMe | SO₂Et |
| 2-159 | CF₃ | O(CH₂)₂OMe | SO₂Me |
| 2-160 | CF₃ | O(CH₂)₃OMe | SO₂Me |
| 2-161 | CF₃ | OCH₂CONMe₂ | SO₂Me |
| 2-162 | CF₃ | OCH₂CONMe₂ | SO₂Et |
| 2-163 | CF₃ | OCH₂CONMe₂ | Cl |
| 2-164 | CF₃ | OCH₂CONMe₂ | Br |
| 2-165 | CF₃ | OCH₂CONMe₂ | I |
| 2-166 | CF₃ | OCH₂CONMe₂ | F |
| 2-167 | CF₃ | O(CH₂)₂OMe | Cl |
| 2-168 | CF₃ | O(CH₂)₃OMe | Cl |
| 2-169 | CF₃ | O(CH₂)₂OMe | Br |
| 2-170 | CF₃ | O(CH₂)₃OMe | Br |
| 2-171 | CF₃ | O(CH₂)₂OMe | I |
| 2-172 | CF₃ | O(CH₂)₃OMe | I |
| 2-173 | CF₃ | O(CH₂)₂OMe | F |
| 2-174 | CF₃ | O(CH₂)₃OMe | F |
| 2-175 | CF₃ | [1,4]dioxan-2-yl-methoxy | SO₂Me |
| 2-176 | CF₃ | [1,4]dioxan-2-yl-methoxy | SO₂Et |
| 2-177 | CF₃ | [1,4]dioxan-2-yl-methoxy | Cl |
| 2-178 | CF₃ | [1,4]dioxan-2-yl-methoxy | Br |
| 2-179 | CF₃ | [1,4]dioxan-2-yl-methoxy | I |
| 2-180 | CF₃ | [1,4]dioxan-2-yl-methoxy | F |
| 2-181 | Br | OMe | Br |
| 2-182 | Br | O(CH₂)₂OMe | Br |
| 2-183 | Br | O(CH₂)₄OMe | SO₂Me |
| 2-184 | Br | O(CH₂)₄OMe | SO₂Et |
| 2-185 | Br | O(CH₂)₃OMe | SO₂Me |
| 2-186 | Br | O(CH₂)₃OMe | SO₂Et |
| 2-187 | Br | O(CH₂)₂OMe | SO₂Me |
| 2-188 | Br | O(CH₂)₂OMe | SO₂Et |
| 2-189 | Br | [1,4]dioxan-2-yl-methoxy | SO₂Me |
| 2-190 | Br | [1,4]dioxan-2-yl-methoxy | SO₂Et |
| 2-191 | Br | SMe | Me |
| 2-192 | Br | SOMe | Me |
| 2-193 | Br | SO₂Me | Me |
| 2-194 | Br | SEt | Me |
| 2-195 | Br | SOEt | Me |
| 2-196 | Br | SO₂Et | Me |
| 2-197 | I | O(CH₂)₄OMe | SO₂Me |
| 2-198 | I | O(CH₂)₄OMe | SO₂Et |
| 2-199 | I | O(CH₂)₃OMe | SO₂Me |
| 2-200 | I | O(CH₂)₃OMe | SO₂Et |
| 2-201 | I | O(CH₂)₂OMe | SO₂Me |
| 2-202 | I | O(CH₂)₂OMe | SO₂Et |
| 2-203 | I | [1,4]dioxan-2-yl-methoxy | SO₂Me |
| 2-204 | I | [1,4]dioxan-2-yl-methoxy | SO₂Et |
| 2-205 | I | SMe | Me |
| 2-206 | I | SOMe | Me |
| 2-207 | I | SO₂Me | Me |
| 2-208 | I | SEt | Me |
| 2-209 | I | SOEt | Me |
| 2-210 | I | SO₂Et | Me |
| 2-211 | CH₂SMe | OMe | SO₂Me |
| 2-212 | CH₂OMe | OMe | SO₂Me |
| 2-213 | CH₂O(CH₂)₂OMe | NH(CH₂)₂OEt | SO₂Me |
| 2-214 | CH₂O(CH₂)₂OMe | NH(CH₂)₃OEt | SO₂Me |
| 2-215 | CH₂O(CH₂)₃OMe | OMe | SO₂Me |
| 2-216 | CH₂O(CH₂)₂OMe | NH(CH₂)₂OMe | SO₂Me |
| 2-217 | CH₂O(CH₂)₂OMe | NH(CH₂)₃OMe | SO₂Me |
| 2-218 | SO₂Me | NH₂ | CF₃ |
| 2-219 | SO₂Me | F | CF₃ |
| 2-220 | SO₂Me | NHEt | Cl |
| 2-221 | SMe | SEt | F |
| 2-222 | SMe | SMe | F |
| 2-223 | Me | NH₂ | Cl |
| 2-224 | Me | NH₂ | Br |
| 2-225 | Me | NHMe | Cl |
| 2-226 | Me | NHMe | Br |
| 2-227 | Me | NMe₂ | Cl |
| 2-228 | Me | NMe₂ | Br |
| 2-227 | Me | NMe₂ | Cl |
| 2-228 | Me | NMe₂ | Br |
| 2-229 | NO₂ | O(CH₂)₂OMe | Me |
| 2-230 | CF₃ | S(O)₂Et | SO₂Me |
| 2-231 | CF₃ | S(O)₂Et | SO₂Et |
| 2-232 | CF₃ | SCH₂CONMe₂ | SO₂Me |
| 2-233 | CF₃ | SCH₂CONMe₂ | SO₂Et |
| 2-234 | CF₃ | SCH₂COOH | SO₂Me |
| 2-235 | CF₃ | SCH₂COOH | SO₂Et |
| 2-236 | Me | SO₂—CH₂—CH₂—CH═CH₂ | CF₃ |
| 2-237 | Cl | Me | SO₂Et |
| 2-238 | CF₃ | SEt | SO₂Me |
| 2-239 | OMe | NO₂ | Cl |
| 2-240 | OMe | NH(CO)i-Pr | Cl |
| 2-241 | OMe | NH(CO)CH₂Ph | Cl |
| 2-242 | CF₃ | SEt | SO₂Et |
| 2-243 | CF₃ | S(O)Et | SO₂Me |
| 2-244 | Cl | Me | Cl |
| 2-245 | Me | 3,5-dimethylpyrazol-1-yl | SO₂Me |
| 2-247 | Me | 1,2,3-triazol-1-yl | SO₂Me |
| 2-248 | Me | Me | SMe |
| 2-249 | Me | pyrrolidin-2-on-1-yl | SO₂Me |
| 2-250 | CF₃ | S(O)Et | SO₂Et |
| 2-251 | Cl | pyrazol-1-yl | SO₂Me |
| 2-252 | Me | 3-methylpyrazol-1-yl | SO₂Me |
| 2-253 | Cl | CH₂—N(Et)OMe | SO₂Me |
| 2-254 | Me | Me | Cl |
| 2-255 | OH | Cl | Cl |
| 2-256 | Me | 1,2,4-triazol-1-yl | SO₂Me |
| 2-257 | Me | 4-methoxypyrazol-1-yl | SO₂Me |
| 2-258 | Me | 1,2,4-triazol-1-yl | CF₃ |
| 2-259 | Me | tetrahydro-pyrimidin- | SO₂Me |
| | | 2(1H)-on-1-yl | |
| 2-260 | Me | NH—(CH₂)₂—O(CO)Et | SO₂Me |
| 2-261 | Me | NH-iPr | SO₂Me |
| 2-262 | Cl | NH—CH₂—(CO)NHEt | Cl |
| 2-263 | Me | NH—CH₂—(CO)NMe₂ | SO₂Me |
| 2-264 | Me | NH—CH₂-furan-2-yl | SO₂Me |
| 2-265 | Me | NH—CH₂—(CO)NHEt | SO₂Me |
| 2-266 | Me | F | SO₂Me |
| 2-267 | F | SO₂Me | SO₂Me |
| 2-268 | Cl | (4-cyclopropyl-3- | Cl |
| | | methyl-5-oxo- | |
| | | 4,5-dihydro-1H-1,2,4- | |
| | | triazol-1-yl)methyl | |
| 2-269 | Cl | [4-methyl-5-oxo-3- | Cl |
| | | (2,2,2-trifluoro-ethoxy)-4,5- | |
| | | dihydro-1H-1,2,4- | |
| | | triazol-1-yl]methyl | |
| 2-270 | Cl | (3-isopropoxy-4-methyl- | Cl |
| | | 5-oxo-4,5- | |
| | | dihydro-1H-1,2,4- | |
| | | triazol-1-yl]methyl | |
| 2-271 | Cl | (4-methyl-5-oxo-4,5- | Cl |
| | | dihydro-1H- | |
| | | 1,2,4-triazol-1-yl)methyl | |
| 2-272 | Me | Cl | SO₂Et |
| 2-273 | SO₂Me | F | Cl |
| 2-274 | Me | 1,2,3-triazol-1-yl | SO₂Me |
| 2-275 | Me | isobutyl(methyl) | SO₂Me |
| | | carbamoylamino | |
| 2-276 | Me | 3-oxomorpholin-4-yl | SO₂Me |
| 2-277 | OMe | [ethyl(methylsulfonyl) | Cl |
| | | amino]-methyl | |
| 2-278 | F | SO₂Me | CF₃ |
| 2-279 | OMe | benzoylamino | Cl |
| 2-280 | OMe | cyclopropylcarbonylamino | Cl |
| 2-281 | OMe | propionylamino | Cl |
| 2-282 | NO₂ | SO₂Me | SO₂Me |
| 2-283 | NO₂ | SO₂Me | Cl |
| 2-284 | NO₂ | SOMe | SO₂Me |
| 2-285 | NO₂ | SOMe | Br |
| 2-286 | NO₂ | SOMe | Cl |
| 2-287 | NO₂ | SMe | SO₂Me |
| 2-288 | NO₂ | SMe | Br |
| 2-289 | NO₂ | SMe | Cl |
| 2-290 | Cl | CH₂OCH(CH₃)₂ | SO₂Et |
| 2-291 | Cl | CH₂OEt | SO₂Et |
| 2-292 | Cl | CH₂OMe | SO₂Et |
| 2-293 | Cl | CH₂OCH₂C₂F₅ | SO₂Me |
| 2-294 | Cl | CH₂OCH₂CH F₂ | SO₂Me |
| 2-295 | Cl | CH₂OCH₂CCH | SO₂Et |
| 2-296 | Cl | CH₂OC₂H₄OMe | SO₂Me |
| 2-297 | Cl | CH₂(OC₂H₄)₂OMe | SO₂Me |
| 2-298 | Cl | 5-ethoxymethyl-4,5- | SO₂Et |
| | | dihydro-1,2-oxazol-3-yl | |
| 2-299 | Cl | 5-methoxymethyl-4,5- | SO₂Et |
| | | dihydro-1,2-oxazol-3-yl | |
| 2-300 | Et | SOMe | CF₃ |
| 2-301 | iPr | SMe | CF₃ |
| 2-302 | Et | SMe | CF₃ |
| 2-303 | Et | SO₂Me | CF₃ |
| 2-304 | cPr | SOMe | CF₃ |
| 2-305 | CH═CH₂ | SMe | CF₃ |
| 2-306 | Et | SMe | Cl |
| 2-307 | Et | SO₂Me | Cl |
| 2-308 | CI | NMe₂ | Cl |
| 2-309 | CH₂O(CH₂)₂OMe | NH(CH₂)₃OMe | SO₂Me |
| 2-313 | Me | SO₂(CH₂)₂OMe | CF₃ |
| 2-314 | Me | SOEt | SO₂Me |
| 2-315 | Me | SO₂Et | SO₂Me |
| 2-316 | Me | SMe | 1,2,4-triazol- |
| | | | 1-yl |
| 2-317 | OEt | SMe | CF₃ |
| 2-318 | Me | S(CH₂)₂OMe | CF₃ |
| 2-319 | Me | SOMe | 1,2,4-triazol- |
| | | | 1-yl |
| 2-320 | OEt | SOMe | CF₃ |
| 2-321 | Me | SO(CH₂)₂OMe | CF₃ |
| 2-322 | Me | SCH₂CCMe | SO₂Me |
| 2-323 | Me | S-c-Pen | SO₂Me |
| 2-324 | OMe | SMe | OMe |
| 2-325 | Me | SCH₂CH═CHCH₃ | SO₂Me |
| 2-326 | Me | SOCH₂CCMe | SO₂Me |
| 2-327 | Me | SO₂-c-Pen | SO₂Me |
| 2-328 | Me | SO-c-Pen | SO₂Me |
| 2-329 | Me | S(CH₂)₃Cl | SO₂Me |
| 2-330 | Me | SCH₂(4-F-Ph) | SO₂Me |
| 2-331 | Me | SO₂CH₂CCMe | SO₂Me |
| 2-332 | Me | SO₂CH₂CH═CHCH₃ | SO₂Me |
| 2-333 | Me | SOCH₂CH═CHCH₃ | SO₂Me |
| 2-334 | Me | SOCH₂-Epoxy-Me | SO₂Me |
| 2-335 | Me | SO₂(CH₂)₃Cl | SO₂Me |
| 2-336 | Me | SO(CH₂)₃Cl | SO₂Me |
| 2-337 | Me | SOCH₂(4-F-Ph) | SO₂Me |
| 2-338 | Me | SO₂CH₂(4-F-Ph) | SO₂Me |
| 2-339 | Me | SO₂Me | C₂ F₅ |
| 2-340 | O(CH₂)₂OMe | SMe | CF₃ |
| 2-341 | O(CH₂)₂OMe | SO₂Me | CF₃ |
| 2-342 | O(CH₂)₂OMe | SOMe | CF₃ |
| 2-343 | Me | S(CH₂)₂OCH₂CF₃ | SO₂Me |
| 2-344 | Me | SO(CH₂)₂OCH₂CF₃ | SO₂Me |
| 2-345 | Me | SO₂(CH₂)₂OCH₂CF₃ | SO₂Me |
| 2-346 | OEt | SEt | CF₃ |
| 2-347 | O—CH₂-c-Pr | SMe | CF₃ |
| 2-348 | OMe | SEt | CF₃ |
| 2-349 | OMe | SO₂Et | CF₃ |
| 2-350 | OMe | SOEt | CF₃ |
| 2-351 | OEt | SO₂Et | CF₃ |
| 2-352 | OEt | SOEt | CF₃ |
| 2-353 | O—CH₂-c-Pr | SOMe | CF₃ |
| 2-354 | O—CH₂-c-Pr | SO₂Me | CF₃ |
| 2-355 | Me | SEt | SO₂Me |

TABLE 3
Compounds of the general formula (I) according to the invention in
which R is iso-propyl

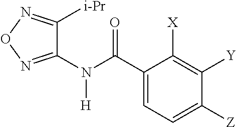

| No. | X | Y | Z |
|---|---|---|---|
| 3-1 | CF₃ | OCH₂CON(Me)Et | SO₂Me |
| 3-2 | CF₃ | OCH₂CON(Me)Et | SO₂Et |
| 3-4 | CF₃ | 2-(1H-pyrazol-1-yl)ethoxyl | SO₂Me |
| 3-5 | CF₃ | 2-(1H-pyrazol-1-yl)ethoxyl | SO₂Et |
| 3-6 | CF₃ | tetrahydrofuran- | SO₂Me |
| | | 2-ylmethoxy | |
| 3-7 | CF₃ | tetrahydrofuran- | SO₂Et |
| | | 2-ylmethoxy | |
| 3-8 | CF₃ | OH | SO₂Me |
| 3-9 | CF₃ | OH | SO₂Et |
| 3-10 | CF₃ | SH | SO₂Me |
| 3-11 | CF₃ | SH | SO₂Et |
| 3-15 | CF₃ | SMe | SO₂Me |
| 3-16 | CF₃ | SMe | SO₂Et |
| 3-17 | CF₃ | S(O)Me | SO₂Me |
| 3-24 | CF₃ | S(O)Me | SO₂Et |
| 3-25 | CF₃ | S(O)₂Me | SO₂Me |
| 3-26 | CF₃ | S(O)₂Me | SO₂Et |
| 3-27 | CF₃ | 2-[(methylsulfonyl) | SO₂Me |
| | | amino]ethoxy | |
| 3-28 | CF₃ | 2-[(methylsulfonyl)- | SO₂Me |
| | | amino]ethyl}sulfanyl | |
| 3-29 | CF₃ | 2-[(methylsulfonyl)- | SO₂Et |
| | | amino]ethyl}sulfanyl | |
| 3-30 | NO₂ | O(CH₂)₂OMe | OMe |
| 3-31 | NO₂ | OMe | Me |
| 3-32 | NO₂ | NH₂ | OMe |
| 3-33 | NO₂ | NH₂ | SO₂Et |
| 3-34 | NO₂ | NH₂ | Cl |
| 3-35 | NO₂ | NHMe | Cl |
| 3-36 | NO₂ | NMe₂ | Cl |
| 3-37 | NO₂ | NH₂ | Br |
| 3-38 | NO₂ | NHMe | Br |
| 3-39 | NO₂ | NMe₂ | Br |
| 3-40 | NO₂ | NH₂ | F |
| 3-41 | NO₂ | NHMe | F |
| 3-42 | NO₂ | NMe₂ | F |
| 3-43 | NO₂ | NH₂ | SO₂Me |
| 3-44 | NO₂ | NHMe | SO₂Me |
| 3-45 | NO₂ | NMe₂ | SO₂Me |
| 3-46 | NO₂ | NH₂ | 1H-1,2,4- |
| | | | triazol-1-yl |
| 3-47 | NO₂ | NHMe | 1H-1,2,4- |
| | | | triazol-1-yl |
| 3-48 | NO₂ | NMe₂ | 1H-1,2,4- |
| | | | triazol-1-yl |
| 3-49 | Me | F | F |
| 3-50 | Me | F | Cl |
| 3-51 | Me | SMe | CF₃ |
| 3-52 | Me | Cl | SO₂Me |
| 3-53 | Me | SO₂Me | SO₂Me |
| 3-54 | Me | SO₂Me | CF₃ |
| 3-55 | Me | Cl | CF₃ |
| 3-56 | Me | S(O)Me | CF₃ |
| 3-57 | Me | SEt | OMe |
| 3-58 | Me | NMe₂ | SO₂Me |
| 3-59 | Me | NH(CH₂)₂OMe | SO₂Me |
| 3-60 | Me | O(CH₂)₄OMe | SO₂Me |
| 3-61 | Me | NH₂ | SO₂Me |
| 3-62 | Me | O(CH₂)₂—O(3,5-di- | SO₂Me |
| | | methoxypyrimidin-2-yl | |
| 3-63 | Me | O(CH₂)₂—O—NMe₂ | Cl |
| 3-64 | Me | O(CH₂)₂—NH(CO)NMe₂ | Cl |
| 3-65 | Me | O(CH₂)-5-pyrrolidin-2-one | Br |
| 3-66 | Me | O(CH₂)₂—NH(CO)NHCO₂Et | Cl |
| 3-67 | Me | O(CH₂)—(CO)NEt₂ | Br |
| 3-68 | Me | O(CH₂)-5-2,4-dimethyl-2,4- | Cl |
| | | dihydro-3H-1,2,4- | |
| | | triazol-3-one | |
| 3-69 | Me | O(CH₂)-3,5-dimethyl- | Cl |
| | | 1,2-oxazol-4-yl | |
| 3-70 | Me | O(CH₂)₂—NHCO₂Me | Cl |
| 3-71 | Me | 4,5-dihydro-1,2-oxazol-3-yl | SO₂Me |
| 3-72 | Me | Me | SO₂Me |
| 3-73 | Me | OH | SO₂Me |
| 3-74 | Me | O—CH₂—NHSO₂cPr | Cl |
| 3-75 | Me | O(CH₂)₂NHSO₂Me | SO₂Me |
| 3-76 | Me | S(O)Me | SO₂Me |
| 3-77 | Me | SMe | SO₂Me |
| 3-78 | Me | SMe | OMe |
| 3-79 | Me | S(O)Me | OMe |
| 3-80 | Me | SO₂Me | OMe |
| 3-81 | Me | SMe | Cl |
| 3-82 | Me | S(O)Me | Cl |
| 3-83 | Me | SO₂Me | Cl |
| 3-84 | Me | [1,4]dioxan-2-yl-methoxy | SO₂Me |
| 3-85 | Me | [1,4]dioxan-2-yl-methoxy | SO₂Et |
| 3-86 | Me | O(CH₂)₄OMe | SO₂Et |
| 3-87 | Me | O(CH₂)₃OMe | SO₂Me |
| 3-88 | Me | O(CH₂)₃OMe | SO₂Et |
| 3-89 | Me | O(CH₂)₂OMe | SO₂Me |
| 3-90 | Me | O(CH₂)₂OMe | SO₂Et |
| 3-91 | Me | S(O)Me | SO₂Me |
| 3-92 | Me | SMe | SO₂Me |
| 3-93 | Me | SMe | OMe |
| 3-94 | Me | S(O)Me | OMe |
| 3-95 | Me | SO₂Me | OMe |
| 3-96 | Me | SMe | Cl |
| 3-97 | Me | S(O)Me | Cl |
| 3-98 | Me | SO₂Me | Cl |
| 3-99 | Me | SMe | Br |
| 3-100 | Me | SOMe | Br |
| 3-101 | Me | SO₂Me | Br |
| 3-102 | Me | SMe | I |
| 3-103 | Me | SOMe | I |
| 3-104 | Me | SO₂Me | I |
| 3-105 | Me | SEt | Cl |
| 3-106 | Me | SOEt | Cl |
| 3-107 | Me | SO₂Et | Cl |
| 3-108 | Me | SEt | Br |
| 3-109 | Me | SOEt | Br |
| 3-110 | Me | SO₂Et | Br |
| 3-111 | Me | SEt | I |
| 3-112 | Me | SOEt | I |
| 3-113 | Me | SO₂Et | I |
| 3-114 | Me | SEt | F |
| 3-115 | Me | SOEt | F |
| 3-116 | Me | SO₂Et | F |
| 3-117 | Cl | OCH₂(CO)NMe₂ | Cl |
| 3-118 | Cl | CH₂OCH₂CF₃ | SO₂Me |
| 3-119 | Cl | 5-cyanomethyl-4,5- | SO₂Et |
| | | dihydro-1,2-oxazol-3-yl | |
| 3-120 | Cl | CH₂O-tetrahydro-furan-3-yl | SO₂Me |
| 3-121 | Cl | CH₂O-tetrahydrofuran-2-yl | SO₂Me |
| 3-122 | Cl | SMe | SO₂Me |
| 3-123 | Cl | F | SMe |
| 3-124 | Cl | CH₂OCH₂-tetrahydrofuran-2-yl | SO₂Me |
| 3-125 | Cl | CH₂OCH₂-tetrahydrofuran-3-yl | SO₂Et |
| 3-126 | Cl | O(CH₂)-5-pyrrolidin-2-one | Cl |
| 3-127 | Cl | SMe | Cl |
| 3-128 | Cl | S(O)Me | SO₂Me |
| 3-129 | Cl | CH₂O-tetrahydrofuran-3-yl | SO₂Et |
| 3-130 | Cl | O(CH₂)₂OMe | Cl |
| 3-131 | Cl | O(CH₂)₂OMe | SO₂Me |
| 3-132 | Cl | O(CH₂)₄OMe | SO₂Me |
| 3-133 | Cl | O(CH₂)₄OMe | SO₂Et |
| 3-134 | Cl | O(CH₂)₃OMe | SO₂Me |
| 3-135 | Cl | O(CH₂)₃OMe | SO₂Et |
| 3-136 | Cl | O(CH₂)₂OMe | SO₂Me |
| 3-137 | Cl | O(CH₂)₂OMe | SO₂Et |
| 3-138 | Cl | [1,4]dioxan-2-yl-methoxy | SO₂Me |
| 3-139 | Cl | [1,4]dioxan-2-yl-methoxy | SO₂Et |
| 3-140 | Cl | SO₂Me | Me |
| 3-141 | Cl | SEt | Me |
| 3-142 | Cl | SOEt | Me |
| 3-143 | Cl | SO₂Et | Me |
| 3-144 | Cl | 4,5-dihydro-1,2-oxazol-3-yl | SO₂Me |
| 3-145 | Cl | Cl | SO₂Me |
| 3-146 | F | SMe | CF₃ |
| 3-147 | F | S(O)Me | CF₃ |
| 3-148 | OMe | OMe | OMe |
| 3-149 | OMe | SMe | CF₃ |
| 3-150 | OMe | S(O)Me | CF₃ |
| 3-151 | OMe | SO₂Me | CF₃ |
| 3-152 | Et | NH(CH₂)₂OMe | SO₂Me |
| 3-153 | Et | F | SO₂Me |
| 3-154 | Et | SMe | CF₃ |
| 3-155 | CF₃ | F | SO₂Me |
| 3-156 | CF₃ | F | SO₂Et |
| 3-157 | CF₃ | O(CH₂)₂OMe | SO₂Et |
| 3-158 | CF₃ | O(CH₂)₃OMe | SO₂Et |
| 3-159 | CF₃ | O(CH₂)₂OMe | SO₂Me |
| 3-160 | CF₃ | O(CH₂)₃OMe | SO₂Me |
| 3-161 | CF₃ | OCH₂CONMe₂ | SO₂Me |
| 3-162 | CF₃ | OCH₂CONMe₂ | SO₂Et |
| 3-163 | CF₃ | OCH₂CONMe₂ | Cl |
| 3-164 | CF₃ | OCH₂CONMe₂ | Br |
| 3-165 | CF₃ | OCH₂CONMe₂ | I |
| 3-166 | CF₃ | OCH₂CONMe₂ | F |
| 3-167 | CF₃ | O(CH₂)₂OMe | Cl |
| 3-168 | CF₃ | O(CH₂)₃OMe | Cl |
| 3-169 | CF₃ | O(CH₂)₂OMe | Br |
| 3-170 | CF₃ | O(CH₂)₃OMe | Br |
| 3-171 | CF₃ | O(CH₂)₂OMe | I |
| 3-172 | CF₃ | O(CH₂)₃OMe | I |
| 3-173 | CF₃ | O(CH₂)₂OMe | F |
| 3-174 | CF₃ | O(CH₂)₃OMe | F |
| 3-175 | CF₃ | [1,4]dioxan-2-yl-methoxy | SO₂Me |
| 3-176 | CF₃ | [1,4]dioxan-2-yl-methoxy | SO₂Et |
| 3-177 | CF₃ | [1,4]dioxan-2-yl-methoxy | Cl |
| 3-178 | CF₃ | [1,4]dioxan-2-yl-methoxy | Br |
| 3-179 | CF₃ | [1,4]dioxan-2-yl-methoxy | I |
| 3-180 | CF₃ | [1,4]dioxan-2-yl-methoxy | F |
| 3-181 | Br | OMe | Br |
| 3-182 | Br | O(CH₂)₂OMe | Br |
| 3-183 | Br | O(CH₂)₄OMe | SO₂Me |
| 3-184 | Br | O(CH₂)₄OMe | SO₂Et |
| 3-185 | Br | O(CH₂)₃OMe | SO₂Me |
| 3-186 | Br | O(CH₂)₃OMe | SO₂Et |
| 3-187 | Br | O(CH₂)₂OMe | SO₂Me |
| 3-188 | Br | O(CH₂)₂OMe | SO₂Et |
| 3-189 | Br | [1,4]dioxan-2-yl-methoxy | SO₂Me |
| 3-190 | Br | [1,4]dioxan-2-yl-methoxy | SO₂Et |
| 3-191 | Br | SMe | Me |
| 3-192 | Br | SOMe | Me |
| 3-193 | Br | SO₂Me | Me |
| 3-194 | Br | SEt | Me |
| 3-195 | Br | SOEt | Me |
| 3-196 | Br | SO₂Et | Me |
| 3-197 | I | O(CH₂)₄OMe | SO₂Me |
| 3-198 | I | O(CH₂)₄OMe | SO₂Et |
| 3-199 | I | O(CH₂)₃OMe | SO₂Me |
| 3-200 | I | O(CH₂)₃OMe | SO₂Et |
| 3-201 | I | O(CH₂)₂OMe | SO₂Me |
| 3-202 | I | O(CH₂)₂OMe | SO₂Et |
| 3-203 | I | [1,4]dioxan-2-yl-methoxy | SO₂Me |
| 3-204 | I | [1,4]dioxan-2-yl-methoxy | SO₂Et |
| 3-205 | I | SMe | Me |
| 3-206 | I | SOMe | Me |
| 3-207 | I | SO₂Me | Me |
| 3-208 | I | SEt | Me |
| 3-209 | I | SOEt | Me |
| 3-210 | I | SO₂Et | Me |
| 3-211 | CH₂SMe | OMe | SO₂Me |
| 3-212 | CH₂OMe | OMe | SO₂Me |
| 3-213 | CH₂O(CH₂)₂OMe | NH(CH₂)₂OEt | SO₂Me |
| 3-214 | CH₂O(CH₂)₂OMe | NH(CH₂)₃OEt | SO₂Me |
| 3-215 | CH₂O(CH₂)₃OMe | OMe | SO₂Me |
| 3-216 | CH₂O(CH₂)₂OMe | NH(CH₂)₂OMe | SO₂Me |
| 3-217 | CH₂O(CH₂)₂OMe | NH(CH₂)₃OMe | SO₂Me |
| 3-218 | SO₂Me | NH₂ | CF₃ |
| 3-219 | SO₂Me | F | CF₃ |
| 3-220 | SO₂Me | NHEt | Cl |
| 3-221 | SMe | SEt | F |
| 3-222 | SMe | SMe | F |
| 3-223 | Me | NH₂ | Cl |
| 3-224 | Me | NH₂ | Br |
| 3-225 | Me | NHMe | Cl |
| 3-226 | Me | NHMe | Br |
| 3-227 | Me | NMe₂ | Cl |
| 3-228 | Me | NMe₂ | Br |
| 3-227 | Me | NMe₂ | Cl |
| 3-228 | Me | NMe₂ | Br |
| 3-229 | NO₂ | O(CH₂)₂OMe | Me |
| 3-230 | CF₃ | S(O)₂Et | SO₂Me |
| 3-231 | CF₃ | S(O)₂Et | SO₂Et |
| 3-232 | CF₃ | SCH₂CONMe₂ | SO₂Me |
| 3-233 | CF₃ | SCH₂CONMe₂ | SO₂Et |
| 3-234 | CF₃ | SCH₂COOH | SO₂Me |
| 3-235 | CF₃ | SCH₂COOH | SO₂Et |
| 3-236 | Me | SO₂—CH₂—CH₂—CH═CH₂ | CF₃ |
| 3-237 | Cl | Me | SO₂Et |
| 3-238 | CF₃ | SEt | SO₂Me |
| 3-239 | OMe | NO₂ | Cl |
| 3-240 | OMe | NH(CO)i-Pr | Cl |
| 3-241 | OMe | NH(CO)CH₂Ph | Cl |
| 3-242 | CF₃ | SEt | SO₂Et |
| 3-243 | CF₃ | S(O)Et | SO₂Me |
| 3-244 | Cl | Me | Cl |
| 3-245 | Me | 3,5-dimethylpyrazol-1-yl | SO₂Me |
| 3-247 | Me | 1,2,3-triazol-1-yl | SO₂Me |
| 3-248 | Me | Me | SMe |
| 3-249 | Me | pyrrolidin-2-on-1-yl | SO₂Me |
| 3-250 | CF₃ | S(O)Et | SO₂Et |
| 3-251 | Cl | pyrazol-1-yl | SO₂Me |
| 3-252 | Me | 3-methylpyrazol-1-yl | SO₂Me |
| 3-253 | Cl | CH₂—N(Et)OMe | SO₂Me |
| 3-254 | Me | Me | Cl |
| 3-255 | OH | Cl | Cl |
| 3-256 | Me | 1,2,4-triazol-1-yl | SO₂Me |
| 3-257 | Me | 4-methoxypyrazol-1-yl | SO₂Me |
| 3-258 | Me | 1,2,4-triazol-1-yl | CF₃ |
| 3-259 | Me | tetrahydro-pyrimidin- | SO₂Me |
| | | 2(1H)-on-1-yl | |
| 3-260 | Me | NH—(CH₂)₂—O(CO)Et | SO₂Me |
| 3-261 | Me | NH-iPr | SO₂Me |
| 3-262 | Cl | NH—CH₂—(CO)NHEt | Cl |
| 3-263 | Me | NH—CH₂—(CO)NMe₂ | SO₂Me |
| 3-264 | Me | NH—CH₂-furan-2-yl | SO₂Me |
| 3-265 | Me | NH—CH₂—(CO)NHEt | SO₂Me |
| 3-266 | Me | F | SO₂Me |
| 3-267 | F | SO₂Me | SO₂Me |
| 3-268 | Cl | (4-cyclopropyl-3-methyl- | Cl |
| | | 5-oxo-4,5-dihydro- | |
| | | 1H-1,2,4-triazol-1- | |
| | | yl)methyl | |
| 3-269 | Cl | [4-methyl-5-oxo-3- | Cl |
| | | (2,2,2-trifluoro-ethoxy)- | |
| | | 4,5-dihydro-1H-1,2,4- | |
| | | triazol-1-yl]methyl | |
| 3-270 | Cl | (3-isopropoxy-4-methyl- | Cl |
| | | 5-oxo-4,5-dihydro- | |
| | | 1H-1,2,4-triazol-1- | |
| | | yl]methyl | |
| 3-271 | Cl | (4-methyl-5-oxo-4,5- | Cl |
| | | dihydro-1H- | |
| | | 1,2,4-triazol-1-yl)methyl | |
| 3-272 | Me | Cl | SO₂Et |
| 3-273 | SO₂Me | F | Cl |
| 3-274 | Me | 1,2,3-triazol-1-yl | SO₂Me |
| 3-275 | Me | isobutyl(methyl) | SO₂Me |
| | | carbamoylamino | |
| 3-276 | Me | 3-oxomorpholin-4-yl | SO₂Me |
| 3-277 | OMe | [ethyl(methylsulfonyl) | Cl |
| | | amino]-methyl | |
| 3-278 | F | SO₂Me | CF₃ |
| 3-279 | OMe | benzoylamino | Cl |
| 3-280 | OMe | cyclopropylcarbonylamino | Cl |
| 3-281 | OMe | propionylamino | Cl |
| 3-282 | NO₂ | SO₂Me | SO₂Me |
| 3-283 | NO₂ | SO₂Me | Cl |
| 3-284 | NO₂ | SOMe | SO₂Me |
| 3-285 | NO₂ | SOMe | Br |
| 3-286 | NO₂ | SOMe | Cl |
| 3-287 | NO₂ | SMe | SO₂Me |
| 3-288 | NO₂ | SMe | Br |
| 3-289 | NO₂ | SMe | Cl |
| 3-290 | Cl | CH₂OCH(CH₃)₂ | SO₂Et |
| 3-291 | Cl | CH₂OEt | SO₂Et |
| 3-292 | Cl | CH₂OMe | SO₂Et |
| 3-293 | Cl | CH₂OCH₂C₂F₅ | SO₂Me |
| 3-294 | Cl | CH₂OCH₂CH F₂ | SO₂Me |
| 3-295 | Cl | CH₂OCH₂CCH | SO₂Et |
| 3-296 | Cl | CH₂OC₂H₄OMe | SO₂Me |
| 3-297 | Cl | CH₂(OC₂H₄)₂OMe | SO₂Me |
| 3-298 | Cl | 5-ethoxymethyl-4,5- | SO₂Et |
| | | dihydro-1,2-oxazol-3-yl | |
| 3-299 | Cl | 5-methoxymethyl-4,5- | SO₂Et |
| | | dihydro-1,2-oxazol-3-yl | |
| 3-300 | Et | SOMe | CF₃ |
| 3-301 | iPr | SMe | CF₃ |
| 3-302 | Et | SMe | CF₃ |
| 3-303 | Et | SO₂Me | CF₃ |
| 3-304 | cPr | SOMe | CF₃ |
| 3-305 | CH═CH₂ | SMe | CF₃ |
| 3-306 | Et | SMe | Cl |
| 3-307 | Et | SO₂Me | Cl |
| 3-308 | CI | NMe₂ | Cl |
| 3-309 | CH₂O(CH₂)₂OMe | NH(CH₂)₃OMe | SO₂Me |
| 3-313 | Me | SO₂(CH₂)₂OMe | CF₃ |
| 3-314 | Me | SOEt | SO₂Me |
| 3-315 | Me | SO₂Et | SO₂Me |
| 3-316 | Me | SMe | 1,2,4-triazol- |
| | | | 1-yl |
| 3-317 | OEt | SMe | CF₃ |
| 3-318 | Me | S(CH₂)₂OMe | CF₃ |
| 3-319 | Me | SOMe | 1,2,4-triazol- |
| | | | 1-yl |
| 3-320 | OEt | SOMe | CF₃ |
| 3-321 | Me | SO(CH₂)₂OMe | CF₃ |
| 3-322 | Me | SCH₂CCMe | SO₂Me |
| 3-323 | Me | S-c- Pen | SO₂Me |
| 3-324 | OMe | SMe | OMe |
| 3-325 | Me | SCH₂CH═CHCH₃ | SO₂Me |
| 3-326 | Me | SOCH₂CCMe | SO₂Me |
| 3-327 | Me | SO₂-c-Pen | SO₂Me |
| 3-328 | Me | SO-c-Pen | SO₂Me |
| 3-329 | Me | S(CH₂)₃Cl | SO₂Me |
| 3-330 | Me | SCH₂(4-F-Ph) | SO₂Me |
| 3-331 | Me | SO₂CH₂CCMe | SO₂Me |
| 3-332 | Me | SO₂CH₂CH═CHCH₃ | SO₂Me |
| 3-333 | Me | SOCH₂CH═CHCH₃ | SO₂Me |
| 3-334 | Me | SOCH₂-Epoxy-Me | SO₂Me |
| 3-335 | Me | SO₂(CH₂)₃Cl | SO₂Me |
| 3-336 | Me | SO(CH₂)₃Cl | SO₂Me |
| 3-337 | Me | SOCH₂(4-F-Ph) | SO₂Me |
| 3-338 | Me | SO₂CH₂(4-F-Ph) | SO₂Me |
| 3-339 | Me | SO₂Me | C₂ F₅ |
| 3-340 | O(CH₂)₂OMe | SMe | CF₃ |
| 3-341 | O(CH₂)₂OMe | SO₂Me | CF₃ |
| 3-342 | O(CH₂)₂OMe | SOMe | CF₃ |
| 3-343 | Me | S(CH₂)₂OCH₂CF₃ | SO₂Me |
| 3-344 | Me | SO(CH₂)₂OCH₂CF₃ | SO₂Me |
| 3-345 | Me | SO₂(CH₂)₂OCH₂CF₃ | SO₂Me |
| 3-346 | OEt | SEt | CF₃ |
| 3-347 | O—CH₂-c-Pr | SMe | CF₃ |
| 3-348 | OMe | SEt | CF₃ |
| 3-349 | OMe | SO₂Et | CF₃ |
| 3-350 | OMe | SOEt | CF₃ |
| 3-351 | OEt | SO₂Et | CF₃ |
| 3-352 | OEt | SOEt | CF₃ |
| 3-353 | O—CH₂-c-Pr | SOMe | CF₃ |
| 3-354 | O—CH₂-c-Pr | SO₂Me | CF₃ |
| 3-355 | Me | SEt | SO₂Me |

TABLE 4
Compounds of the general formula (I) according to the invention in
which R is propyl

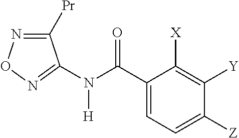

| No. | X | Y | Z |
|---|---|---|---|
| 4-1 | CF₃ | OCH₂CON(Me)Et | SO₂Me |
| 4-2 | CF₃ | OCH₂CON(Me)Et | SO₂Et |
| 4-4 | CF₃ | 2-(1H-pyrazol-1-yl)ethoxyl | SO₂Me |
| 4-5 | CF₃ | 2-(1H-pyrazol-1-yl)ethoxyl | SO₂Et |
| 4-6 | CF₃ | tetrahydrofuran-2-yl-methoxy | SO₂Me |
| 4-7 | CF₃ | tetrahydrofuran-2-yl-methoxy | SO₂Et |
| 4-8 | CF₃ | OH | SO₂Me |
| 4-9 | CF₃ | OH | SO₂Et |
| 4-10 | CF₃ | SH | SO₂Me |
| 4-11 | CF₃ | SH | SO₂Et |
| 4-15 | CF₃ | SMe | SO₂Me |
| 4-16 | CF₃ | SMe | SO₂Et |
| 4-17 | CF₃ | S(O)Me | SO₂Me |
| 4-24 | CF₃ | S(O)Me | SO₂Et |
| 4-25 | CF₃ | S(O)₂Me | SO₂Me |
| 4-26 | CF₃ | S(O)₂Me | SO₂Et |
| 4-27 | CF₃ | 2-[(methylsulfonyl)amino]ethoxy | SO₂Me |
| 4-28 | CF₃ | 2-[(methylsulfonyl)-amino]ethyl}sulfanyl | SO₂Me |
| 4-29 | CF₃ | 2-[(methylsulfonyl)-amino]ethyl}sulfanyl | SO₂Et |
| 4-30 | NO₂ | O(CH₂)₂OMe | OMe |
| 4-31 | NO₂ | OMe | Me |
| 4-32 | NO₂ | NH₂ | OMe |
| 4-33 | NO₂ | NH₂ | SO₂Et |
| 4-34 | NO₂ | NH₂ | Cl |
| 4-35 | NO₂ | NHMe | Cl |
| 4-36 | NO₂ | NMe₂ | Cl |
| 4-37 | NO₂ | NH₂ | Br |
| 4-38 | NO₂ | NHMe | Br |
| 4-39 | NO₂ | NMe₂ | Br |
| 4-40 | NO₂ | NH₂ | F |
| 4-41 | NO₂ | NHMe | F |
| 4-42 | NO₂ | NMe₂ | F |
| 4-43 | NO₂ | NH₂ | SO₂Me |
| 4-44 | NO₂ | NHMe | SO₂Me |
| 4-45 | NO₂ | NMe₂ | SO₂Me |
| 4-46 | NO₂ | NH₂ | 1H-1,2,4-triazol-1-yl |
| 4-47 | NO₂ | NHMe | 1H-1,2,4-triazol-1-yl |
| 4-48 | NO₂ | NMe₂ | 1H-1,2,4-triazol-1-yl |
| 4-49 | Me | F | F |
| 4-50 | Me | F | Cl |
| 4-51 | Me | SMe | CF₃ |
| 4-52 | Me | Cl | SO₂Me |
| 4-53 | Me | SO₂Me | SO₂Me |
| 4-54 | Me | SO₂Me | CF₃ |
| 4-55 | Me | Cl | CF₃ |
| 4-56 | Me | S(O)Me | CF₃ |
| 4-57 | Me | SEt | OMe |
| 4-58 | Me | NMe₂ | SO₂Me |
| 4-59 | Me | NH(CH₂)₂OMe | SO₂Me |
| 4-60 | Me | O(CH₂)₄OMe | SO₂Me |
| 4-61 | Me | NH₂ | SO₂Me |
| 4-62 | Me | O(CH₂)₂—O(3,5-di-methoxypyrimidin-2-yl | SO₂Me |
| 4-63 | Me | O(CH₂)₂—O—NMe₂ | Cl |
| 4-64 | Me | O(CH₂)₂—NH(CO)NMe₂ | Cl |
| 4-65 | Me | O(CH₂)-5-pyrrolidin-2-one | Br |
| 4-66 | Me | O(CH₂)₂—NH(CO)NHCO₂Et | Cl |
| 4-67 | Me | O(CH₂)—(CO)NEt₂ | Br |
| 4-68 | Me | O(CH₂)-5-2,4-dimethyl-2,4-dihydro-3H- | Cl |
| | | 1,2,4-triazol-3-one | |
| 4-69 | Me | O(CH₂)-3,5-dimethyl-1,2-oxazol-4-yl | Cl |
| 4-70 | Me | O(CH₂)₂—NHCO₂Me | Cl |
| 4-71 | Me | 4,5-dihydro-1,2-oxazol-3-yl | SO₂Me |
| 4-72 | Me | Me | SO₂Me |
| 4-73 | Me | OH | SO₂Me |
| 4-74 | Me | O—CH₂—NHSO₂cPr | Cl |
| 4-75 | Me | O(CH₂)₂NHSO₂Me | SO₂Me |
| 4-76 | Me | S(O)Me | SO₂Me |
| 4-77 | Me | SMe | SO₂Me |
| 4-78 | Me | SMe | OMe |
| 4-79 | Me | S(O)Me | OMe |
| 4-80 | Me | SO₂Me | OMe |
| 4-81 | Me | SMe | Cl |
| 4-82 | Me | S(O)Me | Cl |
| 4-83 | Me | SO₂Me | Cl |
| 4-84 | Me | [1,4]dioxan-2-yl-methoxy | SO₂Me |
| 4-85 | Me | [1,4]dioxan-2-yl-methoxy | SO₂Et |
| 4-86 | Me | O(CH₂)₄OMe | SO₂Et |
| 4-87 | Me | O(CH₂)₃OMe | SO₂Me |
| 4-88 | Me | O(CH₂)₃OMe | SO₂Et |
| 4-89 | Me | O(CH₂)₂OMe | SO₂Me |
| 4-90 | Me | O(CH₂)₂OMe | SO₂Et |
| 4-91 | Me | S(O)Me | SO₂Me |
| 4-92 | Me | SMe | SO₂Me |
| 4-93 | Me | SMe | OMe |
| 4-94 | Me | S(O)Me | OMe |
| 4-95 | Me | SO₂Me | OMe |
| 4-96 | Me | SMe | Cl |
| 4-97 | Me | S(O)Me | Cl |
| 4-98 | Me | SO₂Me | Cl |
| 4-99 | Me | SMe | Br |
| 4-100 | Me | SOMe | Br |
| 4-101 | Me | SO₂Me | Br |
| 4-102 | Me | SMe | I |
| 4-103 | Me | SOMe | I |
| 4-104 | Me | SO₂Me | I |
| 4-105 | Me | SEt | Cl |
| 4-106 | Me | SOEt | Cl |
| 4-107 | Me | SO₂Et | Cl |
| 4-108 | Me | SEt | Br |
| 4-109 | Me | SOEt | Br |
| 4-110 | Me | SO₂Et | Br |
| 4-111 | Me | SEt | I |
| 4-112 | Me | SOEt | I |
| 4-113 | Me | SO₂Et | I |
| 4-114 | Me | SEt | F |
| 4-115 | Me | SOEt | F |
| 4-116 | Me | SO₂Et | F |
| 4-117 | Cl | OCH₂(CO)NMe₂ | Cl |
| 4-118 | Cl | Cl | SO₂Me |
| 4-119 | Cl | CH₂OCH₂CF₃ | SO₂Me |
| 4-120 | Cl | 5-cyanomethyl-4,5-dihydro-1,2- oxazol-3-yl | SO₂Et |
| 4-121 | Cl | CH₂O-tetrahydrofuran-3-yl | SO₂Me |
| 4-122 | Cl | CH₂O-tetrahydrofuran-2-yl | SO₂Me |
| 4-123 | Cl | SMe | SO₂Me |
| 4-124 | Cl | F | SMe |
| 4-125 | Cl | CH₂OCH₂-tetrahydrofuran-2-yl | SO₂Me |
| 4-126 | Cl | CH₂OCH₂-tetrahydrofuran-3-yl | SO₂Et |
| 4-127 | Cl | O(CH₂)-5-pyrrolidin-2-one | Cl |
| 4-128 | Cl | SMe | Cl |
| 4-129 | Cl | S(O)Me | SO₂Me |
| 4-130 | Cl | CH₂O-tetrahydrofuran-3-yl | SO₂Et |
| 4-131 | Cl | O(CH₂)₂OMe | Cl |
| 4-132 | Cl | O(CH₂)₂OMe | SO₂Me |
| 4-133 | Cl | O(CH₂)₄OMe | SO₂Me |
| 4-134 | Cl | O(CH₂)₄OMe | SO₂Et |
| 4-135 | Cl | O(CH₂)₃OMe | SO₂Me |
| 4-136 | Cl | O(CH₂)₃OMe | SO₂Et |
| 4-137 | Cl | O(CH₂)₂OMe | SO₂Me |
| 4-138 | Cl | O(CH₂)₂OMe | SO₂Et |
| 4-139 | Cl | [1,4]dioxan-2-yl-methoxy | SO₂Me |
| 4-140 | Cl | [1,4]dioxan-2-yl-methoxy | SO₂Et |
| 4-141 | Cl | SO₂Me | Me |
| 4-142 | Cl | SEt | Me |
| 4-143 | Cl | SOEt | Me |
| 4-144 | Cl | SO₂Et | Me |
| 2-145 | Cl | 4,5-dihydro-1,4-oxazol-3-yl | SO₂Me |
| 4-146 | Cl | Cl | SO₂Me |
| 4-147 | F | SMe | CF₃ |
| 4-148 | F | S(O)Me | CF₃ |
| 4-149 | OMe | SMe | CF₃ |
| 4-150 | OMe | S(O)Me | CF₃ |
| 4-151 | OMe | SO₂Me | CF₃ |
| 4-152 | Et | NH(CH₂)₂OMe | SO₂Me |
| 4-153 | Et | F | SO₂Me |
| 4-154 | Et | SMe | CF₃ |
| 4-155 | CF₃ | F | SO₂Me |
| 4-156 | CF₃ | F | SO₂Et |
| 4-157 | CF₃ | O(CH₂)₂OMe | SO₂Et |
| 4-158 | CF₃ | O(CH₂)₃OMe | SO₂Et |
| 4-159 | CF₃ | O(CH₂)₂OMe | SO₂Me |
| 4-160 | CF₃ | O(CH₂)₃OMe | SO₂Me |
| 4-161 | CF₃ | OCH₂CONMe₂ | SO₂Me |
| 4-162 | CF₃ | OCH₂CONMe₂ | SO₂Et |
| 4-163 | CF₃ | OCH₂CONMe₂ | Cl |
| 4-164 | CF₃ | OCH₂CONMe₂ | Br |
| 4-165 | CF₃ | OCH₂CONMe₂ | I |
| 4-166 | CF₃ | OCH₂CONMe₂ | F |
| 4-167 | CF₃ | O(CH₂)₂OMe | Cl |
| 4-168 | CF₃ | O(CH₂)₃OMe | Cl |
| 4-169 | CF₃ | O(CH₂)₂OMe | Br |
| 4-170 | CF₃ | O(CH₂)₃OMe | Br |
| 4-171 | CF₃ | O(CH₂)₂OMe | I |
| 4-172 | CF₃ | O(CH₂)₃OMe | I |
| 4-173 | CF₃ | O(CH₂)₂OMe | F |
| 4-174 | CF₃ | O(CH₂)₃OMe | F |
| 4-175 | CF₃ | [1,4]dioxan-2-yl-methoxy | SO₂Me |
| 4-176 | CF₃ | [1,4]dioxan-2-yl-methoxy | SO₂Et |
| 4-177 | CF₃ | [1,4]dioxan-2-yl-methoxy | Cl |
| 2-178 | CF₃ | [1,4]dioxan-2-yl-methoxy | Br |
| 4-179 | CF₃ | [1,4]dioxan-2-yl-methoxy | I |
| 4-180 | CF₃ | [1,4]dioxan-2-yl-methoxy | F |
| 4-181 | Br | OMe | Br |
| 4-182 | Br | O(CH₂)₂OMe | Br |
| 4-183 | Br | O(CH₂)₄OMe | SO₂Me |
| 4-184 | Br | O(CH₂)₄OMe | SO₂Et |
| 4-185 | Br | O(CH₂)₃OMe | SO₂Me |
| 4-186 | Br | O(CH₂)₃OMe | SO₂Et |
| 4-187 | Br | O(CH₂)₂OMe | SO₂Me |
| 4-188 | Br | O(CH₂)₂OMe | SO₂Et |
| 4-189 | Br | [1,4]dioxan-2-yl-methoxy | SO₂Me |
| 4-190 | Br | [1,4]dioxan-2-yl-methoxy | SO₂Et |
| 4-191 | Br | SMe | Me |
| 4-192 | Br | SOMe | Me |
| 4-193 | Br | SO₂Me | Me |
| 4-194 | Br | SEt | Me |
| 4-195 | Br | SOEt | Me |
| 4-196 | Br | SO₂Et | Me |
| 4-197 | I | O(CH₂)₄OMe | SO₂Me |
| 4-198 | I | O(CH₂)₄OMe | SO₂Et |
| 4-199 | I | O(CH₂)₃OMe | SO₂Me |
| 4-200 | I | O(CH₂)₃OMe | SO₂Et |
| 4-201 | I | O(CH₂)₂OMe | SO₂Me |
| 4-202 | I | O(CH₂)₂OMe | SO₂Et |
| 4-203 | I | [1,4]dioxan-2-yl-methoxy | SO₂Me |
| 4-204 | I | [1,4]dioxan-2-yl-methoxy | SO₂Et |
| 4-205 | I | SMe | Me |
| 4-206 | I | SOMe | Me |
| 4-207 | I | SO₂Me | Me |
| 4-208 | I | SEt | Me |
| 4-209 | I | SOEt | Me |
| 4-210 | I | SO₂Et | Me |
| 4-211 | CH₂SMe | OMe | SO₂Me |
| 4-212 | CH₂OMe | OMe | SO₂Me |
| 4-213 | CH₂O(CH₂)₂OMe | NH(CH₂)₂OEt | SO₂Me |
| 4-214 | CH₂O(CH₂)₂OMe | NH(CH₂)₃OEt | SO₂Me |
| 4-215 | CH₂O(CH₂)₃OMe | OMe | SO₂Me |
| 4-216 | CH₂O(CH₂)₂OMe | NH(CH₂)₂OMe | SO₂Me |
| 4-217 | CH₂O(CH₂)₂OMe | NH(CH₂)₃OMe | SO₂Me |
| 4-218 | SO₂Me | NH₂ | CF₃ |
| 4-219 | SO₂Me | F | CF₃ |
| 4-220 | SO₂Me | NHEt | Cl |
| 4-221 | SMe | SEt | F |
| 4-222 | SMe | SMe | F |
| 4-223 | Me | NH₂ | Cl |
| 4-224 | Me | NH₂ | Br |
| 4-225 | Me | NHMe | Cl |
| 4-226 | Me | NHMe | Br |
| 4-227 | Me | NMe₂ | Cl |
| 4-228 | Me | NMe₂ | Br |
| 4-227 | Me | NMe₂ | Cl |
| 4-228 | Me | NMe₂ | Br |
| 4-229 | NO₂ | O(CH₂)₂OMe | Me |
| 4-230 | CF₃ | S(O)₂Et | SO₂Me |
| 4-231 | CF₃ | S(O)₂Et | SO₂Et |
| 4-232 | CF₃ | SCH₂CONMe₂ | SO₂Me |
| 4-233 | CF₃ | SCH₂CONMe₂ | SO₂Et |
| 4-234 | CF₃ | SCH₂COOH | SO₂Me |
| 4-235 | CF₃ | SCH₂COOH | SO₂Et |
| 4-236 | Me | SO₂—CH₂—CH₂—CH═CH₂ | CF₃ |
| 4-237 | Cl | Me | SO₂Et |
| 4-238 | CF₃ | SEt | SO₂Me |
| 4-239 | OMe | NO₂ | Cl |
| 4-240 | OMe | NH(CO)i-Pr | Cl |
| 4-241 | OMe | NH(CO)CH₂Ph | Cl |
| 4-242 | CF₃ | SEt | SO₂Et |
| 4-243 | CF₃ | S(O)Et | SO₂Me |
| 4-244 | Cl | Me | Cl |
| 4-245 | Me | 3,5-dimethylpyrazol-1-yl | SO₂Me |
| 4-247 | Me | 1,2,3-triazol-1-yl | SO₂Me |
| 4-248 | Me | Me | SMe |
| 4-249 | Me | pyrrolidin-2-on-1-yl | SO₂Me |
| 4-250 | CF₃ | S(O)Et | SO₂Et |
| 4-251 | Cl | pyrazol-1-yl | SO₂Me |
| 4-252 | Me | 3-methylpyrazol-1-yl | SO₂Me |
| 4-253 | Cl | CH₂—N(Et)OMe | SO₂Me |
| 4-254 | Me | Me | Cl |
| 4-255 | OH | Cl | Cl |
| 4-256 | Me | 1,2,4-triazol-1-yl | SO₂Me |
| 4-257 | Me | 4-methoxypyrazol-1-yl | SO₂Me |
| 4-258 | Me | 1,2,4-triazol-1-yl | CF₃ |
| 4-259 | Me | tetrahydropyrimidin-2(1H)-on-1-yl | SO₂Me |
| 4-260 | Me | NH—(CH₂)₂—O(CO)Et | SO₂Me |
| 4-261 | Me | NH—iPr | SO₂Me |
| 4-262 | Cl | NH—CH₂—(CO)NHEt | Cl |
| 4-263 | Me | NH—CH₂—(CO)NMe₂ | SO₂Me |
| 4-264 | Me | NH—CH₂-furan-2-yl | SO₂Me |
| 4-265 | Me | NH—CH₂—(CO)NHEt | SO₂Me |
| 4-266 | Me | F | SO₂Me |
| 4-267 | F | SO₂Me | SO₂Me |
| 4-268 | Cl | (4-cyclopropyl-3-methyl-5-oxo- | Cl |
| | | 4,5-dihydro-1H-1,2,4-triazol-1-yl)methyl | |
| 4-269 | Cl | [4-methyl-5-oxo-3-(2,2,2-trifluoroethoxy)- | Cl |
| | | 4,5-dihydro-1H-1,2,4- triazol-1-yl]methyl | |
| 4-270 | Cl | (3-isopropoxy-4-methyl-5-oxo-4,5- | Cl |
| | | dihydro-1H-1,2,4-triazol-1-y1]-methyl | |
| 4-271 | Cl | (4-methyl-5-oxo-4,5-dihydro-1H- | Cl |
| | | 1,2,4-triazol-1-yl)methyl | |
| 4-272 | Me | Cl | SO₂Et |
| 4-273 | SO₂Me | F | Cl |
| 4-274 | Me | 1,2,3-triazol-1-yl | SO₂Me |
| 4-275 | Me | isobutyl(methyl)carbamoylamino | SO₂Me |
| 4-276 | Me | 3-oxomorpholin-4-yl | SO₂Me |
| 4-277 | OMe | [ethyl(methylsulfonyl)-amino]methyl | Cl |
| 4-278 | F | SO₂Me | CF₃ |
| 4-279 | OMe | benzoylamino | Cl |
| 4-280 | OMe | cyclopropylcarbonyl-amino | Cl |
| 4-281 | OMe | propionylamino | Cl |
| 4-282 | NO₂ | SO₂Me | SO₂Me |
| 4-283 | NO₂ | SO₂Me | Cl |
| 4-284 | NO₂ | SOMe | SO₂Me |
| 4-285 | NO₂ | SOMe | Br |
| 4-286 | NO₂ | SOMe | Cl |
| 4-287 | NO₂ | SMe | SO₂Me |
| 4-288 | NO₂ | SMe | Br |
| 4-289 | NO₂ | SMe | Cl |
| 4-290 | Cl | CH₂OCH(CH₃)₂ | SO₂Et |
| 4-291 | Cl | CH₂OEt | SO₂Et |
| 4-292 | Cl | CH₂OMe | SO₂Et |
| 4-293 | Cl | CH₂OCH₂C₂F₅ | SO₂Me |
| 4-294 | Cl | CH₂OCH₂CHF₂ | SO₂Me |
| 4-295 | Cl | CH₂OCH₂CCH | SO₂Et |
| 4-296 | Cl | CH₂OC₂H₄OMe | SO₂Me |
| 4-297 | Cl | CH₂(OC₂H₄)₂OMe | SO₂Me |
| 4-298 | Cl | 5-ethoxymethyl-4,5-dihydro-1,2-oxazol-3-yl | SO₂Et |
| 4-299 | Cl | 5-methoxymethyl-4,5-dihydro-1,2-oxazol-3-yl | SO₂Et |
| 4-300 | Et | SOMe | CF₃ |
| 4-301 | iPr | SMe | CF₃ |
| 4-302 | Et | SMe | CF₃ |
| 4-303 | Et | SO₂Me | CF₃ |
| 4-304 | cPr | SOMe | CF₃ |
| 4-305 | CH═CH₂ | SMe | CF₃ |
| 4-306 | Et | SMe | Cl |
| 4-307 | Et | SO₂Me | Cl |
| 4-308 | Cl | NMe₂ | Cl |
| 4-309 | CH₂O(CH₂)₂OMe | NH(CH₂)₃OMe | SO₂Me |
| 4-313 | Me | SO₂(CH₂)₂OMe | CF₃ |
| 4-314 | Me | SOEt | SO₂Me |
| 4-315 | Me | SO₂Et | SO₂Me |
| 4-316 | Me | SMe | 1,2,4-triazol-1-yl |
| 4-317 | OEt | SMe | CF₃ |
| 4-318 | Me | S(CH₂)₂OMe | CF₃ |
| 4-319 | Me | SOMe | 1,2,4-triazol-1-yl |
| 4-320 | OEt | SOMe | CF₃ |
| 4-321 | Me | SO(CH₂)₂OMe | CF₃ |
| 4-322 | Me | SCH₂CCMe | SO₂Me |
| 4-323 | Me | S—c-Pen | SO₂Me |
| 4-324 | OMe | SMe | OMe |
| 4-325 | Me | SCH₂CH═CHCH₃ | SO₂Me |
| 4-326 | Me | SOCH₂CCMe | SO₂Me |
| 4-327 | Me | SO₄—c-Pen | SO₂Me |
| 4-328 | Me | SO—c-Pen | SO₂Me |
| 4-329 | Me | S(CH₂)₃Cl | SO₂Me |
| 4-330 | Me | SCH₂(4-F—Ph) | SO₂Me |
| 4-331 | Me | SO₂CH₂CCMe | SO₂Me |
| 4-332 | Me | SO₂CH₂CH═CHCH₃ | SO₂Me |
| 4-333 | Me | SOCH₂CH═CHCH₃ | SO₂Me |
| 4-334 | Me | SOCH₂-epoxy-Me | SO₂Me |
| 4-335 | Me | SO₂(CH₂)₃Cl | SO₂Me |
| 4-336 | Me | SO(CH₂)₃Cl | SO₂Me |
| 4-337 | Me | SOCH₂(4-F—Ph) | SO₂Me |
| 4-338 | Me | SO₂CH₂(4-F—Ph) | SO₂Me |
| 4-339 | Me | SO₂Me | C₂F₅ |
| 4-340 | O(CH₂)₂OMe | SMe | CF₃ |
| 4-341 | O(CH₂)₂OMe | SO₂Me | CF₃ |
| 4-342 | O(CH₂)₂OMe | SOMe | CF₃ |
| 4-343 | Me | S(CH₂)₂OCH₂CF₃ | SO₂Me |
| 4-344 | Me | SO(CH₂)₂OCH₂CF₃ | SO₂Me |
| 4-345 | Me | SO₂(CH₂)₂OCH₂CF₃ | SO₂Me |
| 4-346 | OEt | SEt | CF₃ |
| 4-347 | O—CH₂—c-Pr | SMe | CF₃ |
| 4-348 | OMe | SEt | CF₃ |
| 4-349 | OMe | SO₂Et | CF₃ |
| 4-350 | OMe | SOEt | CF₃ |
| 4-351 | OEt | SO₂Et | CF₃ |
| 4-352 | OEt | SOEt | CF₃ |
| 4-353 | O—CH₂—c-Pr | SOMe | CF₃ |
| 4-354 | O—CH₂—c-Pr | SO₂Me | CF₃ |
| 4-355 | Me | SEt | SO₂Me |

TABLE 5
Compounds of the general formula (I) according to the invention in
which R is chloromethyl

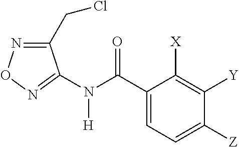

| No. | X | Y | Z |
|---|---|---|---|
| 5-1 | CF₃ | OCH₂CON(Me)Et | SO₂Me |
| 5-2 | CF₃ | OCH₂CON(Me)Et | SO₂Et |
| 5-4 | CF₃ | 2-(1H-pyrazol-1-yl)ethoxyl | SO₂Me |
| 5-5 | CF₃ | 2-(1H-pyrazol-1-yl)ethoxyl | SO₂Et |
| 5-6 | CF₃ | tetrahydrofuran-2-yl-methoxy | SO₂Me |
| 5-7 | CF₃ | tetrahydrofuran-2-yl-methoxy | SO₂Et |
| 5-8 | CF₃ | OH | SO₂Me |
| 5-9 | CF₃ | OH | SO₂Et |
| 5-10 | CF₃ | SH | SO₂Me |
| 5-11 | CF₃ | SH | SO₂Et |
| 5-15 | CF₃ | SMe | SO₂Me |
| 5-16 | CF₃ | SMe | SO₂Et |
| 5-17 | CF₃ | S(O)Me | SO₂Me |
| 5-24 | CF₃ | S(O)Me | SO₂Et |
| 5-25 | CF₃ | S(O)₂Me | SO₂Me |
| 5-26 | CF₃ | S(O)₂Me | SO₂Et |
| 5-27 | CF₃ | 2-[(methylsulfonyl)amino]ethoxy | SO₂Me |
| 5-28 | CF₃ | 2-[(methylsulfonyl)-amino]ethyl}sulfanyl | SO₂Me |
| 5-29 | CF₃ | 2-[(methylsulfonyl)-amino]ethyl}sulfanyl | SO₂Et |
| 5-30 | NO₂ | O(CH₂)₂OMe | OMe |
| 5-31 | NO₂ | OMe | Me |
| 5-32 | NO₂ | NH₂ | OMe |
| 5-33 | NO₂ | NH₂ | SO₂Et |
| 5-34 | NO₂ | NH₂ | Cl |
| 5-35 | NO₂ | NHMe | Cl |
| 5-36 | NO₂ | NMe₂ | Cl |
| 5-37 | NO₂ | NH₂ | Br |
| 5-38 | NO₂ | NHMe | Br |
| 5-39 | NO₂ | NMe₂ | Br |
| 5-40 | NO₂ | NH₂ | F |
| 5-41 | NO₂ | NHMe | F |
| 5-42 | NO₂ | NMe₂ | F |
| 5-43 | NO₂ | NH₂ | SO₂Me |
| 5-44 | NO₂ | NHMe | SO₂Me |
| 5-45 | NO₂ | NMe₂ | SO₂Me |
| 5-46 | NO₂ | NH₂ | 1H-1,2,4-triazol-1-yl |
| 5-47 | NO₂ | NHMe | 1H-1,2,4-triazol-1-yl |
| 5-48 | NO₂ | NMe₂ | 1H-1,2,4-triazol-1-yl |
| 5-49 | Me | F | F |
| 5-50 | Me | F | Cl |
| 5-51 | Me | SMe | CF₃ |
| 5-52 | Me | Cl | SO₂Me |
| 5-53 | Me | SO₂Me | SO₂Me |
| 5-54 | Me | SO₂Me | CF₃ |
| 5-55 | Me | Cl | CF₃ |
| 5-56 | Me | S(O)Me | CF₃ |
| 5-57 | Me | SEt | OMe |
| 5-58 | Me | NMe₂ | SO₂Me |
| 5-59 | Me | NH(CH₂)₂OMe | SO₂Me |
| 5-60 | Me | O(CH₂)₄OMe | SO₂Me |
| 5-61 | Me | NH₂ | SO₂Me |
| 5-62 | Me | O(CH₂)₂—O(3,5-di-methoxypyrimidin-2-yl | SO₂Me |
| 5-63 | Me | O(CH₂)₂—O—NMe₂ | Cl |
| 5-64 | Me | O(CH₂)₂—NH(CO)NMe₂ | Cl |
| 5-65 | Me | O(CH₂)-5-pyrrolidin-2-one | Br |
| 5-66 | Me | O(CH₂)₂—NH(CO)NHCO₂Et | Cl |
| 5-67 | Me | O(CH₂)—(CO)NEt₂ | Br |
| 5-68 | Me | O(CH₂)-5-2,4-dimethyl-2,4-dihydro-3H- | Cl |
| | | 1,2,4-triazol-3-one | |
| 5-69 | Me | O(CH₂)-3,5-dimethyl-1,2-oxazol-4-yl | Cl |
| 5-70 | Me | O(CH₂)₂—NHCO₂Me | Cl |
| 5-71 | Me | 4,5-dihydro-1,2-oxazol-3-yl | SO₂Me |
| 5-72 | Me | Me | SO₂Me |
| 5-73 | Me | OH | SO₂Me |
| 5-74 | Me | O—CH₂—NHSO₂cPr | Cl |
| 5-75 | Me | O(CH₂)₂NHSO₂Me | SO₂Me |
| 5-76 | Me | S(O)Me | SO₂Me |
| 5-77 | Me | SMe | SO₂Me |
| 5-78 | Me | SMe | OMe |
| 5-79 | Me | S(O)Me | OMe |
| 5-80 | Me | SO₂Me | OMe |
| 5-81 | Me | SMe | Cl |
| 5-82 | Me | S(O)Me | Cl |
| 5-83 | Me | SO₂Me | Cl |
| 5-84 | Me | [1,4]dioxan-2-yl-methoxy | SO₂Me |
| 5-85 | Me | [1,4]dioxan-2-yl-methoxy | SO₂Et |
| 5-86 | Me | O(CH₂)₄OMe | SO₂Et |
| 5-87 | Me | O(CH₂)₃OMe | SO₂Me |
| 5-88 | Me | O(CH₂)₃OMe | SO₂Et |
| 5-89 | Me | O(CH₂)₂OMe | SO₂Me |
| 5-90 | Me | O(CH₂)₂OMe | SO₂Et |
| 5-91 | Me | S(O)Me | SO₂Me |
| 5-92 | Me | SMe | SO₂Me |
| 5-93 | Me | SMe | OMe |
| 5-94 | Me | S(O)Me | OMe |
| 5-95 | Me | SO₂Me | OMe |
| 5-96 | Me | SMe | Cl |
| 5-97 | Me | S(O)Me | Cl |
| 5-98 | Me | SO₂Me | Cl |
| 5-99 | Me | SMe | Br |
| 5-100 | Me | SOMe | Br |
| 5-101 | Me | SO₂Me | Br |
| 5-102 | Me | SMe | I |
| 5-103 | Me | SOMe | I |
| 5-104 | Me | SO₂Me | I |
| 5-105 | Me | SEt | Cl |
| 5-106 | Me | SOEt | Cl |
| 5-107 | Me | SO₂Et | Cl |
| 5-108 | Me | SEt | Br |
| 5-109 | Me | SOEt | Br |
| 5-110 | Me | SO₂Et | Br |
| 5-111 | Me | SEt | I |
| 5-112 | Me | SOEt | I |
| 5-113 | Me | SO₂Et | I |
| 5-114 | Me | SEt | F |
| 5-115 | Me | SOEt | F |
| 5-116 | Me | SO₂Et | F |
| 5-117 | Cl | OCH₂(CO)NMe₂ | Cl |
| 5-118 | Cl | Cl | SO₂Me |
| 5-119 | Cl | CH₂OCH₂CF₃ | SO₂Me |
| 5-120 | Cl | 5-cyanomethyl-4,5-dihydro-1,2-oxazol-3-yl | SO₂Et |
| 5-121 | Cl | CH₂O-tetrahydrofuran-3-yl | SO₂Me |
| 5-122 | Cl | CH₂O-tetrahydrofuran-2-yl | SO₂Me |
| 5-123 | Cl | SMe | SO₂Me |
| 5-124 | Cl | F | SMe |
| 5-125 | Cl | CH₂OCH₂-tetrahydrofuran-2-yl | SO₂Me |
| 5-126 | Cl | CH₂OCH₂-tetrahydrofuran-3-yl | SO₂Et |
| 5-127 | Cl | O(CH₂)-5-pyrrolidin-2-one | Cl |
| 5-128 | Cl | SMe | Cl |
| 5-129 | Cl | S(O)Me | SO₂Me |
| 5-130 | Cl | CH₂O-tetrahydrofuran-3-yl | SO₂Et |
| 5-131 | Cl | O(CH₂)₂OMe | Cl |
| 5-132 | Cl | O(CH₂)₂OMe | SO₂Me |
| 5-133 | Cl | O(CH₂)₄OMe | SO₂Me |
| 5-134 | Cl | O(CH₂)₄OMe | SO₂Et |
| 5-135 | Cl | O(CH₂)₃OMe | SO₂Me |
| 5-136 | Cl | O(CH₂)₃OMe | SO₂Et |
| 5-137 | Cl | O(CH₂)₂OMe | SO₂Me |
| 5-138 | Cl | O(CH₂)₂OMe | SO₂Et |
| 5-139 | Cl | [1,4]dioxan-2-yl-methoxy | SO₂Me |
| 5-140 | Cl | [1,4]dioxan-2-yl-methoxy | SO₂Et |
| 5-141 | Cl | SO₂Me | Me |
| 5-142 | Cl | SEt | Me |
| 5-143 | Cl | SOEt | Me |
| 5-144 | Cl | SO₂Et | Me |
| 2-145 | Cl | 4,5-dihydro-1,5-oxazol-3-yl | SO₂Me |
| 5-146 | Cl | Cl | SO₂Me |
| 5-147 | F | SMe | CF₃ |
| 5-148 | F | S(O)Me | CF₃ |
| 5-149 | OMe | SMe | CF₃ |
| 5-150 | OMe | S(O)Me | CF₃ |
| 5-151 | OMe | SO₂Me | CF₃ |
| 5-152 | Et | NH(CH₂)₂OMe | SO₂Me |
| 5-153 | Et | F | SO₂Me |
| 5-154 | Et | SMe | CF₃ |
| 5-155 | CF₃ | F | SO₂Me |
| 5-156 | CF₃ | F | SO₂Et |
| 5-157 | CF₃ | O(CH₂)₂OMe | SO₂Et |
| 5-158 | CF₃ | O(CH₂)₃OMe | SO₂Et |
| 5-159 | CF₃ | O(CH₂)₂OMe | SO₂Me |
| 5-160 | CF₃ | O(CH₂)₃OMe | SO₂Me |
| 5-161 | CF₃ | OCH₂CONMe₂ | SO₂Me |
| 5-162 | CF₃ | OCH₂CONMe₂ | SO₂Et |
| 5-163 | CF₃ | OCH₂CONMe₂ | Cl |
| 5-164 | CF₃ | OCH₂CONMe₂ | Br |
| 5-165 | CF₃ | OCH₂CONMe₂ | I |
| 5-166 | CF₃ | OCH₂CONMe₂ | F |
| 5-167 | CF₃ | O(CH₂)₂OMe | Cl |
| 5-168 | CF₃ | O(CH₂)₃OMe | Cl |
| 5-169 | CF₃ | O(CH₂)₂OMe | Br |
| 5-170 | CF₃ | O(CH₂)₃OMe | Br |
| 5-171 | CF₃ | O(CH₂)₂OMe | I |
| 5-172 | CF₃ | O(CH₂)₃OMe | I |
| 5-173 | CF₃ | O(CH₂)₂OMe | F |
| 5-174 | CF₃ | O(CH₂)₃OMe | F |
| 5-175 | CF₃ | [1,4]dioxan-2-yl-methoxy | SO₂Me |
| 5-176 | CF₃ | [1,4]dioxan-2-yl-methoxy | SO₂Et |
| 5-177 | CF₃ | [1,4]dioxan-2-yl-methoxy | Cl |
| 2-178 | CF₃ | [1,4]dioxan-2-yl-methoxy | Br |
| 5-179 | CF₃ | [1,4]dioxan-2-yl-methoxy | I |
| 5-180 | CF₃ | [1,4]dioxan-2-yl-methoxy | F |
| 5-181 | Br | OMe | Br |
| 5-182 | Br | O(CH₂)₂OMe | Br |
| 5-183 | Br | O(CH₂)₄OMe | SO₂Me |
| 5-184 | Br | O(CH₂)₄OMe | SO₂Et |
| 5-185 | Br | O(CH₂)₃OMe | SO₂Me |
| 5-186 | Br | O(CH₂)₃OMe | SO₂Et |
| 5-187 | Br | O(CH₂)₂OMe | SO₂Me |
| 5-188 | Br | O(CH₂)₂OMe | SO₂Et |
| 5-189 | Br | [1,4]dioxan-2-yl-methoxy | SO₂Me |
| 5-190 | Br | [1,4]dioxan-2-yl-methoxy | SO₂Et |
| 5-191 | Br | SMe | Me |
| 5-192 | Br | SOMe | Me |
| 5-193 | Br | SO₂Me | Me |
| 5-194 | Br | SEt | Me |
| 5-195 | Br | SOEt | Me |
| 5-196 | Br | SO₂Et | Me |
| 5-197 | I | O(CH₂)₄OMe | SO₂Me |
| 5-198 | I | O(CH₂)₄OMe | SO₂Et |
| 5-199 | I | O(CH₂)₃OMe | SO₂Me |
| 5-200 | I | O(CH₂)₃OMe | SO₂Et |
| 5-201 | I | O(CH₂)₂OMe | SO₂Me |
| 5-202 | I | O(CH₂)₂OMe | SO₂Et |
| 5-203 | I | [1,4]dioxan-2-yl-methoxy | SO₂Me |
| 5-204 | I | [1,4]dioxan-2-yl-methoxy | SO₂Et |
| 5-205 | I | SMe | Me |
| 5-206 | I | SOMe | Me |
| 5-207 | I | SO₂Me | Me |
| 5-208 | I | SEt | Me |
| 5-209 | I | SOEt | Me |
| 5-210 | I | SO₂Et | Me |
| 5-211 | CH₂SMe | OMe | SO₂Me |
| 5-212 | CH₂OMe | OMe | SO₂Me |
| 5-213 | CH₂O(CH₂)₂OMe | NH(CH₂)₂OEt | SO₂Me |
| 5-214 | CH₂O(CH₂)₂OMe | NH(CH₂)₃OEt | SO₂Me |
| 5-215 | CH₂O(CH₂)₃OMe | OMe | SO₂Me |
| 5-216 | CH₂O(CH₂)₂OMe | NH(CH₂)₂OMe | SO₂Me |
| 5-217 | CH₂O(CH₂)₂OMe | NH(CH₂)₃OMe | SO₂Me |
| 5-218 | SO₂Me | NH₂ | CF₃ |
| 5-219 | SO₂Me | F | CF₃ |
| 5-220 | SO₂Me | NHEt | Cl |
| 5-221 | SMe | SEt | F |
| 5-222 | SMe | SMe | F |
| 5-223 | Me | NH₂ | Cl |
| 5-224 | Me | NH₂ | Br |
| 5-225 | Me | NHMe | Cl |
| 5-226 | Me | NHMe | Br |
| 5-227 | Me | NMe₂ | Cl |
| 5-228 | Me | NMe₂ | Br |
| 5-229 | NO₂ | O(CH₂)₂OMe | Me |
| 5-230 | CF₃ | S(O)₂Et | SO₂Me |
| 5-231 | CF₃ | S(O)₂Et | SO₂Et |
| 5-232 | CF₃ | SCH₂CONMe₂ | SO₂Me |
| 5-233 | CF₃ | SCH₂CONMe₂ | SO₂Et |
| 5-234 | CF₃ | SCH₂COOH | SO₂Me |
| 5-235 | CF₃ | SCH₂COOH | SO₂Et |
| 5-236 | Me | SO₂—CH₂—CH₂—CH═CH₂ | CF₃ |
| 5-237 | Cl | Me | SO₂Et |
| 5-238 | CF₃ | SEt | SO₂Me |
| 5-239 | OMe | NO₂ | Cl |
| 5-240 | OMe | NH(CO)i-Pr | Cl |
| 5-241 | OMe | NH(CO)CH₂Ph | Cl |
| 5-242 | CF₃ | SEt | SO₂Et |
| 5-243 | CF₃ | S(O)Et | SO₂Me |
| 5-244 | Cl | Me | Cl |
| 5-245 | Me | 3,5-dimethylpyrazol-1-yl | SO₂Me |
| 5-247 | Me | 1,2,3-triazol-1-yl | SO₂Me |
| 5-248 | Me | Me | SMe |
| 5-249 | Me | pyrrolidin-2-on-1-yl | SO₂Me |
| 5-250 | CF₃ | S(O)Et | SO₂Et |
| 5-251 | Cl | pyrazol-1-yl | SO₂Me |
| 5-252 | Me | 3-methylpyrazol-1-yl | SO₂Me |
| 5-253 | Cl | CH₂—N(Et)OMe | SO₂Me |
| 5-254 | Me | Me | Cl |
| 5-255 | OH | Cl | Cl |
| 5-256 | Me | 1,2,4-triazol-1-yl | SO₂Me |
| 5-257 | Me | 4-methoxypyrazol-1-yl | SO₂Me |
| 5-258 | Me | 1,2,4-triazol-1-yl | CF₃ |
| 5-259 | Me | tetrahydropyrimidin-2(1H)-on-1-yl | SO₂Me |
| 5-260 | Me | NH—(CH₂)₂—O(CO)Et | SO₂Me |
| 5-261 | Me | NH—iPr | SO₂Me |
| 5-262 | Cl | NH—CH₂—(CO)NHEt | Cl |
| 5-263 | Me | NH—CH₂—(CO)NMe₂ | SO₂Me |
| 5-264 | Me | NH—CH₂-furan-2-yl | SO₂Me |
| 5-265 | Me | NH—CH₂—(CO)NHEt | SO₂Me |
| 5-266 | Me | F | SO₂Me |
| 5-267 | F | SO₂Me | SO₂Me |
| 5-268 | Cl | (4-cyclopropyl-3-methyl-5-oxo- | Cl |
| | | 4,5-dihydro-1H-1,2,4-triazol-1-yl)methyl | |
| 5-269 | Cl | [4-methyl-5-oxo-3-(2,2,2-trifluoroethoxy)- | Cl |
| | | 4,5-dihydro-1H-1,2,4-triazol-1-yl]methyl | |
| 5-270 | Cl | (3-isopropoxy-4-methyl-5-oxo-4,5- | Cl |
| | | dihydro-1H-1,2,4-triazol-1-yl]-methyl | |
| 5-271 | Cl | (4-methyl-5-oxo-4,5-dihydro-1H- | Cl |
| | | 1,2,4-triazol-1-yl)methyl | |
| 5-272 | Me | Cl | SO₂Et |
| 5-273 | SO₂Me | F | Cl |
| 5-274 | Me | 1,2,3-triazol-1-yl | SO₂Me |
| 5-275 | Me | isobutyl(methyl)carbamoylamino | SO₂Me |
| 5-276 | Me | 3-oxomorpholin-4-yl | SO₂Me |
| 5-277 | OMe | [ethyl(methylsulfonyl)-amino]methyl | Cl |
| 5-278 | F | SO₂Me | CF₃ |
| 5-279 | OMe | benzoylamino | Cl |
| 5-280 | OMe | cyclopropylcarbonyl-amino | Cl |
| 5-281 | OMe | propionylamino | Cl |
| 5-282 | NO₂ | SO₂Me | SO₂Me |
| 5-283 | NO₂ | SO₂Me | Cl |
| 5-284 | NO₂ | SOMe | SO₂Me |
| 5-285 | NO₂ | SOMe | Br |
| 5-286 | NO₂ | SOMe | Cl |
| 5-287 | NO₂ | SMe | SO₂Me |
| 5-288 | NO₂ | SMe | Br |
| 5-289 | NO₂ | SMe | Cl |
| 5-290 | Cl | CH₂OCH(CH₃)₂ | SO₂Et |
| 5-291 | Cl | CH₂OEt | SO₂Et |
| 5-292 | Cl | CH₂OMe | SO₂Et |
| 5-293 | Cl | CH₂OCH₂C₂F₅ | SO₂Me |
| 5-294 | Cl | CH₂OCH₂CHF₂ | SO₂Me |
| 5-295 | Cl | CH₂OCH₂CCH | SO₂Et |
| 5-296 | Cl | CH₂OC₂H₄OMe | SO₂Me |
| 5-297 | Cl | CH₂(OC₂H₄)₂OMe | SO₂Me |
| 5-298 | Cl | 5-ethoxymethyl-4,5-dihydro-1,2-oxazol-3-yl | SO₂Et |
| 5-299 | Cl | 5-Methoxymethyl-4,5-dihydro-1,2-oxazol-3-yl | SO₂Et |
| 5-300 | Et | SOMe | CF₃ |
| 5-301 | iPr | SMe | CF₃ |
| 5-302 | Et | SMe | CF₃ |
| 5-303 | Et | SO₂Me | CF₃ |
| 5-304 | cPr | SOMe | CF₃ |
| 5-305 | CH═CH₂ | SMe | CF₃ |
| 5-306 | Et | SMe | Cl |
| 5-307 | Et | SO₂Me | Cl |
| 5-308 | Cl | NMe₂ | Cl |
| 5-309 | CH₂O(CH₂)₂OMe | NH(CH₂)₃OMe | SO₂Me |
| 5-313 | Me | SO₂(CH₂)₂OMe | CF₃ |
| 5-314 | Me | SOEt | SO₂Me |
| 5-315 | Me | SO₂Et | SO₂Me |
| 5-316 | Me | SMe | 1,2,4-triazol-1-yl |
| 5-317 | OEt | SMe | CF₃ |
| 5-318 | Me | S(CH₂)₂OMe | CF₃ |
| 5-319 | Me | SOMe | 1,2,4-triazol-1-yl |
| 5-320 | OEt | SOMe | CF₃ |
| 5-321 | Me | SO(CH₂)₂OMe | CF₃ |
| 5-322 | Me | SCH₂CCMe | SO₂Me |
| 5-323 | Me | S—c-Pen | SO₂Me |
| 5-324 | OMe | SMe | OMe |
| 5-325 | Me | SCH₂CH═CHCH₃ | SO₂Me |
| 5-326 | Me | SOCH₂CCMe | SO₂Me |
| 5-327 | Me | SO₅—c-Pen | SO₂Me |
| 5-328 | Me | SO—c-Pen | SO₂Me |
| 5-329 | Me | S(CH₂)₃Cl | SO₂Me |
| 5-330 | Me | SCH₂(4-F—Ph) | SO₂Me |
| 5-331 | Me | SO₂CH₂CCMe | SO₂Me |
| 5-332 | Me | SO₂CH₂CH═CHCH₃ | SO₂Me |
| 5-333 | Me | SOCH₂CH═CHCH₃ | SO₂Me |
| 5-334 | Me | SOCH₂-epoxy-Me | SO₂Me |
| 5-335 | Me | SO₂(CH₂)₃Cl | SO₂Me |
| 5-336 | Me | SO(CH₂)₃Cl | SO₂Me |
| 5-337 | Me | SOCH₂(4-F—Ph) | SO₂Me |
| 5-338 | Me | SO₂CH₂(4-F—Ph) | SO₂Me |
| 5-339 | Me | SO₂Me | C₂F₅ |
| 5-340 | O(CH₂)₂OMe | SMe | CF₃ |
| 5-341 | O(CH₂)₂OMe | SO₂Me | CF₃ |
| 5-342 | O(CH₂)₂OMe | SOMe | CF₃ |
| 5-343 | Me | S(CH₂)₂OCH₂CF₃ | SO₂Me |
| 5-344 | Me | SO(CH₂)₂OCH₂CF₃ | SO₂Me |
| 5-345 | Me | SO₂(CH₂)₂OCH₂CF₃ | SO₂Me |
| 5-346 | OEt | SEt | CF₃ |
| 5-347 | O—CH₂—c-Pr | SMe | CF₃ |
| 5-348 | OMe | SEt | CF₃ |
| 5-349 | OMe | SO₂Et | CF₃ |
| 5-350 | OMe | SOEt | CF₃ |
| 5-351 | OEt | SO₂Et | CF₃ |
| 5-352 | OEt | SOEt | CF₃ |
| 5-353 | O—CH₂—c-Pr | SOMe | CF₃ |
| 5-354 | O—CH₂—c-Pr | SO₂Me | CF₃ |
| 5-355 | Me | SEt | SO₂Me |

TABLE 6
Compounds of the general formula (I) according to the invention in
which R is tert-butyl

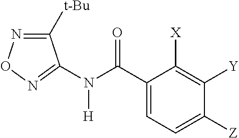

| No. | X | Y | Z |
|---|---|---|---|
| 6-1 | CF₃ | OCH₂CON(Me)Et | SO₂Me |
| 6-2 | CF₃ | OCH₂CON(Me)Et | SO₂Et |
| 6-4 | CF₃ | 2-(1H-pyrazol-1-yl)ethoxyl | SO₂Me |
| 6-5 | CF₃ | 2-(1H-pyrazol-1-yl)ethoxyl | SO₂Et |
| 6-6 | CF₃ | tetrahydrofuran-2-yl-methoxy | SO₂Me |
| 6-7 | CF₃ | tetrahydrofuran-2-yl-methoxy | SO₂Et |
| 6-8 | CF₃ | OH | SO₂Me |
| 6-9 | CF₃ | OH | SO₂Et |
| 6-10 | CF₃ | SH | SO₂Me |
| 6-11 | CF₃ | SH | SO₂Et |
| 6-15 | CF₃ | SMe | SO₂Me |
| 6-16 | CF₃ | SMe | SO₂Et |
| 6-17 | CF₃ | S(O)Me | SO₂Me |
| 6-24 | CF₃ | S(O)Me | SO₂Et |
| 6-25 | CF₃ | S(O)₂Me | SO₂Me |
| 6-26 | CF₃ | S(O)₂Me | SO₂Et |
| 6-27 | CF₃ | 2-[(methylsulfonyl)amino]ethoxy | SO₂Me |
| 628 | CF₃ | 2-[(methylsulfonyl)-amino]ethyl}sulfanyl | SO₂Me |
| 6-29 | CF₃ | 2-[(methylsulfonyl)-amino]ethyl}sulfanyl | SO₂Et |
| 6-30 | Me | H | NO₂ |
| 6-31 | NO₂ | OMe | Me |
| 6-32 | NO₂ | NH₂ | OMe |
| 6-33 | NO₂ | NH₂ | SO₂Et |
| 6-34 | NO₂ | NH₂ | Cl |
| 6-35 | NO₂ | NHMe | Cl |
| 6-36 | NO₂ | NMe₂ | Cl |
| 6-37 | NO₂ | NH₂ | Br |
| 6-38 | NO₂ | NHMe | Br |
| 6-39 | NO₂ | NMe₂ | Br |
| 6-40 | NO₂ | NH₂ | F |
| 6-41 | NO₂ | NHMe | F |
| 6-42 | NO₂ | NMe₂ | F |
| 6-43 | NO₂ | NH₂ | SO₂Me |
| 6-44 | NO₂ | NHMe | SO₂Me |
| 6-45 | NO₂ | NMe₂ | SO₂Me |
| 6-46 | NO₂ | NH₂ | 1H-1,2,4-triazol-5-yl |
| 6-47 | NO₂ | NHMe | 1H-1,2,4-triazol-5-yl |
| 6-48 | NO₂ | NMe₂ | 1H-1,2,4-triazol-5-yl |
| 6-49 | Me | F | F |
| 6-50 | Me | F | Cl |
| 6-51 | Me | SMe | CF₃ |
| 6-52 | Me | Cl | SO₂Me |
| 6-53 | Me | SO₂Me | SO₂Me |
| 6-54 | Me | SO₂Me | CF₃ |
| 6-55 | Me | Cl | CF₃ |
| 6-56 | Me | S(O)Me | CF₃ |
| 6-57 | Me | SEt | OMe |
| 6-58 | Me | NMe₂ | SO₂Me |
| 6-59 | Me | NH(CH₂)₂OMe | SO₂Me |
| 6-60 | Me | O(CH₂)₄OMe | SO₂Me |
| 6-61 | Me | NH₂ | SO₂Me |
| 6-62 | Me | O(CH₂)₂—O-(3,5-dimethoxypyrimidin-2-yl | SO₂Me |
| 6-63 | Me | O(CH₂)₂—O—NMe₂ | Cl |
| 6-64 | Me | O(CH₂)₂—NH(CO)NMe₂ | Cl |
| 6-65 | Me | O(CH₂)-5-pyrrolidin-2-one | Br |
| 6-66 | Me | O(CH₂)₂—NH(CO)NHCO₂Et | Cl |
| 6-67 | Me | O(CH₂)—(CO)NEt₂ | Br |
| 6-68 | Me | O(CH₂)-5-2,4-dimethyl-2,4-dihydro-3H- | Cl |
| | | 1,2,4-triazol-3-one | |
| 6-69 | Me | O(CH₂)-3,5-dimethyl-1,2-oxazol-4-yl | Cl |
| 6-70 | Me | O(CH₂)₂—NHCO₂Me | Cl |
| 6-71 | Me | 4,5-dihydro-1,2-oxazol-3-yl | SO₂Me |
| 6-72 | Me | Me | SO₂Me |
| 6-73 | Me | OH | SO₂Me |
| 6-74 | Me | O—CH₂—NHSO₂cPr | Cl |
| 6-75 | Me | O(CH₂)₂NHSO₂Me | SO₂Me |
| 6-76 | Me | S(O)Me | SO₂Me |
| 6-77 | Me | SMe | SO₂Me |
| 6-78 | Me | SMe | OMe |
| 6-79 | Me | S(O)Me | OMe |
| 6-80 | Me | SO₂Me | OMe |
| 6-81 | Me | SMe | Cl |
| 6-82 | Me | S(O)Me | Cl |
| 6-83 | Me | SO₂Me | Cl |
| 6-84 | Me | [1,4]dioxan-2-yl-methoxy | SO₂Me |
| 6-85 | Me | [1,4]dioxan-2-yl-methoxy | SO₂Et |
| 6-86 | Me | O(CH₂)₄OMe | SO₂Et |
| 6-87 | Me | O(CH₂)₃OMe | SO₂Me |
| 6-88 | Me | O(CH₂)₃OMe | SO₂Et |
| 6-89 | Me | O(CH₂)₂OMe | SO₂Me |
| 6-90 | Me | O(CH₂)₂OMe | SO₂Et |
| 6-91 | Me | S(O)Me | SO₂Me |
| 6-92 | Me | SMe | SO₂Me |
| 6-93 | Me | SMe | OMe |
| 6-94 | Me | S(O)Me | OMe |
| 6-95 | Me | SO₂Me | OMe |
| 6-96 | Me | SMe | Cl |
| 6-97 | Me | S(O)Me | Cl |
| 6-98 | Me | SO₂Me | Cl |
| 6-99 | Me | SMe | Br |
| 6-100 | Me | SOMe | Br |
| 6-101 | Me | SO₂Me | Br |
| 6-102 | Me | SMe | I |
| 6-103 | Me | SOMe | I |
| 6-104 | Me | SO₂Me | I |
| 6-105 | Me | SEt | Cl |
| 6-106 | Me | SOEt | Cl |
| 6-107 | Me | SO₂Et | Cl |
| 6-108 | Me | SEt | Br |
| 6-109 | Me | SOEt | Br |
| 6-110 | Me | SO₂Et | Br |
| 6-111 | Me | SEt | I |
| 6-112 | Me | SOEt | I |
| 6-113 | Me | SO₂Et | I |
| 6-114 | Me | SEt | F |
| 6-115 | Me | SOEt | F |
| 6-116 | Me | SO₂Et | F |
| 6-117 | Cl | OCH₂(CO)NMe₂ | Cl |
| 6-118 | Cl | Cl | SO₂Me |
| 6-119 | Cl | CH₂OCH₂CF₃ | SO₂Me |
| 6-120 | Cl | 5-cyanomethyl-4,5-dihydro-1,2-oxazol-3-yl | SO₂Et |
| 6-121 | Cl | CH₂O-tetra-hydrofuran-3-yl | SO₂Me |
| 6-122 | Cl | CH₂O-tetra-hydrofuran-2-yl | SO₂Me |
| 6-123 | Cl | SMe | SO₂Me |
| 6-124 | Cl | F | SMe |
| 6-125 | Cl | CH₂OCH₂-tetrahydrofuran-2-yl | SO₂Me |
| 6-126 | Cl | CH₂OCH₂-tetrahydrofuran-3-yl | SO₂Et |
| 6-127 | Cl | O(CH₂)-5-pyrrolidin-2-one | Cl |
| 6-128 | Cl | SMe | Cl |
| 6-129 | Cl | S(O)Me | SO₂Me |
| 6-130 | Cl | CH₂O-tetrahydrofuran-3-yl | SO₂Et |
| 6-131 | Cl | O(CH₂)₂OMe | Cl |
| 6-132 | Cl | O(CH₂)₂OMe | SO₂Me |
| 6-133 | Cl | O(CH₂)₄OMe | SO₂Me |
| 6-134 | Cl | O(CH₂)₄OMe | SO₂Et |
| 6-135 | Cl | O(CH₂)₃OMe | SO₂Me |
| 6-136 | Cl | O(CH₂)₃OMe | SO₂Et |
| 6-137 | Cl | O(CH₂)₂OMe | SO₂Me |
| 6-138 | Cl | O(CH₂)₂OMe | SO₂Et |
| 6-139 | Cl | [1,4]dioxan-2-yl-methoxy | SO₂Me |
| 6-140 | Cl | [1,4]dioxan-2-yl-methoxy | SO₂Et |
| 6-141 | Cl | SO₂Me | Me |
| 6-142 | Cl | SEt | Me |
| 6-143 | Cl | SOEt | Me |
| 6-144 | Cl | SO₂Et | Me |
| 6-145 | Cl | 4,5-dihydro-1,2-oxazol-3-yl | SO₂Me |
| 6-146 | Cl | Cl | SO₂Me |
| 6-147 | F | SMe | CF₃ |
| 6-148 | F | S(O)Me | CF₃ |
| 6-149 | OMe | SMe | CF₃ |
| 6-150 | OMe | S(O)Me | CF₃ |
| 6-151 | OMe | SO₂Me | CF₃ |
| 6-152 | Et | NH(CH₂)₂OMe | SO₂Me |
| 6-153 | Et | F | SO₂Me |
| 6-154 | Et | SMe | CF₃ |
| 6-155 | CF₃ | F | SO₂Me |
| 6-156 | CF₃ | F | SO₂Et |
| 6-157 | CF₃ | O(CH₂)₂OMe | SO₂Et |
| 6-158 | CF₃ | O(CH₂)₃OMe | SO₂Et |
| 6-159 | CF₃ | O(CH₂)₂OMe | SO₂Me |
| 6-160 | CF₃ | O(CH₂)₃OMe | SO₂Me |
| 6-161 | CF₃ | OCH₂CONMe₂ | SO₂Me |
| 6-162 | CF₃ | OCH₂CONMe₂ | SO₂Et |
| 6-163 | CF₃ | OCH₂CONMe₂ | Cl |
| 6-164 | CF₃ | OCH₂CONMe₂ | Br |
| 6-165 | CF₃ | OCH₂CONMe₂ | I |
| 6-166 | CF₃ | OCH₂CONMe₂ | F |
| 6-167 | CF₃ | O(CH₂)₂OMe | Cl |
| 6-168 | CF₃ | O(CH₂)₃OMe | Cl |
| 6-169 | CF₃ | O(CH₂)₂OMe | Br |
| 6-170 | CF₃ | O(CH₂)₃OMe | Br |
| 6-171 | CF₃ | O(CH₂)₂OMe | I |
| 6-172 | CF₃ | O(CH₂)₃OMe | I |
| 6-173 | CF₃ | O(CH₂)₂OMe | F |
| 6-174 | CF₃ | O(CH₂)₃OMe | F |
| 6-175 | CF₃ | [1,4]dioxan-2-yl-methoxy | SO₂Me |
| 6-176 | CF₃ | [1,4]dioxan-2-yl-methoxy | SO₂Et |
| 6-177 | CF₃ | [1,4]dioxan-2-yl-methoxy | Cl |
| 6-178 | CF₃ | [1,4]dioxan-2-yl-methoxy | Br |
| 6-179 | CF₃ | [1,4]dioxan-2-yl-methoxy | I |
| 6-180 | CF₃ | [1,4]dioxan-2-yl-methoxy | F |
| 6-181 | Br | OMe | Br |
| 6-182 | Br | O(CH₂)₂OMe | Br |
| 6-183 | Br | O(CH₂)₄OMe | SO₂Me |
| 6-184 | Br | O(CH₂)₄OMe | SO₂Et |
| 6-185 | Br | O(CH₂)₃OMe | SO₂Me |
| 6-186 | Br | O(CH₂)₃OMe | SO₂Et |
| 6-187 | Br | O(CH₂)₂OMe | SO₂Me |
| 6-188 | Br | O(CH₂)₂OMe | SO₂Et |
| 6-189 | Br | [1,4]dioxan-2-yl-methoxy | SO₂Me |
| 6-190 | Br | [1,4]dioxan-2-yl-methoxy | SO₂Et |
| 6-191 | Br | SMe | Me |
| 6-192 | Br | SOMe | Me |
| 6-193 | Br | SO₂Me | Me |
| 6-194 | Br | SEt | Me |
| 6-195 | Br | SOEt | Me |
| 6-196 | Br | SO₂Et | Me |
| 6-197 | I | O(CH₂)₄OMe | SO₂Me |
| 6-198 | I | O(CH₂)₄OMe | SO₂Et |
| 6-199 | I | O(CH₂)₃OMe | SO₂Me |
| 6-200 | I | O(CH₂)₃OMe | SO₂Et |
| 6-201 | I | O(CH₂)₂OMe | SO₂Me |
| 6-202 | I | O(CH₂)₂OMe | SO₂Et |
| 6-203 | I | [1,4]dioxan-2-yl-methoxy | SO₂Me |
| 6-204 | I | [1,4]dioxan-2-yl-methoxy | SO₂Et |
| 6-205 | I | SMe | Me |
| 6-206 | I | SOMe | Me |
| 6-207 | I | SO₂Me | Me |
| 6-208 | I | SEt | Me |
| 6-209 | I | SOEt | Me |
| 6-210 | I | SO₂Et | Me |
| 6-211 | CH₂SMe | OMe | SO₂Me |
| 6-212 | CH₂OMe | OMe | SO₂Me |
| 6-213 | CH₂O(CH₂)₂OMe | NH(CH₂)₂OEt | SO₂Me |
| 6-214 | CH₂O(CH₂)₂OMe | NH(CH₂)₃OEt | SO₂Me |
| 6-215 | CH₂O(CH₂)₃OMe | OMe | SO₂Me |
| 6-216 | CH₂O(CH₂)₂OMe | NH(CH₂)₂OMe | SO₂Me |
| 6-217 | CH₂O(CH₂)₂OMe | NH(CH₂)₃OMe | SO₂Me |
| 6-218 | SO₂Me | NH₂ | CF₃ |
| 6-219 | SO₂Me | F | CF₃ |
| 6-220 | SO₂Me | NHEt | Cl |
| 6-221 | SMe | SEt | F |
| 6-222 | SMe | SMe | F |
| 6-223 | Me | NH₂ | Cl |
| 6-224 | Me | NH₂ | Br |
| 6-225 | Me | NHMe | Cl |
| 6-226 | Me | NHMe | Br |
| 6-227 | Me | NMe₂ | Cl |
| 6-228 | Me | NMe₂ | Br |
| 6-229 | NO₂ | O(CH₂)₂OMe | Me |
| 6-230 | CF₃ | S(O)₂Et | SO₂Me |
| 6-231 | CF₃ | S(O)₂Et | SO₂Et |
| 6-232 | CF₃ | SCH₂CONMe₂ | SO₂Me |
| 6-233 | CF₃ | SCH₂CONMe₂ | SO₂Et |
| 6-234 | CF₃ | SCH₂COOH | SO₂Me |
| 6-235 | CF₃ | SCH₂COOH | SO₂Et |
| 6-236 | Me | SO₂—CH₂—CH₂—CH═CH₂ | CF₃ |
| 6-237 | Cl | Me | SO₂Et |
| 6-238 | CF₃ | Set | SO₂Me |
| 6-239 | OMe | NO₂ | Cl |
| 6-240 | OMe | NH(CO)i-Pr | Cl |
| 6-241 | OMe | NH(CO)CH₂Ph | Cl |
| 6-242 | CF₃ | SEt | SO₂Et |
| 6-243 | CF₃ | S(O)Et | SO₂Me |
| 6-244 | Cl | Me | Cl |
| 6-245 | Me | 3,5-dimethylpyrazol-6-yl | SO₂Me |
| 6-246 | SMe | H | CF₃ |
| 6-247 | Me | 1,2,3-triazol-6-yl | SO₂Me |
| 6-248 | Me | Me | SMe |
| 6-249 | Me | pyrrolidin-2-on-6-yl | SO₂Me |
| 6-250 | CF₃ | S(O)Et | SO₂Et |
| 6-251 | Cl | pyrazol-6-yl | SO₂Me |
| 6-252 | Me | 3-methylpyrazol-6-yl | SO₂Me |
| 6-253 | Cl | CH₂—N(Et)OMe | SO₂Me |
| 6-254 | Me | Me | Cl |
| 6-255 | OH | Cl | Cl |
| 6-256 | Me | 1,2,4-triazol-1-yl | SO₂Me |
| 6-257 | Me | 4-methoxypyrazol-6-yl | SO₂Me |
| 6-258 | Me | 1,2,4-triazol-1-yl | CF₃ |
| 6-259 | Me | tetrahydropyrimidin-2(1H)-on-6-yl | SO₂Me |
| 6-260 | Me | NH—(CH₂)₂—O(CO)Et | SO₂Me |
| 6-261 | Me | NH—iPr | SO₂Me |
| 6-262 | Cl | NH—CH₂—(CO)NHEt | Cl |
| 6-263 | Me | NH—CH₂—(CO)NMe₂ | SO₂Me |
| 6-264 | Me | NH—CH₂-furan-2-yl | SO₂Me |
| 6-265 | Me | NH—CH₂—(CO)NHEt | SO₂Me |
| 6-266 | Me | F | SO₂Me |
| 6-267 | F | SO₂Me | SO₂Me |
| 6-268 | Cl | (4-cyclopropyl-3-methyl-5-oxo- | Cl |
| | | 4,5-dihydro-1H-1,2,4-triazol-6-yl)methyl | |
| 6-269 | Cl | [4-methyl-5-oxo-3-(2,2,2-trifluoro-ethoxy)- | Cl |
| | | 4,5-dihydro-1H-1,2,4-triazol-6-yl]-methyl | |
| 6-270 | Cl | (3-isopropoxy-4-methyl-5-oxo-4,5- | Cl |
| | | dihydro-1H-1,2,4-triazol-6-yl]methyl | |
| 6-271 | Cl | (4-methyl-5-oxo-4,5-dihydro-1H- | Cl |
| | | 1,2,4-triazol-6-yl)methyl | |
| 6-272 | Me | Cl | SO₂Et |
| 6-273 | SO₂Me | F | Cl |
| 6-274 | Cl | | morpholin-4-yl |
| 6-275 | Me | isobutyl(methyl)carbamoylamino | SO₂Me |
| 6-276 | Me | 3-oxomorpholin-4-yl | SO₂Me |
| 6-277 | OMe | [ethyl(methylsulfonyl)-amino]methyl | Cl |
| 6-279 | OMe | benzoylamino | Cl |
| 6-280 | OMe | cyclopropylcarbonylamino | Cl |
| 6-281 | OMe | propionylamino | Cl |
| 6-282 | NO₂ | SO₂Me | SO₂Me |
| 6-283 | NO₂ | SOMe | SO₂Me |
| 6-284 | NO₂ | SO₂Me | Cl |
| 6-285 | NO₂ | SOMe | Br |
| 6-286 | NO₂ | SOMe | Cl |
| 6-287 | NO₂ | SMe | SO₂Me |
| 6-288 | NO₂ | SMe | Br |
| 6-289 | NO₂ | SMe | Cl |
| 6-290 | Cl | CH₂OEt | SO₂Et |
| 6-291 | Cl | CH₂OC₂H₄OC₂H₄OMe | SO₂Me |
| 6-292 | Cl | CH₂OMe | SO₂Et |
| 6-293 | Cl | 5-methoxymethyl-5-methyl-4,5-dihydro- | SO₂Et |
| | | 1,2-oxazol-3-yl | |
| 6-294 | Cl | 5-methoxymethyl-4,5-dihydro-1,2-oxazol-3-yl | SO₂Et |
| 6-295 | Et | SOMe | CF₃ |
| 6-296 | Cl | 5-ethoxymethyl-4,5-dihydro-1,2-oxazol-3-yl | SO₂Et |
| 6-308 | Cl | NMe₂ | Cl |
| 6-309 | CH₂O(CH₂)₂OMe | NH(CH₂)₃OMe | SO₂Me |
| 6-313 | Me | SO₂(CH₂)₂OMe | CF₃ |
| 6-314 | Me | SOEt | SO₂Me |
| 6-315 | Me | SO₂Et | SO₂Me |
| 6-316 | Me | SMe | 1,2,4-triazol-1-yl |
| 6-317 | OEt | SMe | CF₃ |
| 6-318 | Me | S(CH₂)₂OMe | CF₃ |
| 6-319 | Me | SOMe | 1,2,4-triazol-1-yl |
| 6-320 | OEt | SOMe | CF₃ |
| 6-321 | Me | SO(CH₂)₂OMe | CF₃ |
| 6-322 | Me | SCH₂CCMe | SO₂Me |
| 6-323 | Me | S—c-Pen | SO₂Me |
| 6-324 | OMe | SMe | OMe |
| 6-325 | Me | SCH₂CH═CHCH₃ | SO₂Me |
| 6-326 | Me | SOCH₂CCMe | SO₂Me |
| 6-327 | Me | SO₂—c-Pen | SO₂Me |
| 6-328 | Me | SO—c-Pen | SO₂Me |
| 6-329 | Me | S(CH₂)₃Cl | SO₂Me |
| 6-330 | Me | SCH₂(4-F—Ph) | SO₂Me |
| 6-331 | Me | SO₂CH₂CCMe | SO₂Me |
| 6-332 | Me | SO₂CH₂CH═CHCH₃ | SO₂Me |
| 6-333 | Me | SOCH₂CH═CHCH₃ | SO₂Me |
| 6-334 | Me | SOCH₂-epoxy-CH₃ | SO₂Me |
| 6-335 | Me | SO₂(CH₂)₃Cl | SO₂Me |
| 6-336 | Me | SO(CH₂)₃Cl | SO₂Me |
| 6-337 | Me | SOCH₂(4-F—Ph) | SO₂Me |
| 6-338 | Me | SO₂CH₂(4-F—Ph) | SO₂Me |
| 6-339 | Me | SO₂Me | C₂F₅ |
| 6-340 | O(CH₂)₂OMe | SMe | CF₃ |
| 6-341 | O(CH₂)₂OMe | SO₂Me | CF₃ |
| 6-342 | O(CH₂)₂OMe | SOMe | CF₃ |
| 6-343 | Me | S(CH₂)₂OCH₂CF₃ | SO₂Me |
| 6-344 | Me | SO(CH₂)₂OCH₂CF₃ | SO₂Me |
| 6-345 | Me | SO₂(CH₂)₂OCH₂CF₃ | SO₂Me |
| 6-346 | OEt | SEt | CF₃ |
| 6-347 | O—CH₂—c-Pr | SMe | CF₃ |
| 6-348 | OMe | SEt | CF₃ |
| 6-349 | OMe | SO₂Et | CF₃ |
| 6-350 | OMe | SOEt | CF₃ |
| 6-351 | OEt | SO₂Et | CF₃ |
| 6-352 | OEt | SOEt | CF₃ |
| 6-353 | O—CH₂—c-Pr | SOMe | CF₃ |
| 6-354 | O—CH₂—c-Pr | SO₂Me | CF₃ |
| 6-355 | Me | SEt | SO₂Me |

TABLE 7
Compounds of the general formula (I) according to the invention in
which R is trifluoromethyl

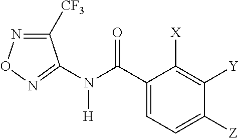

| No. | X | Y | Z |
|---|---|---|---|
| 7-1 | CF₃ | OCH₂CON(Me)Et | SO₂Me |
| 7-2 | CF₃ | OCH₂CON(Me)Et | SO₂Et |
| 7-4 | CF₃ | 2-(1H-pyrazol-1-yl)ethoxyl | SO₂Me |
| 7-5 | CF₃ | 2-(1H-pyrazol-1-yl)ethoxyl | SO₂Et |
| 7-6 | CF₃ | tetrahydrofuran-2-yl-methoxy | SO₂Me |
| 7-7 | CF₃ | tetrahydrofuran-2-yl-methoxy | SO₂Et |
| 7-8 | CF₃ | OH | SO₂Me |
| 7-9 | CF₃ | OH | SO₂Et |
| 7-10 | CF₃ | SH | SO₂Me |
| 7-11 | CF₃ | SH | SO₂Et |
| 7-15 | CF₃ | SMe | SO₂Me |
| 7-16 | CF₃ | SMe | SO₂Et |
| 7-17 | CF₃ | S(O)Me | SO₂Me |
| 7-24 | CF₃ | S(O)Me | SO₂Et |
| 7-25 | CF₃ | S(O)₂Me | SO₂Me |
| 7-26 | CF₃ | S(O)₂Me | SO₂Et |
| 7-27 | CF₃ | 2-[(methylsulfonyl)amino]ethoxy | SO₂Me |
| 7-28 | CF₃ | 2-[(methylsulfonyl)-amino]ethyl}sulfanyl | SO₂Me |
| 7-29 | CF₃ | 2-[(methylsulfonyl)-amino]ethyl}sulfanyl | SO₂Et |
| 7-30 | NO₂ | O(CH₂)₂OMe | OMe |
| 7-31 | NO₂ | OMe | Me |
| 7-32 | NO₂ | NH₂ | OMe |
| 7-33 | NO₂ | NH₂ | SO₂Et |
| 7-34 | NO₂ | NH₂ | Cl |
| 7-35 | NO₂ | NHMe | Cl |
| 7-36 | NO₂ | NMe₂ | Cl |
| 7-37 | NO₂ | NH₂ | Br |
| 7-38 | NO₂ | NHMe | Br |
| 7-39 | NO₂ | NMe₂ | Br |
| 7-40 | NO₂ | NH₂ | F |
| 7-41 | NO₂ | NHMe | F |
| 7-42 | NO₂ | NMe₂ | F |
| 7-43 | NO₂ | NH₂ | SO₂Me |
| 7-44 | NO₂ | NHMe | SO₂Me |
| 7-45 | NO₂ | NMe₂ | SO₂Me |
| 7-46 | NO₂ | NH₂ | 1H-1,2,4-triazol-1-yl |
| 7-47 | NO₂ | NHMe | 1H-1,2,4-triazol-1-yl |
| 7-48 | NO₂ | NMe₂ | 1H-1,2,4-triazol-1-yl |
| 7-49 | Me | F | F |
| 7-50 | Me | F | Cl |
| 7-51 | Me | SMe | CF₃ |
| 7-52 | Me | Cl | SO₂Me |
| 7-53 | Me | SO₂Me | SO₂Me |
| 7-54 | Me | SO₂Me | CF₃ |
| 7-55 | Me | Cl | CF₃ |
| 7-56 | Me | S(O)Me | CF₃ |
| 7-57 | Me | SEt | OMe |
| 7-58 | Me | NMe₂ | SO₂Me |
| 7-59 | Me | NH(CH₂)₂OMe | SO₂Me |
| 7-60 | Me | O(CH₂)₄OMe | SO₂Me |
| 7-61 | Me | NH₂ | SO₂Me |
| 7-62 | Me | O(CH₂)₂—O(3,5-dimethoxypyrimidin-2-yl | SO₂Me |
| 7-63 | Me | O(CH₂)₂—O—NMe₂ | Cl |
| 7-64 | Me | O(CH₂)₂—NH(CO)NMe₂ | Cl |
| 7-65 | Me | O(CH₂)-5-pyrrolidin-2-one | Br |
| 7-66 | Me | O(CH₂)₂—NH(CO)NHCO₂Et | Cl |
| 7-67 | Me | O(CH₂)—(CO)NEt₂ | Br |
| 7-68 | Me | O(CH₂)-5-2,4-dimethyl-2,4-dihydro-3H-1,2,4-triazol-3-one | Cl |
| 7-69 | Me | O(CH₂)-3,5-dimethyl-1,2-oxazol-4-yl | Cl |
| 7-70 | Me | O(CH₂)₂—NHCO₂Me | Cl |
| 7-71 | Me | 4,5-dihydro-1,2-oxazol-3-yl | SO₂Me |
| 7-72 | Me | Me | SO₂Me |
| 7-73 | Me | OH | SO₂Me |
| 7-74 | Me | O—CH₂—NHSO₂cPr | Cl |
| 7-75 | Me | O(CH₂)₂NHSO₂Me | SO₂Me |
| 7-76 | Me | S(O)Me | SO₂Me |
| 7-77 | Me | SMe | SO₂Me |
| 7-78 | Me | SMe | OMe |
| 7-79 | Me | S(O)Me | OMe |
| 7-80 | Me | SO₂Me | OMe |
| 7-81 | Me | SMe | Cl |
| 7-82 | Me | S(O)Me | Cl |
| 7-83 | Me | SO₂Me | Cl |
| 7-84 | Me | [1,4]dioxan-2-yl-methoxy | SO₂Me |
| 7-85 | Me | [1,4]dioxan-2-yl-methoxy | SO₂Et |
| 7-86 | Me | O(CH₂)₄OMe | SO₂Et |
| 7-87 | Me | O(CH₂)₃OMe | SO₂Me |
| 7-88 | Me | O(CH₂)₃OMe | SO₂Et |
| 7-89 | Me | O(CH₂)₂OMe | SO₂Me |
| 7-90 | Me | O(CH₂)₂OMe | SO₂Et |
| 7-91 | Me | S(O)Me | SO₂Me |
| 7-92 | Me | SMe | SO₂Me |
| 7-93 | Me | SMe | OMe |
| 7-94 | Me | S(O)Me | OMe |
| 7-95 | Me | SO₂Me | OMe |
| 7-96 | Me | SMe | Cl |
| 7-97 | Me | S(O)Me | Cl |
| 7-98 | Me | SO₂Me | Cl |
| 7-99 | Me | SMe | Br |
| 7-100 | Me | SOMe | Br |
| 7-101 | Me | SO₂Me | Br |
| 7-102 | Me | SMe | I |
| 7-103 | Me | SOMe | I |
| 7-104 | Me | SO₂Me | I |
| 7-105 | Me | SEt | Cl |
| 7-106 | Me | SOEt | Cl |
| 7-107 | Me | SO₂Et | Cl |
| 7-108 | Me | SEt | Br |
| 7-109 | Me | SOEt | Br |
| 7-110 | Me | SO₂Et | Br |
| 7-111 | Me | SEt | I |
| 7-112 | Me | SOEt | I |
| 7-113 | Me | SO₂Et | I |
| 7-114 | Me | SEt | F |
| 7-115 | Me | SOEt | F |
| 7-116 | Me | SO₂Et | F |
| 7-117 | Cl | OCH₂(CO)NMe₂ | Cl |
| 7-118 | Cl | Cl | SO₂Me |
| 7-119 | Cl | CH₂OCH₂CF₃ | SO₂Me |
| 7-120 | Cl | 5-cyanomethyl-4,5-dihydro-1,2-oxazol-3-yl | SO₂Et |
| 7-121 | Cl | CH₂O-tetrahydrofuran-3-yl | SO₂Me |
| 7-122 | Cl | CH₂O-tetrahydrofuran-2-yl | SO₂Me |
| 7-123 | Cl | SMe | SO₂Me |
| 7-124 | Cl | F | SMe |
| 7-125 | Cl | CH₂OCH₂-tetrahydrofuran-2-yl | SO₂Me |
| 7-126 | Cl | CH₂OCH₂-tetrahydrofuran-3-yl | SO₂Et |
| 7-127 | Cl | O(CH₂)-5-pyrrolidin-2-one | Cl |
| 7-128 | Cl | SMe | Cl |
| 7-129 | Cl | S(O)Me | SO₂Me |
| 7-130 | Cl | CH₂O-tetrahydrofuran-3-yl | SO₂Et |
| 7-131 | Cl | O(CH₂)₂OMe | Cl |
| 7-132 | Cl | O(CH₂)₂OMe | SO₂Me |
| 7-133 | Cl | O(CH₂)₄OMe | SO₂Me |
| 7-134 | Cl | O(CH₂)₄OMe | SO₂Et |
| 7-135 | Cl | O(CH₂)₃OMe | SO₂Me |
| 7-136 | Cl | O(CH₂)₃OMe | SO₂Et |
| 7-137 | Cl | O(CH₂)₂OMe | SO₂Me |
| 7-138 | Cl | O(CH₂)₂OMe | SO₂Et |
| 7-139 | Cl | [1,4]dioxan-2-yl-methoxy | SO₂Me |
| 7-140 | Cl | [1,4]dioxan-2-yl-methoxy | SO₂Et |
| 7-141 | Cl | SO₂Me | Me |
| 7-142 | Cl | SEt | Me |
| 7-143 | Cl | SOEt | Me |
| 7-144 | Cl | SO₂Et | Me |
| 2-145 | Cl | 4,5-dihydro-1,7-oxazol-3-yl | SO₂Me |
| 7-146 | Cl | Cl | SO₂Me |
| 7-147 | F | SMe | CF₃ |
| 7-148 | F | S(O)Me | CF₃ |
| 7-149 | OMe | SMe | CF₃ |
| 7-150 | OMe | S(O)Me | CF₃ |
| 7-151 | OMe | SO₂Me | CF₃ |
| 7-152 | Et | NH(CH₂)₂OMe | SO₂Me |
| 7-153 | Et | F | SO₂Me |
| 7-154 | Et | SMe | CF₃ |
| 7-155 | CF₃ | F | SO₂Me |
| 7-156 | CF₃ | F | SO₂Et |
| 7-157 | CF₃ | O(CH₂)₂OMe | SO₂Et |
| 7-158 | CF₃ | O(CH₂)₃OMe | SO₂Et |
| 7-159 | CF₃ | O(CH₂)₂OMe | SO₂Me |
| 7-160 | CF₃ | O(CH₂)₃OMe | SO₂Me |
| 7-161 | CF₃ | OCH₂CONMe₂ | SO₂Me |
| 7-162 | CF₃ | OCH₂CONMe₂ | SO₂Et |
| 7-163 | CF₃ | OCH₂CONMe₂ | Cl |
| 7-164 | CF₃ | OCH₂CONMe₂ | Br |
| 7-165 | CF₃ | OCH₂CONMe₂ | I |
| 7-166 | CF₃ | OCH₂CONMe₂ | F |
| 7-167 | CF₃ | O(CH₂)₂OMe | Cl |
| 7-168 | CF₃ | O(CH₂)₃OMe | Cl |
| 7-169 | CF₃ | O(CH₂)₂OMe | Br |
| 7-170 | CF₃ | O(CH₂)₃OMe | Br |
| 7-171 | CF₃ | O(CH₂)₂OMe | I |
| 7-172 | CF₃ | O(CH₂)₃OMe | I |
| 7-173 | CF₃ | O(CH₂)₂OMe | F |
| 7-174 | CF₃ | O(CH₂)₃OMe | F |
| 7-175 | CF₃ | [1,4]dioxan-2-yl-methoxy | SO₂Me |
| 7-176 | CF₃ | [1,4]dioxan-2-yl-methoxy | SO₂Et |
| 7-177 | CF₃ | [1,4]dioxan-2-yl-methoxy | Cl |
| 2-178 | CF₃ | [1,4]dioxan-2-yl-methoxy | Br |
| 7-179 | CF₃ | [1,4]dioxan-2-yl-methoxy | I |
| 7-180 | CF₃ | [1,4]dDioxan-2-yl-methoxy | F |
| 7-181 | Br | OMe | Br |
| 7-182 | Br | O(CH₂)₂OMe | Br |
| 7-183 | Br | O(CH₂)₄OMe | SO₂Me |
| 7-184 | Br | O(CH₂)₄OMe | SO₂Et |
| 7-185 | Br | O(CH₂)₃OMe | SO₂Me |
| 7-186 | Br | O(CH₂)₃OMe | SO₂Et |
| 7-187 | Br | O(CH₂)₂OMe | SO₂Me |
| 7-188 | Br | O(CH₂)₂OMe | SO₂Et |
| 7-189 | Br | [1,4]dioxan-2-yl-methoxy | SO₂Me |
| 7-190 | Br | [1,4]dioxan-2-yl-methoxy | SO₂Et |
| 7-191 | Br | SMe | Me |
| 7-192 | Br | SOMe | Me |
| 7-193 | Br | SO₂Me | Me |
| 7-194 | Br | SEt | Me |
| 7-195 | Br | SOEt | Me |
| 7-196 | Br | SO₂Et | Me |
| 7-197 | I | O(CH₂)₄OMe | SO₂Me |
| 7-198 | I | O(CH₂)₄OMe | SO₂Et |
| 7-199 | I | O(CH₂)₃OMe | SO₂Me |
| 7-200 | I | O(CH₂)₃OMe | SO₂Et |
| 7-201 | I | O(CH₂)₂OMe | SO₂Me |
| 7-202 | I | O(CH₂)₂OMe | SO₂Et |
| 7-203 | I | [1,4]dioxan-2-yl-methoxy | SO₂Me |
| 7-204 | I | [1,4]dioxan-2-yl-methoxy | SO₂Et |
| 7-205 | I | SMe | Me |
| 7-206 | I | SOMe | Me |
| 7-207 | I | SO₂Me | Me |
| 7-208 | I | SEt | Me |
| 7-209 | I | SOEt | Me |
| 7-210 | I | SO₂Et | Me |
| 7-211 | CH₂SMe | OMe | SO₂Me |
| 7-212 | CH₂OMe | OMe | SO₂Me |
| 7-213 | CH₂O(CH₂)₂OMe | NH(CH₂)₂OEt | SO₂Me |
| 7-214 | CH₂O(CH₂)₂OMe | NH(CH₂)₃OEt | SO₂Me |
| 7-215 | CH₂O(CH₂)₃OMe | OMe | SO₂Me |
| 7-216 | CH₂O(CH₂)₂OMe | NH(CH₂)₂OMe | SO₂Me |
| 7-217 | CH₂O(CH₂)₂OMe | NH(CH₂)₃OMe | SO₂Me |
| 7-218 | SO₂Me | NH₂ | CF₃ |
| 7-219 | SO₂Me | F | CF₃ |
| 7-220 | SO₂Me | NHEt | Cl |
| 7-221 | SMe | SEt | F |
| 7-222 | SMe | SMe | F |
| 7-223 | Me | NH₂ | Cl |
| 7-224 | Me | NH₂ | Br |
| 7-225 | Me | NHMe | Cl |
| 7-226 | Me | NHMe | Br |
| 7-227 | Me | NMe₂ | Cl |
| 7-228 | Me | NMe₂ | Br |
| 7-227 | Me | NMe₂ | Cl |
| 7-228 | Me | NMe₂ | Br |
| 7-229 | NO₂ | O(CH₂)₂OMe | Me |
| 7-230 | CF₃ | S(O)₂Et | SO₂Me |
| 7-231 | CF₃ | S(O)₂Et | SO₂Et |
| 7-232 | CF₃ | SCH₂CONMe₂ | SO₂Me |
| 7-233 | CF₃ | SCH₂CONMe₂ | SO₂Et |
| 7-234 | CF₃ | SCH₂COOH | SO₂Me |
| 7-235 | CF₃ | SCH₂COOH | SO₂Et |
| 7-236 | Me | SO₂—CH₂—CH₂—CH═CH₂ | CF₃ |
| 7-237 | Cl | Me | SO₂Et |
| 7-238 | CF₃ | SEt | SO₂Me |
| 7-239 | OMe | NO₂ | Cl |
| 7-240 | OMe | NH(CO)i-Pr | Cl |
| 7-241 | OMe | NH(CO)CH₂Ph | Cl |
| 7-242 | CF₃ | SEt | SO₂Et |
| 7-243 | CF₃ | S(O)Et | SO₂Me |
| 7-244 | Cl | Me | Cl |
| 7-245 | Me | 3,5-dimethylpyrazol-1-yl | SO₂Me |
| 7-247 | Me | 1,2,3-triazol-1-yl | SO₂Me |
| 7-248 | Me | Me | SMe |
| 7-249 | Me | pyrrolidin-2-on-1-yl | SO₂Me |
| 7-250 | CF₃ | S(O)Et | SO₂Et |
| 7-251 | Cl | pyrazol-1-yl | SO₂Me |
| 7-252 | Me | 3-methylpyrazol-1-yl | SO₂Me |
| 7-253 | Cl | CH₂—N(Et)OMe | SO₂Me |
| 7-254 | Me | Me | Cl |
| 7-255 | OH | Cl | Cl |
| 7-256 | Me | 1,2,4-triazol-1-yl | SO₂Me |
| 7-257 | Me | 4-methoxypyrazol-1-yl | SO₂Me |
| 7-258 | Me | 1,2,4-triazol-1-yl | CF₃ |
| 7-259 | Me | tetrahydropyrimidin-2(1H)-on-1-yl | SO₂Me |
| 7-260 | Me | NH—(CH₂)₂—O(CO)Et | SO₂Me |
| 7-261 | Me | NH—iPr | SO₂Me |
| 7-262 | Cl | NH—CH₂—(CO)NHEt | Cl |
| 7-263 | Me | NH—CH₂—(CO)NMe₂ | SO₂Me |
| 7-264 | Me | NH—CH₂-furan-2-yl | SO₂Me |
| 7-265 | Me | NH—CH₂—(CO)NHEt | SO₂Me |
| 7-266 | Me | F | SO₂Me |
| 7-267 | F | SO₂Me | SO₂Me |
| 7-268 | Cl | (4-cyclopropyl-3-methyl-5-oxo- | Cl |
| | | 4,5-dihydro-1H-1,2,4-triazol-1-yl)methyl | |
| 7-269 | Cl | [4-methyl-5-oxo-3-(2,2,2-trifluoroethoxy)- | Cl |
| | | 4,5-dihydro-1H-1,2,4-triazol-1-yl]methyl | |
| 7-270 | Cl | (3-isopropoxy-4-methyl-5-oxo-4,5- | Cl |
| | | dihydro-1H-1,2,4-triazol-1-yl]-methyl | |
| 7-271 | Cl | (4-methyl-5-oxo-4,5-dihydro-1H- | Cl |
| | | 1,2,4-triazol-1-yl)methyl | |
| 7-272 | Me | Cl | SO₂Et |
| 7-273 | SO₂Me | F | Cl |
| 7-274 | Me | 1,2,3-triazol-1-yl | SO₂Me |
| 7-275 | Me | isobutyl(methyl)carbamoylamino | SO₂Me |
| 7-276 | Me | 3-oxomorpholin-4-yl | SO₂Me |
| 7-277 | OMe | [ethyl(methylsulfonyl)-amino]methyl | Cl |
| 7-278 | F | SO₂Me | CF₃ |
| 7-279 | OMe | benzoylamino | Cl |
| 7-280 | OMe | cyclopropylcarbonyl-amino | Cl |
| 7-281 | OMe | propionylamino | Cl |
| 7-282 | NO₂ | SO₂Me | SO₂Me |
| 7-283 | NO₂ | SO₂Me | Cl |
| 7-284 | NO₂ | SOMe | SO₂Me |
| 7-285 | NO₂ | SOMe | Br |
| 7-286 | NO₂ | SOMe | Cl |
| 7-287 | NO₂ | SMe | SO₂Me |
| 7-288 | NO₂ | SMe | Br |
| 7-289 | NO₂ | SMe | Cl |
| 7-290 | Cl | CH₂OCH(CH₃)₂ | SO₂Et |
| 7-291 | Cl | CH₂OEt | SO₂Et |
| 7-292 | Cl | CH₂OMe | SO₂Et |
| 7-293 | Cl | CH₂OCH₂C₂F₅ | SO₂Me |
| 7-294 | Cl | CH₂OCH₂CHF₂ | SO₂Me |
| 7-295 | Cl | CH₂OCH₂CCH | SO₂Et |
| 7-296 | Cl | CH₂OC₂H₄OMe | SO₂Me |
| 7-297 | Cl | CH₂(OC₂H₄)₂OMe | SO₂Me |
| 7-298 | Cl | 5-ethoxymethyl-4,5-dihydro-1,2-oxazol-3-yl | SO₂Et |
| 7-299 | Cl | 5-methoxymethyl-4,5-dihydro-1,2-oxazol-3-yl | SO₂Et |
| 7-300 | Et | SOMe | CF₃ |
| 7-301 | iPr | SMe | CF₃ |
| 7-302 | Et | SMe | CF₃ |
| 7-303 | Et | SO₂Me | CF₃ |
| 7-304 | cPr | SOMe | CF₃ |
| 7-305 | CH═CH₂ | SMe | CF₃ |
| 7-306 | Et | SMe | Cl |
| 7-307 | Et | SO₂Me | Cl |
| 7-308 | Cl | NMe₂ | Cl |
| 7-309 | CH₂O(CH₂)₂OMe | NH(CH₂)₃OMe | SO₂Me |
| 7-313 | Me | SO₂(CH₂)₂OMe | CF₃ |
| 7-314 | Me | SOEt | SO₂Me |
| 7-315 | Me | SO₂Et | SO₂Me |
| 7-316 | Me | SMe | 1,2,4-triazol-1-yl |
| 7-317 | OEt | SMe | CF₃ |
| 7-318 | Me | S(CH₂)₂OMe | CF₃ |
| 7-319 | Me | SOMe | 1,2,4-triazol-1-yl |
| 7-320 | OEt | SOMe | CF₃ |
| 7-321 | Me | SO(CH₂)₂OMe | CF₃ |
| 7-322 | Me | SCH₂CCMe | SO₂Me |
| 7-323 | Me | S—c-Pen | SO₂Me |
| 7-324 | OMe | SMe | OMe |
| 7-325 | Me | SCH₂CH═CHCH₃ | SO₂Me |
| 7-326 | Me | SOCH₂CCMe | SO₂Me |
| 7-327 | Me | SO₇—c-Pen | SO₂Me |
| 7-328 | Me | SO—c-Pen | SO₂Me |
| 7-329 | Me | S(CH₂)₃Cl | SO₂Me |
| 7-330 | Me | SCH₂(4-F-Ph) | SO₂Me |
| 7-331 | Me | SO₂CH₂CCMe | SO₂Me |
| 7-332 | Me | SO₂CH₂CH═CHCH₃ | SO₂Me |
| 7-333 | Me | SOCH₂CH═CHCH₃ | SO₂Me |
| 7-334 | Me | SOCH₂-epoxy-Me | SO₂Me |
| 7-335 | Me | SO₂(CH₂)₃Cl | SO₂Me |
| 7-336 | Me | SO(CH₂)₃Cl | SO₂Me |
| 7-337 | Me | SOCH₂(4-F—Ph) | SO₂Me |
| 7-338 | Me | SO₂CH₂(4-F—Ph) | SO₂Me |
| 7-339 | Me | SO₂Me | C₂F₅ |
| 7-340 | O(CH₂)₂OMe | SMe | CF₃ |
| 7-341 | O(CH₂)₂OMe | SO₂Me | CF₃ |
| 7-342 | O(CH₂)₂OMe | SOMe | CF₃ |
| 7-343 | Me | S(CH₂)₂OCH₂CF₃ | SO₂Me |
| 7-344 | Me | SO(CH₂)₂OCH₂CF₃ | SO₂Me |
| 7-345 | Me | SO₂(CH₂)₂OCH₂CF₃ | SO₂Me |
| 7-346 | OEt | SEt | CF₃ |
| 7-347 | O—CH₂—c-Pr | SMe | CF₃ |
| 7-348 | OMe | SEt | CF₃ |
| 7-349 | OMe | SO₂Et | CF₃ |
| 7-350 | OMe | SOEt | CF₃ |
| 7-351 | OEt | SO₂Et | CF₃ |
| 7-352 | OEt | SOEt | CF₃ |
| 7-353 | O—CH₂—c-Pr | SOMe | CF₃ |
| 7-354 | O—CH₂—c-Pr | SO₂Me | CF₃ |
| 7-355 | Me | SEt | SO₂Me |

TABLE 8
Compounds of the general formula (I) according to the invention in
which R is cyano

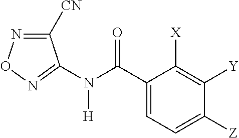

| No. | X | Y | Z |
|---|---|---|---|
| 8-1 | CF₃ | OCH₂CON(Me)Et | SO₂Me |
| 8-2 | CF₃ | OCH₂CON(Me)Et | SO₂Et |
| 8-4 | CF₃ | 2-(1H-pyrazol-1-yl)ethoxyl | SO₂Me |
| 8-5 | CF₃ | 2-(1H-pyrazol-1-yl)ethoxyl | SO₂Et |
| 8-6 | CF₃ | tetrahydrofuran-2-yl-methoxy | SO₂Me |
| 8-7 | CF₃ | tetrahydrofuran-2-yl-methoxy | SO₂Et |
| 8-8 | CF₃ | OH | SO₂Me |
| 8-9 | CF₃ | OH | SO₂Et |
| 8-10 | CF₃ | SH | SO₂Me |
| 8-11 | CF₃ | SH | SO₂Et |
| 8-15 | CF₃ | SMe | SO₂Me |
| 8-16 | CF₃ | SMe | SO₂Et |
| 8-17 | CF₃ | S(O)Me | SO₂Me |
| 8-24 | CF₃ | S(O)Me | SO₂Et |
| 8-25 | CF₃ | S(O)₂Me | SO₂Me |
| 8-26 | CF₃ | S(O)₂Me | SO₂Et |
| 8-27 | CF₃ | 2-[(methylsulfonyl)amino]ethoxy | SO₂Me |
| 8-28 | CF₃ | 2-[(methylsulfonyl)-amino]ethyl}sulfanyl | SO₂Me |
| 8-29 | CF₃ | 2-[(methylsulfonyl)-amino]ethyl}sulfanyl | SO₂Et |
| 8-30 | NO₂ | O(CH₂)₂OMe | OMe |
| 8-31 | NO₂ | OMe | Me |
| 8-32 | NO₂ | NH₂ | OMe |
| 8-33 | NO₂ | NH₂ | SO₂Et |
| 8-34 | NO₂ | NH₂ | Cl |
| 8-35 | NO₂ | NHMe | Cl |
| 8-36 | NO₂ | NMe₂ | Cl |
| 8-37 | NO₂ | NH₂ | Br |
| 8-38 | NO₂ | NHMe | Br |
| 8-39 | NO₂ | NMe₂ | Br |
| 8-40 | NO₂ | NH₂ | F |
| 8-41 | NO₂ | NHMe | F |
| 8-42 | NO₂ | NMe₂ | F |
| 8-43 | NO₂ | NH₂ | SO₂Me |
| 8-44 | NO₂ | NHMe | SO₂Me |
| 8-45 | NO₂ | NMe₂ | SO₂Me |
| 8-46 | NO₂ | NH₂ | 1H-1,2,4-triazol-1-yl |
| 8-47 | NO₂ | NHMe | 1H-1,2,4-triazol-1-yl |
| 8-48 | NO₂ | NMe₂ | 1H-1,2,4-triazol-1-yl |
| 8-49 | Me | F | F |
| 8-50 | Me | F | Cl |
| 8-51 | Me | SMe | CF₃ |
| 8-52 | Me | Cl | SO₂Me |
| 8-53 | Me | SO₂Me | SO₂Me |
| 8-54 | Me | SO₂Me | CF₃ |
| 8-55 | Me | Cl | CF₃ |
| 8-56 | Me | S(O)Me | CF₃ |
| 8-57 | Me | SEt | OMe |
| 8-58 | Me | NMe₂ | SO₂Me |
| 8-59 | Me | NH(CH₂)₂OMe | SO₂Me |
| 8-60 | Me | O(CH₂)₄OMe | SO₂Me |
| 8-61 | Me | NH₂ | SO₂Me |
| 8-62 | Me | O(CH₂)₂—O(3,5-di-methoxypyrimidin-2-yl | SO₂Me |
| 8-63 | Me | O(CH2)₂—O—NMe₂ | Cl |
| 8-64 | Me | O(CH₂)₂—NH(CO)NMe₂ | Cl |
| 8-65 | Me | O(CH₂)-5-pyrrolidin-2-one | Br |
| 8-66 | Me | O(CH₂)₂—NH(CO)NHCO₂Et | Cl |
| 8-67 | Me | O(CH₂)—(CO)NEt₂ | Br |
| 8-68 | Me | O(CH₂)-5-2,4-dimethyl-2,4-dihydro-3H- | Cl |
| | | 1,2,4-triazol-3-one | |
| 8-69 | Me | O(CH₂)-3,5-dimethyl-1,2-oxazol-4-yl | Cl |
| 8-70 | Me | O(CH₂)₂—NHCO₂Me | Cl |
| 8-71 | Me | 4,5-dihydro-1,2-oxazol-3-yl | SO₂Me |
| 8-72 | Me | Me | SO₂Me |
| 8-73 | Me | OH | SO₂Me |
| 8-74 | Me | O—CH₂—NHSO₂cPr | Cl |
| 8-75 | Me | O(CH₂)₂NHSO₂Me | SO₂Me |
| 8-76 | Me | S(O)Me | SO₂Me |
| 8-77 | Me | SMe | SO₂Me |
| 8-78 | Me | SMe | OMe |
| 8-79 | Me | S(O)Me | OMe |
| 8-80 | Me | SO₂Me | OMe |
| 8-81 | Me | SMe | Cl |
| 8-82 | Me | S(O)Me | Cl |
| 8-83 | Me | SO₂Me | Cl |
| 8-84 | Me | [1,4]dioxan-2-yl-methoxy | SO₂Me |
| 8-85 | Me | [1,4]dioxan-2-yl-methoxy | SO₂Et |
| 8-86 | Me | O(CH₂)₄OMe | SO₂Et |
| 8-87 | Me | O(CH₂)₃OMe | SO₂Me |
| 8-88 | Me | O(CH₂)₃OMe | SO₂Et |
| 8-89 | Me | O(CH₂)₂OMe | SO₂Me |
| 8-90 | Me | O(CH₂)₂OMe | SO₂Et |
| 8-91 | Me | S(O)Me | SO₂Me |
| 8-92 | Me | SMe | SO₂Me |
| 8-93 | Me | SMe | OMe |
| 8-94 | Me | S(O)Me | OMe |
| 8-95 | Me | SO₂Me | OMe |
| 8-96 | Me | SMe | Cl |
| 8-97 | Me | S(O)Me | Cl |
| 8-98 | Me | SO₂Me | Cl |
| 8-99 | Me | SMe | Br |
| 8-100 | Me | SOMe | Br |
| 8-101 | Me | SO₂Me | Br |
| 8-102 | Me | SMe | I |
| 8-103 | Me | SOMe | I |
| 8-104 | Me | SO₂Me | I |
| 8-105 | Me | SEt | Cl |
| 8-106 | Me | SOEt | Cl |
| 8-107 | Me | SO₂Et | Cl |
| 8-108 | Me | SEt | Br |
| 8-109 | Me | SOEt | Br |
| 8-110 | Me | SO₂Et | Br |
| 8-111 | Me | SEt | I |
| 8-112 | Me | SOEt | I |
| 8-113 | Me | SO₂Et | I |
| 8-114 | Me | SEt | F |
| 8-115 | Me | SOEt | F |
| 8-116 | Me | SO₂Et | F |
| 8-117 | Cl | OCH₂(CO)NMe₂ | Cl |
| 8-118 | Cl | Cl | SO₂Me |
| 8-119 | Cl | CH₂OCH₂CF₃ | SO₂Me |
| 8-120 | Cl | 5-cyanomethyl-4,5-dihydro-1,2-oxazol-3-yl | SO₂Et |
| 8-121 | Cl | CH₂O-tetrahydrofuran-3-yl | SO₂Me |
| 8-122 | Cl | CH₂O-tetrahydrofuran-2-yl | SO₂Me |
| 8-123 | Cl | SMe | SO₂Me |
| 8-124 | Cl | F | SMe |
| 8-125 | Cl | CH₂OCH₂-tetrahydrofuran-2-yl | SO₂Me |
| 8-126 | Cl | CH₂OCH₂-tetrahydrofuran-3-yl | SO₂Et |
| 8-127 | Cl | O(CH₂)-5-pyrrolidin-2-one | Cl |
| 8-128 | Cl | SMe | Cl |
| 8-129 | Cl | S(O)Me | SO₂Me |
| 8-130 | Cl | CH₂O-tetrahydrofuran-3-yl | SO₂Et |
| 8-131 | Cl | O(CH₂)₂OMe | Cl |
| 8-132 | Cl | O(CH₂)₂OMe | SO₂Me |
| 8-133 | Cl | O(CH₂)₄OMe | SO₂Me |
| 8-134 | Cl | O(CH₂)₄OMe | SO₂Et |
| 8-135 | Cl | O(CH₂)₃OMe | SO₂Me |
| 8-136 | Cl | O(CH₂)₃OMe | SO₂Et |
| 8-137 | Cl | O(CH₂)₂OMe | SO₂Me |
| 8-138 | Cl | O(CH₂)₂OMe | SO₂Et |
| 8-139 | Cl | [1,4]dioxan-2-yl-methoxy | SO₂Me |
| 8-140 | Cl | [1,4]dioxan-2-yl-methoxy | SO₂Et |
| 8-141 | Cl | SO₂Me | Me |
| 8-142 | Cl | SEt | Me |
| 8-143 | Cl | SOEt | Me |
| 8-144 | Cl | SO₂Et | Me |
| 2-145 | Cl | 4,5-dihydro-1,8-oxazol-3-yl | SO₂Me |
| 8-146 | Cl | Cl | SO₂Me |
| 8-147 | F | SMe | CF₃ |
| 8-148 | F | S(O)Me | CF₃ |
| 8-149 | OMe | SMe | CF₃ |
| 8-150 | OMe | S(O)Me | CF₃ |
| 8-151 | OMe | SO2Me | CF₃ |
| 8-152 | Et | NH(CH₂)₂OMe | SO₂Me |
| 8-153 | Et | F | SO₂Me |
| 8-154 | Et | SMe | CF₃ |
| 8-155 | CF₃ | F | SO₂Me |
| 8-156 | CF₃ | F | SO₂Et |
| 8-157 | CF₃ | O(CH₂)₂OMe | SO₂Et |
| 8-158 | CF₃ | O(CH₂)₃OMe | SO₂Et |
| 8-159 | CF₃ | O(CH₂)₂OMe | SO₂Me |
| 8-160 | CF₃ | O(CH₂)₃OMe | SO₂Me |
| 8-161 | CF₃ | OCH₂CONMe₂ | SO₂Me |
| 8-162 | CF₃ | OCH₂CONMe₂ | SO₂Et |
| 8-163 | CF₃ | OCH₂CONMe₂ | Cl |
| 8-164 | CF₃ | OCH₂CONMe₂ | Br |
| 8-165 | CF₃ | OCH₂CONMe₂ | I |
| 8-166 | CF₃ | OCH₂CONMe₂ | F |
| 8-167 | CF₃ | O(CH₂)₂OMe | Cl |
| 8-168 | CF₃ | O(CH₂)₃OMe | Cl |
| 8-169 | CF₃ | O(CH₂)₂OMe | Br |
| 8-170 | CF₃ | O(CH₂)₃OMe | Br |
| 8-171 | CF₃ | O(CH₂)₂OMe | I |
| 8-172 | CF₃ | O(CH₂)₃OMe | I |
| 8-173 | CF₃ | O(CH₂)₂OMe | F |
| 8-174 | CF₃ | O(CH₂)₃OMe | F |
| 8-175 | CF₃ | [1,4]dioxan-2-yl-methoxy | SO₂Me |
| 8-176 | CF₃ | [1,4]dioxan-2-yl-methoxy | SO₂Et |
| 8-177 | CF₃ | [1,4]dioxan-2-yl-methoxy | Cl |
| 2-178 | CF₃ | [1,4]dioxan-2-yl-methoxy | Br |
| 8-179 | CF₃ | [1,4]dioxan-2-yl-methoxy | I |
| 8-180 | CF₃ | [1,4]dioxan-2-yl-methoxy | F |
| 8-181 | Br | OMe | Br |
| 8-182 | Br | O(CH₂)₂OMe | Br |
| 8-183 | Br | O(CH₂)₄OMe | SO₂Me |
| 8-184 | Br | O(CH₂)₄OMe | SO₂Et |
| 8-185 | Br | O(CH₂)₃OMe | SO₂Me |
| 8-186 | Br | O(CH₂)₃OMe | SO₂Et |
| 8-187 | Br | O(CH₂)₂OMe | SO₂Me |
| 8-188 | Br | O(CH₂)₂OMe | SO₂Et |
| 8-189 | Br | [1,4]dioxan-2-yl-methoxy | SO₂Me |
| 8-190 | Br | [1,4]dioxan-2-yl-methoxy | SO₂Et |
| 8-191 | Br | SMe | Me |
| 8-192 | Br | SOMe | Me |
| 8-193 | Br | SO₂Me | Me |
| 8-194 | Br | SEt | Me |
| 8-195 | Br | SOEt | Me |
| 8-196 | Br | SO₂Et | Me |
| 8-197 | I | O(CH₂)₄OMe | SO₂Me |
| 8-198 | I | O(CH₂)₄OMe | SO₂Et |
| 8-199 | I | O(CH₂)₃OMe | SO₂Me |
| 8-200 | I | O(CH₂)₃OMe | SO₂Et |
| 8-201 | I | O(CH₂)₂OMe | SO₂Me |
| 8-202 | I | O(CH₂)₂OMe | SO₂Et |
| 8-203 | I | [1,4]dioxan-2-yl-methoxy | SO₂Me |
| 8-204 | I | [1,4]dioxan-2-yl-methoxy | SO₂Et |
| 8-205 | I | SMe | Me |
| 8-206 | I | SOMe | Me |
| 8-207 | I | SO₂Me | Me |
| 8-208 | I | SEt | Me |
| 8-209 | I | SOEt | Me |
| 8-210 | I | SO₂Et | Me |
| 8-211 | CH₂SMe | OMe | SO₂Me |
| 8-212 | CH₂OMe | OMe | SO₂Me |
| 8-213 | CH₂O(CH₂)₂OMe | NH(CH₂)₂OEt | SO₂Me |
| 8-214 | CH₂O(CH₂)₂OMe | NH(CH₂)₃OEt | SO₂Me |
| 8-215 | CH₂O(CH₂)₃OMe | OMe | SO₂Me |
| 8-216 | CH₂O(CH₂)₂OMe | NH(CH₂)₂OMe | SO₂Me |
| 8-217 | CH₂O(CH₂)₂OMe | NH(CH₂)₃OMe | SO₂Me |
| 8-218 | SO₂Me | NH₂ | CF₃ |
| 8-219 | SO₂Me | F | CF₃ |
| 8-220 | SO₂Me | NHEt | Cl |
| 8-221 | SMe | SEt | F |
| 8-222 | SMe | SMe | F |
| 8-223 | Me | NH₂ | Cl |
| 8-224 | Me | NH₂ | Br |
| 8-225 | Me | NHMe | Cl |
| 8-226 | Me | NHMe | Br |
| 8-227 | Me | NMe₂ | Cl |
| 8-228 | Me | NMe₂ | Br |
| 8-227 | Me | NMe₂ | Cl |
| 8-228 | Me | NMe₂ | Br |
| 8-229 | NO₂ | O(CH₂)₂OMe | Me |
| 8-230 | CF₃ | S(O)₂Et | SO₂Me |
| 8-231 | CF₃ | S(O)₂Et | SO₂Et |
| 8-232 | CF₃ | SCH₂CONMe₂ | SO₂Me |
| 8-233 | CF₃ | SCH₂CONMe₂ | SO₂Et |
| 8-234 | CF₃ | SCH₂COOH | SO₂Me |
| 8-235 | CF₃ | SCH₂COOH | SO₂Et |
| 8-236 | Me | SO₂—CH₂—CH₂—CH═CH₂ | CF₃ |
| 8-237 | Cl | Me | SO₂Et |
| 8-238 | CF₃ | SEt | SO₂Me |
| 8-239 | OMe | NO₂ | Cl |
| 8-240 | OMe | NH(CO)i-Pr | Cl |
| 8-241 | OMe | NH(CO)CH₂Ph | Cl |
| 8-242 | CF₃ | SEt | SO₂Et |
| 8-243 | CF₃ | S(O)Et | SO₂Me |
| 8-244 | Cl | Me | Cl |
| 8-245 | Me | 3,5-dimethylpyrazol-1-yl | SO₂Me |
| 8-246 | SMe | H | CF₃ |
| 8-247 | Me | 1,2,3-triazol-1-yl | SO₂Me |
| 8-248 | Me | Me | SMe |
| 8-249 | Me | pyrrolidin-2-on-1-yl | SO₂Me |
| 8-250 | CF₃ | S(O)Et | SO₂Et |
| 8-251 | Cl | pyrazol-1-yl | SO₂Me |
| 8-252 | Me | 3-methylpyrazol-1-yl | SO₂Me |
| 8-253 | Cl | CH₂—N(Et)OMe | SO₂Me |
| 8-254 | Me | Me | Cl |
| 8-255 | OH | Cl | Cl |
| 8-256 | Me | 1,2,4-triazol-1-yl | SO₂Me |
| 8-257 | Me | 4-methoxypyrazol-1-yl | SO₂Me |
| 8-258 | Me | 1,2,4-triazol-1-yl | CF₃ |
| 8-259 | Me | tetrahydropyrimidin-2(1H)-one-1-yl | SO₂Me |
| 8-260 | Me | NH—(CH₂)₂—O(CO)Et | SO₂Me |
| 8-261 | Me | NH—iPr | SO₂Me |
| 8-262 | Cl | NH—CH₂—(CO)NHEt | Cl |
| 8-263 | Me | NH—CH₂—(CO)NMe₂ | SO₂Me |
| 8-264 | Me | NH—CH₂-furan-2-yl | SO₂Me |
| 8-265 | Me | NH—CH₂—(CO)NHEt | SO₂Me |
| 8-266 | Me | F | SO₂Me |
| 8-267 | F | SO₂Me | SO₂Me |
| 8-268 | Cl | (4-cyclopropyl-3-methyl-5-oxo- | Cl |
| | | 4,5-dihydro-1H-1,2,4-triazol-1-yl)methyl | |
| 8-269 | Cl | [4-methyl-5-oxo-3-(2,2,2-trifluorethoxy)- | Cl |
| | | 4,5-dihydro-1H-1,2,4-triazol-1-yl]nethyl | |
| 8-270 | Cl | (3-isopropoxy-4-methyl-5-oxo-4,5- | Cl |
| | | dihydro-1H-1,2,4-triazol-1-yl]-methyl | |
| 8-271 | Cl | (4-methyl-5-oxo-4,5-dihydro-1H- | Cl |
| | | 1,2,4-triazol-1-yl)methyl | |
| 8-272 | Me | Cl | SO₂Et |
| 8-273 | SO₂Me | F | Cl |
| 8-274 | Me | 1,2,3-triazol-1-yl | SO₂Me |
| 8-275 | Me | isobutyl(methyl)carbamoylamino | SO₂Me |
| 8-276 | Me | 3-oxomorpholin-4-yl | SO₂Me |
| 8-277 | OMe | [ethyl(methylsulfonyl)-amino]methyl | Cl |
| 8-278 | F | SO₂Me | CF₃ |
| 8-279 | OMe | benzoylamino | Cl |
| 8-280 | OMe | cyclopropylcarbonylamino | Cl |
| 8-281 | OMe | propionylamino | Cl |
| 8-282 | NO₂ | SO₂Me | SO₂Me |
| 8-283 | NO₂ | SO₂Me | Cl |
| 8-284 | NO₂ | SOMe | SO₂Me |
| 8-285 | NO₂ | SOMe | Br |
| 8-286 | NO₂ | SOMe | Cl |
| 8-287 | NO₂ | SMe | SO₂Me |
| 8-288 | NO₂ | SMe | Br |
| 8-289 | NO₂ | SMe | Cl |
| 8-290 | Cl | CH₂OCH(CH₃)₂ | SO₂Et |
| 8-291 | Cl | CH₂OEt | SO₂Et |
| 8-292 | Cl | CH₂OMe | SO₂Et |
| 8-293 | Cl | CH₂OCH₂C₂F₅ | SO₂Me |
| 8-294 | Cl | CH₂OCH₂CHF₂ | SO₂Me |
| 8-295 | Cl | CH₂OCH₂CCH | SO₂Et |
| 8-296 | Cl | CH₂OC₂H₄OMe | SO₂Me |
| 8-297 | Cl | CH₂(OC₂H₄)₂OMe | SO₂Me |
| 8-298 | Cl | 5-ethoxymethyl-4,5-dihydro-1,2-oxazol-3-yl | SO₂Et |
| 8-299 | Cl | 5-methoxymethyl-4,5-dihydro-1,2-oxazol-3-yl | SO₂Et |
| 8-300 | Et | SOMe | CF₃ |
| 8-301 | iPr | SMe | CF₃ |
| 8-302 | Et | SMe | CF₃ |
| 8-303 | Et | SO₂Me | CF₃ |
| 8-304 | cPr | SOMe | CF₃ |
| 8-305 | CH═CH₂ | SMe | CF₃ |
| 8-306 | Et | SMe | Cl |
| 8-307 | Et | SO₂Me | Cl |
| 8-308 | Cl | NMe₂ | Cl |
| 8-309 | CH₂O(CH₂)₂OMe | NH(CH₂)₃OMe | SO₂Me |
| 8-313 | Me | SO₂(CH₂)₂OMe | CF₃ |
| 8-314 | Me | SOEt | SO₂Me |
| 8-315 | Me | SO₂Et | SO₂Me |
| 8-316 | Me | SMe | 1,2,4-triazol-1-yl |
| 8-317 | OEt | SMe | CF₃ |
| 8-318 | Me | S(CH₂)₂OMe | CF₃ |
| 8-319 | Me | SOMe | 1,2,4-triazol-1-yl |
| 8-320 | OEt | SOMe | CF₃ |
| 8-321 | Me | SO(CH₂)₂OMe | CF₃ |
| 8-322 | Me | SCH₂CCMe | SO₂Me |
| 8-323 | Me | S—c-Pen | SO₂Me |
| 8-324 | OMe | SMe | OMe |
| 8-325 | Me | SCH₂CH═CHCH₃ | SO₂Me |
| 8-326 | Me | SOCH₂CCMe | SO₂Me |
| 8-327 | Me | SO₈—c-Pen | SO₂Me |
| 8-328 | Me | SO—c-Pen | SO₂Me |
| 8-329 | Me | S(CH₂)₃Cl | SO₂Me |
| 8-330 | Me | SCH₂(4-F—Ph) | SO₂Me |
| 8-331 | Me | SO₂CH₂CCMe | SO₂Me |
| 8-332 | Me | SO₂CH₂CH═CHCH3 | SO₂Me |
| 8-333 | Me | SOCH₂CH═CHCH3 | SO₂Me |
| 8-334 | Me | SOCH₂-epoxy-Me | SO₂Me |
| 8-335 | Me | SO₂(CH₂)₃Cl | SO₂Me |
| 8-336 | Me | SO(CH₂)₃Cl | SO₂Me |
| 8-337 | Me | SOCH₂(4-F—Ph) | SO₂Me |
| 8-338 | Me | SO₂CH₂(4-F—Ph) | SO₂Me |
| 8-339 | Me | SO₂Me | C₂F₅ |
| 8-340 | O(CH₂)₂OMe | SMe | CF₃ |
| 8-341 | O(CH₂)₂OMe | SO₂Me | CF₃ |
| 8-342 | O(CH₂)₂OMe | SOMe | CF₃ |
| 8-343 | Me | S(CH₂)₂OCH₂CF₃ | SO₂Me |
| 8-344 | Me | SO(CH₂)₂OCH₂CF₃ | SO₂Me |
| 8-345 | Me | SO₂(CH₂)₂OCH₂CF₃ | SO₂Me |
| 8-346 | OEt | SEt | CF₃ |
| 8-347 | O—CH₂—c-Pr | SMe | CF₃ |
| 8-348 | OMe | SEt | CF₃ |
| 8-349 | OMe | SO₂Et | CF₃ |
| 8-350 | OMe | SOEt | CF₃ |
| 8-351 | OEt | SO₂Et | CF₃ |
| 8-352 | OEt | SOEt | CF₃ |
| 8-353 | O—CH₂—c-Pr | SOMe | CF₃ |
| 8-354 | O—CH₂—c-Pr | SO₂Me | CF₃ |
| 8-355 | Me | SEt | SO₂Me |

TABLE 9
Compounds of the general formula (I) according to the invention in
which R is a radical OR*

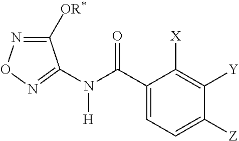

| No. | R* | X | Y | Z |
|---|---|---|---|---|
| 9-50 | Me | NO₂ | O(CH₂)₂OMe | OMe |
| 9-51 | Me | NO₂ | OMe | Me |
| 9-52 | Me | NO₂ | NH₂ | OMe |
| 9-53 | Me | NO₂ | NH₂ | SO₂Me |
| 9-54 | Me | NO₂ | NH₂ | Cl |
| 9-55 | Me | NO₂ | NHMe | Cl |
| 9-56 | Me | NO₂ | NMe₂ | Cl |
| 9-57 | Me | NO₂ | NH₂ | Br |
| 9-58 | Me | NO₂ | NHMe | Br |
| 9-59 | Me | NO₂ | NMe₂ | Br |
| 9-60 | Me | NO₂ | NH₂ | F |
| 9-61 | Me | NO₂ | NHMe | F |
| 9-62 | Me | NO₂ | NMe₂ | F |
| 9-63 | Me | NO₂ | NH₂ | SO₂Me |
| 9-64 | Me | NO₂ | NHMe | SO₂Me |
| 9-65 | Me | NO₂ | NMe₂ | SO₂Me |
| 9-66 | Me | NO₂ | NH₂ | 1H-1,2,4-triazol-1-yl |
| 9-67 | Me | NO₂ | NHMe | 1H-1,2,4-triazol-1-yl |
| 9-68 | Me | NO₂ | NMe₂ | 1H-1,2,4-triazol-1-yl |
| 9-69 | Me | Me | F | F |
| 9-70 | Me | Me | F | Cl |
| 9-71 | Me | Me | SMe | CF₃ |
| 9-72 | Me | Me | Cl | SO₂Me |
| 9-73 | Me | Me | SO₂Me | SO₂Me |
| 9-74 | Et | Me | SO₂Me | SO₂Me |
| 9-75 | n-Pr | Me | SO₂Me | SO₂Me |
| 9-76 | i-Pr | Me | SO₂Me | SO₂Me |
| 9-77 | t-Bu | Me | SO₂Me | SO₂Me |
| 9-78 | Ph | Me | SO₂Me | SO₂Me |
| 9-79 | Me | Me | SO₂Me | CF₃ |
| 9-80 | Et | Me | SO₂Me | CF₃ |
| 9-81 | n-Pr | Me | SO₂Me | CF₃ |
| 9-82 | i-Pr | Me | SO₂Me | CF₃ |
| 9-83 | t-Bu | Me | SO₂Me | CF₃ |
| 9-84 | Ph | Me | SO₂Me | CF₃ |
| 9-85 | Me | Me | Cl | CF₃ |
| 9-86 | Me | Me | S(O)Me | CF₃ |
| 9-87 | Me | Me | SEt | OMe |
| 9-88 | Me | Me | NMe₂ | SO₂Me |
| 9-89 | Et | Me | NMe₂ | SO₂Me |
| 9-90 | n-Pr | Me | NMe₂ | SO₂Me |
| 9-91 | i-Pr | Me | NMe₂ | SO₂Me |
| 9-92 | t-Bu | Me | NMe₂ | SO₂Me |
| 9-93 | Ph | Me | NMe₂ | SO₂Me |
| 9-94 | Me | Me | NH(CH₂)₂OMe | SO₂Me |
| 9-95 | Et | Me | NH(CH₂)₂OMe | SO₂Me |
| 9-96 | n-Pr | Me | NH(CH₂)₂OMe | SO₂Me |
| 9-97 | i-Pr | Me | NH(CH₂)₂OMe | SO₂Me |
| 9-98 | t-Bu | Me | NH(CH₂)₂OMe | SO₂Me |
| 9-99 | Ph | Me | NH(CH₂)₂OMe | SO₂Me |
| 9-100 | Me | Me | O(CH₂)₄OMe | SO₂Me |
| 9-101 | Me | Me | NH₂ | SO₂Me |
| 9-102 | Me | Me | O(CH₂)₂—O(3,5-dimethoxy- | SO₂Me |
| | | | pyrimidin-2-yl | |
| 9-103 | Me | Me | O(CH₂)₂—O—NMe₂ | Cl |
| 9-104 | Me | Me | O(CH₂)₂—NH(CO)NMe₂ | Cl |
| 9-105 | Me | Me | O(CH₂)-5-pyrrolidin-2-one | Br |
| 9-106 | Me | Me | O(CH₂)₂—NH(CO)NHCO₂Et | Cl |
| 9-107 | Me | Me | O(CH₂)—(CO)NEt₂ | Br |
| 9-108 | Me | Me | O(CH₂)-5-2,4-dimethy1-2,4-dihydro- | Cl |
| | | | 3H-1,2,4-triazol-3-one | |
| 9-109 | Me | Me | O(CH₂)-3,5-dimethyl-1,2- | Cl |
| | | | oxazol-4-yl | |
| 9-110 | Me | Me | O(CH₂)₂—NHCO₂Me | Cl |
| 9-111 | Me | Me | 4,5-dihydro-1,2-oxazol-3-yl | SO₂Me |
| 9-112 | Et | Me | 4,5-dihydro-1,2-oxazol-3-yl | SO₂Me |
| 9-113 | n-Pr | Me | 4,5-dihydro-1,2-oxazol-3-yl | SO₂Me |
| 9-114 | i-Pr | Me | 4,5-dihydro-1,2-oxazol-3-yl | SO₂Me |
| 9-115 | t-Bu | Me | 4,5-dihydro-1,2-oxazol-3-yl | SO₂Me |
| 9-116 | Ph | Me | 4,5-dihydro-1,2-oxazol-3-yl | SO₂Me |
| 9-117 | Me | Me | Me | SO₂Me |
| 9-118 | Me | Me | OH | SO₂Me |
| 9-119 | Me | Me | O—CH₂—NHSO₂cPr | Cl |
| 9-120 | Me | Me | O—CH₂—NHSO₂Me | SO₂Me |
| 9-121 | Et | Me | O—CH₂—NHSO₂Me | SO₂Me |
| 9-122 | n-Pr | Me | O—CH₂—NHSO₂Me | SO₂Me |
| 9-123 | i-Pr | Me | O—CH₂—NHSO₂Me | SO₂Me |
| 9-124 | t-Bu | Me | O—CH₂—NHSO₂Me | SO₂Me |
| 9-125 | Ph | Me | O—CH₂—NHSO₂Me | SO₂Me |
| 9-126 | Me | Me | SMe | Cl |
| 9-127 | Me | Me | SOMe | Cl |
| 9-128 | Et | Me | SO₂Me | Cl |
| 9-129 | n-Pr | Me | SO₂Me | Cl |
| 9-130 | i-Pr | Me | SO₂Me | Cl |
| 9-131 | t-Bu | Me | SO₂Me | Cl |
| 9-132 | Ph | Me | SO₂Me | Cl |
| 9-133 | Me | Me | SO₂Me | Cl |
| 9-134 | Me | Me | SMe | Br |
| 9-135 | Me | Me | SOMe | Br |
| 9-136 | Me | Me | SO₂Me | Br |
| 9-137 | Me | Me | SMe | I |
| 9-138 | Me | Me | SOMe | I |
| 9-139 | Me | Me | SO₂Me | I |
| 9-140 | Me | Me | SEt | Cl |
| 9-141 | Me | Me | SOEt | Cl |
| 9-142 | Me | Me | SO₂Et | Cl |
| 9-143 | Me | Me | SEt | Br |
| 9-144 | Me | Me | SOEt | Br |
| 9-145 | Me | Me | SO₂Et | Br |
| 9-146 | Me | Me | SEt | I |
| 9-147 | Me | Me | SOEt | I |
| 9-148 | Me | Me | SO₂Et | I |
| 9-149 | Me | Me | SEt | F |
| 9-150 | Me | Me | SOEt | F |
| 9-151 | Me | Me | SO₂Et | F |
| 9-152 | Me | Me | S(O)Me | SO₂Me |
| 9-153 | Me | Me | SMe | SO₂Me |
| 9-154 | Me | Me | SMe | OMe |
| 9-155 | Me | Me | S(O)Me | OMe |
| 9-156 | Me | Me | SO₂Me | OMe |
| 9-157 | Me | Me | SMe | Cl |
| 9-158 | Me | Me | S(O)Me | Cl |
| 9-159 | Me | Me | SO₂Me | Cl |
| 9-160 | Me | Me | [1,4]dioxan-2-yl-methoxy | SO₂Me |
| 9-161 | Me | Me | [1,4]dioxan-2-yl-methoxy | SO₂Et |
| 9-162 | Me | Me | O(CH₂)₄OMe | SO₂Et |
| 9-163 | Me | Me | O(CH₂)₃OMe | SO₂Me |
| 9-164 | Me | Me | O(CH₂)₃OMe | SO₂Et |
| 9-165 | Me | Me | O(CH₂)₂OMe | SO₂Me |
| 9-166 | Me | Me | O(CH₂)₂OMe | SO₂Et |
| 9-167 | Me | Me | S(O)Me | SO₂Me |
| 9-168 | Me | Me | SMe | SO₂Me |
| 9-169 | Me | Me | SMe | OMe |
| 9-170 | Me | Me | S(O)Me | OMe |
| 9-171 | Me | Me | SO₂Me | OMe |
| 9-172 | Me | Cl | OCH₂(CO)NMe₂ | Cl |
| 9-173 | Me | Cl | Cl | SO₂Me |
| 9-174 | Me | Cl | CH₂OCH₂CF₃ | SO₂Me |
| 9-175 | Et | Cl | CH₂OCH₂CF₃ | SO₂Me |
| 9-176 | n-Pr | Cl | CH₂OCH₂CF₃ | SO₂Me |
| 9-177 | i-Pr | Cl | CH₂OCH₂CF₃ | SO₂Me |
| 9-178 | t-Bu | Cl | CH₂OCH₂CF₃ | SO₂Me |
| 9-179 | Ph | Cl | CH₂OCH₂CF₃ | SO₂Me |
| 9-180 | Me | Cl | 5-cyanomethyl-4,5-dihydro-1,2- | SO₂Et |
| | | | oxazol-3-yl | |
| 9-181 | Et | Cl | 5-cyanomethyl-4,5-dihydro-1,2- | SO₂Et |
| | | | oxazol-3-yl | |
| 9-182 | n-Pr | Cl | 5-cyanomethyl-4,5-dihydro-1,2- | SO₂Et |
| | | | oxazol-3-yl | |
| 9-183 | i-Pr | Cl | 5-cyanomethyl-4,5-dihydro-1,2- | SO₂Et |
| | | | oxazol-3-yl | |
| 9-184 | t-Bu | Cl | 5-cyanomethyl-4,5-dihydro-1,2- | SO₂Et |
| | | | oxazol-3-yl | |
| 9-185 | Ph | Cl | 5-cyanomethyl-4,5-dihydro-1,2- | SO₂Et |
| | | | oxazol-3-yl | |
| 9-186 | Me | Cl | CH₂O-tetrahydro-furan-3-yl | SO₂Me |
| 9-187 | Et | Cl | CH₂O-tetrahydro-furan-3-yl | SO₂Me |
| 9-188 | n-Pr | Cl | CH₂O-tetrahydro-furan-3-yl | SO₂Me |
| 9-189 | i-Pr | Cl | CH₂O-tetrahydro-furan-3-yl | SO₂Me |
| 9-190 | t-Bu | Cl | CH₂O-tetrahydro-furan-3-yl | SO₂Me |
| 9-191 | Ph | Cl | CH₂O-tetrahydro-furan-2-yl | SO₂Me |
| 9-192 | Me | Cl | SMe | SO₂Me |
| 9-193 | Me | Cl | F | SMe |
| 9-194 | n-Pr | Cl | CH₂OCH₂-tetrahydrofuran-2-yl | SO₂Me |
| 9-195 | Me | Cl | CH₂OCH₂-tetrahydrofuran-3-yl | SO₂Et |
| 9-196 | n-Pr | Cl | O(CH₂)-5-pyrrolidin-2-one | Cl |
| 9-197 | Me | Cl | O(CH₂)-5-pyrrolidin-2-one | Cl |
| 9-198 | Me | Cl | O(CH₂)-5-pyrrolidin-2-one | Cl |
| 9-199 | Me | Cl | S(O)Me | SO₂Me |
| 9-200 | Me | Cl | CH₂O-tetrahydro-furan-3-yl | SO₂Et |
| 9-201 | Me | Cl | SMe | Cl |
| 9-202 | Me | Cl | O(CH₂)₂OMe | Cl |
| 9-203 | Et | Cl | O(CH₂)₂OMe | Cl |
| 9-204 | n-Pr | Cl | O(CH₂)₂OMe | Cl |
| 9-205 | i-Pr | Cl | O(CH₂)₂OMe | Cl |
| 9-206 | t-Bu | Cl | O(CH₂)₂OMe | Cl |
| 9-207 | Ph | Cl | O(CH₂)₂OMe | Cl |
| 9-208 | Me | Cl | O(CH₂)₄OMe | SO₂Me |
| 9-209 | Me | Cl | O(CH₂)₄OMe | SO₂Et |
| 9-210 | Me | Cl | O(CH₂)₃OMe | SO₂Me |
| 9-211 | Me | Cl | O(CH₂)₃OMe | SO₂Et |
| 9-212 | Me | Cl | O(CH₂)₂OMe | SO₂Me |
| 9-213 | Me | Cl | O(CH₂)₂OMe | SO₂Et |
| 9-214 | Me | Cl | [1,4]dioxan-2-yl-methoxy | SO₂Me |
| 9-215 | Me | Cl | [1,4]dioxan-2-yl-methoxy | SO₂Et |
| 9-216 | Me | Cl | SO₂Me | Me |
| 9-217 | Me | Cl | SEt | Me |
| 9-218 | Me | Cl | SOEt | Me |
| 9-219 | Me | Cl | SO₂Et | Me |
| 9-220 | Me | Cl | 4,5-dihydro-1,2-oxazol-3-yl | SO₂Me |
| 9-221 | Me | Cl | Cl | SO₂Me |
| 9-222 | Me | F | SMe | CF₃ |
| 9-223 | n.Pr | F | SMe | CF₃ |
| 9-224 | n-Pr | F | S(O)Me | CF₃ |
| 9-225 | Me | F | S(O)Me | CF₃ |
| 9-226 | | F | S(O)Me | CF₃ |
| 9-227 | Me | F | SO₂Me | CF₃ |
| 9-228 | n.Pr | F | SO₂Me | CF₃ |
| 9-229 | Me | SMe | SEt | F |
| 9-230 | n-Pr | SMe | SEt | F |
| 9-231 | Me | OMe | SMe | CF₃ |
| 9-232 | Me | OMe | S(O)Me | CF₃ |
| 9-233 | Me | OMe | SO₂Me | CF₃ |
| 9-234 | Me | Et | NH(CH₂)₂OMe | SO₂Me |
| 9-235 | Me | Et | F | SO₂Me |
| 9-236 | Me | Et | SMe | CF₃ |
| 9-237 | Me | CF₃ | F | SO₂Me |
| 9-238 | Me | CF₃ | F | SO₂Et |
| 9-239 | Me | CF₃ | O(CH₂)₂OMe | SO₂Et |
| 9-240 | Me | CF₃ | O(CH₂)₃OMe | SO₂Et |
| 9-241 | Me | CF₃ | O(CH₂)₂OMe | SO₂Me |
| 9-242 | Me | CF₃ | O(CH₂)₃OMe | SO₂Me |
| 9-243 | Me | CF₃ | OCH₂CONMe₂ | SO₂Me |
| 9-244 | Me | CF₃ | OCH₂CONMe₂ | SO₂Et |
| 9-245 | Me | CF₃ | OCH₂CONMe₂ | Cl |
| 9-246 | Me | CF₃ | OCH₂CONMe₂ | Br |
| 9-247 | Me | CF₃ | OCH₂CONMe₂ | I |
| 9-248 | Me | CF₃ | OCH₂CONMe₂ | F |
| 9-249 | Me | CF₃ | O(CH₂)₂OMe | Cl |
| 9-250 | Me | CF₃ | O(CH₂)₃OMe | Cl |
| 9-251 | Me | CF₃ | O(CH₂)₂OMe | Br |
| 9-252 | Me | CF₃ | O(CH₂)₃OMe | Br |
| 9-253 | Me | CF₃ | O(CH₂)₂OMe | I |
| 9-254 | Me | CF₃ | O(CH₂)₃OMe | I |
| 9-255 | Me | CF₃ | O(CH₂)₂OMe | F |
| 9-256 | Me | CF₃ | O(CH₂)₃OMe | F |
| 9-257 | Me | CF₃ | [1,4]dioxan-2-yl-methoxy | SO₂Me |
| 9-258 | Me | CF₃ | [1,4]dioxan-2-yl-methoxy | SO₂Et |
| 9-259 | Me | CF₃ | [1,4]dioxan-2-yl-methoxy | Cl |
| 9-260 | Me | CF₃ | [1,4]dioxan-2-yl-methoxy | Br |
| 9-261 | Me | CF₃ | [1,4]dioxan-2-yl-methoxy | I |
| 9-262 | Me | CF₃ | [1,4]dioxan-2-yl-methoxy | F |
| 9-263 | Me | Br | OMe | Br |
| 9-264 | Me | Br | O(CH₂)₂OMe | Br |
| 9-265 | Me | Br | O(CH₂)₄OMe | SO₂Me |
| 9-266 | Me | Br | O(CH₂)₄OMe | SO₂Et |
| 9-267 | Me | Br | O(CH₂)₃OMe | SO₂Me |
| 9-268 | Me | Br | O(CH₂)₃OMe | SO₂Et |
| 9-269 | Me | Br | O(CH₂)₂OMe | SO₂Me |
| 9-270 | Me | Br | O(CH₂)₂OMe | SO₂Et |
| 9-271 | Me | Br | [1,4]dioxan-2-yl-methoxy | SO₂Me |
| 9-272 | Me | Br | [1,4]dioxan-2-yl-methoxy | SO₂Et |
| 9-273 | Me | Br | SMe | Me |
| 9-274 | Me | Br | SOMe | Me |
| 9-275 | Me | Br | SO₂Me | Me |
| 9-276 | Me | Br | SEt | Me |
| 9-277 | Me | Br | SOEt | Me |
| 9-278 | Me | Br | SO₂Et | Me |
| 9-279 | Me | I | O(CH₂)₄OMe | SO₂Me |
| 9-280 | Me | I | O(CH₂)₄OMe | SO₂Et |
| 9-281 | Me | I | O(CH₂)₃OMe | SO₂Me |
| 9-282 | Me | I | O(CH₂)₃OMe | SO₂Et |
| 9-283 | Me | I | O(CH₂)₂OMe | SO₂Me |
| 9-284 | Me | I | O(CH₂)₂OMe | SO₂Et |
| 9-285 | Me | I | [1,4]dioxan-2-yl-methoxy | SO₂Me |
| 9-286 | Me | I | [1,4]dioxan-2-yl-methoxy | SO₂Et |
| 9-287 | Me | I | SMe | Me |
| 9-288 | Me | I | SOMe | Me |
| 9-289 | Me | I | SO₂Me | Me |
| 9-290 | Me | I | SEt | Me |
| 9-291 | Me | I | SOEt | Me |
| 9-292 | Me | I | SO₂Et | Me |
| 9-293 | Me | CH₂SMe | OMe | SO₂Me |
| 9-294 | Me | CH₂OMe | OMe | SO₂Me |
| 9-295 | Me | CH₂O(CH₂)₂OMe | NH(CH₂)₂OEt | SO₂Me |
| 9-296 | Me | CH₂O(CH₂)₂OMe | NH(CH₂)₃OEt | SO₂Me |
| 9-297 | Me | CH₂O(CH₂)₃OMe | OMe | SO₂Me |
| 9-298 | Me | CH₂O(CH₂)₂OMe | NH(CH₂)₂OMe | SO₂Me |
| 9-299 | Me | CH₂O(CH₂)₂OMe | NH(CH₂)₃OMe | SO₂Me |
| 9-300 | Me | SO₂Me | NH₂ | CF₃ |
| 9-301 | Me | SO₂Me | F | CF₃ |
| 9-302 | Me | SO₂Me | NHEt | Cl |
| 9-303 | Me | SMe | SEt | F |
| 9-304 | Me | SMe | SMe | F |
| 9-305 | n-Pr | SMe | SMe | F |
| 9-306 | Benzyl | Me | SO₂Me | CF₃ |
| 9-307 | Me | Cl | Me | SO₂Et |
| 9-308 | Benzyl | Me | SO₂Me | CF₃ |
| 9-309 | Benzyl | Me | SO₂Me | SO₂Me |
| 9-310 | Benzyl | Me | S(O)Me | CF₃ |
| 9-311 | Me | Cl | 1H-pyrazol-1-yl | SO₂Me |
| 9-312 | Me | Me | F | SO₂Me |
| 9-313 | Me | Me | 1H-1,2,3-triazol-1-yl | SO₂Me |
| 9-314 | Me | Cl | Me | Cl |
| 9-315 | Me | Cl | CH₂OCH₂-2-tetrahydrofuran-2-yl | SO₂Me |
| 9-316 | Me | Me | Me | SMe |
| 9-317 | Ph | Me | S(O)Me | CF₃ |
| 9-318 | Me | Cl | S(O)Me | Cl |
| 9-319 | Me | Cl | CH₂N(OMe)Et | SO₂Me |
| 9-320 | n-Pr | Cl | Me | SO₂Et |
| 9-321 | Me | Me | 4-methoxy-1H-pyrazol-1-yl | SO₂Me |
| 9-322 | Ph | Me | Cl | SO₂Me |
| 9-323 | n-Pr | Me | S(O)Me | CF₃ |

TABLE 10
Compounds of the general formula (I) according to the invention

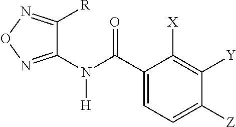

| No. | R | X | Y | Z |
|---|---|---|---|---|
| 10-46 | Ph | NO₂ | O(CH₂)₂OMe | OMe |
| 10-47 | Ph | NO₂ | OMe | Me |
| 10-48 | Ph | NO₂ | NH₂ | OMe |
| 10-49 | Ph | NO₂ | NH₂ | SO₂Et |
| 10-50 | Ph | NO₂ | NH₂ | Cl |
| 10-51 | Ph | NO₂ | NHMe | Cl |
| 10-52 | Ph | NO₂ | NMe₂ | Cl |
| 10-53 | Ph | NO₂ | NH₂ | Br |
| 10-54 | Ph | NO₂ | NHMe | Br |
| 10-55 | Ph | NO₂ | NMe₂ | Br |
| 10-56 | Ph | NO₂ | NH₂ | F |
| 10-57 | Ph | NO₂ | NHMe | F |
| 10-58 | Ph | NO₂ | NMe₂ | F |
| 10-59 | Ph | NO₂ | NH₂ | SO₂Me |
| 10-60 | Ph | NO₂ | NHMe | SO₂Me |
| 10-61 | Ph | NO₂ | NMe₂ | SO₂Me |
| 10-62 | Ph | NO₂ | NH₂ | 1H-1,2,4-triazol-1-yl |
| 10-63 | Ph | NO₂ | NHMe | 1H-1,2,4-triazol-1-yl |
| 10-64 | Ph | NO₂ | NMe₂ | 1H-1,2,4-triazol-1-yl |
| 10-65 | Ph | Me | F | F |
| 10-66 | Ph | Me | F | Cl |
| 10-67 | Ph | Me | SMe | CF₃ |
| 10-68 | Ph | Me | Cl | SO₂Me |
| 10-69 | Ph | Me | SO₂Me | SO₂Me |
| 10-70 | 4-Cl-Ph | Me | SO₂Me | SO₂Me |
| 10-71 | 1-ethylbenz- | Me | SO₂Me | SO₂Me |
| | imidazol-2-yl | | | |
| 10-72 | 1,2,4-triazol-1-yl | Me | SO₂Me | SO₂Me |
| 10-73 | benzoxazol-2-yl | Me | SO₂Me | SO₂Me |
| 10-74 | Ph | Me | SO₂Me | CF₃ |
| 10-75 | 4-Cl-Ph | Me | SO₂Me | CF₃ |
| 10-76 | 1-ethylbenz- | Me | SO₂Me | CF₃ |
| | imidazol-2-yl | | | |
| 10-77 | 1,2,4-triazol-1-yl | Me | SO₂Me | CF₃ |
| 10-78 | benzoxazol-2-yl | Me | SO₂Me | CF₃ |
| 10-79 | Ph | Me | Cl | CF₃ |
| 10-80 | Ph | Me | S(O)Me | CF₃ |
| 10-81 | Ph | Me | SEt | OMe |
| 10-82 | Ph | Me | NMe₂ | SO₂Me |
| 10-83 | 4-Cl-Ph | Me | NMe₂ | SO₂Me |
| 10-84 | 1-ethylbenz- | Me | NMe₂ | SO₂Me |
| | imidazol-2-yl | | | |
| 10-85 | 1,2,4-triazol-1-yl | Me | NMe₂ | SO₂Me |
| 10-86 | benzoxazol-2-yl | Me | NMe₂ | SO₂Me |
| 10-87 | Ph | Me | NH(CH₂)₂OMe | SO₂Me |
| 10-88 | 4-Cl-Ph | Me | NH(CH₂)₂OMe | SO₂Me |
| 10-89 | 1-ethylbenz- | Me | NH(CH₂)₂OMe | SO₂Me |
| | imidazol-2-yl | | | |
| 10-90 | 1,2,4-triazol-1-yl | Me | NH(CH₂)₂OMe | SO₂Me |
| 10-91 | benzoxazol-2-yl | Me | NH(CH₂)₂OMe | SO₂Me |
| 10-92 | Ph | Me | O(CH₂)₄OMe | SO₂Me |
| 10-93 | Ph | Me | NH₂ | SO₂Me |
| 10-94 | Ph | Me | O(CH₂)₂-O(3,5-di- | SO₂Me |
| | | | methoxypyrimidin-2- | |
| | | | yl | |
| 10-95 | Ph | Me | O(CH₂)₂-O-NMe₂ | Cl |
| 10-96 | Ph | Me | O(CH₂)₂- | Cl |
| | | | NH(CO)NMe₂ | |
| 10-97 | Ph | Me | O(CH₂)-5-pyrrolidin- | Br |
| | | | 2-one | |
| 10-98 | Ph | Me | O(CH₂)₂- | Cl |
| | | | NH(CO)NHCO₂Et | |
| 10-99 | Ph | Me | O(CH₂)-(CO)NEt₂ | Br |
| 10-100 | Ph | Me | O(CH₂)-5-2,4- | Cl |
| | | | dimethyl-2,4-dihydro- | |
| | | | 3H-1,2,4-triazol-3- | |
| | | | one | |
| 10-101 | Ph | Me | O(CH₂)-3,5-dimethyl- | Cl |
| | | | 1,2-oxazol-4-yl | |
| 10-102 | Ph | Me | O(CH₂)₂-NHCO₂Me | Cl |
| 10-103 | Ph | Me | 4,5-dihydro-1,2- | SO₂Me |
| | | | oxazol-3-yl | |
| 10-104 | 4-Cl-Ph | Me | 4,5-dihydro-1,2- | SO₂Me |
| | | | oxazol-3-yl | |
| 10-105 | 1-ethylbenz- | Me | 4,5-dihydro-1,2- | SO₂Me |
| | imidazol-2-yl | | oxazol-3-yl | |
| 10-106 | 1,2,4-triazol-1-yl | Me | 4,5-dihydro-1,2- | SO₂Me |
| | | | oxazol-3-yl | |
| 10-107 | benzoxazol-2-yl | Me | 4,5-dihydro-1,2- | SO₂Me |
| | | | oxazol-3-yl | |
| 10-108 | Ph | Me | Me | SO₂Me |
| 10-109 | Ph | Me | OH | SO₂Me |
| 10-110 | Ph | Me | O-CH₂-NHSO₂cPr | Cl |
| 10-111 | Ph | Me | O-CH₂-NHSO₂Me | SO₂Me |
| 10-112 | 4-Cl-Ph | Me | O-CH₂-NHSO₂Me | SO₂Me |
| 10-113 | 1-ethylbenz- | Me | O-CH₂-NHSO₂Me | SO₂Me |
| | imidazol-2-yl | | | |
| 10-114 | 1,2,4-triazol-1-yl | Me | O-CH₂-NHSO₂Me | SO₂Me |
| 10-115 | benzoxazol-2-yl | Me | O-CH₂-NHSO₂Me | SO₂Me |
| 10-116 | Ph | Me | SMe | Cl |
| 10-117 | Ph | Me | SOMe | Cl |
| 10-118 | 4-Cl-Ph | Me | SO₂Me | Cl |
| 10-119 | 1-ethylbenz- | Me | SO₂Me | Cl |
| | imidazol-2-yl | | | |
| 10-120 | 1,2,4-triazol-1-yl | Me | SO₂Me | Cl |
| 10-121 | benzoxazol-2-yl | Me | SO₂Me | Cl |
| 10-122 | Ph | Me | S(O)Me | SO₂Me |
| 10-123 | Ph | Me | SMe | SO₂Me |
| 10-124 | Ph | Me | SMe | OMe |
| 10-125 | Ph | Me | S(O)Me | OMe |
| 10-126 | Ph | Me | SO₂Me | OMe |
| 10-127 | Ph | Me | SMe | Cl |
| 10-128 | Ph | Me | S(O)Me | Cl |
| 10-129 | Ph | Me | SO₂Me | Cl |
| 10-130 | Ph | Me | [1,4]dioxan-2- | SO₂Me |
| | | | ylmethoxy | |
| 10-131 | Ph | Me | [1,4]dioxan-2- | SO₂Et |
| | | | ylmethoxy | |
| 10-132 | Ph | Me | O(CH₂)₄OMe | SO₂Et |
| 10-133 | Ph | Me | O(CH₂)₃OMe | SO₂Me |
| 10-134 | Ph | Me | O(CH₂)₃OMe | SO₂Et |
| 10-135 | Ph | Me | O(CH₂)₂OMe | SO₂Me |
| 10-136 | Ph | Me | O(CH₂)₂OMe | SO₂Et |
| 10-137 | Ph | Me | S(O)Me | SO₂Me |
| 10-138 | Ph | Me | SMe | SO₂Me |
| 10-139 | Ph | Me | SMe | OMe |
| 10-140 | Ph | Me | S(O)Me | OMe |
| 10-141 | Ph | Me | SO₂Me | OMe |
| 10-142 | Ph | Me | SMe | Cl |
| 10-143 | Ph | Me | S(O)Me | Cl |
| 10-144 | Ph | Me | SO₂Me | Cl |
| 10-145 | Ph | Me | SMe | Br |
| 10-146 | Ph | Me | SOMe | Br |
| 10-147 | Ph | Me | SO₂Me | Br |
| 10-148 | Ph | Me | SMe | I |
| 10-149 | Ph | Me | SOMe | I |
| 10-150 | Ph | Me | SO₂Me | I |
| 10-151 | Ph | Me | SEt | Cl |
| 10-152 | Ph | Me | SOEt | Cl |
| 10-153 | Ph | Me | SO₂Et | Cl |
| 10-154 | Ph | Me | SEt | Br |
| 10-155 | Ph | Me | SOEt | Br |
| 10-156 | Ph | Me | SO₂Et | Br |
| 10-157 | Ph | Me | SEt | I |
| 10-158 | Ph | Me | SOEt | I |
| 10-159 | Ph | Me | SO₂Et | I |
| 10-160 | Ph | Me | SEt | F |
| 10-161 | Ph | Me | SOEt | F |
| 10-162 | Ph | Me | SO₂Et | F |
| 10-163 | Ph | Cl | OCH₂(CO)NMe₂ | Cl |
| 10-164 | Ph | Cl | Cl | SO₂Me |
| 10-165 | Ph | Cl | CH₂OCH₂CF₃ | SO₂Me |
| 10-166 | 4-Cl-Ph | Cl | CH₂OCH₂CF₃ | SO₂Me |
| 10-167 | 1-ethylbenz- | Cl | CH₂OCH₂CF₃ | SO₂Me |
| | imidazol-2-yl | | | |
| 10-168 | 1,2,4-triazol-1-yl | Cl | CH₂OCH₂CF₃ | SO₂Me |
| 10-169 | benzoxazol-2-yl | Cl | CH₂OCH₂CF₃ | SO₂Me |
| 10-170 | Ph | Cl | 5-cyanomethyl-4,5- | SO₂Et |
| | | | dihydro-1,2-oxazol-3- | |
| | | | yl | |
| 10-171 | 4-Cl-Ph | Cl | 5-cyano-methyl-4,5- | SO₂Et |
| | | | dihydro-1,2-oxazol-3- | |
| | | | yl | |
| 10-172 | 1-ethyl- | Cl | 5-cyano-methyl-4,5- | SO₂Et |
| | benzimidazol-2- | | dihydro-1,2-oxazol-3- | |
| | yl | | yl | |
| 10-173 | 1,2,4-triazol-1-yl | Cl | 5-cyano-methyl-4,5- | SO₂Et |
| | | | dihydro-1,2-oxazol-3- | |
| | | | yl | |
| 10-174 | benzoxazol-2-yl | Cl | 5-cyano-methyl-4,5- | SO₂Et |
| | | | dihydro-1,2-oxazol-3-yl | |
| 10-175 | Ph | Cl | CH₂O-tetra- | SO₂Me |
| | | | hydrofuran-3-yl | |
| 10-176 | 4-Cl-Ph | Cl | CH₂O-tetra- | SO₂Me |
| | | | hydrofuran-3-yl | |
| 10-177 | 1-ethyl- | Cl | CH₂O-tetra- | SO₂Me |
| | benzimidazol-2- | | hydrofuran-3-yl | |
| | yl | | | |
| 10-178 | 1,2,4-triazol-1-yl | Cl | CH₂O-tetra- | SO₂Me |
| | | | hydrofuran-3-yl | |
| 10-179 | benzoxazol-2-yl | Cl | CH₂O-tetra- | SO₂Me |
| | | | hydrofuran-3-yl | |
| 10-180 | Ph | Cl | CH₂O-tetra- | SO₂Me |
| | | | hydrofuran-2-yl | |
| 10-181 | Ph | Cl | SMe | SO₂Me |
| 10-182 | Ph | Cl | F | SMe |
| 10-183 | 1,2,4-triazol-1-yl | Cl | CH₂OCH₂- | SO₂Me |
| | | | tetrahydro-furan-2-yl | |
| 10-184 | 1-ethyl- | Cl | CH₂OCH₂- | SO₂Me |
| | benzimidazol-2- | | tetrahydro-furan-2-yl | |
| | yl | | | |
| 10-185 | Ph | Cl | CH₂OCH₂- | SO₂Me |
| | | | tetrahydrofuran-3-yl | |
| 10-186 | Ph | Cl | O(CH₂)-5-pyrrolidin- | Cl |
| | | | 2-one | |
| 10-187 | Ph | Cl | SMe | Cl |
| 10-188 | Ph | Cl | S(O)Me | Cl |
| 10-189 | Ph | Cl | SO₂Me | Cl |
| 10-190 | Ph | Cl | CH₂O-tetrahydro- | SO₂Et |
| | | | furan-3-yl | |
| 10-191 | Ph | Cl | O(CH₂)₂OMe | Cl |
| 10-192 | 4-Cl-Ph | Cl | O(CH₂)₂OMe | Cl |
| 10-193 | 1-ethyl- | Cl | O(CH₂)₂OMe | Cl |
| | benzimidazol-2- | | | |
| | yl | | | |
| 10-194 | 1,2,4-triazol-1-yl | Cl | O(CH₂)₂OMe | Cl |
| 10-195 | benzoxazol-2-yl | Cl | O(CH₂)₂OMe | Cl |
| 10-196 | Ph | Cl | O(CH₂)₄OMe | SO₂Me |
| 10-197 | Ph | Cl | O(CH₂)₄OMe | SO₂Et |
| 10-198 | Ph | Cl | O(CH₂)₃OMe | SO₂Me |
| 10-199 | Ph | Cl | O(CH₂)₃OMe | SO₂Et |
| 10-200 | Ph | Cl | O(CH₂)₂OMe | SO₂Me |
| 10-201 | Ph | Cl | O(CH₂)₂OMe | SO₂Et |
| 10-202 | Ph | Cl | [1,4]dioxan-2- | SO₂Me |
| | | | ylmethoxy | |
| 10-203 | Ph | Cl | [1,4]dioxan-2- | SO₂Et |
| | | | ylmethoxy | |
| 10-204 | Ph | Cl | SO₂Me | Me |
| 10-205 | Ph | Cl | SEt | Me |
| 10-206 | Ph | Cl | SOEt | Me |
| 10-207 | Ph | Cl | SO₂Et | Me |
| 10-208 | Ph | Cl | 4,5-dihydro-1,2- | SO₂Me |
| | | | oxazol-3-yl | |
| 10-209 | Ph | Cl | Cl | SO₂Me |
| 10-210 | Ph | F | SMe | CF₃ |
| 10-211 | 4-Cl-Ph | F | S(O)Me | CF₃ |
| 10-212 | Ph | F | S(O)Me | CF₃ |
| 10-213 | Ph | OMe | SMe | CF₃ |
| 10-214 | Ph | OMe | S(O)Me | CF₃ |
| 10-215 | Ph | OMe | SO₂Me | CF₃ |
| 10-216 | Ph | Et | NH(CH₂)₂OMe | SO₂Me |
| 10-217 | Ph | Et | F | SO₂Me |
| 10-218 | Ph | Et | SMe | CF₃ |
| 10-219 | Ph | CF₃ | F | SO₂Me |
| 10-220 | Ph | CF₃ | F | SO₂Et |
| 10-221 | Ph | CF₃ | O(CH₂)₂OMe | SO₂Et |
| 10-222 | Ph | CF₃ | O(CH₂)₃OMe | SO₂Et |
| 10-223 | Ph | CF₃ | O(CH₂)₂OMe | SO₂Me |
| 10-224 | Ph | CF₃ | O(CH₂)₃OMe | SO₂Me |
| 10-225 | Ph | CF₃ | OCH₂CONMe₂ | SO₂Me |
| 10-226 | Ph | CF₃ | OCH₂CONMe₂ | SO₂Et |
| 10-227 | Ph | CF₃ | OCH₂CONMe₂ | Cl |
| 10-228 | Ph | CF₃ | OCH₂CONMe₂ | Br |
| 10-229 | Ph | CF₃ | OCH₂CONMe₂ | I |
| 10-230 | Ph | CF₃ | OCH₂CONMe₂ | F |
| 10-231 | Ph | CF₃ | O(CH₂)₂OMe | Cl |
| 10-232 | Ph | CF₃ | O(CH₂)₃OMe | Cl |
| 10-233 | Ph | CF₃ | O(CH₂)₂OMe | Br |
| 10-234 | Ph | CF₃ | O(CH₂)₃OMe | Br |
| 10-235 | Ph | CF₃ | O(CH₂)₂OMe | I |
| 10-236 | Ph | CF₃ | O(CH₂)₃OMe | I |
| 10-237 | Ph | CF₃ | O(CH₂)₂OMe | F |
| 10-238 | Ph | CF₃ | O(CH₂)₃OMe | F |
| 10-239 | Ph | CF₃ | [1,4]dioxan-2- | SO₂Me |
| | | | ylmethoxy | |
| 10-240 | Ph | CF₃ | [1,4]dioxan-2- | SO₂Et |
| | | | ylmethoxy | |
| 10-241 | Ph | CF₃ | [1,4]dioxan-2- | Cl |
| | | | ylmethoxy | |
| 10-242 | Ph | CF₃ | [1,4]dioxan-2- | Br |
| | | | ylmethoxy | |
| 10-243 | Ph | CF₃ | [1,4]dioxan-2- | I |
| | | | ylmethoxy | |
| 10-244 | Ph | CF₃ | [1,4]dioxan-2- | F |
| | | | ylmethoxy | |
| 10-245 | Ph | Br | OMe | Br |
| 10-246 | Ph | Br | O(CH₂)₂OMe | Br |
| 10-247 | Ph | Br | O(CH₂)₄OMe | SO₂Me |
| 10-248 | Ph | Br | O(CH₂)₄OMe | SO₂Et |
| 10-249 | Ph | Br | O(CH₂)₃OMe | SO₂Me |
| 10-250 | Ph | Br | O(CH₂)₃OMe | SO₂Et |
| 10-251 | Ph | Br | O(CH₂)₂OMe | SO₂Me |
| 10-252 | Ph | Br | O(CH₂)₂OMe | SO₂Et |
| 10-253 | Ph | Br | [1,4]dioxan-2- | SO₂Me |
| | | | ylmethoxy | |
| 10-254 | Ph | Br | [1,4]dioxan-2- | SO₂Et |
| | | | ylmethoxy | |
| 10-255 | Ph | Br | SMe | Me |
| 10-256 | Ph | Br | SOMe | Me |
| 10-257 | Ph | Br | SO₂Me | Me |
| 10-258 | Ph | Br | SEt | Me |
| 10-259 | Ph | Br | SOEt | Me |
| 10-260 | Ph | Br | SO₂Et | Me |
| 10-261 | Ph | I | O(CH₂)₄OMe | SO₂Me |
| 10-262 | Ph | I | O(CH₂)₄OMe | SO₂Et |
| 10-263 | Ph | I | O(CH₂)₃OMe | SO₂Me |
| 10-264 | Ph | I | O(CH₂)₃OMe | SO₂Et |
| 10-265 | Ph | I | O(CH₂)₂OMe | SO₂Me |
| 10-266 | Ph | I | O(CH₂)₂OMe | SO₂Et |
| 10-267 | Ph | I | [1,4]dioxan-2- | SO₂Me |
| | | | ylmethoxy | |
| 10-268 | Ph | I | [1,4]dioxan-2- | SO₂Et |
| | | | ylmethoxy | |
| 10-269 | Ph | I | SMe | Me |
| 10-270 | Ph | I | SOMe | Me |
| 10-271 | Ph | I | SO₂Me | Me |
| 10-272 | Ph | I | SEt | Me |
| 10-273 | Ph | I | SOEt | Me |
| 10-274 | Ph | I | SO₂Et | Me |
| 10-275 | Ph | CH₂SMe | OMe | SO₂Me |
| 10-276 | Ph | CH₂OMe | OMe | SO₂Me |
| 10-277 | Ph | CH₂O(CH₂)₂O | NH(CH₂)₂OEt | SO₂Me |
| | | Me | | |
| 10-278 | Ph | CH₂O(CH₂)₂O | NH(CH₂)₃OEt | SO₂Me |
| | | Me | | |
| 10-279 | Ph | CH₂O(CH₂)₃O | OMe | SO₂Me |
| | | Me | | |
| 10-280 | Ph | CH₂O(CH₂)₂O | NH(CH₂)₂OMe | SO₂Me |
| | | Me | | |
| 10-281 | Ph | CH₂O(CH₂)₂O | NH(CH₂)₃OMe | SO₂Me |
| | | Me | | |
| 10-282 | Ph | SO₂Me | NH₂ | CF₃ |
| 10-283 | Ph | SO₂Me | F | CF₃ |
| 10-284 | Ph | SO₂Me | NHEt | Cl |
| 10-285 | Ph | SMe | SEt | F |
| 10-286 | Ph | SMe | SMe | F |
| 10-287 | 5-phenyl-1H- | Me | SO₂Me | CF₃ |
| | 1,2,3-triazol-1-yl | | | |
| 10-288 | 5-phenyl-1H- | Me | SO₂Me | SO₂Me |
| | 1,2,3-triazol-1-yl | | | |
| 10-289 | 4-OMe-phenyl | Me | SO₂Me | CF₃ |
| 10-290 | 4-OMe-phenyl | Me | SO₂Me | SO₂Me |
| 10-291 | 4-OMe-phenyl | Me | S(O)Me | SO₂Me |
| 10-292 | 4-OMe-phenyl | Cl | 5-cyano-methyl-4,5- | SO₂Et |
| | | | dihydro-1,2-oxazol-3- | |
| | | | yl | |
| 10-293 | 4-OMe-phenyl | Cl | CH₂OCH₂CF₃ | SO₂Me |
| 10-293 | 4-OMe-phenyl | Cl | Me | SO₂Me |
| 10-294 | 4-Cl-Ph | Cl | CH₂OCH₂- | SO₂Me |
| | | | tetrahydrofuran-2-yl | |
| 10-295 | 4-Cl-Ph | Me | Cl | SO₂Me |
| 10-296 | 4-Cl-Ph | Me | S(O)Me | CF₃ |
| 10-297 | 4-F-Ph | Me | SO₂Me | CF₃ |
| 10-298 | 4-F-Ph | Me | SO₂Me | SO₂Me |
| 10-299 | 4-F-Ph | Cl | CH₂OCH₂- | SO₂Me |
| | | | tetrahydrofuran-2-yl | |
| 10-300 | 4-F-Ph | Cl | CH₂OCH₂CF₃ | SO₂Me |
| 10-301 | 4-F-Ph | Me | Me | SO₂Me |
| 10-302 | 4-F-Ph | Cl | 5-cyano-methyl-4,5- | SO₂Et |
| | | | dihydro-1,2-oxazol-3- | |
| | | | yl | |
| 10-304 | 4-F-Ph | Me | S(O)Me | CF₃ |
| 10-305 | Ph | Cl | Me | SO₂Et |
| 10-306 | Ph | Me | 1,2,3-1H-triazol-1-yl | SO₂Me |
| 10-307 | 1,2,4-triazol-1-yl | Me | S(O)Me | CF₃ |
| 10-308 | 4-methyl-1,3- | Me | SO₂Me | CF₃ |
| | thiazol-2-yl | | | |
| 10-309 | thiophen-2-yl | Me | SO₂Me | CF₃ |
| 10-310 | 1,2,4-oxadiazol- | Me | SO₂Me | CF₃ |
| | 3-yl | | | |
| 10-311 | 5- | Me | SO₂Me | CF₃ |
| | methoxymethyl- | | | |
| | 1,2,4-oxadiazol- | | | |
| | 3-yl | | | |
| 10-312 | 1-methyl-5- | Me | SO₂Me | CF₃ |
| | ethylsulfonyl- | | | |
| | 1,3,4-triazol-2-yl | | | |
| 10-313 | 4-methyl-1,3- | Me | SO₂Me | SO₂Me |
| | thiazol-2-yl | | | |
| 10-314 | thiophen-2-yl | Me | SO₂Me | SO₂Me |
| 10-315 | 1,2,4-oxadiazol- | Me | SO₂Me | SO₂Me |
| | 3-yl | | | |
| 10-316 | 5- | Me | SO₂Me | SO₂Me |
| | methoxymethyl- | | | |
| | 1,2,4-oxadiazol- | | | |
| | 3-yl | | | |
| 10-317 | 1-methyl-5- | Me | SO₂Me | SO₂Me |
| | methylsulfonyl- | | | |
| | 1,3,4-triazol-2-yl | | | |
| 10-318 | pyridin-2-yl | Me | SO₂Me | CF₃ |
| 10-319 | pyridin-2-yl | Me | S(O)Me | CF₃ |
| 10-320 | pyridin-2-yl | Me | SO₂Me | SO₂Me |
| 10-321 | pyridin-3-yl | Me | SO₂Me | CF₃ |
| 10-322 | pyridin-3-yl | Me | S(O)Me | CF₃ |
| 10-323 | pyridin-3-yl | Me | SO₂Me | SO₂Me |
| 10-324 | pyridin-4-yl | Me | SO₂Me | CF₃ |
| 10-325 | pyridin-4-yl | Me | S(O)Me | CF₃ |
| 10-326 | pyridin-4-yl | Me | SO₂Me | SO₂Me |
| 10-327 | 4-(5- | Me | SO₂Me | CF₃ |
| | allylsulfanyl)-4- | | | |
| | methyl-4H- | | | |
| | 1,2,4-triazol-3-yl | | | |
| 10-328 | 4-(5- | Me | S(O)Me | CF₃ |
| | allylsulfanyl)-4- | | | |
| | methyl-4H- | | | |
| | 1,2,4-triazol-3-yl | | | |
| 10-329 | 4-(5- | Me | SO₂Me | SO₂Me |
| | allylsulfanyl)-4- | | | |
| | methyl-4H- | | | |
| | 1,2,4-triazol-3-yl | | | |

TABLE 11
Compounds of the general formula (I) according to the invention
(I)

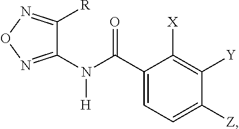

| No. | R | X | Y | Z |
|---|---|---|---|---|
| 11-2 | Bz | CF₃ | SMe | SO₂Me |
| 11-3 | Bz | CF₃ | OCH₂(CO)NMe₂ | SO₂Me |
| 11-4 | Bz | Cl | pyrazol-1-yl | SO₂Me |
| 11-5 | Bz | Cl | CH₂OCH₂CF₃ | SO₂Me |
| 11-6 | Bz | Cl | CH₂O-tetra- | SO₂Me |
| | | | hydrofuran-3-yl | |
| 11-7 | Bz | Cl | 5-cyanomethyl-4,5- | SO₂Et |
| | | | dihydro-1,2-oxazol-3- | |
| | | | yl | |
| 11-8 | Bz | Me | 4,5-dihydro-1,2- | SO₂Me |
| | | | oxazol-3-yl | |
| 11-9 | Bz | Me | SO₂Me | Cl |
| 11-10 | Bz | Me | SO₂Me | SO₂Me |
| 11-11 | Bz | Me | SO₂Me | CF₃ |
| 11-12 | Bz | Me | NMe₂ | SO₂Me |
| 11-13 | Bz | Cl | O(CH₂)₂OMe | Cl |
| 11-14 | Bz | Me | NH(CH₂)₂OMe | SO₂Me |
| 11-15 | Bz | Me | O(CH₂)₂NHSO₂Me | SO₂Me |
| 11-16 | CO2Me | CF₃ | SMe | SO₂CH₃ |
| 11-17 | CO₂Me | CF₃ | OCH₂(CO)NMe₂ | SO₂Me |
| 11-18 | CO₂Me | Cl | pyrazol-1-yl | SO₂Me |
| 11-19 | CO₂Me | F | SO₂Me | CF₃ |
| 11-20 | CO₂Me | Cl | CH₂OCH₂CF₃ | SO₂Me |
| 11-21 | CO₂Me | Cl | CH₂O- | SO₂Me |
| | | | tetrahydrofuran-3-yl | |
| 11-22 | CO₂Me | Cl | 5-cyanomethyl-4,5- | SO₂Et |
| | | | dihydro-1,2-oxazol-3- | |
| | | | yl | |
| 11-23 | CO₂Me | Me | 4,5-dihydro-1,2- | SO₂Me |
| | | | oxazol-3-yl | |
| 11-24 | CO₂Me | Me | SO₂Me | Cl |
| 11-25 | CO₂Me | Me | SO₂Me | SO₂Me |
| 11-26 | CO₂Me | Me | SO₂Me | CF₃ |
| 11-27 | CO₂Me | Me | NMe₂ | SO₂Me |
| 11-28 | CO₂Me | Cl | O(CH₂)₂OMe | Cl |
| 11-29 | CO₂Me | Me | NH(CH₂)₂OMe | SO₂Me |
| 11-30 | CO₂Me | Me | O(CH₂)₂NHSO₂Me | SO₂Me |
| 11-31 | NHAc | CF₃ | SMe | SO₂CH₃ |
| 11-32 | NHAc | CF₃ | OCH₂(CO)NMe₂ | SO₂Me |
| 11-33 | NHAc | Cl | pyrazol-1-yl | SO₂Me |
| 11-34 | NHAc | F | SO₂Me | CF₃ |
| 11-35 | NHAc | Cl | CH₂OCH₂CF₃ | SO₂Me |
| 11-36 | NHAc | Cl | CH₂O- | SO₂Me |
| | | | tetrahydrofuran-3-yl | |
| 11-37 | NHAc | Cl | 5-cyanomethyl-4,5- | SO₂Et |
| | | | dihydro-1,2-oxazol-3- | |
| | | | yl | SO₂Me |
| 11-38 | NHAc | Me | 4,5-dihydro-1,2- | |
| | | | oxazol-3-yl | |
| 11-39 | NHAc | Me | SO₂Me | Cl |
| 11-40 | NHAc | Me | SO₂Me | SO₂Me |
| 11-41 | NHAc | Me | SO₂Me | CF₃ |
| 11-42 | NHAc | Me | NMe₂ | SO₂Me |
| 11-43 | NHAc | Cl | O(CH₂)₂OMe | Cl |
| 11-44 | NHAc | Me | NH(CH₂)₂OMe | SO₂Me |
| 11-45 | NHAc | Me | O(CH₂)₂NHSO₂Me | SO₂Me |
| 11-46 | Ac | CF₃ | SMe | SO₂CH₃ |
| 11-47 | Ac | CF₃ | OCH₂(CO)NMe₂ | SO₂Me |
| 11-48 | Ac | Cl | pyrazol-1-yl | SO₂Me |
| 11-49 | Ac | F | SO₂Me | CF₃ |
| 11-50 | Ac | Cl | CH₂OCH₂CF₃ | SO₂Me |
| 11-51 | Ac | Cl | CH₂O- | SO₂Me |
| | | | tetrahydrofuran-3-yl | |
| 11-52 | Ac | Cl | 5-cyanomethyl-4,5- | SO₂Et |
| | | | dihydro-1,2-oxazol-3- | |
| | | | yl | |
| 11-53 | Ac | Me | 4,5-dihydro-1,2- | SO₂Me |
| | | | oxazol-3-yl | |
| 11-54 | Ac | Me | SO₂Me | Cl |
| 11-55 | Ac | Me | SO₂Me | SO₂Me |
| 11-56 | Ac | Me | SO₂Me | CF₃ |
| 11-57 | Ac | Me | NMe₂ | SO₂Me |
| 11-58 | Ac | Cl | O(CH₂)₂OMe | Cl |
| 11-59 | Ac | Me | NH(CH₂)₂OMe | SO₂Me |
| 11-60 | Ac | Me | O(CH₂)₂NHSO₂Me | SO₂Me |
| 11-61 | piperidin-1-yl | CF₃ | SMe | SO₂CH₃ |
| 11-62 | piperidin-1-yl | CF₃ | OCH₂(CO)NMe₂ | SO₂Me |
| 11-63 | piperidin-1-yl | Cl | Pyrazol-1-yl | SO₂Me |
| 11-64 | piperidin-1-yl | F | SO₂Me | CF₃ |
| 11-65 | piperidin-1-yl | Cl | CH₂OCH₂CF₃ | SO₂Me |
| 11-66 | piperidin-1-yl | Cl | CH₂O- | SO₂Me |
| | | | tetrahydrofuran-3-yl | |
| 11-67 | piperidin-1-yl | Cl | 5-cyanomethyl-4,5- | SO₂Et |
| | | | dihydro-1,2-oxazol-3- | |
| | | | yl | |
| 11-68 | piperidin-1-yl | Me | 4,5-dihydro-1,2- | SO₂Me |
| | | | oxazol-3-yl | |
| 11-69 | piperidin-1-yl | Me | SO₂Me | Cl |
| 11-70 | piperidin-1-yl | Me | SO₂Me | SO₂Me |
| 11-71 | piperidin-1-yl | Me | SO₂Me | CF₃ |
| 11-72 | piperidin-1-yl | Me | NMe₂ | SO₂Me |
| 11-73 | piperidin-1-yl | Cl | O(CH₂)₂OMe | Cl |
| 11-74 | SMe | CF₃ | SMe | SO₂CH₃ |
| 11-75 | SMe | CF₃ | OCH₂(CO)NMe₂ | SO₂Me |
| 11-76 | SMe | Cl | pyrazol-1-yl | SO₂Me |
| 11-77 | SMe | F | SO₂Me | CF₃ |
| 11-78 | SMe | Cl | CH₂OCH₂CF₃ | SO₂Me |
| 11-79 | SMe | Cl | CH₂O- | SO₂Me |
| | | | tetrahydrofuran-3-yl | |
| 11-80 | SMe | Cl | 5-cyanomethyl-4,5- | SO₂Et |
| | | | dihydro-1,2-oxazol-3- | |
| | | | yl | |
| 11-81 | SMe | Me | 4,5-dihydro-1,2- | SO₂Me |
| | | | oxazol-3yl | |
| 11-82 | SMe | Me | SO₂Me | Cl |
| 11-83 | SMe | Me | SO₂Me | SO₂Me |
| 11-84 | SMe | Me | SO₂Me | CF₃ |
| 11-85 | SMe | Me | NMe₂ | SO₂Me |
| 11-86 | SMe | Cl | O(CH₂)₂OMe | Cl |
| 11-87 | SMe | Me | NH(CH₂)₂OMe | SO₂Me |
| 11-88 | SMe | Me | O(CH₂)₂NHSO₂Me | SO₂Me |
| 11-89 | Cl | CF₃ | SMe | SO₂CH₃ |
| 11-90 | Cl | CF₃ | OCH₂(CO)NMe₂ | SO₂Me |
| 11-91 | Cl | Cl | pyrazol-1-yl | SO₂Me |
| 11-92 | Cl | F | SO₂Me | CF₃ |
| 11-93 | Cl | Cl | CH₂OCH₂CF₃ | SO₂Me |
| 11-94 | Cl | Cl | CH₂O- | SO₂Me |
| | | | tetrahydrofuran-3-yl | |
| 11-95 | Cl | Cl | 5-cyanomethyl- | SO₂Et |
| | | | dihydro-1,2-oxazol-3- | |
| | | | yl | |
| 11-96 | Cl | Me | 4,5-dihydro-1,2- | SO₂Me |
| | | | oxazol-3-yl | |
| 11-97 | Cl | Me | SO₂Me | Cl |
| 11-98 | Cl | Me | SO₂Me | SO₂Me |
| 11-99 | Cl | Me | SO₂Me | CF₃ |
| 11-100 | Cl | Me | NMe₂ | SO₂Me |
| 11-101 | Cl | Cl | O(CH₂)₂OMe | Cl |
| 11-102 | Cl | Me | NH(CH₂)₂OMe | SO₂Me |
| 11-103 | Cl | Me | O(CH₂)₂NHSO₂Me | SO₂Me |
| 11-104 | Br | CF₃ | SMe | SO₂CH₃ |
| 11-105 | Br | CF₃ | OCH₂(CO)NMe₂ | SO₂Me |
| 11-106 | Br | Cl | pyrazol-1-yl | SO₂Me |
| 11-107 | Br | F | SO₂Me | CF₃ |
| 11-108 | Br | Cl | CH₂OCH₂CF₃ | SO₂Me |
| 11-109 | Br | Cl | CH₂O- | SO₂Me |
| | | | tetrahydrofuran-3-yl | |
| 11-110 | Br | Cl | 5-cyanomethyl- | SO₂Et |
| | | | dihydro-1,2-oxazol-3- | |
| | | | yl | |
| 11-111 | Br | Me | 4,5-dihydro-1,2- | SO₂Me |
| | | | oxazol-3-yl | |
| 11-112 | Br | Me | SO₂Me | Cl |
| 11-113 | Br | Me | SO₂Me | SO₂Me |
| 11-114 | Br | Me | SO₂Me | CF₃ |
| 11-115 | Br | Me | NMe₂ | SO₂Me |
| 11-116 | Br | Cl | O(CH₂)₂OMe | Cl |
| 11-117 | Br | Me | NH(CH₂)₂OMe | SO₂Me |
| 11-118 | Br | Me | O(CH₂)₂NHSO₂Me | SO₂Me |
| 11-119 | I | CF₃ | SMe | SO₂CH₃ |
| 11-120 | I | CF₃ | OCH₂(CO)NMe₂ | SO₂Me |
| 11-121 | I | Cl | pyrazol-1-yl | SO₂Me |
| 11-122 | 1 | F | SO₂Me | CF₃ |
| 11-123 | 1 | Cl | CH₂OCH₂CF₃ | SO₂Me |
| 11-124 | 1 | Cl | CH₂O- | SO₂Me |
| | | | tetrahydrofuran-3-yl | |
| 11-125 | 1 | Cl | 5-cyanomethyl-4,5- | SO₂Et |
| | | | dihydro-1,2-oxazol-3-yl | |
| 11-126 | I | Me | 4,5-dihydro-1,2- | SO₂Me |
| | | | oxazol-3-yl | |
| 11-127 | I | Me | SO₂Me | Cl |
| 11-128 | I | Me | SO₂Me | SO₂Me |
| 11-129 | I | Me | SO₂Me | CF₃ |
| 11-130 | I | Me | NMe₂ | SO₂Me |
| 11-131 | 1 | Cl | O(CH₂)₂OMe | Cl |
| 11-132 | I | Me | NH(CH₂)₂OMe | SO₂Me |
| 11-133 | I | Me | O(CH₂)₂NHSO₂Me | SO₂Me |
| 11-134 | C(O)NH2 | CF₃ | SMe | SO₂CH₃ |
| 11-135 | C(O)NH2 | CF₃ | OCH₂(CO)NMe₂ | SO₂Me |
| 11-136 | C(O)NH2 | Cl | pyrazol-1-yl | SO₂Me |
| 11-137 | C(O)NH2 | F | SO₂Me | CF₃ |
| 11-138 | C(O)NH2 | Cl | CH₂OCH₂CF₃ | SO₂Me |
| 11-139 | C(O)NH2 | Cl | CH₂O- | SO₂Me |
| | | | tetrahydrofuran-3-yl | |
| 11-140 | C(O)NH2 | Cl | 5-cyanomethyl-4,5- | SO₂Et |
| | | | dihydro-1,2-oxazol-3- | |
| | | | yl | |
| 11-141 | C(O)NH2 | Me | 4,5-dihydro-1,2- | SO₂Me |
| | | | oxazol-3-yl | |
| 11-142 | CH₂OMe | Me | SO₂Me | Cl |
| 11-143 | CH₂OMe | Me | SO₂Me | SO₂Me |
| 11-144 | CH₂OMe | Me | SO₂Me | CF₃ |
| 11-145 | CH₂OMe | Me | NMe₂ | SO₂Me |
| 11-146 | CH₂OMe | Cl | O(CH₂)₂OMe | Cl |
| 11-147 | CH₂OMe | Me | NH(CH₂)₂OMe | SO₂Me |
| 11-148 | CH₂OMe | Me | O(CH₂)₂NHSO₂Me | SO₂Me |
| 11-149 | NH₂ | CF₃ | SMe | SO₂CH₃ |
| 11-150 | NH₂ | CF₃ | OCH₂(CO)NMe₂ | SO₂Me |
| 11-151 | NH₂ | Cl | pyrazol-1-yl | SO₂Me |
| 11-152 | NH₂ | Me | 1,2,3-triazol-2-yl | SO₂Me |
| 11-153 | NH₂ | Cl | CH₂OCH₂CF₃ | SO₂Me |
| 11-154 | NH₂ | Cl | CH₂O- | SO₂Me |
| | | | tetrahydrofuran-3-yl | |
| 11-155 | NH₂ | Cl | 5-cyanomethyl-4,5- | SO₂Et |
| | | | dihydro-1,2-oxazol-3- | |
| | | | yl | |
| 11-156 | NH₂ | Me | 4,5-dihydro-1,2- | SO₂Me |
| | | | oxazol-3yl | |
| 11-157 | NH₂ | Me | SO₂Me | Cl |
| 11-158 | NH₂ | Me | SO₂Me | SO₂Me |
| 11-159 | NH₂ | Me | SO₂Me | CF₃ |
| 11-160 | NH₂ | Me | NMe₂ | SO₂Me |
| 11-161 | NH₂ | Cl | O(CH₂)₂OMe | Cl |
| 11-162 | NH₂ | Me | NH(CH₂)₂OMe | SO₂Me |
| 11-163 | NH₂ | Me | O(CH₂)₂NHSO₂Me | SO₂Me |
| 11-164 | H | CF₃ | SMe | SO₂CH₃ |
| 11-165 | H | CF₃ | OCH₂(CO)NMe₂ | SO₂Me |
| 11-166 | H | Cl | pyrazol-1-yl | SO₂Me |
| 11-167 | H | F | SO₂Me | CF₃ |
| 11-168 | H | Cl | CH₂OCH₂CF₃ | SO₂Me |
| 11-169 | H | Cl | CH₂O- | SO₂Me |
| | | | tetrahydrofuran-3-yl | |
| 11-170 | H | Cl | 5-cyanomethyl-4,5- | SO2Et |
| | | | dihydro-1,2-oxazol-3- | |
| | | | yl | |
| 11-171 | H | Me | 4,5-dihydro-1,2- | SO₂Me |
| | | | oxazol-3-yl | |
| 11-172 | H | Me | SO₂Me | Cl |
| 11-173 | H | Me | SO₂Me | SO₂Me |
| 11-174 | H | Me | SO₂Me | CF₃ |
| 11-175 | H | Me | NMe₂ | SO₂Me |
| 11-176 | H | Cl | O(CH₂)₂OMe | Cl |
| 11-177 | H | Me | NH(CH₂)₂OMe | SO₂Me |
| 11-178 | H | Me | O(CH₂)₂NHSO₂Me | SO₂Me |
| 11-179 | NO₂ | CF₃ | SMe | SO₂CH₃ |
| 11-180 | NO₂ | CF₃ | OCH₂(CO)NMe₂ | SO₂Me |
| 11-181 | NO₂ | Cl | pyrazol-1-yl | SO₂Me |
| 11-182 | NO₂ | F | SO₂Me | CF₃ |
| 11-183 | NO₂ | Cl | CH₂OCH₂CF₃ | SO₂Me |
| 11-184 | NO₂ | Cl | CH₂O- | SO₂Me |
| | | | tetrahydrofuran-3-yl | |
| 11-185 | NO₂ | Cl | 5-cyanomethyl-4,5- | SO₂Et |
| | | | dihydro-1,2-oxazol-3- | |
| | | | yl | |
| 11-186 | NO₂ | Me | 4,5-dihydro-1,2- | SO₂Me |
| | | | oxazol-3-yl | |
| 11-187 | NO₂ | Me | SO₂Me | Cl |
| 11-188 | NO₂ | Me | SO₂Me | SO₂Me |
| 11-189 | NO₂ | Me | SO₂Me | CF₃ |
| 11-190 | NO₂ | Me | NMe₂ | SO₂Me |
| 11-191 | NO₂ | Cl | O(CH₂)₂OMe | Cl |
| 11-192 | NO₂ | Me | NH(CH₂)₂OMe | SO₂Me |
| 11-193 | NO₂ | Me | O(CH₂)₂NHSO₂Me | SO₂Me |
| 11-194 | c-Pr | CF₃ | SMe | SO₂CH₃ |
| 11-195 | c-Pr | CF₃ | OCH2(CO)NMe2 | SO₂Me |
| 11-196 | c-Pr | Cl | pyrazol-1-yl | SO₂Me |
| 11-197 | c-Pr | F | SO₂Me | CF₃ |
| 11-198 | c-Pr | Cl | CH₂OCH₂CF₃ | SO₂Me |
| 11-199 | c-Pr | Cl | CH₂O- | SO₂Me |
| | | | tetrahydrofuran-3-yl | |
| 11-200 | c-Pr | Cl | 5-cyanomethyl-4,5- | SO₂Et |
| | | | dihydro-1,2-oxazol-3- | |
| | | | yl | |
| 11-201 | c-Pr | Me | 4,5-dihydro-1,2- | SO₂Me |
| | | | oxazol-3-yl | |
| 11-202 | c-Pr | Me | SO₂Me | Cl |
| 11-203 | c-Pr | Me | SO₂Me | SO₂Me |
| 11-204 | c-Pr | Me | SO₂Me | CF₃ |
| 11-205 | c-Pr | Me | NMe₂ | SO₂Me |
| 11-206 | c-Pr | Cl | O(CH₂)₂OMe | Cl |
| 11-207 | c-Pr | Me | NH(CH₂)₂OMe | SO₂Me |
| 11-208 | c-Pr | Me | O(CH₂)₂NHSO₂Me | SO₂Me |
| 11-209 | piperidin-1-yl | Cl | SMe | SO₂Me |
| 11-210 | piperidin-1-yl | F | S(O)Me | CF₃ |
| 11-211 | piperidin-1-yl | Cl | (tetrahydrofuran-2- | SO₂Me |
| | | | ylmethoxy)methyl | |
| 11-212 | piperidin-1-yl | Cl | Me | SO₂Et |
| 11-213 | piperidin-1-yl | Me | Me | SO₂Me |
| 11-214 | piperidin-1-yl | Cl | Me | SO₂Me |
| 11-215 | piperidin-1-yl | Me | Cl | SO₂MeSO₂Me |
| 11-216 | piperidin-1-yl | Me | S(O)Me | CF₃ |
| 11-217 | piperidin-1-yl | Cl | Cl | SO₂Me |
| 11-218 | NO₂ | Me | S(O)Me | CF₃ |
| 11-219 | NH₂ | Cl | (tetrahydrofuran-2- | SO₂Me |
| | | | ylmethoxy)methyl | |
| 11-220 | NH₂ | Me | 1,2,3-triazol-1-yl | SO₂Me |
| 11-221 | CO₂Me | F | S(O)Me | CF₃ |
| 11-222 | CO₂Me | Cl | (tetrahydrofuran-2- | SO₂Me |
| | | | ylmethoxy)methyl | |
| 11-223 | CO₂Me | Me | Cl | SO₂Me |
| 11-224 | CO₂Me | Me | S(O)Me | CF₃ |
| 11-225 | CO₂Me | Cl | 1H-pyrazol-1-yl | SO₂Me |
| 11-226 | CO₂Me | Me | F | SO₂Me |
| 11-227 | CO₂Me | Me | 1,2,4-Triazol-1-yl | SO₂Me |
| 11-228 | CO₂Me | Cl | Cl | SO₂Me |
| 11-229 | CO₂Me | Me | Me | SMe |
| 11-230 | CO₂Me | Cl | Me | Cl |
| 11-231 | CO₂Me | Cl | F | Me |
| 11-232 | CO₂Me | Cl | SMe | SO₂Me |
| 11-233 | CO2Et | Me | SO₂Me | CF₃ |
| 11-234 | CO2H | Me | SO₂Me | CF₃ |
| 11-235 | piperidin-1-yl- | Cl | 5-cyanomethyl-4,5- | SO₂Et |
| | carbonyl | | dihydro-1,2-oxazol-3- | |
| | | | yl | |
| 11-236 | piperidin-1-yl- | Cl | CH₂OCH₂CF₃ | SO₂Me |
| | carbonyl | | | |
| 11-237 | piperidin-1-yl- | Me | SO₂Me | CF₃ |
| | carbonyl | | | |
| 11-238 | piperidin-1-yl- | Me | Cl | SO₂Me |
| | carbonyl | | | |
| 11-239 | SEt | Me | SO₂Me | CF₃ |
| 11-240 | SPh | Me | SO₂Me | CF₃ |
| 11-241 | SO₂Me | Me | SO₂Me | CF₃ |
| 11-242 | Br | Me | Me | SO₂Me |
| 11-243 | S(O)Me | Me | SO₂Me | CF₃ |
| 11-244 | S(O)Me | Me | Me | SO₂Me |
| 11-245 | c-Pr | Me | S(O)Me | CF₃ |
| 11-246 | c-Pr | Cl | (tetrahydrofuran-2- | SO₂Me |
| | | | ylmethoxy)methyl | |
| 11-247 | c-Pr | Cl | Cl | SO₂Me |
| 11-248 | c-Pr | Me | Me | SO₂Me |
| 11-249 | Bz | Me | SMe | CF₃ |
| 11-250 | Bz | Me | S(O)Me | CF₃ |
| 11-251 | Bz | Me | SO₂Me | CF₃ |
| 11-252 | Bz | Me | SMe | SO₂CH₃ |
| 11-253 | Bz | Me | S(O)Me | SO₂CH₃ |
| 11-254 | Bz | Me | SO₂Me | SO₂CH₃ |
| 11-255 | Bz | F | SMe | CF₃ |
| 11-256 | Bz | F | S(O)Me | CF₃ |
| 11-257 | Bz | F | SO₂Me | CF₃ |

As already disclosed in PCT/EP2010/005739, the compounds of the formula (I) and/or their salts to be used according to the invention, hereinbelow also referred to together as “compounds according to the invention”, have excellent herbicidal efficacy against a broad spectrum of economically important monocotyledonous and dicotyledonous annual harmful plants. The active compounds act efficiently even on perennial weeds which produce shoots from rhizomes, rootstocks and other perennial organs and which are difficult to control.

The present invention therefore relates to a method for controlling unwanted plants, in areas of transgenic crop plants being tolerant to HPPD inhibitor herbicides by containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No. 12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, comprising the application of one or more N-(1,2,5-oxadiazol-3-yl)benzamides whose phenyl ring is substituted in the 2-, 3- and 4-position as defined above to the plants (for example harmful plants such as monocotyledonous or dicotyledonous weeds or undesired crop plants), to the seed (for example grains, seeds or vegetative propagules such as tubers or shoot parts with buds) or to the area on which the plants grow (for example the area under cultivation). Specific examples may be mentioned of some representatives of the monocotyledonous and dicotyledonous weed flora which can be controlled by the compounds according to the invention, without the enumeration being restricted to certain species.

Monocotyledonous harmful plants of the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria, Sorghum.

Dicotyledonous weeds of the genera: Abutilon, Amaranthus, Ambrosia, Anoda, Anthemis, Aphanes, Artemisia, Atriplex, Bellis, Bidens, Capsella, Carduus, Cassia, Centaurea, Chenopodium, Cirsium, Convolvulus, Datura, Desmodium, Emex, Erysimum, Euphorbia, Galeopsis, Galinsoga, Galium, Hibiscus, Ipomoea, Kochia, Lamium, Lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Urtica, Veronica, Viola, Xanthium.

Trangenic crop plants of economically important crops to which the N-(1,2,5-oxadiazol-3-yl)benzamides whose phenyl ring is substituted in the 2-, 3- and 4-position as defined above might be applied are, for example dicotyledonous crops of the genera Arachis, Beta, Brassica, Cucumis, Cucurbita, Helianthus, Daucus, Glycine, Gossypium, Ipomoea, Lactuca, Linum, Lycopersicon, Nicotiana, Phaseolus, Pisum, Solanum, Vicia, or monocotyledonous crops of the genera Allium, Ananas, Asparagus, Avena, Hordeum, Oryza, Panicum, Saccharum, Secale, Sorghum, Triticale, Triticum, Zea, in particular Zea and Triticum.

This is why the present invention preferably relates to the method for controlling unwanted plants, in areas of transgenic crop plants being tolerant to HPPD inhibitor herbicides by containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No. 12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, comprising the application of one or more N-(1,2,5-oxadiazol-3-yl)benzamides whose phenyl ring is substituted in the 2-, 3- and 4-position as defined above to the plants (for example harmful plants such as monocotyledonous or dicotyledonous weeds or undesired crop plants), to the seed (for example grains, seeds or vegetative propagules such as tubers or shoot parts with buds) or to the area on which the plants grow (for example the area under cultivation) in dicotyledonous crops of the genera Arachis, Beta, Brassica, Cucumis, Cucurbita, Helianthus, Daucus, Glycine, Gossypium, Ipomoea, Lactuca, Linum, Lycopersicon, Nicotiana, Phaseolus, Pisum, Solanum, Vicia, or monocotyledonous crops of the genera Allium, Ananas, Asparagus, Avena, Hordeum, Oryza, Panicum, Saccharum, Secale, Sorghum, Triticale, Triticum, Zea, in particular Zea and Triticum.

It is preferred to use the N-(1,2,5-oxadiazol-3-yl)benzamides whose phenyl ring is substituted in the 2-, 3- and 4-position by selected radicals as defined above or their salts in economically important transgenic crops of useful plants and ornamentals, for example of cereals such as wheat, barley, rye, oats, sorghum/millet, rice, cassava and maize or else crops of sugar beet, sugar cane, cotton, soybean, oilseed rape, potato, tomato, peas and other vegetables, which crops contain one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No. 12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575

The invention also relates to the use, in a method for transforming plants, of a nucleic acid which encodes an HPPD as a marker gene or as a coding sequence which makes it possible to confer to the plant tolerance to herbicides which are HPPD inhibitors, and the use of N-(1,2,5-oxadiazol-3-yl)benzamides whose phenyl ring is substituted in the 2-, 3- and 4-position by selected radicals as defined above or their salts on plants containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No. 12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

In the commercial production of crops, it is desirable to eliminate under reliable pesticidial management unwanted plants (i.e., “weeds”) from a field of crop plants. An ideal treatment would be one which could be applied to an entire field but which would eliminate only the unwanted plants while leaving the crop plants unaffected. One such treatment system would involve the use of crop plants which are tolerant to an herbicide so that when the herbicide is sprayed on a field of herbicide-tolerant crop plants, the crop plants would continue to thrive while non-herbicide-tolerant weeds are killed or severely damaged. Ideally, such treatment systems would take advantage of varying herbicide properties so that weed control could provide the best possible combination of flexibility and economy. For example, individual herbicides have different longevities in the field, and some herbicides persist and are effective for a relatively long time after they are applied to a field while other herbicides are quickly broken down into other and/or non-active compounds. An ideal treatment system would allow the use of different herbicides so that growers could tailor the choice of herbicides for a particular situation.

While a number of herbicide-tolerant crop plants are presently commercially available, one issue that has arisen for many commercial herbicides and herbicide/crop combinations is that individual herbicides typically have incomplete spectrum of activity against common weed species. For most individual herbicides which have been in use for some time, populations of herbicide resistant weed species and biotypes have become more prevalent (see, e.g., Tranel and Wright (2002) Weed Science 50: 700-712; Owen and Zelaya (2005) Pest Manag. Sci. 61: 301-311). Transgenic plants which are resistant to more than one herbicide have been described (see, e.g., WO2005/012515). However, improvements in every aspect of crop production, weed control options, extension of residual weed control, and improvement in crop yield are continuously in demand.

The above defined chimeric gene(s) encoding one or more HPPD protein(s) or mutants thereof being functional in transgenic plants in order to perform tolerance to HPPD inhibitor herbicides belonging to the class of N-(1,2,5-oxadiazol-3-yl)benzamides whose phenyl ring is substituted in the 2-, 3- and 4-position by selected radicals as defined above or their salts is/are advantageously combined in plants with other genes which encode proteins or RNAs that confer useful agronomic properties to such plants. Among the genes which encode proteins or RNAs that confer useful agronomic properties on the transformed plants, mention can be made of the DNA sequences encoding proteins which confer tolerance to one or more herbicides that, according to their chemical structure, differ from HPPD inhibitor herbicides, and others which confer tolerance to certain insects, those which confer tolerance to certain diseases and or biotic and abiotic stresses, DNAs that encodes RNAs that provide nematode or insect control, etc.

Such genes are in particular described in published PCT Patent Applications WO 91/02071 and WO95/06128.

Among the DNA sequences encoding proteins which confer tolerance to certain herbicides on the transformed plant cells and plants, mention can be made of a bar or PAT gene or the Streptomyces coelicolor gene described in WO2009/152359 which confers tolerance to glufosinate herbicides, a gene encoding a suitable EPSPS which confers tolerance to herbicides having EPSPS as a target, such as glyphosate and its salts (U.S. Pat. No. 4,535,060, U.S. Pat. No. 4,769,061, U.S. Pat. No. 5,094,945, U.S. Pat. No. 4,940,835, U.S. Pat. No. 5,188,642, U.S. Pat. No. 4,971,908, U.S. Pat. No. 5,145,783, U.S. Pat. No. 5,310,667, U.S. Pat. No. 5,312,910, U.S. Pat. No. 5,627,061, U.S. Pat. No. 5,633,435), or a gene encoding glyphosate oxydoreductase (U.S. Pat. No. 5,463,175).

Among the DNA sequences encoding a suitable EPSPS which confer tolerance to the herbicides which have EPSPS as a target, mention will more particularly be made of the gene which encodes a plant EPSPS, in particular maize EPSPS, particularly a maize EPSPS which comprises two mutations, particularly a mutation at amino acid position 102 and a mutation at amino acid position 106 (WO 2004/074443), and which is described in U.S. Pat. No. 6,566,587, hereinafter named double mutant maize EPSPS or 2mEPSPS, or the gene which encodes an EPSPS isolated from Agrobacterium and which is described by SEQ ID No. 2 and SEQ ID No. 3 of U.S. Pat. No. 5,633,435, also named CP4.

Among the DNA sequences encoding a suitable EPSPS which confer tolerance to the herbicides which have EPSPS as a target, mention will more particularly be made of the gene which encodes an EPSPS GRG23 from Arthrobacter globiformis, but also the mutants GRG23 ACE1, GRG23 ACE2, or GRG23 ACE3, particularly the mutants or variants of GRG23 as described in WO2008/100353, such as GRG23(ace3)R173K of SEQ ID No. 29 in WO2008/100353.

In the case of the DNA sequences encoding EPSPS, and more particularly encoding the above genes, the sequence encoding these enzymes is advantageously preceded by a sequence encoding a transit peptide, in particular the “optimized transit peptide” described in U.S. Pat. No. 5,510,471 or 5,633,448.

In WO 2007/024782, plants being tolerant to glyphosate and at least one ALS (acetolactate synthase) inhibitor are disclosed. More specifically plants containing genes encoding a GAT (Glyphosate-N-Acetyltransferase) polypeptide and a polypeptide conferring resistance to ALS inhibitors are disclosed.

In U.S. Pat. No. 6,855,533, transgenic tobacco plants containing mutated Arabidopsis ALS/AHAS genes were disclosed.

In U.S. Pat. No. 6,153,401, plants containing genes encoding 2,4-D-monooxygenases conferring tolerance to 2,4-D (2,4-dichlorophenoxyacetic acid) by metabolisation are disclosed.

In US 2008/0119361 and US 2008/0120739, plants containing genes encoding Dicamba monooxygenases conferring tolerance to dicamba (3,6-dichloro-2-methoxybenzoic acid) by metabolisation are disclosed.

In WO2011/028833 and WO2011/028832 plants containing genes encoding mutagenized or recombinant Acetyl-coenzyme-A carboylase (ACCase) conferring tolerance to at least one herbicide is selected from the group consisting of alloxydim, butroxydim, clethodim, cloproxydim, cycloxydim, sethoxydim, tepraloxydim, tralkoxydim, chlorazifop, clodinafop, clofop, diclofop, fenoxaprop, fenoxaprop-P, fenthiaprop, fluazifop, fluazifop-P, haloxyfop, haloxyfop-P, isoxapyrifop, propaquizafop, quizalofop, quizalofop-P, trifop, and pinoxaden or agronomically acceptable salts or esters of any of these herbicides are disclosed.

All the above mentioned herbicide tolerance traits can be combined with those performing HPPD tolerance in plants concerning N-(1,2,5-oxadiazol-3-yl)benzamides whose phenyl ring is substituted in the 2-, 3- and 4-position by selected radicals as defined above or their salts by containing one or more chimeric gene(s) (I) comprising a DNA sequence encoding hydroxyphenylpyruvate dioxygenase (HPPD) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No. 12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

Among the DNA sequences encoding proteins concerning properties of tolerance to insects, mention will more particularly be made of the Bt proteins widely described in the literature and well known to those skilled in the art. Mention will also be made of proteins extracted from bacteria such as Photorhabdus (WO 97/17432 & WO 98/08932).

Among such DNA sequences encoding proteins of interest which confer novel properties of tolerance to insects, mention will more particularly be made of the Bt Cry or VIP proteins widely described in the literature and well known to those skilled in the art. These include the Cry1F protein or hybrids derived from a Cry1F protein (e.g., the hybrid Cry1A-Cry1F proteins described in U.S. Pat. No. 6,326,169; U.S. Pat. No. 6,281,016; U.S. Pat. No. 6,218,188, or toxic fragments thereof), the Cry1A-type proteins or toxic fragments thereof, preferably the Cry1Ac protein or hybrids derived from the Cry1Ac protein (e.g., the hybrid Cry1Ab-Cry1Ac protein described in U.S. Pat. No. 5,880,275) or the Cry1Ab or Bt2 protein or insecticidal fragments thereof as described in EP451878, the Cry2Ae, Cry2Af or Cry2Ag proteins as described in WO02/057664 or toxic fragments thereof, the Cry1A.105 protein described in WO 2007/140256 (SEQ ID No. 7) or a toxic fragment thereof, the VIP3Aa19 protein of NCBI accession ABG20428, the VIP3Aa20 protein of NCBI accession ABG20429 (SEQ ID No. 2 in WO 2007/142840), the VIP3A proteins produced in the COT202 or COT203 cotton events (WO 2005/054479 and WO 2005/054480, respectively), the Cry proteins as described in WO01/47952, the VIP3Aa protein or a toxic fragment thereof as described in Estruch et al. (1996), Proc Natl Acad Sci U S A. 28; 93(11):5389-94 and U.S. Pat. No. 6,291,156, the insecticidal proteins from Xenorhabdus (as described in WO98/50427), Serratia (particularly from S. entomophila) or Photorhabdus species strains, such as Tc-proteins from Photorhabdus as described in WO98/08932 (e.g., Waterfield et al., 2001, Appl Environ Microbiol. 67(11):5017-24; Ffrench-Constant and Bowen, 2000, Cell Mol Life Sci.; 57(5):828-33). Also any variants or mutants of any one of these proteins differing in some (1-10, preferably 1-5) amino acids from any of the above sequences, particularly the sequence of their toxic fragment, or which are fused to a transit peptide, such as a plastid transit peptide, or another protein or peptide, is included herein.

The present invention also relates to the use of N-(1,2,5-oxadiazol-3-yl)benzamides whose phenyl ring is substituted in the 2-, 3- and 4-position by selected radicals as defined above or their salts in transgenic plants comprising a chimeric gene (or expression cassette) which comprises a coding sequence as well as heterologous regulatory elements, at the 5′ and/or 3′ position, at least at the 5′ position, which are able to function in a host organism, in particular plant cells or plants, with the coding sequence containing at least one nucleic acid sequence which encodes an HPPD (I) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c)

Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) represents HPPD encoded by a mutated nucleic acid sequence of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

In another particular embodiment, the present invention relates to the use of N-(1,2,5-oxadiazol-3-yl)benzamides whose phenyl ring is substituted in the 2-, 3- and 4-position by selected radicals as defined above or their salts in transgenic plant comprising a chimeric gene as previously described, wherein the chimeric gene contains in the 5′ position of the nucleic acid sequence encoding hydroxyphenylpyruvate dioxygenase (HPPD) (I) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) encoded by a mutated nucleic acid sequence of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575., a nucleic acid sequence which encodes a plant transit peptide, with this sequence being arranged between the promoter region and the nucleic acid sequence encoding hydroxyphenylpyruvate dioxygenase (HPPD) (I) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) encoded by a mutated nucleic acid sequence of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, so as to permit expression of a transit peptide/HPPD fusion protein.

In a further particular embodiment, the present invention relates to the use of N-(1,2,5-oxadiazol-3-yl)benzamides whose phenyl ring is substituted in the 2-, 3- and 4-position by selected radicals as defined above or their salts on plants, plant parts, or plant seeds containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, or to the use of N-(1,2,5-oxadiazol-3-yl)benzamides whose phenyl ring is substituted in the 2-, 3- and 4-position by selected radicals as defined above or their salts on soil where such plants, plant parts or seeds are to be grown or sown, either alone or in combination with one or more other known herbicides acting in a different matter to HPPD inhibitors.

In a further particular embodiment, the N-(1,2,5-oxadiazol-3-yl)benzamides whose phenyl ring is substituted in the 2-, 3- and 4-position by selected radicals as defined above or their salts herbicide can applied in combination either in mixture, simultaneously or successively with HPPD inhibitor herbicides selected from the group consisting of triketones (named triketone HPPD inhibitor), such as tembotrione, sulcotrione mesotrione, bicyclopyrone, tefuryltrione, particularly tembotrione, of the class diketone such as diketonitrile of the class of isoxazoles such as isoxaflutole or of the class of pyrazolinates (named pyrazolinate HPPD inhibitor), such as pyrasulfotole, pyrazolate, topramezone, benzofenap, even more specifically present invention relates to the application of tembotrione, mesotrione, diketonitrile, bicyclopyrone, tefuryltrione, benzofenap, pyrasulfotole, pyrazolate and sulcotrione to such HPPD inhibitor tolerant plants, plant parts or plant seeds containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

As a regulatory sequence which functions as a promoter in plant cells and plants, use may be made of any promoter sequence of a gene which is naturally expressed in plants, in particular a promoter which is expressed especially in the leaves of plants, such as for example “constitutive” promoters of bacterial, viral or plant origin, or “light-dependent” promoters, such as that of a plant ribulose-biscarboxylase/oxygenase (RuBisCO) small subunit gene, or any suitable known promoter-expressible which may be used. Among the promoters of plant origin, mention will be made of the histone promoters as described in EP 0 507 698 A1, the rice actin promoter (U.S. Pat. No. 5,641,876), or a plant ubiquitin promoter (U.S. Pat. No. 5,510,474). Among the promoters of a plant virus gene, mention will be made of that of the cauliflower mosaic virus (CaMV 19S or 35S, Sanders et al. (1987), Nucleic Acids Res. 15(4):1543-58.), the circovirus (AU 689 311) or the Cassava vein mosaic virus (CsVMV, U.S. Pat. No. 7,053,205).

In a further particular embodiment, present invention relates to the use of N-(1,2,5-oxadiazol-3-yl)benzamides whose phenyl ring is substituted in the 2-, 3- and 4-position by selected radicals as defined above or their salts on plants, plant parts, or plant seeds comprising a promoter sequence specific for particular regions or tissues of plants can be used to express one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, such as promoters specific for seeds (Datla, R. et al., 1997, Biotechnology Ann. Rev. 3, 269-296), especially the napin promoter (EP 255 378 A1), the phaseolin promoter, the glutenin promoter, the helianthinin promoter (WO 92/17580), the albumin promoter (WO 98/45460), the oleosin promoter (WO 98/45461), the SAT1 promoter or the SAT3 promoter (PCT/US98/06978).

Use may also be made of an inducible promoter advantageously chosen from the phenylalanine ammonia lyase (PAL), HMG-CoA reductase (HMG), chitinase, glucanase, proteinase inhibitor (PI), PR1 family gene, nopaline synthase (nos) and vspB promoters (U.S. Pat. No. 5,670,349, Table 3), the HMG2 promoter (U.S. Pat. No. 5,670,349), the apple beta-galactosidase (ABG1) promoter and the apple aminocyclopropane carboxylate synthase (ACC synthase) promoter (WO 98/45445).

The genes encoding hydroxyphenylpyruvate dioxygenase (HPPD) (I) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) represented by a mutated DNA sequence of HPPD encoding genes of the before defined organisms, preferably represented by mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 may also be used in combination with the promoter, of other regulatory sequences, which are located between the promoter and the coding sequence, such as transcription activators (“enhancers”), for instance the translation activator of the tobacco mosaic virus (TMV) described in Application WO 87/07644, or of the tobacco etch virus (TEV) described by Carrington & Freed 1990, J. Virol. 64: 1590-1597, for example, or introns such as the adh1 intron of maize or intron 1 of rice actin in order to perform a sufficient tolerance to N-(1,2,5-oxadiazol-3-yl)benzamides whose phenyl ring is substituted in the 2-, 3- and 4-position by selected radicals as defined above or their salts.

In a further particular embodiment, the present invention relates to the use of N-(1,2,5-oxadiazol-3-yl)benzamides whose phenyl ring is substituted in the 2-, 3- and 4-position by selected radicals as defined above or their salts on plants, plant parts, or plant seeds containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 and also containing a CYP450 Maize monooxygenase (nsf1 gene) gene being under the control of an identical or different plant expressible promoter in order to confer tolerance to N-(1,2,5-oxadiazol-3-yl)benzamides whose phenyl ring is substituted in the 2-, 3- and 4-position by selected radicals as defined above or their salts.

As a regulatory terminator or polyadenylation sequence, use may be made of any corresponding sequence of bacterial origin, such as for example the nos terminator of Agrobacterium tumefaciens, of viral origin, such as for example the CaMV ³⁵S terminator, or of plant origin, such as for example a histone terminator as described in published Patent Application EP 0 633 317 A1.

It is to be understood that in order to obtain an optimized expression by a host adapted codon usage of the respective chimeric gene(s), one could adopt non-planta genes to the codon usage of the respective plant organism in which such chimeric genes will be inserted. Accordingly, in all of the described chimeric genes expressing HPPD of non-planta origin, the respective HPPD encoding DNA sequence can be replaced by an amended DNA sequence encoding the identical amino acid sequence, i.e. SEQ ID No. 3 can be replaced by SEQ ID No. 5., SEQ ID No. 6 can be replaced by SEQ ID No. 18, SEQ ID No. 8 can be replaced by SEQ ID No. 19, SEQ ID No. 10 can be replaced by SEQ ID No. 20, SEQ ID No. 12 can be replaced by SEQ ID No. 21, SEQ ID No. 14 can be replaced by SEQ ID No. 22, SEQ ID No, 16 can be replace by SEQ ID No.23.

The term “gene”, as used herein refers to a DNA coding region flanked by 5′ and/or 3′ regulatory sequences allowing a RNA to be transcribed which can be translated to a protein, typically comprising at least a promoter region. A “chimeric gene”, when referring to an HPPD encoding DNA, refers to an HPPD encoding DNA sequence having 5′ and/or 3′ regulatory sequences different from the naturally occurring bacterial 5′ and/or 3′ regulatory sequences which drive the expression of the HPPD protein in its native host cell (also referred to as “heterologous promoter” or “heterologous regulatory sequences”).

The terms “DNA/protein comprising the sequence X” and “DNA/protein with the sequence comprising sequence X”, as used herein, refer to a DNA or protein including or containing at least the sequence X in their nucleotide or amino acid sequence, so that other nucleotide or amino acid sequences can be included at the 5′ (or N-terminal) and/or 3′ (or C-terminal) end, e.g., a N-terminal transit or signal peptide. The term “comprising”, as used herein, is open-ended language in the meaning of “including”, meaning that other elements then those specifically recited can also be present. The term “consisting of”, as used herein, is closed-ended language, i.e., only those elements specifically recited are present. The term “DNA encoding a protein comprising sequence X”, as used herein, refers to a DNA comprising a coding sequence which after transcription and translation results in a protein containing at least amino acid sequence X. A DNA encoding a protein need not be a naturally occurring DNA, and can be a semi-synthetic, fully synthetic or artificial DNA and can include introns and 5′ and/or 3′ flanking regions. The term “nucleotide sequence”, as used herein, refers to the sequence of a DNA or RNA molecule, which can be in single- or double-stranded form.

HPPD proteins according to the invention may be equipped with a signal peptide according to procedures known in the art, see, e.g., published PCT patent application WO 96/10083, or they can be replaced by another peptide such as a chloroplast transit peptide (e.g., Van Den Broeck et al., 1985, Nature 313, 358, or a modified chloroplast transit peptide of U.S. Pat. No. 5,510,471) causing transport of the protein to the chloroplasts, by a secretory signal peptide or a peptide targeting the protein to other plastids, mitochondria, the ER, or another organelle, or it can be replaced by a methionine amino acid or by a methionine-alanine dipeptide. Signal sequences for targeting to intracellular organelles or for secretion outside the plant cell or to the cell wall are found in naturally targeted or secreted proteins, preferably those described by Klosgen et al. (1989, Mol. Gen. Genet. 217, 155-161), Klosgen and Weil (1991, Mol. Gen. Genet. 225, 297-304), Neuhaus & Rogers (1998, Plant Mol. Biol. 38, 127-144), Bih et al. (1999, J. Biol. Chem. 274, 22884-22894), Morris et al. (1999, Biochem. Biophys. Res. Commun. 255, 328-333), Hesse et al. (1989, EMBO J. 8 2453-2461), Tavladoraki et al. (1998, FEBS Lett. 426, 62-66), Terashima et al. (1999, Appl. Microbiol. Biotechnol. 52, 516-523), Park et al. (1997, J. Biol. Chem. 272, 6876-6881), Shcherban et al. (1995, Proc. Natl. Acad. Sci. USA 92, 9245-9249), all of which are incorporated herein by reference, particularly the signal peptide sequences from targeted or secreted proteins of corn, cotton, soybean, or rice. A DNA sequence encoding such a plant signal peptide can be inserted in the chimeric gene encoding the HPPD protein for expression in plants.

The invention also encompasses variant HPPD enzymes which are amino acid sequences similar to the HPPD amino acid sequence of SEQ ID No. 2, SEQ ID No. ID No. 4, SEQ ID No. 7, SEQ ID No. 9, SEQ ID No. 11, SEQ ID No. 13, SEQ ID No. 15, and SEQ ID No. 17 wherein in each of the before one or more amino acids have been inserted, deleted or substituted. In the present context, variants of an amino acid sequence refer to those polypeptides, enzymes or proteins which have a similar catalytic activity as the amino acid sequences described herein, notwithstanding any amino acid substitutions, additions or deletions thereto. Preferably the variant amino acid sequence has a sequence identity of at least about 80%, or 85 or 90%, 95%, 97%, 98% or 99% with the amino acid sequence of SEQ ID No. 2, SEQ ID No. 4, SEQ ID No. 7, SEQ ID No. 9, SEQ ID No. 11, SEQ ID No. 13, SEQ ID No. 15, and SEQ ID No. 17, respectively. Also preferably, a polypeptide comprising the variant amino acid sequence has HPPD enzymatic activity. Methods to determine HPPD enzymatic activity are well known in the art and include assays as extensively described in WO 2009/144079 or in WO 2002/046387, or in PCT/EP2010/070561.

Substitutions encompass amino acid alterations in which an amino acid is replaced with a different naturally-occurring or a non-conventional amino acid residue. Such substitutions may be classified as “conservative”, in which an amino acid residue contained in an HPPD protein of this invention is replaced with another naturally-occurring amino acid of similar character, for example Gly [symbol] Ala, Val [symbol] Ile [symbol] Leu, Asp [symbol] Glu, Lys [symbol] Arg, Asn [symbol] Gln or Phe [symbol] Trp [symbol] Tyr. Substitutions encompassed by the present invention may also be “non-conservative”, in which an amino acid residue which is present in an HPPD protein of the invention is substituted with an amino acid with different properties, such as a naturally-occurring amino acid from a different group (e.g. substituting a charged or hydrophobic amino acid with alanine. Amino acid substitutions are typically of single residues, but may be of multiple residues, either clustered or dispersed. Amino acid deletions will usually be of the order of about 1-10 amino acid residues, while insertions may be of any length. Deletions and insertions may be made to the N-terminus, the C-terminus or be internal deletions or insertions. Generally, insertions within the amino acid sequence will be smaller than amino- or carboxy-terminal fusions and of the order of 1 to 4 amino acid residues. “Similar amino acids”, as used herein, refers to amino acids that have similar amino acid side chains, i.e. amino acids that have polar, non-polar or practically neutral side chains. “Non-similar amino acids”, as used herein, refers to amino acids that have different amino acid side chains, for example an amino acid with a polar side chain is non-similar to an amino acid with a non-polar side chain. Polar side chains usually tend to be present on the surface of a protein where they can interact with the aqueous environment found in cells (“hydrophilic” amino acids). On the other hand, “non-polar” amino acids tend to reside within the center of the protein where they can interact with similar non-polar neighbours (“hydrophobic” amino acids”). Examples of amino acids that have polar side chains are arginine, asparagine, aspartate, cysteine, glutamine, glutamate, histidine, lysine, serine, and threonine (all hydrophilic, except for cysteine which is hydrophobic). Examples of amino acids that have non-polar side chains are alanine, glycine, isoleucine, leucine, methionine, phenylalanine, proline, and tryptophan (all hydrophobic, except for glycine which is neutral).

Unless otherwise stated in the examples, all procedures for making and manipulating recombinant DNA are carried out by the standard procedures described in Sambrook et al., Molecular Cloning—A Laboratory Manual, Second Ed., Cold Spring Harbor Laboratory Press, NY (1989), and in Volumes 1 and 2 of Ausubel et al. (1994) Current Protocols in Molecular Biology, Current Protocols, USA. Standard materials and methods for plant molecular biology work are described in Plant Molecular Biology Labfax (1993) by R. R. D. Croy, jointly published by BIOS Scientific Publications Ltd (UK) and Blackwell Scientific Publications (UK). Procedures for PCR technology can be found in “PCR protocols: a guide to methods and applications”, Edited by M. A. Innis, D. H. Gelfand, J. J. Sninsky and T. J. White (Academic Press, Inc., 1990).

The terms “tolerance”, “tolerant” or “less sensitive” are interchangeable used and mean the relative levels of inherent tolerance of the HPPD screened according to a visible indicator phenotype of the strain or plant transformed with a nucleic acid comprising the gene coding for the respective HPPD protein in the presence of different concentrations of the various HPPD inhibitor herbicides. Dose responses and relative shifts in dose responses associated with these indicator phenotypes (formation of brown colour, growth inhibition, bleaching, herbicidal effect, etc) are conveniently expressed in terms, for example, of GR50 (concentration for 50% reduction of growth) or MIC (minimum inhibitory concentration) values where increases in values correspond to increases in inherent tolerance of the expressed HPPD, in the normal manner based upon plant damage, meristematic bleaching symptoms etc. at a range of different concentrations of herbicides. These data can be expressed in terms of, for example, GR50 values derived from dose/response curves having “dose” plotted on the x-axis and “percentage kill”, “herbicidal effect”, “numbers of emerging green plants” etc. plotted on the y-axis where increased GR50 values correspond to increased levels of inherent tolerance of the expressed HPPD. Herbicides can suitably be applied pre-emergence or post emergence. Likewise, tolerance level is screened via transgenesis, regeneration, breeding and spray testing of a test plant such as tobacco, or a crop plant such as soybean or cotton and according to these results, such plants are at least 2-4× more tolerant to HPPD inhibitor herbicides, like N-(1,2,5-oxadiazol-3-yl)benzamides whose phenyl ring is substituted in the 2-, 3- and 4-position by selected radicals as defined above or their salts than plants that do not contain any exogenous gene encoding an HPPD protein,

“Host organism” or “host” is understood as being any unicellular or multicellular heterologous organism into which the nucleic acid or chimeric gene according to the invention can be introduced for the purpose of producing HPPD. These organisms are, in particular, bacteria, for example E. coli, yeast, in particular of the genera Saccharomyces or Kluyveromyces, Pichia, fungi, in particular Aspergillus, a baculovirus or, preferably, plant cells and plants.

“Plant cell” is understood, according to the invention, as being any cell which is derived from or found in a plant and which is able to form or is part of undifferentiated tissues, such as calli, differentiated tissues such as embryos, parts of plants, plants or seeds. This includes protoplasts and pollen, cultivated plants cells or protoplasts grown in vitro, and plant cells that can regenerate into a complete plant.

“Plant” is understood, according to the invention, as being any differentiated multicellular organism which is capable of photosynthesis, in particular a monocotyledonous or dicotyledonous organism, more especially cultivated plants which are or are not intended for animal or human nutrition, such as maize or corn, wheat, Brassica spp. plants such as Brassica napus or Brassica juncea, soya spp, rice, sugarcane, beetroot, tobacco, cotton, vegetable plants such as cucumber, leek, carrot, tomato, lettuce, peppers, melon, watermelon, etc. Transgenic plants, as used herein, refer to plants comprising one or more foreign or heterologous gene(s) stably inserted in their genome.

In order perform tolerance to N-(1,2,5-oxadiazol-3-yl)benzamides whose phenyl ring is substituted in the 2-, 3- and 4-position by selected radicals as defined above or their salts, any promoter sequence of a gene which is expressed naturally in plants, or any hybrid or combination of promoter elements of genes expressed naturally in plants, including Agrobacterium or plant virus promoters, or any promoter which is suitable for controlling the transcription of a herbicide tolerance gene in plants, can be used as the promoter sequence in the plants of the invention (named “plant-expressible promoter” herein). Examples of such suitable plant-expressible promoters are described above. In one embodiment of this invention, such plant-expressible promoters are operably-linked to a (I) DNA sequence encoding hydroxyphenylpyruvate dioxygenase (HPPD) that is derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) a mutated DNA sequence of HPPD of the before defined organisms, preferably a mutated DNA sequence as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 and also containing.

According to the invention, it is also possible to use, in combination with the promoter regulatory sequence, other regulatory sequences which are located between the promoter and the coding sequence, such as intron sequences, or transcription activators (enhancers) in order to perform tolerace to N-(1,2,5-oxadiazol-3-yl)benzamides whose phenyl ring is substituted in the 2-, 3- and 4-position by selected radicals as defined above or their salts. Examples of such suitable regulatory sequences are described above.

Any corresponding sequence of bacterial or viral origin, such as the nos terminator from Agrobacterium tumefaciens, or of plant origin, such as a histone terminator as described in application EP 0 633 317 A1, may be used as transcription termination (and polyadenylation) regulatory sequence.

In a further particular embodiment, the present invention relates to the use of N-(1,2,5-oxadiazol-3-yl)benzamides whose phenyl ring is substituted in the 2-, 3- and 4-position by selected radicals as defined above or their salts on plants, plant parts, or plant seeds containing a nucleic acid sequence which encodes a transit peptide is employed 5′ (upstream) of the nucleic acid sequence encoding the exogenous chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 and also containing with this transit peptide sequence being arranged between the promoter region and the sequence encoding the exogenous HPPD so as to permit expression of a transit peptide-HPPD fusion protein. The transit peptide makes it possible to direct the HPPD into the plastids, more especially the chloroplasts, with the fusion protein being cleaved between the transit peptide and the HPPD protein when the latter enters the plastid. The transit peptide may be a single peptide, such as an EPSPS transit peptide (described in U.S. Pat. No. 5,188,642) or a transit peptide of the plant ribulose bisphosphate carboxylase/oxygenase small subunit (RuBisCO ssu), where appropriate, including a few amino acids of the N-terminal part of the mature RuBisCO ssu (EP 189 707 A1), or else may be a fusion of several transit peptides such as a transit peptide which comprises a first plant transit peptide which is fused to a part of the N-terminal sequence of a mature protein having a plastid location, with this part in turn being fused to a second plant transit peptide as described in patent EP 508 909 A1, and, more especially, the optimized transit peptide which comprises a transit peptide of the sunflower RuBisCO ssu fused to 22 amino acids of the N-terminal end of the maize RuBisCO ssu, in turn fused to the transit peptide of the maize RuBisCO ssu, as described, with its coding sequence, in patent EP 508 909 A1.

The present invention also relates to the transit peptide HPPD fusion protein and a nucleic acid or plant-expressible chimeric gene encoding such fusion protein, wherein the two elements of this fusion protein are as defined above.

In a further particular embodiment, the present invention relates to the use of N-(1,2,5-oxadiazol-3-yl)benzamides whose phenyl ring is substituted in the 2-, 3- and 4-position by selected radicals as defined above or their salts on plants, plant parts, or plant seeds obtained by cloning, transformation with a expression vector, which expression vector contains at least one chimeric gene encoding the hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575. In addition to the above chimeric gene, this vector can contain an origin of replication. This vector can be a plasmid or plasmid portion, a cosmid, or a bacteriophage or a virus which has been transformed by introducing the chimeric gene according to the invention. Transformation vectors are well known to the skilled person and widely described in the literature. The transformation vector which can be used, in particular, for transforming plant cells or plants may be a virus, which can be employed for transforming plant cells or plants and which additionally contains its own replication and expression elements. The vector for transforming plant cells or plants is preferably a plasmid, such as a disarmed Agrobacterium Ti plasmid.

In a further particular embodiment, the present invention relates to the use of N-(1,2,5-oxadiazol-3-yl)benzamides whose phenyl ring is substituted in the 2-, 3- and 4-position by selected radicals as defined above or their salts on plants, plant parts, or plant seeds containing a chimeric gene which comprises a sequence encoding the hydroxyphenylpyruvate dioxygenase (HPPD) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, and the use of the plants or seeds in a field to grow a crop and harvest a plant product, e.g., soya spp, rice, wheat, barley or corn grains or cotton bolls, where in one embodiment said use involves the application of an N-(1,2,5-oxadiazol-3-yl)benzamides whose phenyl ring is substituted in the 2-, 3- and 4-position by selected radicals as defined above or their salts to such plants to control weeds.

In another particular embodiment, the present invention relates to the use of N-(1,2,5-oxadiazol-3-yl)benzamides whose phenyl ring is substituted in the 2-, 3- and 4-position by selected radicals as defined above or their salts on plants, plant parts, or plant seeds characterized in that it contains one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575. and in addition further contains a chimeric gene comprising a plant-expressible promoter as described above, operably-linked to a nucleic acid sequence encoding a PDH (prephenate dehydrogenase) enzyme (US 2005/0257283) in order to confer tolerance to N-(1,2,5-oxadiazol-3-yl)benzamides whose phenyl ring is substituted in the 2-, 3- and 4-position by selected radicals as defined above or their salts. A plant comprising such two transgenes can be obtained by transforming a plant with one transgene, and then re-transforming this transgenic plant with the second transgene, or by transforming a plant with the two transgenes simultaneously (in the same or in 2 different transforming DNAs or vectors), or by crossing a plant comprising the first transgene with a plant comprising the second transgene, as is well known in the art.

One transformation method in order to obtain plants, plant parts or seeds being tolerant to N-(1,2,5-oxadiazol-3-yl)benzamides whose phenyl ring is substituted in the 2-, 3- and 4-position by selected radicals as defined above or their salts by containing one or more chimeric gene(s) (I) comprising a DNA sequence encoding hydroxyphenylpyruvate dioxygenase (HPPD) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7 (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 comprises bombarding cells, protoplasts or tissues with solid or liquid particles to which DNA is attached, or containing DNA. Another transformation method comprises using, as mean for transfer into the plant, a chimeric gene which is inserted into an Agrobacterium tumefaciens Ti plasmid or an Agrobacterium rhizogenes Ri plasmid. Other methods may be used, such as microinjection or electroporation or otherwise direct gene transfer using PEG. The skilled person can select any appropriate method for transforming the host organism of choice, in particular the plant cell or the plant. As examples, the technology for soybean transformation has been extensively described in the examples 1 to 3 disclosed in EP 1186666 A1, incorporated herein by reference. For rice, Agrobacterium-mediated transformation (Hiei et al., 1994 Plant J 6:271-282, and Hiei et al., 1997 Plant Mol. Biol. 35:205-21, incorporated herein by reference), electroporation (U.S. Pat. No. 5,641,664 and U.S. Pat. No. 5,679,558, incorporated herein by reference), or bombardment (Christou et al., 1991, Biotechnology 9:957 incorporated herein by reference) could be performed. A suitable technology for transformation of monocotyledonous plants, and particularly rice, is described in WO 92/09696, incorporated herein by reference. For cotton, Agrobacterium-mediated transformation (Gould J. H. and Magallanes-Cedeno M., 1998 Plant Molecular Biology reporter, 16:1-10 and Zapata C., 1999, Theoretical Applied Genetics, 98(2):1432-2242 incorporated herein by reference), polybrene and/or treatment-mediated transformation (Sawahel W. A., 2001,—Plant Molecular Biology reporter, 19:377a-377f, incorporated herein by reference) have been described.

Alternatively, N-(1,2,5-oxadiazol-3-yl)benzamides whose phenyl ring is substituted in the 2-, 3- and 4-position by selected radicals as defined above or their salts may be used on plants, plant parts, or plant seeds containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 which HPPD is expressed directly in the plastids, such as the chloroplasts, using transformation of the plastid, such as the chloroplast genome. A suitable method comprises the bombardment of plant cells or tissue by solid particles coated with the DNA or liquid particles comprising the DNA, and integration of the introduced gene by homologous recombination. Suitable vectors and selection systems are known to the person skilled in the art. An example of means and methods which can be used for such integration into the chloroplast genome of tobacco plants is given in WO 06/108830, the content of which is hereby incorporated by reference

The present invention also relates to a method for obtaining a plant tolerant to N-(1,2,5-oxadiazol-3-yl)benzamides whose phenyl ring is substituted in the 2-, 3- and 4-position by selected radicals as defined above or their salts, characterized in that the plant is transformed with one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

Therefore, the present invention also relates to a method for obtaining a plant tolerant to N-(1,2,5-oxadiazol-3-yl)benzamides whose phenyl ring is substituted in the 2-, 3- and 4-position by selected radicals as defined above or their salts by containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, characterized in that the plant contains one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7 (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, which comprises a coding sequence as well as a heterologous regulatory element in the 5′ and optionally in the 3′ positions, which are able to function in a host organism, characterized in that the coding sequence comprises at least a nucleic acid sequence defining a gene encoding an HPPD of the invention as previously described in order to perform a sufficiently high level of tolerance to N-(1,2,5-oxadiazol-3-yl)benzamides whose phenyl ring is substituted in the 2-, 3- and 4-position by selected radicals as defined above or their salts.

In one embodiment of this invention, the HPPD inhibitor in the above method is a N-(1,2,5-oxadiazol-3-yl)benzamides whose phenyl ring is substituted in the 2-, 3- and 4-position by selected radicals as defined above or their salts either alone or in combination with one or more HPPD inhibitor herbicides selected from the group consisting of triketone or pyrazolinate herbicide, preferably tembotrione, mesotrione, bicyclopyrone, tefuryltrione pyrasulfotole, pyrazolate, diketonitrile, benzofenap, or sulcotrione, particularly tembotrione.

The invention also relates to a method for selectively removing weeds or preventing the germination of weeds in a field to be planted with plants or to be sown with seeds, or in a plant crop, by application of a N-(1,2,5-oxadiazol-3-yl)benzamides whose phenyl ring is substituted in the 2-, 3- and 4-position by selected radicals as defined above or their salts to such field or plant crop, which method is characterized in that this N-(1,2,5-oxadiazol-3-yl)benzamides whose phenyl ring is substituted in the 2-, 3- and 4-position by selected radicals as defined above or their salts is applied to plants which have been transformed in accordance with one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, either before sowing the crop (hereinafter named pre-planting application), before emergence of the crop (hereinafter named pre-emergence application), or after emergence of the crop (hereinafter named post-emergence application).

The invention also relates to a method for controlling in an area or a field which contains transformed seeds as previously described in the present invention, which method comprises applying, to the said area of the field, a dose of an N-(1,2,5-oxadiazol-3-yl)benzamides whose phenyl ring is substituted in the 2-, 3- and 4-position by selected radicals as defined above or their salts which is toxic for the said weeds, without significantly affecting the seeds or plants containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575.

The present invention also relates to a method for cultivating the plants which have been transformed with one or more chimeric gene(s) (I) comprising a DNA sequence encoding hydroxyphenylpyruvate dioxygenase (HPPD) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, which method comprises planting seeds comprising a chimeric gene of before, in an area of a field which is appropriate for cultivating the said plants, and in applying, if weeds are present, a dose, which is toxic for the weeds, of one or more N-(1,2,5-oxadiazol-3-yl)benzamides whose phenyl ring is substituted in the 2-, 3- and 4-position by selected radicals as defined above or their salts to the said area of the said field, without significantly affecting the said transformed seeds or the said transformed plants, and in then harvesting the cultivated plants or plant parts when they reach the desired stage of maturity and, where appropriate, in separating the seeds from the harvested plants.

In the above methods, the N-(1,2,5-oxadiazol-3-yl)benzamides whose phenyl ring is substituted in the 2-, 3- and 4-position by selected radicals as defined above or their salts can be applied in accordance with the invention, either before sowing the crop, before the crop emerges or after the crop emerges.

Within the meaning of the present invention, “herbicide” is understood as being a herbicidally active substance on its own or such a substance which is combined with an additive which alters its efficacy, such as, for example, an agent which increases its activity (a synergistic agent) or which limits its activity (a safener). It is of course to be understood that, for their application in practice, the above herbicides are combined, in a manner which is known per se, with the formulation adjuvants which are customarily employed in agricultural chemistry.

Thus, transgenic plants can be obtained which—in addition to the one or more chimeric gene(s) (I) comprising a DNA sequence encoding hydroxyphenylpyruvate dioxygenase (HPPD) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7 (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575—have modified properties as the result of overexpression, suppression or inhibition of homologous (=natural) genes or gene sequences or expression of heterologous (=foreign) genes or gene sequences.

On the plants, plant cells or seeds containing one or more chimeric gene(s) (I) comprising a DNA sequence encoding hydroxyphenylpyruvate dioxygenase (HPPD) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7 (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, it is preferred to employ one or more of the N-(1,2,5-oxadiazol-3-yh)benzamides whose phenyl ring is substituted in the 2-, 3- and 4-position by selected radicals as defined above or their salts in combination with one or more further HPPD inhibitor herbicides belonging to the class of triketones, such as tembotrione, sulcotrione and mesotrione, or of the class of pyrazolinates, such as pyrasulfotole and topramezone, particularly selected from tembotrione, sulcotrione, topramezone, bicyclopyrone, tefuryltrione and mesotrione, more particularly tembotrione in transgenic crops which are also resistant to growth regulators such as, for example, 2,4-D or dicamba, or against herbicides which inhibit essential plant enzymes, for example acetolactate synthases (ALS), EPSP synthases, glutamine synthases (GS), Acetyl-coenzyme A carboxylase (ACCase), or against herbicides from the group of the sulfonylureas, imidazolinones, glyphosate, glufosinate, ACCase inhibitors and analogous active substances.

The invention therefore also relates to the use of herbicides applied to HPPD tolerant plants containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 for controlling harmful plants (i.e. weeds) which also extends to transgenic crop plants comprising a second or more herbicide resistance(s) beside the resistance against one or more N-(1,2,5-oxadiazol-3-yl)benzamides whose phenyl ring is substituted in the 2-, 3- and 4-position by selected radicals as defined above or their salts.

N-(1,2,5-oxadiazol-3-yl)benzamides whose phenyl ring is substituted in the 2-, 3- and 4-position by selected radicals as defined above or their salts can be formulated in various ways, depending on the prevailing biological and/or physico-chemical parameters. Examples of possible formulations are: wettable powders (WP), water-soluble powders (SP), water-soluble concentrates, emulsifiable concentrates (EC), emulsions (EW), such as oil-in-water and water-in-oil emulsions, sprayable solutions, suspension concentrates (SC), oil- or water-based dispersions, oil-miscible solutions, capsule suspensions (CS), dusts (DP), seed-dressing products, granules for application by broadcasting and on the soil, granules (GR) in the form of microgranules, spray granules, coated granules and adsorption granules, water-dispersible granules (WG), water-soluble granules (SG), ULV formulations, microcapsules and waxes.

These individual types of formulation are known in principle and are described, for example, in: Winnacker-Küchler, “Chemische Technologie” [Chemical technology], volume 7, C. Hanser Verlag Munich, 4th Ed. 1986; Wade van Valkenburg, “Pesticide Formulations”, Marcel Dekker, N.Y., 1973; K. Martens, “Spray Drying” Handbook, 3rd Ed. 1979, G. Goodwin Ltd. London.

The formulation auxiliaries required, such as inert materials, surfactants, solvents and further additives, are also known and are described, for example, in: Watkins, “Handbook of Insecticide Dust Diluents and Carriers”, 2nd Ed., Darland Books, Caldwell N.J., H. v. Olphen, “Introduction to Clay Colloid Chemistry”; 2nd Ed., J. Wiley & Sons, N.Y.; C. Marsden, “Solvents Guide”; 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflächenaktive Äthylenoxidaddukte” [Interface-active ethylene oxide adducts], Wiss. Verlagsgesell., Stuttgart 1976; Winnacker-Küchler, “Chemische Technologie” [Chemical technology], volume 7, C. Hanser Verlag Munich, 4th Ed. 1986.

Based on these formulations, it is also possible to prepare combinations with other pesticidally active substances such as, for example, insecticides, acaricides, herbicides, fungicides, and with safeners, fertilizers and/or growth regulators, for example in the form of a ready mix or a tank mix.

Wettable powders are preparations which are uniformly dispersible in water and which, besides the active substance, also comprise ionic and/or nonionic surfactants (wetters, dispersers), for example polyoxyethylated alkylphenols, polyoxyethylated fatty alcohols, polyoxyethylated fatty amines, fatty alcohol polyglycol ether sulfates, alkanesulfonates, alkylbenzenesulfonates, sodium lignosulfonate, sodium 2,2′-dinaphthylmethane-6,6′-disulfonate, sodium dibutylnaphthalenesulfonate or else sodium oleoylmethyltaurinate, besides a diluent or inert substance. To prepare the wettable powders, the herbicidally active substances are ground finely, for example in customary apparatuses such as hammer mills, blower mills and air-jet mills, and mixed with the formulation auxiliaries, either simultaneously or subsequently.

Emulsifiable concentrates are prepared by dissolving the active substance in an organic solvent, for example butanol, cyclohexanone, dimethylformamide, xylene or else higher-boiling aromatics or hydrocarbons or mixtures of the organic solvents with addition of one or more ionic and/or nonionic surfactants (emulsifiers). Examples of emulsifiers which may be used are: calcium alkylarylsulfonates such as calcium dodecylbenzenesulfonate, or nonionic emulsifiers such as fatty acid polyglycol esters, alkylarylpolyglycol ethers, fatty alcohol polyglycol ethers, propylene oxide/ethylene oxide condensates, alkyl polyethers, sorbitan esters such as, for example, sorbitan fatty acid esters or polyoxyethylene sorbitan esters such as, for example, polyoxyethylene sorbitan fatty acid esters.

Dusts are obtained by grinding the active substance with finely divided solid materials such as, for example, talcum, natural clays such as kaolin, bentonite and pyrophyllite, or diatomaceous earth.

Suspension concentrates can be water- or oil-based. They can be prepared for example by wet-grinding by means of commercially available bead mills, if appropriate with addition of surfactants as already listed above for example in the case of the other formulation types.

Emulsions, for example oil-in-water emulsions (EW), can be prepared for example by means of stirrers, colloid mills and/or static mixers using aqueous organic solvents and, if appropriate, surfactants, as have already been mentioned for example above for the other formulation types.

Granules can be prepared either by spraying the active substance onto adsorptive, granulated inert material, or by applying active substance concentrates to the surface of carriers such as sand, kaolinites or granulated inert material with the aid of stickers, for example polyvinyl alcohol, sodium polyacrylate or else mineral oils.

Suitable active substances can also be granulated in the manner which is customary for the production of fertilizer granules, if desired as a mixture with fertilizers.

Water-dispersible granules are generally prepared by customary methods such as spray drying, fluidized-bed granulation, disk granulation, mixing with high-speed stirrers, and extrusion without solid inert material.

To prepare disk granules, fluidized-bed granules, extruder granules and spray granules, see, for example, methods in “Spray-Drying Handbook” 3rd ed. 1979, G. Goodwin Ltd., London; J. E. Browning, “Agglomeration”, Chemical and Engineering 1967, pages 147 et seq.; “Perry's Chemical Engineers Handbook”, 5th Ed., McGraw-Hill, New York 1973, p. 8-57.

For further details of the formulation of crop protection products see, for example, G. C. Klingman, “Weed Control as a Science”, John Wiley and Sons, Inc., New York, 1961, pages 81-96 and J. D. Freyer, S. A. Evans, “Weed Control Handbook”, 5th Ed., Blackwell Scientific Publications, Oxford, 1968, pages 101-103.

As a rule, the agrochemical preparations comprise from 0.1 to 99% by weight, in particular from 0.1 to 95% by weight, of compounds according to the invention. In wettable powders, the active substance concentration is, for example, approximately 10 to 90% by weight, the remainder to 100% by weight being composed of customary formulation constituents. In the case of emulsifiable concentrates, the active substance concentration can amount to approximately 1 to 90, preferably 5 to 80% by weight. Formulations in the form of dusts comprise from 1 to 30% by weight of active substance, preferably in most cases from 5 to 20% by weight of active substance, and sprayable solutions comprise approximately from 0.05 to 80, preferably from 2 to 50% by weight of active substance. In the case of water-dispersible granules, the active substance content depends partly on whether the active compound is in liquid or solid form, and on the granulation auxiliaries, fillers and the like which are being used. In the case of the water-dispersible granules, for example, the active substance content is between 1 and 95% by weight, preferably between 10 and 80% by weight.

In addition, the active substance formulations mentioned comprise, if appropriate, the auxiliaries which are conventional in each case, such as stickers, wetters, dispersants, emulsifiers, penetrations, preservatives, antifreeze agents, solvents, fillers, carriers, colorants, antifoams, evaporation inhibitors, and pH and viscosity regulators.

Based on these formulations, it is also possible to prepare combinations of an HPPD inhibitor herbicide of the class of triketones, such as tembotrione, sulcotrione and mesotrione, or of the class of pyrazolinates, such as pyrasulfotole and topramezone, particularly selected from tembotrione, sulcotrione, topramezone, bicyclopyrone, tefuryltrione and mesotrione, more particularly tembotrione with other pesticidally active substances such as, for example, insecticides, acaricides, herbicides, fungicides, and with safeners, fertilizers and/or growth regulators, for example in the form of a ready mix or a tank mix to be applied to HPPD tolerant plants according to the invention.

### FORMULATION EXAMPLES

a) A dust is obtained by mixing 10 parts by weight of a compound of the formula (I) and/or a salt thereof and 90 parts by weight of talc as inert substance and comminuting the mixture in a hammer mill.
b) A wettable powder which is readily dispersible in water is obtained by mixing 25 parts by weight of a compound of the formula (I) and/or a salt thereof, 64 parts by weight of kaolin-containing quartz as inert substance, 10 parts by weight of potassium lignosulfonate and 1 part by weight of sodium oleoylmethyltaurinate as wetting agent and dispersant, and grinding the mixture in a pinned-disk mill.
c) A readily water-dispersible dispersion concentrate is obtained by mixing 20 parts by weight of a compound of the formula (I) and/or a salt thereof with 6 parts by weight of alkylphenol polyglycol ether (®Triton X 207), 3 parts by weight of isotridecanol polyglycol ether (8 EO) and 71 parts by weight of paraffinic mineral oil (boiling range for example about 255 to above 277° C.) and grinding the mixture in a ball mill to a fineness of below 5 microns.
d) An emulsifiable concentrate is obtained from 15 parts by weight of a compound of the formula (I) and/or a salt thereof, 75 parts by weight of cyclohexanone as solvent and 10 parts by weight of oxethylated nonylphenol as emulsifier.
e) Water-dispersible granules are obtained by mixing
   75 parts by weight of a compound of the formula (I) and/or a salt thereof,
   10 parts by weight of calcium lignosulfonate,
   5 parts by weight of sodium lauryl sulfate,
   3 parts by weight of polyvinyl alcohol and
   7 parts by weight of kaolin,
   grinding the mixture in a pinned-disk mill, and granulating the powder in a fluidized bed by spraying on water as granulating liquid.
f) Water-dispersible granules are also obtained by homogenizing and precomminuting, in a colloid mill,
   25 parts by weight of a compound of the formula (I) and/or a salt thereof,
   5 parts by weight of sodium 2,2′-dinaphthylmethane-6,6′-disulfonate,
   2 parts by weight of sodium oleoylmethyltaurinate,
   1 part by weight of polyvinyl alcohol,
   17 parts by weight of calcium carbonate and
   50 parts by weight of water,
   subsequently grinding the mixture in a bead mill and atomizing and drying the resulting suspension in a spray tower by means of a single-substance nozzle.

A further aspect of present invention is the use of one or more N-(1,2,5-oxadiazol-3-yl)benzamides whose phenyl ring is substituted in the 2-, 3- and 4-position by selected radicals as defined above or their salts to HPPD tolerant plants containing one or more chimeric gene(s) (I) comprising a DNA sequence encoding hydroxyphenylpyruvate dioxygenase (HPPD) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 in combination with further HPPD inhibitor herbicide belonging to the class of triketones, such as tembotrione, sulcotrione and mesotrione, or belonging to the class of pyrazolinates, such as pyrasulfotole and topramezone, particularly selected from tembotrione, sulcotrione, topramezone, bicyclopyrone, tefuryltrione and mesotrione, more particularly tembotrione in mixed formulations or in the tank mix, and/or with further known active substances which are based on the inhibition of, for example, acetolactate synthase, acetyl-CoA carboxylase, cellulose synthase, enolpyruvylshikimate-3-phosphate synthase, glutamine synthetase, p-hydroxyphenylpyruvate dioxygenase, phytoene desaturase, photosystem I, photosystem II, protoporphyrinogen oxidase, as are described in, for example, Weed Research 26 (1986) 441-445 or “The Pesticide Manual”, 14th edition, The British Crop Protection Council and the Royal Soc. of Chemistry, 2003 and the literature cited therein. Known herbicides or plant growth regulators which can be combined with the compounds according to the invention are, for example, the following active substances (the compounds are either designated by the common name according to the International Organization for Standardization (ISO) or by a chemical name, if appropriate together with the code number) and always comprise all use forms such as acids, salts, esters and isomers such as stereoisomers and optical isomers. In this context, one and in some cases also several use forms are mentioned by way of example:

acetochlor, acibenzolar, acibenzolar-5-methyl, acifluorfen, acifluorfen-sodium, aclonifen, alachlor, allidochlor, alloxydim, alloxydim-sodium, ametryne, amicarbazone, amidochlor, amidosulfuron, aminocyclopyrachlor, aminopyralid, amitrole, ammonium sulfamate, ancymidol, anilofos, asulam, atrazine, azafenidin, azimsulfuron, aziprotryne, BAH-043, BAS-140H, BAS-693H, BAS-714H, BAS-762H, BAS-776H, BAS-800H, beflubutamid, benazolin, benazolin-ethyl, bencarbazone, benfluralin, benfuresate, bensulide, bensulfuron-methyl, bentazone, benzfendizone, benzobicyclon, benzofenap, benzofluor, benzoylprop, bifenox, bilanafos, bilanafos-sodium, bispyribac, bispyribac-sodium, bromacil, bromobutide, bromofenoxim, bromoxynil, bromuron, buminafos, busoxinone, butachlor, butafenacil, butamifos, butenachlor, butralin, butroxydim, butylate, cafenstrole, carbetamide, carfentrazone, carfentrazone-ethyl, chlomethoxyfen, chloramben, chlorazifop, chlorazifop-butyl, chlorbromuron, chlorbufam, chlorfenac, chlorfenac-sodium, chlorfenprop, chlorflurenol, chlorflurenol-methyl, chloridazon, chlorimuron, chlorimuron-ethyl, chlormequat-chloride, chlornitrofen, chlorophthalim, chlorthal-dimethyl, chlorotoluron, chlorsulfuron, cinidon, cinidon-ethyl, cinmethylin, cinosulfuron, clethodim, clodinafop clodinafop-propargyl, clofencet, clomazone, clomeprop, cloprop, clopyralid, cloransulam, cloransulam-methyl, cumyluron, cyanamide, cyanazine, cyclanilide, cycloate, cyclosulfamuron, cycloxydim, cycluron, cyhalofop, cyhalofop-butyl, cyperquat, cyprazine, cyprazole, 2,4-D, 2,4-DB, daimuron/dymron, dalapon, daminozide, dazomet, n-decanol, desmedipham, desmetryn, detosyl-pyrazolate (DTP), di-allate, dicamba, dichlobenil, dichlorprop, dichlorprop-P, diclofop, diclofop-methyl, diclofop-P-methyl, diclosulam, diethatyl, diethatyl-ethyl, difenoxuron, difenzoquat, diflufenican, diflufenzopyr, diflufenzopyr-sodium, dimefuron, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenamid, dipropetryn, diquat, diquat-dibromide, dithiopyr, diuron, DNOC, eglinazine-ethyl, endothal, EPTC, esprocarb, ethalfluralin, ethametsulfuron-methyl, ethephon, ethidimuron, ethiozin, ethofumesate, ethoxyfen, ethoxyfen-ethyl, ethoxysulfuron, etobenzanid, F-5331, i.e. N-[2-chloro-4-fluoro-5-[4-(3-fluoro-propyl)-4,5-dihydro-5-oxo-1H-tetrazol-1-yl]-phenyl]ethanesulfonamide, fenoprop, fenoxaprop, fenoxaprop-P, fenoxaprop-ethyl, fenoxaprop-P-ethyl, fentrazamide, fenuron, flamprop, flamprop-M-isopropyl, flamprop-M-methyl, flazasulfuron, florasulam, fluazifop, fluazifop-P, fluazifop-butyl, fluazifop-P-butyl, fluazolate, flucarbazone, flucarbazone-sodium, flucetosulfuron, fluchloralin, flufenacet (thiafluamide), flufenpyr, flufenpyr-ethyl, flumetralin, flumetsulam, flumiclorac, flumiclorac-pentyl, flumioxazin, flumipropyn, fluometuron, fluorodifen, fluoroglycofen, fluoroglycofen-ethyl, flupoxam, flupropacil, flupropanate, flupyrsulfuron, flupyrsulfuron-methyl-sodium, flurenol, flurenol-butyl, fluridone, fluorochloridone, fluoroxypyr, fluoroxypyr-meptyl, flurprimidol, flurtamone, fluthiacet, fluthiacet-methyl, fluthiamide, fomesafen, foramsulfuron, forchlorfenuron, fosamine, furyloxyfen, gibberellic acid, glufosinate, L-glufosinate, L-glufosinate-ammonium, glufosinate-ammonium, glyphosate, glyphosate-isopropylammonium, H-9201, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HNPC-9908, HOK-201, HW-02, imazamethabenz, imazamethabenz-methyl, imazamox, imazapic, imazapyr, imazaquin, imazethapyr, imazosulfuron, inabenfide, indanofan, indoleacetic acid (IAA), 4-indol-3-ylbutyric acid (IBA), iodosulfuron, iodosulfuron-methyl-sodium, ioxynil, isocarbamid, isopropalin, isoproturon, isouron, isoxaben, isoxachlortole, isoxaflutole, isoxapyrifop, KUH-043, KUH-071, karbutilate, ketospiradox, lactofen, lenacil, linuron, maleic hydrazide, MCPA, MCPB, MCPB-methyl, -ethyl and -sodium, mecoprop, mecoprop-sodium, mecoprop-butotyl, mecoprop-P-butotyl, mecoprop-P-dimethylammonium, mecoprop-P-2-ethylhexyl, mecoprop-P-potassium, mefenacet, mefluidide, mepiquat-chloride, mesosulfuron, mesosulfuron-methyl, methabenzthiazuron, metam, metamifop, metamitron, metazachlor, methazole, methoxyphenone, methyldymron, 1-methylcyclopropene, methyl isothiocyanate, metobenzuron, metobenzuron, metobromuron, metolachlor, S-metolachlor, metosulam, metoxuron, metribuzin, metsulfuron, metsulfuron-methyl, molinate, monalide, monocarbamide, monocarbamide dihydrogen sulfate, monolinuron, monosulfuron, monuron, MT 128, MT-5950, i.e. N4-[3-chloro-4-(1-methylethyl)-phenyl]-2-methylpentanamide, NGGC-011, naproanilide, napropamide, naptalam, NC-310, i.e. 4-(2,4-dichlorobenzoyl)-1-methyl-5-benzyloxypyrazole, neburon, nicosulfuron, nipyraclofen, nitralin, nitrofen, nitrophenolat-sodium (isomer mixture), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazole, paraquat, paraquat dichloride, pelargonic acid (nonanoic acid), pendimethalin, pendralin, penoxsulam, pentanochlor, pentoxazone, perfluidone, pethoxamid, phenisopham, phenmedipham, phenmedipham-ethyl, picloram, picolinafen, pinoxaden, piperophos, pirifenop, pirifenop-butyl, pretilachlor, primisulfuron, primisulfuron-methyl, probenazole, profluazol, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyzamide, prosulfalin, prosulfocarb, prosulfuron, prynachlor, pyraclonil, pyraflufen, pyraflufen-ethyl, pyrazolynate (pyrazolate), pyrazosulfuron-ethyl, pyrazoxyfen, pyribambenz, pyribambenz-isopropyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, secbumeton, sethoxydim, siduron, simazine, simetryn, SN-106279, sulf-allate (CDEC), sulfentrazone, sulfometuron, sulfometuron-methyl, sulfosate (glyphosate-trimesium), sulfosulfuron, SYN-523, SYP-249, SYP-298, SYP-300, tebutam, tebuthiuron, tecnazene, tepraloxydim, terbacil, terbucarb, terbuchlor, terbumeton, terbuthylazine, terbutryne, TH-547, thenylchlor, thiafluamide, thiazafluoron, thiazopyr, thidiazimin, thidiazuron, thiencarbazone, thiencarbazone-methyl, thifensulfuron, thifensulfuron-methyl, thiobencarb, tiocarbazil, tralkoxydim, tri-allate, triasulfuron, triaziflam, triazofenamide, tribenuron, tribenuron-methyl, trichloroacetic acid (TCA), triclopyr, tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-P, vernolate, ZJ-0166, ZJ-0270, ZJ-0543, ZJ-0862 and the following compounds

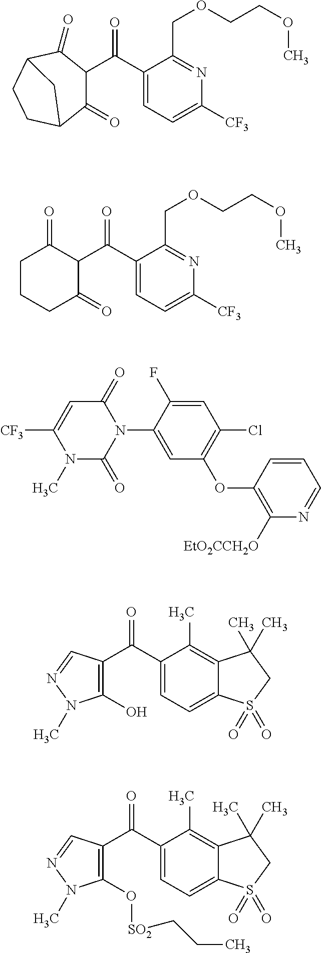

The application rate required of an N-(1,2,5-oxadiazol-3-yl)benzamides whose phenyl ring is substituted in the 2-, 3- and 4-position by selected radicals as defined above or their salts to be applied to areas where HPPD tolerant plants containing one or more chimeric gene(s) (I) comprising a DNA sequence encoding hydroxyphenylpyruvate dioxygenase (HPPD) derived from a member of a group of organisms consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17, or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 are growing varies as a function of the external conditions such as temperature, humidity, the nature of the herbicide used and the like. It can vary within wide limits, for example between 0.001 and 1.0 kg/ha and more of active substance, but it is preferably between 0.005 and 750 g/ha.

In case of combined applications of N-(1,2,5-oxadiazol-3-yh)benzamides whose phenyl ring is substituted in the 2-, 3- and 4-position by selected radicals as defined above or their salts herbicides that differ from HPPD N-(1,2,5-oxadiazol-3-yh)benzamides whose phenyl ring is substituted in the 2-, 3- and 4-position by selected radicals as defined above or their salts to the HPPD tolerant plants containing one or more chimeric gene(s) (I) comprising a DNA sequence encoding hydroxyphenylpyruvate dioxygenase (HPPD) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11 or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575, these mixtures may cause crop injury, based on the presence herbicides different to N-(1,2,5-oxadiazol-3-yl)benzamides whose phenyl ring is substituted in the 2-, 3- and 4-position by selected radicals as defined above or their salts. In order to reduce/eliminate such crop injuries, appropriate safeners may be added. These safeners, which are employed in antidotically active amounts, reduce the phytotoxic side effects of herbicides/pesticides used, for example in economically important crops, such as cereals (wheat, barley, rye, corn, rice, millet), alfalfa, sugar beet, sugarcane, oilseed rape, cotton and soya spp., preferably corn, cotton, sugarbeet, or soya spp.

The safeners are preferably selected from the group consisting of:

A) compounds of the formula (S-I)

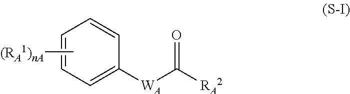

where the symbols and indices have the following meanings:
n_{A} is a natural number from 0 to 5, preferably from 0 to 3;
R_{A}¹ is halogen, (C₁-C₄)-alkyl, (C₁-C₄)-alkoxy, nitro or (C₁-C₄)-haloalkyl;
W_{A} is an unsubstituted or substituted divalent heterocyclic radical from the group consisting of partially unsaturated or aromatic five-membered heterocycles having 1 to 3 hetero ring atoms of the type N or O, where at least one nitrogen atom and at most one oxygen atom is present in the ring, preferably a radical from the group consisting of (W_{A}¹) to (W_{A}⁴),

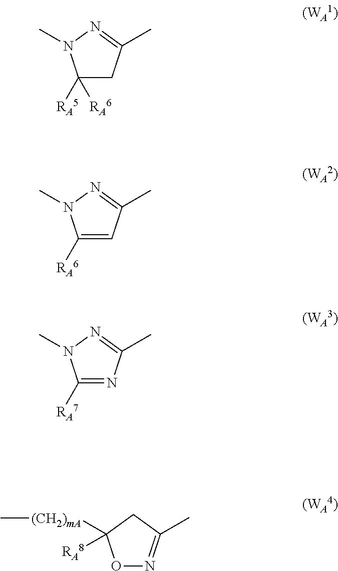

m_{A} is 0 or 1;
R_{A}² is OR_{A}³, SR_{A}³ or NR_{A}³R_{A}⁴ or a saturated
   or unsaturated 3- to 7-membered heterocycle having at least one nitrogen atom and up to 3 heteroatoms, preferably from the group consisting of O and S, which is attached via the nitrogen atom to the carbonyl group in (S—I) and which is unsubstituted or substituted by radicals from the group consisting of (C₁-C₄)-alkyl, (C₁-C₄)-alkoxy and optionally substituted phenyl, preferably a radical of the formula OR_{A}³, NHR_{A}⁴ or N(CH₃)₂, in particular of the formula OR_{A}³;
R_{A}³ is hydrogen or an unsubstituted or substituted aliphatic hydrocarbon radical having preferably a total of 1 to 18 carbon atoms;
R_{A}⁴ is hydrogen, (C₁-C₆)-alkyl, (C₁-C₆)-alkoxy or substituted or unsubstituted phenyl;
R_{A}⁵ is H, (C₁-C₈)-alkyl, (C₁-C₈)-haloalkyl), (C₁-C₄)-alkoxy-(C₁-C₈)-alkyl, cyano or COOR_{A}⁹ where R_{A}⁹ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₁₂)-cycloalkyl or tri-(C₁-C₄)-alkylsilyl;
R_{A}⁶, R_{A}⁷, R_{A}⁸ are identical or different and are hydrogen, (C₁-C₈)-alkyl, (C₁-C₈)-haloalkyl, (C₃-C₁₂)-cycloalkyl or substituted or unsubstituted phenyl;
   preferably:
   a) compounds of the type of the dichlorophenylpyrazoline-3-carboxylic acid, preferably compounds such as ethyl 1-(2,4-dichlorophenyl)-5-(ethoxycarbonyl)-5-methyl-2-pyrazoline-3-carboxylate (S1-1) (“mefenpyr-diethyl”, see Pestic. Man.), and related compounds, as described in WO 91/07874;
   b) derivatives of dichlorophenylpyrazolecarboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806;
   c) compounds of the type of the triazolecarboxylic acids, preferably compounds such as fenchlorazole(-ethyl ester), i.e. ethyl 1-(2,4-dichlorophenyl)-5-trichloro-methyl-(1H)-1,2,4-triazole-3-carboxylate (S1-6), and related compounds, as described in EP-A-174 562 and EP-A-346 620;
   d) compounds of the type of the 5-benzyl- or 5-phenyl-2-isoxazoline-3-carboxylic acid or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or ethyl 5,5-diphenyl-2-isoxazolinecarboxylate (S1-9) (“isoxadifen-ethyl”) or n-propyl 5,5-diphenyl-2-isoxazolinecarboxylate (S1-10) or ethyl 5-(4-fluorophenyl)-5-phenyl-2-isoxazoline-3-carboxylate (S1-11), as described in the patent application WO-A-95/07897.
   B) Quinoline derivatives of the formula (S-III)

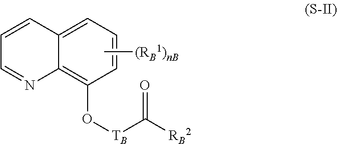

where the symbols and indices have the following meanings:
R_{B}¹ is halogen, (C₁-C₄)-alkyl, (C₁-C₄)-alkoxy, nitro or (C₁-C₄)-haloalkyl;
n_{B} is a natural number from 0 to 5, preferably from 0 to 3;
R_{B}² OR_{B}³, SR_{B}³ or NR_{B}³R_{B}⁴ or a saturated or unsaturated 3- to 7-membered heterocycle having at least one nitrogen atom and up to 3 heteroatoms, preferably from the group consisting of O and S, which is attached via the nitrogen atom to the carbonyl group in (S-II) and is unsubstituted or substituted by radicals from the group consisting of (C₁-C₄)-alkyl, (C₁-C₄)-alkoxy or optionally substituted phenyl, preferably a radical of the formula OR_{B}³, NHR_{B}⁴ or N(CH₃)₂, in particular of the formula OR_{B}³;
R_{B}³ is hydrogen or an unsubstituted or substituted aliphatic hydrocarbon radical having preferably a total of 1 to 18 carbon atoms;
R_{B}⁴ is hydrogen, (C₁-C₆)-alkyl, (C₁-C₆)-alkoxy or substituted or unsubstituted phenyl;
T_{B} is a (C₁- or C₂)-alkanediyl chain which is unsubstituted or substituted by one or two (C₁-C₄)-alkyl radicals or by [(C₁-C₃)-alkoxy]carbonyl;
preferably:
a) compounds of the type of the 8-quinolinoxyacetic acid (S2), preferably 1-methylhexyl (5-chloro-8-quinolinoxy)acetate (common name “cloquintocet-mexyl” (S2-1) (see Pestic. Man.),
1,3-dimethylbut-1-yl (5-chloro-8-quinolinoxy)acetate (S2-2),
4-allyloxybutyl (5-chloro-8-quinolinoxy)acetate (S2-3),
1-allyloxyprop-2-yl (5-chloro-8-quinolinoxy)acetate- (S2-4),
ethyl (5-chloro-8-quinolinoxy)acetate (S2-5),
methyl (5-chloro-8-quinolinoxy)acetate (S2-6),
allyl (5-chloro-8-quinolinoxy)acetate (S2-7),
2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds, as described in EP-A-86 750, EP-A-94 349 and EP-A-191 736 or EP-A-0 492 366, and also their hydrates and salts, as described in WO-A-2002/034048.
   b) Compounds of the type of the (5-chloro-8-quinolinoxy)malonic acid, preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
   C) Compounds of the formula (S-III)

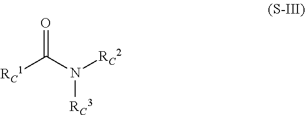

where the symbols and indices have the following meanings:
R_{C}¹ is (C₁-C₄)-alkyl, (C₁-C₄)-haloalkyl, (C₂-C₄)-alkenyl, (C₂-C₄)-haloalkenyl, (C₃-C₇)-cycloalkyl, preferably dichloromethyl;
R_{C}², R_{C}³ are identical or different and are hydrogen, (C₁-C₄)-alkyl, (C₂-C₄)-alkenyl, (C₂-C₄)-alkynyl, (C₁-C₄)-haloalkyl, (C₂-C₄)-haloalkenyl, (C₁-C₄)-alkylcarbamoyl-(C₁-C₄)-alkyl, (C₂-C₄)-alkenylcarbamoyl-(C₁-C₄)-alkyl, (C₁-C₄)-alkoxy-(C₁-C₄)-alkyl, dioxolanyl-(C₁-C₄)-alkyl, thiazolyl, furyl, furylalkyl, thienyl, piperidyl, substituted or unsubstituted phenyl, or R_{C}² and R_{C}³ together form a substituted or unsubstituted heterocyclic ring,
preferably an oxazolidine, thiazolidine, piperidine, morpholine, hexahydropyrimidine or benzoxazine ring;
preferably:

Active compounds of the type of the dichloroacetamides which are frequently used as pre-emergence safener (soil-acting safeners), such as, for example,
“dichlormid” (see Pestic.Man.) (═N,N-diallyl-2,2-dichloroacetamide),
“R-29148” (=3-dichloroacetyl-2,2,5-trimethyl-1,3-oxazolidine from Stauffer),
“R-28725” (=3-dichloroacetyl-2,2,-dimethyl-1,3-oxazolidine from Stauffer),
“benoxacor” (see Pestic. Man.) (=4-dichloroacetyl-3,4-dihydro-3-methyl-2H-1,4-benzoxazine),
“PPG-1292” (═N-allyl-N-[(1,3-dioxolan-2-yl)methyl]dichloroacetamide from PPG Industries),
“DKA-24” (═N-allyl-N—[(allylaminocarbonyl)methyl]dichloroacetamide from Sagro-Chem),
“AD-67” or “MON 4660” (=3-dichloroacetyl-1-oxa-3-aza-spiro[4,5]decane from Nitrokemia or Monsanto),
“TI-35” (=1-dichloroacetylazepane from TRI-Chemical RT) “diclonon” (dicyclonone) or “BAS145138” or “LAB145138” (=3-dichloroacetyl-2,5,5-trimethyl-1,3-diazabicyclo[4.3.0]nonane from BASF) and “furilazole” or “MON 13900” (see Pestic. Man.) (=(RS)-3-dichloroacetyl-5-(2-furyl)-2,2-dimethyloxazolidine).
   D) N-Acylsulfonamides of the Formula (S-IV) and their Salts

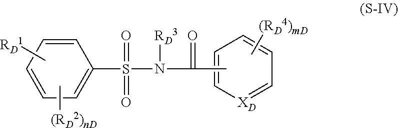

in which

### X_{D} is CH or N;

### R_{D}¹ is CO—NR_{D}⁵R_{D}⁶ or NHCO—R_{D}⁷;

R_{D}² is halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl;
R_{D}³ is hydrogen, (C₁-C₄)-alkyl, (C₂-C₄)-alkenyl or (C₂-C₄)-alkynyl;
R_{D}⁴ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
R_{D}⁶ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl, phenyl or 3- to 6-membered heterocyclyl containing V_{D} heteroatoms from the group consisting of nitrogen, oxygen and sulfur, where the seven last-mentioned radicals are substituted by v_{D} substituents from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R_{D}⁶ is hydrogen, (C₁-C₆)-alkyl, (C₂-C₆)-alkenyl or (C₂-C₆)-alkynyl, where the three last-mentioned radicals are substituted by v_{D} radicals from the group consisting of halogen, hydroxy, (C₁-C₄)-alkyl, (C₁-C₄)-alkoxy and (C₁-C₄)-alkylthio, or
R_{D}⁶ and R_{D}⁶ together with the nitrogen atom carrying them form a pyrrolidinyl or piperidinyl radical;
R_{D}⁷ is hydrogen, (C₁-C₄)-alkylamino, di-(C₁-C₄)-alkylamino, (C₁-C₆)-alkyl, (C₃-C₆)-cycloalkyl, where the 2 last-mentioned radicals are substituted by v_{D} substituents from the group consisting of halogen, (C₁-C₄)-alkoxy, halogen-(C₁-C₆)-alkoxy and (C₁-C₄)-alkylthio and, in the case of cyclic radicals, also (C₁-C₄)-alkyl and (C₁-C₄)-haloalkyl;
n_{D} is 0, 1 or 2;
m_{D} is 1 or 2;
v_{D} is 0, 1, 2 or 3;
from among these, preference is given to compounds of the type of the N-acylsulfonamides, for example of the formula (S-V) below, which are known, for example, from WO 97/45016

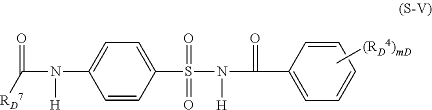

in which
R_{D}⁷ is (C₁-C₆)-alkyl, (C₃-C₆)-cycloalkyl, where the 2 last-mentioned radicals are substituted by V_{D} substituents from the group consisting of halogen, (C₁-C₄)-alkoxy, halogen-(C₁-C₆)-alkoxy and (C₁-C₄)-alkylthio and, in the case of cyclic radicals, also (C₁-C₄)-alkyl and (C₁-C₄)-haloalkyl;
R_{D}⁴ is halogen, (C₁-C₄)-alkyl, (C₁-C₄)-alkoxy, CF₃,
m_{D} is 1 or 2;
v_{D} is 0, 1, 2 or 3;
and also
acylsulfamoylbenzamides, for example of the formula (S-VI) below, which are known, for example, from WO 99/16744,

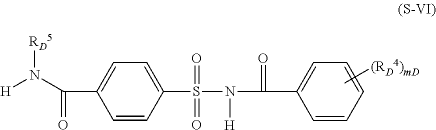

for example those in which
R_{D}⁵=cyclopropyl and (R_{D}⁴)=2-OMe (“cyprosulfamide”, S3-1),
R_{D}⁵=cyclopropyl and (R_{D}⁴)=5-Cl-2-OMe (S3-2),
R_{D}⁵=ethyl and (R_{D}⁴)=2-OMe (S3-3),
R_{D}⁵=isopropyl and (R_{D}⁴)=5-Cl-2-OMe (S3-4) and
R_{D}⁵=isopropyl and (R_{D}⁴)=2-OMe (S3-5);
and also
compounds of the type of the N-acylsulfamoylphenylureas of the formula (S-VII), which are known, for example, from EP-A-365484

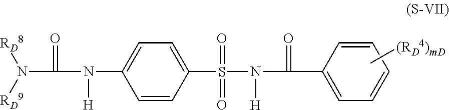

in which
R_{D}⁸ and R_{D}⁹ independently of one another are hydrogen, (C₁-C₈)-alkyl, (C₃-C₈)-cycloalkyl, (C₃-C₆)-alkenyl, (C₃-C₆)-alkynyl,
R_{D}⁴ is halogen, (C₁-C₄)-alkyl, (C₁-C₄)-alkoxy, CF₃
m_{D} is 1 or 2;
from among these in particular
1-[4-(N²-methoxybenzoylsulfamoyl)phenyl]-3-methylurea,
1-[4-(N²-methoxybenzoylsulfamoyl)phenyl]-3,3-dimethylurea,
1-[4-(N4,5-dimethylbenzoylsulfamoyl)phenyl]-3-methylurea,
   1-[4-(N-naphthoylsulfamoyl)phenyl]-3,3-dimethylurea,

G) active compounds from the class of the hydroxyaromatics and aromatic-aliphatic carboxylic acid derivatives, for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 1,2-dihydro-2-oxo-6-trifluoromethylpyridine-3-carboxamide, 2-hydroxycinnamic acid, 2,4-dichlorocinnamic acid, as described in WO 2004084631, WO 2005015994, WO 2006007981, WO 2005016001;

H) active compounds from the class of the 1,2-dihydroquinoxalin-2-ones, for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydro-quinoxalin-2-one, as described in WO 2005112630,
I) active compounds which, in addition to a herbicidal action against harmful plants, also have safener action on crop plants such as rice, such as, for example, “dimepiperate” or “MY-93” (see Pestic. Man.) (═S-1-methyl-1-phenylethyl piperidine-1-thiocarboxylate), which is known as safener for rice against damage by the herbicide molinate,
“daimuron” or “SK 23” (see Pestic. Man.) (=1-(1-methyl-1-phenylethyl)-3-p-tolyl-urea), which is known as safener for rice against damage by the herbicide imazosulfuron,
“cumyluron”=“JC-940” (=3-(2-chlorophenylmethyl)-1-(1-methyl-1-phenyl-ethyl)urea, see JP-A-60087254), which is known as safener for rice against damage by a number of herbicides, “methoxyphenone” or “NK 049” (=3,3′-dimethyl-4-methoxybenzophenone), which is known as safener for rice against damage by a number of herbicides, “CSB” (=1-bromo-4-(chloromethylsulfonyl)benzene) (CAS Reg. No. 54091-06-4 from Kumiai), which is known as safener against damage by a number of herbicides in rice,
K) compounds of the formula (S-IIX),

as described in WO-A-1998/38856

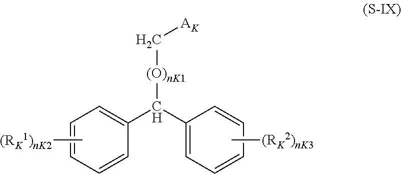

in which the symbols and indices have the following meanings:
R_{K}¹, R_{K}² independently of one another are halogen, (C₁-C₄)-alkyl, (C₁-C₄)-alkoxy, (C₁-C₄)-haloalkyl, (C₁-C₄)-alkylamino, di-(C₁-C₄)-alkylamino, nitro;

### A_{K} is COOR_{K}³ or COOR_{K}⁴

R_{K}³, R_{K}⁴ independently of one another are hydrogen, (C₁-C₄)-alkyl, (C₂-C₆)-alkenyl, (C₂-C₄)-alkynyl, cyanoalkyl, (C₁-C₄)-haloalkyl, phenyl, nitrophenyl, benzyl, halobenzyl, pyridinylalkyl or alkylammonium,
n_{K}¹ is 0 or 1,
n_{K}², n_{K}³ independently of one another are 0, 1 or 2 preferably: methyl(diphenylmethoxy)acetate (CAS Reg. No.: 41858-19-9),
L) compounds of the formula (S-X),

as described in WO A-98/27049

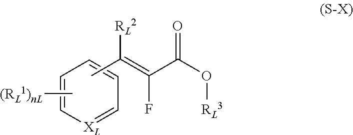

in which the symbols and indices have the following meanings:
X_{L} is CH or N,
n_{L} is, in the case that X═N, an integer from 0 to 4 and, in the case that X═CH, an integer from 0 to 5,
R₁: is halogen, (C₁-C₄)-alkyl, (C₁-C₄)-haloalkyl, (C₁-C₄)-alkoxy, (C₁-C₄)-haloalkoxy, nitro, (C₁-C₄)-alkylthio, (C₁-C₄)-alkylsulfonyl, (C₁-C₄)-alkoxycarbonyl, optionally substituted phenyl, optionally substituted phenoxy,
R_{L}² is hydrogen or (C₁-C₄)-alkyl,
R_{L}³ is hydrogen, (C₁-C₈)-alkyl, (C₂-C₄)-alkenyl, (C₂-C₄)-alkynyl or aryl, where each of the carbon-containing radicals mentioned above is unsubstituted or substituted by one or more, preferably by up to three, identical or different radicals from the group consisting of halogen and alkoxy; or salts thereof,
   M) active compounds from the class of the 3-(5-tetrazolylcarbonyl)-2-quinolones, for example
   1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No.: 95855-00-8), as described in WO-A-1999000020,
   N) compounds of the formula (S-XI) or (S-XII),

as described in WO-A-2007023719 and WO-A-2007023764

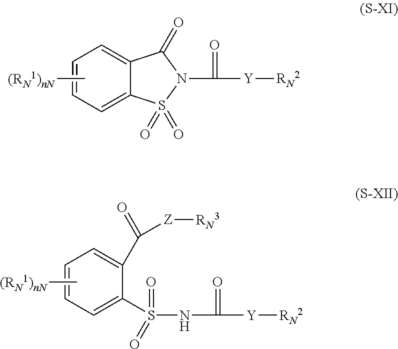

in which
R_{N}¹ is halogen, (C₁-C₄)-alkyl, methoxy, nitro, cyano, CF₃, OCF₃
Y, Z independently of one another are O or S,
n_{N} is an integer from 0 to 4,
R_{N}² is (C₁-C₁₆)-alkyl, (C₂-C₆)-alkenyl, (C₃-C₆)-cycloalkyl, aryl, benzyl, halobenzyl,
R_{N}³ is hydrogen, (C₁-C₆)alkyl,
O) one or more compounds from the group consisting of:
1,8-naphthalic anhydride,
O,O-diethyl S-2-ethylthioethyl phosphorodithioate (disulfoton),
4-chlorophenyl methylcarbamate (mephenate),
O,O-diethyl O-phenyl phosphorothioate (dietholate),
4-carboxy-3,4-dihydro-2H-1-benzopyran-4-acetic acid (CL-304415, CAS Reg. No.: 31541-57-8),
2-propenyl 1-oxa-4-azaspiro[4.5]decane-4-carbodithioate (MG-838, CAS Reg. No.: 133993-74-5),
methyl[(3-oxo-1H-2-benzothiopyran-4(3H)-ylidene)methoxy]acetate (from WO-A-98/13361; CAS Reg. No.: 205121-04-6),
cyanomethoxyimino(phenyl)acetonitrile (cyometrinil),
1,3-dioxolan-2-ylmethoxyimino(phenyl)acetonitrile (oxabetrinil),
4′-chloro-2,2,2-trifluoroacetophenone O-1,3-dioxolan-2-ylmethyloxime (fluxofenim),
4,6-dichloro-2-phenylpyrimidine (fenclorim),
benzyl 2-chloro-4-trifluoromethyl-1,3-thiazole-5-carboxylate (flurazole),
2-dichloromethyl-2-methyl-1,3-dioxolane (MG-191),
   including the stereoisomers, and the salts customary in agriculture.

A mixture N-(1,2,5-oxadiazol-3-yl)benzamides whose phenyl ring is substituted in the 2-, 3- and 4-position by selected radicals as defined above or their salts to be applied in connection with other known active compounds, such as fungicides, insecticides, acaricides, nematicides, bird repellents, plant nutrients and soil structure improvers to transgenic plants containing one or more chimeric gene(s) (I) comprising a DNA sequence encoding hydroxyphenylpyruvate dioxygenase (HPPD) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 is likewise possible.

Some of the safeners are already known as herbicides and accordingly, in addition to the herbicidal action against harmful plants, also act by protecting the crop plants. The weight ratios of herbicide (mixture) to safener generally depend on the herbicide application rate and the effectiveness of the safener in question and may vary within wide limits, for example in the range from 200:1 to 1:200, preferably from 100:1 to 1:100, in particular from 20:1 to 1:20. The safeners may be formulated analogously to the compounds of the formula (I) or their mixtures with other herbicides/pesticides and be provided and used as a finished formulation or as a tank mix with the herbicides.

The required application rate of the N-(1,2,5-Oxadiazol-3yl)benzamides as defined above to areas where such transgenic plants containing one or more chimeric gene(s) (I) comprising a DNA sequence encoding hydroxyphenylpyruvate dioxygenase (HPPD) derived from a member of a group of organisms, consisting of (a) Avena, preferably Avena sativa, more preferably comprising a DNA sequence identical to SEQ ID No. 1 encoding HPPD defined by SEQ ID No. 2, (b) Pseudomonas, preferably Pseudomonas fluorescens, more preferably comprising a DNA sequence identical to SEQ ID No. 3 encoding HPPD defined by SEQ ID No. 4, (c) Synechococcoideae, preferably Synechococcus sp., more preferably comprising a DNA sequence identical to SEQ ID No. 6, encoding HPPD defined by SEQ ID No. 7, (d) Blepharismidae, preferably Blepharisma japonicum, more preferably comprising a DNA sequence identical to SEQ ID No. 8 encoding HPPD defined by SEQ ID No. 9, (e) Rhodococcus, preferably Rhodococcus sp. (strain RHA1), isolate ro03041 more preferably comprising a DNA sequence identical to SEQ ID No. 10 encoding HPPD defined by SEQ ID No. 11, or Rhodococcus sp. (strain RHA1), isolate ro02040, more preferably comprising a DNA sequence identical to SEQ ID No.12 encoding HPPD defined by SEQ ID No. 13, (f) Picrophilaceae, preferably Picrophilus torridus, more preferably comprising a DNA sequence identical to SEQ ID No. 14 encoding HPPD defined by SEQ ID No. 15, (g) Kordia, preferably Kordia algicida, more preferably comprising a DNA sequence identical to SEQ ID No. 16 encoding HPPD defined by SEQ ID No. 17 or (II) comprising one or more mutated DNA sequences of HPPD encoding genes of the before defined organisms, preferably mutants as described in WO 2010/085705, U.S. Pat. No. 6,245,968, WO 2009/144079, PCT/EP2010/070561, PCT/EP2010/070567, PCT/EP2010/070578, PCT/EP2010/070570, or PCT/EP2010/070575 varies depending, inter alia, on external conditions such as temperature, humidity and the type of herbicide used. It can vary within wide limits, for example between 0.001 and 10 000 g/ha or more of active substance; however, it is preferably between 0.5 and 5000 g/ha, particularly preferably between 0.5 and 1000 g/ha and very particularly preferably between 0.5 and 500 g/ha.

### SEQUENCES LISTING

SEQ ID No. 1: Nucleic acid sequence encoding Avena sativa HPPD optimized for the expression in E. coli cells
SEQ ID No. 2: Protein encoded by SEQ ID No. 1
SEQ ID No. 3: Nucleic acid sequence encoding Pseudomonas fluorescens HPPD mutated at position 336; mutation Gly=>Trp
SEQ ID No. 4: Protein encoded by SEQ ID No. 3
SEQ ID No. 5: Nucleic acid sequence encoding Pseudomonas fluorescens HPPD mutated at at position 336; mutation Gly=>Trp; optimized for the expression in soybean and cotton
SEQ ID No. 6: Nucleic acid sequence encoding Synechococcus sp. HPPD
SEQ ID No. 7: Protein encoded by SEQ ID No. 6
SEQ ID No. 8: Nucleic acid sequence encoding Blepharisma japonicum HPPD
SEQ ID No. 9: Protein encoded by SEQ ID No. 8
SEQ ID No. 10: Nucleic acid sequence encoding Rhodococcus sp. (strain RHA1), isolate ro03041 HPPD
SEQ ID No. 11: Protein encoded by SEQ ID No. 10
SEQ ID No. 12: Nucleic acid sequence encoding Rhodococcus sp. (strain RHA1), isolate ro02040 HPPD
SEQ ID No. 13: Protein encoded by SEQ ID No. 12
SEQ ID No. 14: Nucleic acid sequence encoding Picrophilus torridus HPPD
SEQ ID No. 15: Protein encoded by SEQ ID No. 14
SEQ ID No. 16: Nucleic acid sequence encoding Kordia algicida HPPD
SEQ ID No. 17: Protein encoded by SEQ ID No. 16
SEQ ID No. 18: Nucleic acid sequence encoding Synechococcus sp. HPPD optimized for the expression in soybean and cotton
SEQ ID No. 19: Nucleic acid sequence encoding Blepharisma japonicum HPPD optimized for the expression in soybean and cotton
SEQ ID No. 20: Nucleic acid sequence encoding Rhodococcus sp. (strain RHA1), isolate ro0341 HPPD optimized for the expression in soybean and cotton
SEQ ID No. 21: Nucleic acid sequence encoding Rhodococcus sp. (strain RHA1), isolate ro0240 HPPD optimized for the expression in soybean and cotton
SEQ ID No. 22: Nucleic acid sequence encoding Picropphilus torridus HPPD optimized for the expression in soybean and cotton
SEQ ID No. 23: Nucleic acid sequence encoding Kordia algicida HPPD optimized for the expression in soybean and cotton

The examples which follow illustrate the invention

I. Cloning of Specific Genes Coding for HPPDs from Various Organisms
A. Cloning of Avena HPPD (according WO02/46387)
A1—Cloning for Expression in E. coli Cells

cDNA coding for Avena sativa HPPD (AvHPPD; SEQ ID No. 1) was ordered at GeneArt (Regensburg, Germany) using the codon usage optimized for the expression of the gene in Escherichia coli cells. Upstream to the start codon ATG, was added the sequence corresponding to the recognition site of the restriction enzyme BamHI, and downstream to the stop codon was added the sequence stretch corresponding to the recognition site of the enzyme HindIII. The synthesized fragment was cloned using the restriction enzymes BamHI and HindIII in the previously opened vector pET32a (Novagen, Darmstadt, Germany), in order to obtain a fusion with the HisTag present in the vector at the N-Terminal extremity from the AvHPPD protein (SEQ ID No. 2). The resulting vector was named pET32a-AvHPPDe.

The protein was produced in E. coli and isolated following the standard protocol (as described for example in WO2009/144097).

A2—Cloning of the AvHPPD Gene in the pBin19 Binary Vector for Expression in Tobacco Plants

The cDNA corresponding to the gene coding for AvHPPD protein was cut out from the plasmid pET32a-AvHPPDe using the restriction enzymes NcoI and NotI. The overhang sequence resulting from the NotI restriction was filled up, and the consequent fragment was then cloned in the vector pRT100-OTPc (see for example Töpfer (1987), Nucleic Acids Res. 15: 5890, and PCT/EP2010/070561) previously restricted with the enzymes NcoI and SmaI. In this vector, the sequence coding for the AvHPPD was located downstream to the sequence corresponding to an optimized transit peptide responsible for the translocation of the protein to the chloroplast, itself downstream of the sequence corresponding to the CaMV 35S promoter (see for example WO2009/144097). The nucleotide sequence corresponding to the expression cassette CaMV35S-OTPc-AvHPPDe-³⁵S was restricted using the enzyme SbfI and further cloned into the previously opened vector pBin19 with the same enzyme. The resulting plasmid was named pBin19-CaMV35S-OTPc-AvHPPDe-35S, and was used to transform Agrobacterium tumefaciens strain ATHV (see for example PCT/EP2010/070561).

### B Cloning of PfHPPD-G336W

### B1—Cloning of PfHPPD-G336W for the Expression in E. Coli Cells

The gene coding for the mutant HPPD G336W (SEQ ID No. 3) (U.S. Pat. No. 6,245,968) from Pseudomonas fluorescens in the plasmid pKK233-2 (Clontech) (U.S. Pat. No. 6,245,968) was used as template for a PCR to add to the sequence at it 5′ extremity the sequence corresponding to the recognition site of the enzyme NcoI and at its 3′ extremity the sequence corresponding to the recognition site of the enzyme XbaI. (see WO 2009/144079). The cloning was made in order to obtain a His tag fusion protein at the N-terminal extremity of the Pseudomonas HPPD G336W (SEQ ID No. 4), named “pSE420(R1)NX-PfG336W”.

B2—Cloning of PfHPPD-G336W for the Expression in Tobacco Plants pFCO117

A binary vector for tobacco or soybean transformation is, for example, constructed with the CaMV35 promoter driving the expression of the gene PfHPPD-G336W (SEQ ID No 5), with a codon usage optimized for the expression in dicotyledoneous plants and at its 5′ extremity was added a sequence coding for an OTP, and further upstream a sequence TEV (Tobacco etch virus) to improve the stability of the mRNA in plants followed by the CaMV35S terminator. Additionally, the transformation vector also contains a PAT gene cassette in which the gene is driven by a CaVM35S promoter and followed by a CaMV35S terminator for glufosinate based selection during the transformation process and a 2mEPSPS gene cassette in which the gene is driven by an histone promoter from Arabidopsis to confer tolerance to the herbicide glyphosate to the transformed plants. The binary vector was called pFCO117.

C—Cloning of HPPD Obtained from Blepharisma and Kordia for Expression in E. Coli or in Tobacco Plants

These clonings were done as described in PCT/EP2010/070567 (Blepharisma japonicum, FMP37, Example 1, named “pSE420(R1)NX-FMP37”) and PCT/EP2010/070575 (Kordia algicida, FMP27, Example 1, named “pSE420(R1)NX-FMP27”).

D—Production of HPPD Protein in E Coli, Purification Via his-Tag

The Arabidopsis thaliana AtHPPD coding sequence (1335 bp; Genebank AF047834; WO 96/38567) was initially cloned into the expression vector pQE-30 (QIAGEN, Hilden, Germany) in between the restriction sites of BamHI and HindIII. The obtained vector was called “pQE30-AtHPPD” (see WO 2009/144079).

The plasmid possesses the trp-lac (trc) promoter and the lacl^{q} gene that provides the lac repressor in every E. coli host strain. The lac repressor binds to the lac operator (lacO) and restricts expression of the target gene; this inhibition can be alleviated by induction with Isopropyl δ-D-1-thiogalactopyranoside (IPTG).

All above defined E. coli expression vectors were used to transform Escherichia coli BL21 cells (Merck, Darmstadt, Germany).

For the AtHPPD (Arabidopsis thaliana HPPD) that was used as reference see WO 2009/144079.

Expression of HPPD was carried out in E. coli K-12 BL21 containing pQE30-AtHPPD, pET32a-AvHPPDe or pSE420(RI)NX-FMP27 or pSE420(RI)NX-FMP37. Cells were allowed to grow until OD reached 0.5, then expression was initiated from the trp-lac (trc) promoter by induction with 1 mM IPTG which binds to the lac repressor and causes its dissociation from the lac operon. Expression was carried out over 15 h at 28° C.

To prepare the pre-starter culture, 2 mL of TB medium (100 μg*mL⁻¹ carbenicillin) were inoculated with 50 μL of an E. coli K-12 BL21 glycerol stock. The pre-starter culture was incubated at 37° C. with shaking at 140 rpm for 15 h. 200 μl of the pre-starter culture was used to initiate the starter culture (5 mL TB supplement with 100 μg*L⁻¹), which was incubated 3 h at 37° C.

To prepare the main culture, 400 mL of TB medium (100 μg*mL⁻¹ carbenicillin) were inoculated with 4 mL of the starter culture. This starter culture was incubated at 37° C. with shaking at 140 rpm until OD₆₀₀ 0.5 was reached. Then recombinant protein expression was induced with 400 μl of 1M IPTG solution. The cells were allowed to grow for an additional hour under these conditions, then the temperature was lowered to 28° C. and the culture was shaken at 140 rpm for 15 h. Cells were harvested by centrifugation at 6000×g for 15 min at 4° C. Then cell pellets were stored at −80° C.

Isolation and purification of His₆-AtHPPD, His6-AvHPPD, PfHPPD-G336W, His₆-FMP27 and His₆-FMP37 in native form

### Lysis of Cells

Cells were lysed using Lysozyme, an enzyme that cleaves the 1,4-β-linkages between N-acetylmuramic acid and N-acetyl-D-glucosamine residues in peptidoglycan which forms the bacterial cell wall. Cell membranes were then disrupted by the internal pressure of the bacterial cell. In addition, the lysis buffer contained Benzonase® Nuclease, an endonuclease that hydrolyzes all forms of DNA and RNA without damaging proteins and thereby largely reduces viscosity of the cell lysate. Lysis under native conditions was carried out on ice.

For purification of His₆-tagged proteins the QIAexpress® Ni-NTA Fast Start Kit was used following the user manual instruction.

Purification of his₆-Tagged Proteins by Immobilized Metal Ion Affinity Chromatography (IMAC)

The cleared cell lysate (10 mL) obtained after centrifugation of the lysis reaction was loaded onto a Ni-NTA Fast Start Column from the QIAexpress® Ni-NTA Fast Start Kit (Qiagen, Hilden, Germany) and purification was carried out according to the instruction manual. The His₆-tagged protein was eluted with 2.5 mL of elution buffer.

### Desalting of HPPD Solutions by Gel Filtration

HPPD solutions eluted from a Ni-NTA Fast Start Column with 2.5 mL of elution buffer were applied to a Sephadex G-25 PD-10 column (GE Healthcare, Freiburg, Germany) following the user manual instruction. After the whole sample had entered the gel bed, elution was performed with 3.5 mL of storage buffer. The HPPD solutions eluted from the desalting column were frozen at −80° C. in 1 mL aliquots.

Determination of HPPD protein concentration using the Bradford protein assay Protein concentration was determined using the standard Bradford assay (Bradford, (1976), Anal Biochem 72: 248-254).

Determination of purity of HPPD solutions using SDS-PAGE

The integrity of the eluted protein was checked by SDS-PAGE protein gel electrophoresis using the gel NuPAGE® Novex 4-12% Bis-Tris Gels (Invitrogen, Karlsruhe, Germany), approximately 10 μg of protein were loaded. 10 μL of Laemmli Sample Buffer was added to 1-10 μL of protein solution and the mixture was incubated at 90° C. for 10 min. After short centrifugation step, the whole mixture was loaded into a slot of an SDS gel previously fixed in a XCell SureLock™ Novex Mini-Cell gel chamber filled with NuPAGE® MOPS SDS Running Buffer (diluted from the 20×-solution with ddH₂O). A voltage of 150 was then applied to the gel chamber for 1 h. For staining of protein bands, the gel was immersed in Coomassie Brilliant Blue R-250 Staining Solution. For destaining of the polyacrylamide gel, it was immersed in Coomassie Brilliant Blue R-250 Destaining Solution until protein bands appear blue on a white gel.

Evaluation of Tolerance to HPPD Inhibitors of HPPD Enzymes

The HPPD activity was checked by the standard spectrophotmetric assay (method extensively described in WO 2009/144079)

### E—Evaluation of Tolerance to Several HPPD Inhibitor Herbicides

Determination of HPPD activity in presence of several HPPD inhibitors

Level of tolerance of HPPD proteins obtained from different organisms was determined according to the procedure as described in PCT/EP2010/070575.

On the below Table E1, it can be clearly seen, that the HPPDs obtained from Kordia algicida (FMP27), Blepharisma japonicum (FMP37) showed superior level of tolerance to N-(1,2,5-oxadiazol-3-yl)benzamides than the Arabidopsis thaliana HPPD (AtHPPD) under identical experimental conditions.

Table E1: Determination of percentage of inhibition in presence of 5.0×10⁻⁶M of Compound “1-56” compared to the activity measured in absence of Compound No. “1-56” with HPPD originated from Arabidopsis thaliana (AtHPPD), FMP27 (derived from Kordia algicida) and FMP37 (derived from Blepharisma japonicum).

### E1 Compound “1-56”

| Protein | Inihibition % |
|---|---|
| AtHPPD | 90 |
| FMP27 | 85 |
| FMP37 | 79 |

These data show that the HPPD derived from Kordia algicida and Blepharisma japonicum is less sensitive to N-(1,2,5-oxadiazol-3-yl)benzamides compared to the inhibition observed with the HPPD derived from Arabidopsis thaliana, as shown for Compound “1-56”.

### F—Evaluation of Tolerance to HPPD Inhibitors of Tobacco Plants Expressing Tolerant HPPD Enzymes

Genes coding for the selected HPPD were obtained from a member of the group of organisms consisting of Avena sativa, Pseudomonas fluorescens mutant G336W, Blepharisma japonicum and Kordia algicida and cloned into the binary vector pBin19 allowing the integration of DNA into the tobacco genome, under the control of the CaMV35S promoter. For the cloning procedures, see A2 above for Avena sativa, see B2 above for Pseudomonas fluorescens, mutant G336W, see PCT/EP2010/070567, Example 5; for Blepharisma japonicum (FMP37) and see PCT/EP2010/070575, Example 5 for Kordia algicida (FMP27).

Between the sequence corresponding to the promoter and the sequence coding for the HPPD was inserted a DNA sequence coding for a transit peptide to the chloroplast, in order to add at the N-terminal extremity of the protein a target signal to allow the localization of the HPPD protein into the plant chloroplast. Seeds harvested from TO transformants will be put on standard soil for germination. Three weeks later plantlets will be transferred to single pots and grown under standard cultivation conditions (PCT/EP2010/070575). Two weeks later plants we be sprayed with several N-(1,2,5-oxadiazol-3-yl)benzamides whose phenyl ring is substituted in the 2-, 3- and 4-position by selected radicals as defined above.

One week later, the symptoms due to the application of the herbicides will be evaluated.

1. An N-(1,2,5-oxadiazol-3-yl)benzamide of formula (I) and/or a salt thereof, 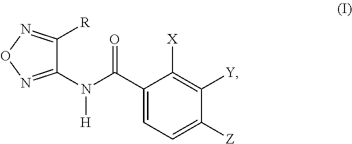
capable of being used for controlling an unwanted plant in an area of a transgenic crop plant being tolerant to an HPPD inhibitor herbicide by containing at least one chimeric gene comprising
(I) a DNA sequence encoding hydroxyphenylpyruvate dioxygenase (HPPD) derived from at least one member of a group of organisms comprising (a) Avena, (b) Pseudomonas, (c) Synechococcoideae, (d) Blepharismidae, (e) Rhodococcus, (f) Picrophilaceae, and/or (g) Kordia, or
(II) comprising at least one mutated DNA sequence of HPPD encoding genes of the before defined group of organisms
in which
R is hydrogen, (C₁-C₆)-alkyl, (C₃-C₇)-cycloalkyl, halo-(C₁-C₆)-alkyl, (C₁-C₆)-alkoxy, halo-(C₁-C₆)-alkoxy, (C₂-C₆)-alkenyl, (C₂-C₆)-alkenyloxy, (C₂-C₆)-haloalkenyl, (C₂-C₆)-alkynyl, (C₂-C₆)-alkynyloxy, (C₂-C₆)-haloalkynyl, cyano, nitro, methylsulfenyl, methylsulfinyl, methylsulfonyl, acetylamino, benzoylamino, methoxycarbonyl, ethoxycarbonyl, methoxycarbonylmethyl, ethoxycarbonylmethyl, benzoyl, methylcarbonyl, piperidinylcarbonyl, trifluoromethylcarbonyl, halogen, amino, aminocarbonyl, methyl-aminocarbonyl, dimethylaminocarbonyl, methoxymethyl or heteroaryl, heterocyclyl or phenyl, each of which is substituted by s radicals selected from the group consisting of methyl, ethyl, methoxy, trifluoromethyl and halogen,
X and Z independently of one another are in each case nitro, halogen, cyano, formyl, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, OR¹, OCOR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², NR₁R₂, P(O)(OR⁵)₂, or heteroaryl, heterocyclyl or phenyl, each of which is substituted by at least one s radical selected from the group consisting of methyl, ethyl, methoxy, nitro, trifluoromethyl and halogen,
Y is nitro, halogen, cyano, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cyclo alkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, CO₂R¹, OR¹, OCOR¹, OSO₂R², S(O)ₙR², SO₂OR¹, SO₂N(R¹)₂, NR¹SO₂R², NR¹COR¹, (C₁-C₆)-alkyl-heteroaryl, O—(C₁-C₆)-alkyl-heterocyclyl, O—(C₁-C₆)-alkyl-heteroaryl, (C₁-C₆)-alkyl-heterocyclyl, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-CN, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², NR¹R², P(O)(OR⁵)₂, tetrahydrofuranyloxymethyl, tetrahydrofuranylmethoxymethyl, O(CH₂)-3,5-dimethyl-1,2-oxazol-4-yl, O(CH₂)₂—O(3,5-dimethoxypyrimidin-2-yl, O(CH₂)-5-pyrrolidin-2-one, O(CH₂)-5-2,4-dimethyl-2,4-dihydro-3H-1,2,4-triazol-3-one, or heteroaryl or heterocyclyl, each of which is substituted by at least one s radical selected from the group consisting of methyl, ethyl, methoxy, halogen and cyanomethyl,
R¹ is hydrogen, (C₁-C₆)-alkyl, (C₁-C₆)-haloalkyl, (C₂-C₆)-alkenyl, (C₂-C₆)-haloalkenyl, (C₂-C₆)-alkynyl, (C₂-C₆)-haloalkynyl, (C₃-C₆)-cycloalkyl, (C₃-C₆)-halocycloalkyl, (C₁-C₆)-alkyl-O—(C₁-C₆)-alkyl, (C₃-C₆)-cycloalkyl-(C₁-C₆)-alkyl, phenyl or phenyl-(C₁-C₆)-alkyl, where the 12 last-mentioned radicals are substituted by at least one s radical selected from the group consisting of cyano, halogen, nitro, rhodano, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R² is (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by at least one s radical selected from the group consisting of cyano, halogen, nitro, thiocyanato, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R³ is hydrogen, (C₁-C₆)-alkyl, (C₂-C₆)-alkenyl or (C₂-C₆)-alkynyl,
R⁴ is (C₁-C₆)-alkyl, (C₂-C₆)-alkenyl or (C₂-C₆)-alkynyl,
R⁵ is methyl or ethyl,
n is 0, 1 or 2,
s is 0, 1, 2 or 3.

2. An N-(1,2,5-oxadiazol-3-yl)benzamide of formula (I) and/or a salt thereof according to claim 1, where, in formula (I)
R is hydrogen, (C₁-C₆)-alkyl, (C₃-C₇)-cycloalkyl, halo-(C₁-C₆)-alkyl, (C₁-C₆)-alkoxy, halo-(C₁-C₆)-alkoxy, cyano, nitro, methylsulfenyl, methylsulfinyl, methylsulfonyl, acetylamino, benzoylamino, methoxycarbonyl, ethoxycarbonyl, benzoyl, methylcarbonyl, piperidinylcarbonyl, trifluoromethylcarbonyl, halogen, amino, aminocarbonyl, methylaminocarbonyl, dimethylaminocarbonyl, methoxymethyl, a heterocycle selected from the group consisting of pyridin-2-yl, pyridin-3-yl, pyridin-4-yl, piperidin-2-yl, piperidin-3-yl, piperidin-4-yl, benzisoxazol-2-yl, 1,2,4-oxadiazol-3-yl, 1,2,4-triazol-3-yl, 1-ethylbenzimidazol-2-yl, 4-methylthiazol-2-yl, thiophen-2-yl, furan-2-yl, furan-3-yl, tetrahydrofuran-2-yl, tetrahydrofuran-3-yl, isoxazol-2-yl, isoxazol-3-yl, oxazol-2-yl, oxazol-3-yl, pyrrol-2-yl, pyrrol-3-yl, imidazol-2-yl, imidazol-5-yl, imidazol-4-yl, pyrazol-3-yl, pyrazol-5-yl, pyrazol-4-yl, isoxazol-3-yl, isoxazol-4-yl, isoxazol-5-yl, oxazol-2-yl, oxazol-4-yl, oxazol-5-yl, isothiazol-3-yl, isothiazol-4-yl, isothiazol-5-yl, thiazol-2-yl, thiazol-4-yl, thiazol-5-yl, 1,2,3-triazol-4-yl, 1,2,3-triazol-5-yl, 1,2,5-triazol-3-yl, 1,3,4-triazol-2-yl, 1,2,4-triazol-3-yl, 1,2,4-triazol-5-yl, 1,2,4-oxadiazol-3-yl, 1,2,4-oxadiazol-5-yl, 1,3,4-oxadiazol-2-yl, 1,2,3-oxadiazol-4-yl, 1,2,3-oxadiazol-5-yl, 1,2,5-oxadiazol-3-yl, 1,2,4-thiadiazol-3-yl, 1,2,4-thiadiazol-5-yl, 1,3,4-thiadiazol-2-yl, 1,2,3-thiadiazol-4-yl, 1,2,3-thiadiazol-5-yl, 1,2,5-thiadiazol-3-yl, 2H-1,2,3,4-tetrazol-5-yl, 1H-1,2,3,4-tetrazol-1-yl, 1,2,3,4-oxatriazol-5-yl, 1,2,3,5-ox atriazol-4-yl, 1,2,3,4-thiatriazol-5-yl, 1,2,3,5-thiatriazol-4-yl, pyrazin-2-yl, pyrazin-3-yl, pyrimidin-2-yl, pyrimidin-4-yl, pyrimidin-5-yl, pyridazin-3-yl and pyridazin-4-yl, which heterocycle is substituted by at least one s radical selected from the group consisting of methyl, methoxy, trifluoromethyl and halogen, or phenyl which is substituted by at least one s radical selected from the group consisting of methyl, methoxy, trifluoromethyl and halogen,
X and Z independently of each other are in each case nitro, halogen, cyano, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, OR¹, COR¹, OSO₂R², S(O)₂R², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², benzoxazol-2-yl, 1-ethylbenzimidazol-2-yl, piperidin-1-yl or 1,2,4-triazol-1-yl,
Y is nitro, halogen, cyano, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cyclo alkyl, (C₃-C₆)-halocycloalkyl, (C₁₋₃—C₆)-cycloalkyl-(C₁-C₆)-alkyl, (C₁₋₃—C₆)-halocycloalkyl-(C₁-C₆)-alkyl, COR¹, OR¹, OCOR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², tetrahydrofuranyloxymethyl, tetrahydrofuranylmethoxymethyl, O(CH₂)-3,5-dimethyl-1,2-oxazol-4-yl, O(CH₂)₂—O(3,5-dimethoxypyrimidin-2-yl, O(CH₂)-5-pyrrolidin-2-one or O(CH₂)-5-2,4-dimethyl-2,4-dihydro-3H-1,2,4-triazol-3-one,
R¹ is hydrogen, (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by at least one s radical selected from the group consisting of cyano, halogen, nitro, thiocyanato, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R² is (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by at least one s radical selected from the group consisting of cyano, halogen, nitro, thiocyanato, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R³ is hydrogen, (C₁-C₆)-alkyl, (C₂-C₆)-alkenyl or (C₂-C₆)-alkynyl,
R⁴ is (C₁-C₆)-alkyl, (C₂-C₆)-alkenyl or (C₂-C₆)-alkynyl,
n is 0, 1 or 2,
s is 0, 1, 2 or 3.

3. An N-(1,2,5-oxadiazol-3-yl)benzamide of formula (I) or a salt thereof according to claim 1, where, in formula (I)
R is hydrogen, (C₁-C₆)-alkyl, (C₃-C₇)-cycloalkyl, halo-(C₁-C₆)-alkyl, (C₁-C₆)-alkoxy, halo-(C₁-C₆)-alkoxy, cyano, nitro, methylsulfenyl, methylsulfinyl, methylsulfonyl, acetylamino, benzoylamino, methoxycarbonyl, ethoxycarbonyl, benzoyl, methylcarbonyl, piperidinylcarbonyl, trifluoromethylcarbonyl, halogen, amino, aminocarbonyl, methylaminocarbonyl, dimethylaminocarbonyl, methoxymethyl, a heterocycle selected from the group consisting of pyridin-2-yl, pyridin-3-yl, pyridin-4-yl, piperidin-2-yl, piperidin-3-yl, piperidin-4-yl, benzisoxazol-2-yl, 1,2,4-oxadiazol-3-yl, 1,2,4-triazol-3-yl, 1-ethylbenzimidazol-2-yl, 4-methylthiazol-2-yl, thiophen-2-yl, furan-2-yl, furan-3-yl, tetrahydrofuran-2-yl, tetrahydrofuran-3-yl, isoxazol-2-yl, isoxazol-3-yl, oxazol-2-yl, oxazol-3-yl, pyrrol-2-yl, pyrrol-3-yl, imidazol-2-yl, imidazol-5-yl, imidazol-4-yl, pyrazol-3-yl, pyrazol-5-yl, pyrazol-4-yl, isoxazol-3-yl, isoxazol-4-yl, isoxazol-5-yl, oxazol-2-yl, oxazol-4-yl, oxazol-5-yl, isothiazol-3-yl, isothiazol-4-yl, isothiazol-5-yl, thiazol-2-yl, thiazol-4-yl, thiazol-5-yl, 1,2,3-triazol-4-yl, 1,2,3-triazol-5-yl, 1,2,5-triazol-3-yl, 1,3,4-triazol-2-yl, 1,2,4-triazol-3-yl, 1,2,4-triazol-5-yl, 1,2,4-oxadiazol-3-yl, 1,2,4-oxadiazol-5-yl, 1,3,4-oxadiazol-2-yl, 1,2,3-oxadiazol-4-yl, 1,2,3-oxadiazol-5-yl, 1,2,5-oxadiazol-3-yl, 1,2,4-thiadiazol-3-yl, 1,2,4-thiadiazol-5-yl, 1,3,4-thiadiazol-2-yl, 1,2,3-thiadiazol-4-yl, 1,2,3-thiadiazol-5-yl, 1,2,5-thiadiazol-3-yl, 2H-1,2,3,4-tetrazol-5-yl, 1H-1,2,3,4-tetrazol-1-yl, 1,2,3,4-oxatriazol-5-yl, 1,2,3,5-oxatriazol-4-yl, 1,2,3,4-thiatriazol-5-yl, 1,2,3,5-thiatriazol-4-yl, pyrazin-2-yl, pyrazin-3-yl, pyrimidin-2-yl, pyrimidin-4-yl, pyrimidin-5-yl, pyridazin-3-yl and pyridazin-4-yl, which heterocycle is substituted by at least one s radical selected from the group consisting of methyl, methoxy, trifluoromethyl and halogen, or phenyl which is substituted by at least one s radical selected from the group consisting of methyl, methoxy, trifluoromethyl and halogen,
X and Z independently of each other are in each case nitro, halogen, cyano, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, OR¹, COR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², benzoxazol-2-yl, 1-ethylbenzimidazol-2-yl, piperidin-1-yl or 1,2,4-triazol-1-yl,
Y is nitro, halogen, cyano, rhodano, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, OR¹, OCOR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R², tetrahydrofuranyloxymethyl, tetrahydrofuranylmethoxymethyl, O(CH₂)-3,5-dimethyl-1,2-oxazol-4-yl, O(CH₂)₂—O(3,5-dimethoxypyrimidin-2-yl, O(CH₂)-5-pyrrolidin-2-one or O(CH₂)-5-2,4-dimethyl-2,4-dihydro-3H-1,2,4-triazol-3-one,
R¹ is hydrogen, (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by at least one s radical selected from the group consisting of cyano, halogen, nitro, thiocyanato, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R² is (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by at least one s radical selected from the group consisting of cyano, halogen, nitro, thiocyanato, OR³, S(O)ₙR⁴, N(R³)₂, NR³OR³, COR³, OCOR³, SCOR³, NR³COR³, CO₂R³, COSR³, CON(R³)₂ and (C₁-C₄)-alkoxy-(C₂-C₆)-alkoxycarbonyl,
R³ is hydrogen, (C₁-C₆)-alkyl, (C₂-C₆)-alkenyl or (C₂-C₆)-alkynyl,
R⁴ is (C₁-C₆)-alkyl, (C₂-C₆)-alkenyl or (C₂-C₆)-alkynyl,
n is 0, 1 or 2,
s is 0, 1, 2 or 3

4. An N-(1,2,5-oxadiazol-3-yl)benzamide of formula (I) and/or a salt thereof as claimed in claim 1, where, in formula (I)
R is hydrogen, (C₁-C₆)-alkyl, (C₃-C₇)-cycloalkyl, halo-(C₁-C₆)-alkyl, (C₁-C₆)-alkoxy, halogen-(C₁-C₆)-alkoxy, cyano, nitro, methylsulfenyl, methylsulfinyl, methylsulfonyl, acetylamino, benzoylamino, methoxycarbonyl, ethoxycarbonyl, benzoyl, methylcarbonyl, piperidinylcarbonyl, trifluoromethylcarbonyl, halogen, amino, aminocarbonyl, methylaminocarbonyl, dimethylaminocarbonyl, methoxymethyl,
X and Z independently of one another are in each case nitro, halogen, cyano, (C₁-C₆)-alkyl, (C₁-C₆)-haloalkyl, (C₃-C₆)-cycloalkyl, OR¹, S(O)ₙR², (C₁-C₆)-alkyl-S(O)ₙR², (C₁-C₆)-alkyl-OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R² or 1,2,4-triazol-1-yl,
Y is S(O)ₙR², 4,5-dihydro-1,2-oxazol-3-yl, 5-cyanomethyl-4,5-dihydro-1,2-oxazol-3-yl or 5-methoxymethyl-4,5-dihydro-1,2-oxazol-3-yl,
R¹ is hydrogen, (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl, phenyl or phenyl-(C₁-C₆)-alkyl, where the seven last-mentioned radicals are substituted by at least one s radical selected from the group consisting of halogen and OR³,
R² is (C₁-C₆)-alkyl, (C₃-C₆)-cycloalkyl or (C₃-C₆)-cycloalkyl-(C₁-C₆)-alkyl, where the three last-mentioned radicals are substituted by at least one s radical selected from the group consisting of halogen and OR³,
R³ is hydrogen or (C₁-C₆)-alkyl,
n is 0, 1 or 2,
s is 0, 1, 2 or 3.

5. A method for controlling an unwanted plant comprising of applying at least N (1,2,5-oxadiazol-3-yl)benzamide and/or salt thereof according to claim 1 in an area of a transgenic crop plant being tolerant to a HPPD inhibitor herbicide by containing at least one chimeric gene comprising (I) a DNA sequence encoding hydroxyphenylpyruvate dioxygenase (HPPD) derived from at least one member of a group of organisms comprising (a) Avena, (b) Pseudomonas, (c) Synechococcoideae, (d) Blepharismidae, (e) Rhodococcus, (f) Picrophilaceae, and/or (g) Kordia, or comprising (II) at least one mutated DNA sequence of an HPPD encoding gene of the before defined group of organisms, and in which said applying is performed to (a) an unwanted plant, (b) to a seed of an unwanted plant, and/or (c) to an area on which a plant grows.

6. A method according to claim 5, in which the transgenic crop plant belongs to a group of dicotyledonous crops comprising Arachis, Beta, Brassica, Cucumis, Cucurbita, Helianthus, Daucus, Glycine, Gossypium, Ipomoea, Lactuca, Linum, Lycopersicon, Nicotiana, Phaseolus, Pisum, Solanum, and/or Vicia, and/or to a group of monocotyledonous crops consisting of comprising Allium, Ananas, Asparagus, Avena, Hordeum, Oryza, Panicum, Saccharum, Secale, Sorghum, Triticale, Triticum, and/or Zea.

7. A method according to claim 5., in which at least one one N-(1,2,5-oxadiazol-3-yl)benzamide is applied in combination with at least one HPPD inhibitor herbicide comprising triketone and/or pyrazolinate herbicide in a mixed formulation and/or in a tank mix, and/or with a further known active substance which is based on inhibition of acetolactate synthase, acetyl-CoA carboxylase, cellulose synthase, enolpyruvylshikimate-3-phosphate synthase, glutamine synthetase, p-hydroxyphenylpyruvate dioxygenase, phytoene desaturase, photosystem I, photosystem II, and/or protoporphyrinogen oxidase, and/or acts as a growth regulator.

8. A method according to claim 7, in which at least one N-(1,2,5-oxadiazol-3-yl)benzamide is applied in combination with at least one HPPD inhibitor herbicide selected from the group consisting of tembotrione, mesotrione, bicyclopyrone, tefuryltrione pyrasulfotole, pyrazolate, diketonitrile, benzofenap, and sulcotrione,

9. A method according to claim 6, in which at least one N-(1,2,5-oxadiazol-3-yl)benzamide and/or salt thereof is applied in combination with at least one HPPD inhibitor herbicide comprising triketone or pyrazolinate herbicide in a mixed formulation and/or in a tank mix, and/or with a further known active substance which is based on inhibition of acetolactate synthase, acetyl-CoA carboxylase, cellulose synthase, enolpyruvylshikimate-3-phosphate synthase, glutamine synthetase, p-hydroxyphenylpyruvate dioxygenase, phytoene desaturase, photosystem I, photosystem II, and/or protoporphyrinogen oxidase, and/or acts as a growth regulator.


SEQUENCE LISTING (23 sequences)

SEQ ID NO: 1 - DNA, 1323 bp, Artificial Sequence
  Nucleic acid sequence encoding Avena sativa HPPD optimized for the expression in Escherichia coli cells
atgcctccgacaccggcaacagcaaccggtgcagcagcagcagccgttacaccggaacatgcagcacgtagctttccgcgtgttgttcgtgttaatccgcgtagcgatcgttttccggttctgagctttcatcatgttgaactgtggtgtgcagatgcagcaagcgcagcaggtcgttttagctttgcactgggtgcacctctggcagcacgttctgatctgagcaccggtaatagcgcacatgcaagcctgctgctgcgtagcggtgcactggcatttctgtttaccgctccgtatgcacctcctccgcaggaagcagcaaccgcagccgcaaccgcaagcattccgagctttagcgcagatgcagcccgtacctttgcagcagcacatggcctggcagttcgtagcgttggtgttcgtgttgcagatgccgcagaagcatttcgcgttagcgttgcgggaggtgcacgtcctgcatttgcaccggcagatctgggtcatggttttggtctggcagaagttgaactgtacggcgatgttgttctgcgttttgttagctatccggatgaaaccgatctgccgtttctgcctggttttgaacgtgttagctctccgggtgcagttgattatggtctgacccgttttgatcatgttgttggcaatgttccggaaatggcaccggttattgattatatgaaaggctttctgggctttcatgaatttgcagaatttaccgcagaagatgttggcaccaccgaaagcggtctgaatagcgttgttctggccaataatagcgaagcagttctgctgccgctgaatgaaccggtgcatggcaccaaacgtcgtagccagattcagacctatctggaatatcatggtggtccgggtgttcagcatattgcactggcaagcaatgatgttctgcgtaccctgcgtgaaatgcgtgcacgtaccccgatgggtggttttgaatttatggcacctccgcaggcaaaatattatgaaggtgtgcgtcgtattgccggtgatgttctgagcgaagagcagattaaagaatgccaggaactgggcgttctggttgatcgtgatgatcagggtgttctgctgcagatttttaccaaaccggttggtgatcgtccgaccttttttctggaaatgattcagcgtattggctgcatggaaaaagatgaagtgggtcaggaatatcagaaaggcggttgtggtggttttggtaaaggcaattttagcgaactgtttaaaagcattgaagattatgaaaaaagcctggaagttaaacagagcgttgttgcccagaaaagctaa

SEQ ID NO: 2 - protein, 440 aa, Avena sativa
MPPTPATATGAAAAAVTPEHAARSFPRVVRVNPRSDRFPVLSFHHVELWCADAASAAGRFSFALGAPLAARSDLSTGNSAHASLLLRSGALAFLFTAPYAPPPQEAATAAATASIPSFSADAARTFAAAHGLAVRSVGVRVADAAEAFRVSVAGGARPAFAPADLGHGFGLAEVELYGDVVLRFVSYPDETDLPFLPGFERVSSPGAVDYGLTRFDHVVGNVPEMAPVIDYMKGFLGFHEFAEFTAEDVGTTESGLNSVVLANNSEAVLLPLNEPVHGTKRRSQIQTYLEYHGGPGVQHIALASNDVLRTLREMRARTPMGGFEFMAPPQAKYYEGVRRIAGDVLSEEQIKECQELGVLVDRDDQGVLLQIFTKPVGDRPTFFLEMIQRIGCMEKDEVGQEYQKGGCGGFGKGNFSELFKSIEDYEKSLEVKQSVVAQKS

SEQ ID NO: 3 - DNA, 1077 bp, Pseudomonas fluorescens
  misc_feature (1006)..(1008): GGT codon  is replaced by codon TGG
atggcagatctatacgaaaacccaatgggcctgatgggctttgaattcatcgaattcgcgtcgccgacgccgggtaccctggagccgatcttcgagatcatgggcttcaccaaagtcgcgacccaccgttccaagaacgtgcacctgtaccgccagggcgagatcaacctgatcctcaacaacgagcccaacagcatcgcctcctactttgcggccgaacacggcccgtcggtgtgcggcatggcgttccgcgtgaaggactcgcaaaaggcctacaaccgcgccctggaactcggcgcccagccgatccatattgacaccgggccgatggaattgaacctgccggcgatcaagggcatcggcggcgcgccgttgtacctgatcgaccgtttcggcgaaggcagctcgatctacgacatcgacttcgtgtacctcgaaggtgtggagcgcaatccggtcggtgcaggtctcaaagtcatcgaccacctgacccacaacgtctatcgcggccgcatggtctactgggccaacttctacgagaaattgttcaacttccgtgaagcgcgttacttcgatatcaagggcgagtacaccggcctgacttccaaggccatgagtgcgccggacggcatgatccgcatcccgctgaacgaagagtcgtccaagggcgcggggcagatcgaagagttcctgatgcagttcaacggcgaaggcatccagcacgtggcgttcctcaccgacgacctggtcaagacctgggacgcgttgaagaaaatcggcatgcgcttcatgaccgcgccgccagacacttattacgaaatgctcgaaggccgcctgcctgaccacggcgagccggtggatcaactgcaggcacgcggtatcctgctggacggatcttccgtggaaggcgacaaacgcctgctgctgcagatcttctcggaaaccctgatgggcccggtgttcttcgaattcatccagcgcaagggcgacgatgggtttggcgagtggaacttcaaggcgctgttcgagtccatcgaacgtgaccaggtgcgtcgtggtgtattgaccgccgattaa

SEQ ID NO: 4 - protein, 358 aa, Pseudomonas fluorescens
  MISC_FEATURE (336)..(336): Gly replaced by Trp
MADLYENPMGLMGFEFIEFASPTPGTLEPIFEIMGFTKVATHRSKNVHLYRQGEINLILNNEPNSIASYFAAEHGPSVCGMAFRVKDSQKAYNRALELGAQPIHIDTGPMELNLPAIKGIGGAPLYLIDRFGEGSSIYDIDFVYLEGVERNPVGAGLKVIDHLTHNVYRGRMVYWANFYEKLFNFREARYFDIKGEYTGLTSKAMSAPDGMIRIPLNEESSKGAGQIEEFLMQFNGEGIQHVAFLTDDLVKTWDALKKIGMRFMTAPPDTYYEMLEGRLPDHGEPVDQLQARGILLDGSSVEGDKRLLLQIFSETLMGPVFFEFIQRKGDDGFGEWNFKALFESIERDQVRRGVLTAD

SEQ ID NO: 5 - DNA, 1077 bp, Artificial Sequence
  Nucleic acid sequence encoding Pseudomonas fluorescens HPPD mutated at the position 336 (Gly to Trp ) optimized for the expression in soybean and cotton
atggctgatctttatgagaaccctatgggtcttatgggcttcgagtttattgagttcgcttctcctacccctggtactcttgaacctattttcgagatcatgggcttcactaaggttgcaactcacaggtctaagaacgttcacctttacaggcagggtgagatcaaccttatccttaacaacgagcctaactccattgcttcttatttcgctgctgagcatggtccatctgtttgcggtatggctttcagagttaaggattctcagaaggcttacaacagggctcttgaacttggtgctcagcctattcatattgataccggacctatggaactcaaccttcctgctattaagggtattggtggtgctcctctttaccttattgatagattcggtgagggctcctccatctacgatattgatttcgtttaccttgagggcgttgagagaaaccctgttggtgctggtcttaaggttatcgatcaccttacccacaacgtttacagaggtaggatggtttactgggctaacttctacgagaagttgttcaacttcagagaggctcgttacttcgatattaagggcgagtacactggtcttacctctaaggctatgtctgctcctgatggtatgatcaggattcctcttaacgaagagtcctctaagggtgctggtcaaattgaagagttcctcatgcaattcaacggtgagggtattcagcatgttgctttcttgaccgatgaccttgttaagacttgggacgctcttaagaaaatcggcatgcgtttcatgactgctcctccagatacttactacgaaatgcttgagggtaggcttcctgatcatggtgaacctgttgatcaacttcaggctaggggtattcttcttgatggttcttctgttgagggcgataagaggcttttgcttcagattttctccgagactcttatgggtcctgtgttcttcgagttcattcagagaaagggtgatgatggtttcggtgaatggaacttcaaggctcttttcgagtccattgagagggatcaagttagaaggggtgttcttaccgctgattaa

SEQ ID NO: 6 - DNA, 1053 bp, Synechococcus sp.
atgaacccgtccattcgaattgtccaagggatccaccacctgcacttctacctttgggatctgccccgttggcgggaacacttttgtcgggtttggggcttccgggtggcaagcgacgccggcaacaccctggagctggagcagggatccctgcgcttgcgcctgtctcagccggcacgggcgggggacgaggtggaccgccatttgcagcggcatgggccgggggtggtggatgtggccttggcggtgggagagcaggagctaccggccttggcggagctgttgcggggccgaggcgcccaactggcgtggatcccggcagcagcggcgctctgcctccacaccccctacgggatccggcattctctgatccctggccccttggatgccgcccctgccgaagcgggcctgttttcccactgggatcacgtggtgttgaacgtggagcagggatccctgcaggcggcagccgactggtatgggcgggtgctgggctggcggcggctgtaccgctacagcatcggcaccgccacctccggcctggaaagcgtggtggtgggggatccggaagcggggatccaatgggccatcaacgagcccacctgtgccgcttcccagattcaggagtttttgcatgcccatggcggcccgggcattcagcacgcggcgctgcacagctcagacattgttgccagcctgcgccggttgcggcaggggggagtggactttttgcaagtggcgccgcagtactacaccagcctggaaagggagctggggttggcgctccgttctgcccttgggcaggccatctcctggcaagacctggtggagcagcagatccttctggatgctaccctgcccgcttctgatggccaggatcgcccccttctgctgcagacctttacccagcccctctttggtcggcccacctttttctttgaagtcattcaacggctaggcggggccacgggctttggcgaggccaattttcaggctttgttcgaggccctggaacggcaacagcgacagcgacaccaggcgctgaccccttag

SEQ ID NO: 7 - protein, 350 aa, Synechococcus sp.
MNPSIRIVQGIHHLHFYLWDLPRWREHFCRVWGFRVASDAGNTLELEQGSLRLRLSQPARAGDEVDRHLQRHGPGVVDVALAVGEQELPALAELLRGRGAQLAWIPAAAALCLHTPYGIRHSLIPGPLDAAPAEAGLFSHWDHVVLNVEQGSLQAAADWYGRVLGWRRLYRYSIGTATSGLESVVVGDPEAGIQWAINEPTCAASQIQEFLHAHGGPGIQHAALHSSDIVASLRRLRQGGVDFLQVAPQYYTSLERELGLALRSALGQAISWQDLVEQQILLDATLPASDGQDRPLLLQTFTQPLFGRPTFFFEVIQRLGGATGFGEANFQALFEALERQQRQRHQALTP

SEQ ID NO: 8 - DNA, 1149 bp, Blepharisma japonicum
atgacttattacgacaagcaagaaacgcgtccagatcttggcgaattctatggtttccatcacgttcgtttttacgtctccaactcagagcaagccgcttcgttctacacatctcgctttgggttttctccggttgcctatgaaggattggaaacaggaaaccaaaaattctgtaccaatgtcgtccgaagcaaccatgtagtcatcgcttttacctcagctctcactcctgaagacaatgaagtgaaccgtcacgttggcaagcatagtgatggagttcaagacattgcctttagtgtaagtgacgcaagagggatgtatgagaaagcgatagctaaaggctgtaaaagcttccgtgagccacaggttttacaagatcaatttggatctgttataatagcgtctctccagacttatggagacactgttcacacattagtccaaaatgtcgactatacaggaccctttttgcctggcttcagagcaatcacaaaagatgatccattaaactctgcctttcctcaggtaaattatgacattattgatcatgttgtaggaaatcagcctggtggcgatatgactcctacagtagaatggtatgagaaatatctagaatttcatcgatattggtctgctgatgagtctgtaatccataccgattattcagcattaaggtctgttgtggttgctgattgggatgaagtgatcaaaatgcctattaatgagcctgctgatggacttagaaaaagtcaaatccaagaatatgtcgaatattatggtggagcaggcgtacaacatattgccttaaaagtcaatgatattatttcagtaataagcaccttaagggctagaggtgtggaattcttagaagttcctcctaaatattatgatagcttaagaaaaagacttgcgcattctgcggtacaaattgaagaagacttaaaaagaattgaagaccttcatattttggttgactttgacgaccgtgggtatttacttcagattttcacaaaaccagtagaagacagacctactctgttttatgaaattattcaaagacataataacaatggattcggaattggaaattttaaagccctatttgaatcattggaacaagagcaagaaagaagaggtaatttgatctaa

SEQ ID NO: 9 - protein, 382 aa, Blepharisma japonicum
MTYYDKQETRPDLGEFYGFHHVRFYVSNSEQAASFYTSRFGFSPVAYEGLETGNQKFCTNVVRSNHVVIAFTSALTPEDNEVNRHVGKHSDGVQDIAFSVSDARGMYEKAIAKGCKSFREPQVLQDQFGSVIIASLQTYGDTVHTLVQNVDYTGPFLPGFRAITKDDPLNSAFPQVNYDIIDHVVGNQPGGDMTPTVEWYEKYLEFHRYWSADESVIHTDYSALRSVVVADWDEVIKMPINEPADGLRKSQIQEYVEYYGGAGVQHIALKVNDIISVISTLRARGVEFLEVPPKYYDSLRKRLAHSAVQIEEDLKRIEDLHILVDFDDRGYLLQIFTKPVEDRPTLFYEIIQRHNNNGFGIGNFKALFESLEQEQERRGNLI

SEQ ID NO: 10 - DNA, 1206 bp, Rhodococcus sp.
atgacgatcgagcagactctcaccgacaaggaacgcctggcaggtctcgacctcggccagctcgagcagttggtcgggctcgtcgagtacgacggcacccgcgacccgttcccggtcagcggctgggatgccgtcgtctgggtggtcggcaacgccacccagaccgcccactacttccagtccgcgttcgggatgaccctcgtcgcctactccggacccaccaccggcaaccgcgaccaccacagcttcgtcctcgaatccggggccgtccgcttcgtcatcaaaggcgccgtgaacccggacagccccctgatcgaccaccaccgcacccacggcgacggcgtcgtcgacatcgccctcgccgtccccgacgtcgacaagtgcatcgcccacgcccgcgcccagggcgccaccgtcctcgacgaaccccacgacgtgaccgacgaccacggcaccgtccgcctcgccgcgatcgccacctacggcgacacccgccacaccctcgtcgaccgcagccactacaccggcccctacctgcccggctacaccgcccgcacctccggccacaccaaacgggacggggcacccaagcgcctgttccaggccctcgaccacgtcgtcggcaacgtcgaactcggcaagatggaccactgggtcgacttctacaaccgggtcatgggctttacgaacatggccgagttcgtcggcgaggacatcgccaccgactactccgcgctgatgagcaaggtcgtctccaacggcaaccaccgggtcaagttccccctcaacgaacccgccctcgccaagaaacgctcgcagatcgacgaatacctcgacttctaccgcggccccggcgcccagcacctggccctggccaccaatgacatcctcaccgccgtcgaccagctgaccgccgagggcgtcgagttcctggccacccccgactcctactacgaggaccccgaactgcgggcccggatcggcaacgtccgcgcccccatcgccgaactgcagaaacgcggcatcctcgtcgaccgcgacgaagacggctacctgctgcagatcttcaccaaacccctcgtcgaccggcccaccgtgttcttcgaactcatcgaacgccacggctccctcggcttcggcatcggcaacttcaaagccctcttcgaggccatcgaacgcgaacaagccgcccgcggaaacttctga

SEQ ID NO: 11 - protein, 401 aa, Rhodococcus sp.
MTIEQTLTDKERLAGLDLGQLEQLVGLVEYDGTRDPFPVSGWDAVVWVVGNATQTAHYFQSAFGMTLVAYSGPTTGNRDHHSFVLESGAVRFVIKGAVNPDSPLIDHHRTHGDGVVDIALAVPDVDKCIAHARAQGATVLDEPHDVTDDHGTVRLAAIATYGDTRHTLVDRSHYTGPYLPGYTARTSGHTKRDGAPKRLFQALDHVVGNVELGKMDHWVDFYNRVMGFTNMAEFVGEDIATDYSALMSKVVSNGNHRVKFPLNEPALAKKRSQIDEYLDFYRGPGAQHLALATNDILTAVDQLTAEGVEFLATPDSYYEDPELRARIGNVRAPIAELQKRGILVDRDEDGYLLQIFTKPLVDRPTVFFELIERHGSLGFGIGNFKALFEAIEREQAARGNF

SEQ ID NO: 12 - DNA, 1209 bp, Rhodococcus sp.
atgactaccgccgacattcgcctgacgccccgcgaggtggccgcacatctggagaccgacgagctccggcagttggtcgggctcgtcgaacacgacgacgcgtcggatccgtttcccgtggtcgcgatggatgccgtggtgttcgtgtgcggcaacgcgacgcagagcacgcagtacttcgtctccacgtggggcatgaccctcgtcgcctacgccgggccggagaccggtcagcgctcgcacaagtccttcgtcctcgagtcggggtcggcacggttcgtgctgcacggcgccgtcgatccgaagagcccgctcgcggaccatcaccgggcgcacggcgacggcgtggtggacctggcgatggaagttctcgacgtcgaccgctgcatcgcgcatgcacgctcgcagggggccaccattctcgaggagccgcgcgacgtcacggatcagttcggcaccgtgcggctcgcggcgatcgccacgtacggcagcacccggcacaccatcgtcgaccgaagccgatacgacggcccctacctccccggattcgtcgcgcgctccagcggtttcgcggcgcgaccgggtaaacccccgcgattgttccaggcgctcgaccacgccgtcggcaacgtcgagatgggccggatggatcactgggtccggttctacaaccgcgtcatgggcttcacgaacatggccgaattcgtcggcgacgacatcgccacggagtactcggcgctgatgtcgaaggtcgtggcgaacggcaatcaccgggtgaagttcccgctcaacgaacccgcggtgggaaagaagaagtcgcagatcgacgaatatctcgagttctacggtgagccgggctgccagcatctggccctcgcgaccggagacatcctcgcgacggtggacgcgttgcgggccgagggtgtcgaattcctgaacacacccgacgcgtactacgaggacccacagctgcgcgcccggatcggcagggtgcgggtgccggtggaggaactgcagaagcgcggaatcctcgtcgaccgcgacgaggacggatacctcctgcagatcttcaccaaaccgctcggcgaccggccgaccgtgttcttcgaggtgatcgaacggcacggttcgctcgggttcggggcgggtaacttccaggccctgttcgaatccatcgagcgtgagcaggcggcgcgcggcaatctgtga

SEQ ID NO: 13 - protein, 402 aa, Rhodococcus sp.
MTTADIRLTPREVAAHLETDELRQLVGLVEHDDASDPFPVVAMDAVVFVCGNATQSTQYFVSTWGMTLVAYAGPETGQRSHKSFVLESGSARFVLHGAVDPKSPLADHHRAHGDGVVDLAMEVLDVDRCIAHARSQGATILEEPRDVTDQFGTVRLAAIATYGSTRHTIVDRSRYDGPYLPGFVARSSGFAARPGKPPRLFQALDHAVGNVEMGRMDHWVRFYNRVMGFTNMAEFVGDDIATEYSALMSKVVANGNHRVKFPLNEPAVGKKKSQIDEYLEFYGEPGCQHLALATGDILATVDALRAEGVEFLNTPDAYYEDPQLRARIGRVRVPVEELQKRGILVDRDEDGYLLQIFTKPLGDRPTVFFEVIERHGSLGFGAGNFQALFESIEREQAARGNL

SEQ ID NO: 14 - DNA, 1107 bp, Picrophilus torridus
atgtatggcaaaaatttaatctcagaactaagggaaaaggagatctttaaacgattacatcacgtggaattttacgttagcagtgccaaaacatggtcatatttcatgaacaggggtcttggatttaaaacagtggcatatgccggtccagaaaccgggataagggacaagatatcctatgttatgtcccagggcactgcaaggatatcttttacatcatcaatgaatgatgatagctatatatcgaatcatgttaaaaaacacggggatggcgtaaaggatatagcacttgaggtcgatgatctggacgaggcaaaaagcctgatagaaaagtatggaacaaaggtttcaaaaataaatgaaataaaggatggaaatggaaagataagaactgcagagataaaaacgtacggtgaaaccgttcatacattaatagaaaccggggattacaatggcgtattcatgcccggttatgaggaatctgaaataaattcaaaaaacactgggataaaaaagatcgatcatatagttggaaatgtctatgagggcgagatggatagctgggttaatttttacatagaaaaacttggctttgagcatttaataacctttgatgataaagatataagaactgattacagcgcattaagatcaaaggttgtaaaatacaatgacgatatcgtatttccaataaatgagcctgcaaagggcttaagaaaatcacagatagaggaatatcttgactattacaggtctgagggcgttcagcacatagcactgttaactgatgatataataaaaactgtatccatgatggaggaaaacggcatagaatttttaaaaacaccaggatcatactatgaatccctatcatcaaggataggctcaatagacgaggatttaaatgaaatagagaaacataacatacttgtggatcgtgatgagaacggatacctattacagatcttcacaaagcctgttactgacaggccaacgttcttctttgaggtcatacagagaaagggtgcaaggtcattcggcaacggtaactttaaggcactttttgaggcgatagaaagggagcaggcaaagagaggaaacctatga

SEQ ID NO: 15 - protein, 368 aa, Picrophilus torridus
MYGKNLISELREKEIFKRLHHVEFYVSSAKTWSYFMNRGLGFKTVAYAGPETGIRDKISYVMSQGTARISFTSSMNDDSYISNHVKKHGDGVKDIALEVDDLDEAKSLIEKYGTKVSKINEIKDGNGKIRTAEIKTYGETVHTLIETGDYNGVFMPGYEESEINSKNTGIKKIDHIVGNVYEGEMDSWVNFYIEKLGFEHLITFDDKDIRTDYSALRSKVVKYNDDIVFPINEPAKGLRKSQIEEYLDYYRSEGVQHIALLTDDIIKTVSMMEENGIEFLKTPGSYYESLSSRIGSIDEDLNEIEKHNILVDRDENGYLLQIFTKPVTDRPTFFFEVIQRKGARSFGNGNFKALFEAIEREQAKRGNL

SEQ ID NO: 16 - DNA, 1164 bp, Kordia algicida
atggcagcagaaataaaaaacttaaaagatttacaaaatacagaatacggactcaaaaaattatttgacgaagcagaagactttcttccacttttaggaacagactacgtagaattatacgtcgggaacgccaaacaatcggcacatttctacaaaacggcttttggttttcaatcagaagcttacgcaggattggaaacaggattaaccgacagagtttcatacgtattaaaacaagataaaattcgcttggtcttaacaacaccattaggaaaaggtggcgaaatcaatgagcatatcgatttacacggcgatggcgtaaaagtagtagcactttgggtagaagatgctacaaaagcctttgaagaaacgaccaaaagaggcgcaaaaccgtacatggaaccaacaaaagaagaagatgaaaacggatatgtaattcgctcaggaatctatacgtacggagaaacggttcatgtttttgtagaacgtaaaaactataacggagtctttttaccaggatatcaaagatgggaatctcactacaatccggagccagttggcttaaaattcatcgatcacatggtaggaaatgtaggttggggagaaatgaaagaatggtgtgaattctacgcgaaagtaatgggatttgcgcaaattatctcctttacagatgatgatatttctaccgattttactgcgttgatgagtaaagtaatgagtaatggaaatggtagaatcaaatttccaatcaatgaacccgcagaaggaaaaaagaaatcgcaaattgaagaatatctagacttttacaatggttcaggagtacaacatattgcggttgctacagacaatattattgatacggtttcgcaaatgcgcgaacgtggagtagaattcttatacgttccagatacatattatgatgacttgttagaacgtgttggcgacatcgatgaagatgtagaagaactcaaaaaacacggaatcttaattgatcgtgatgaagaaggatacttattgcagttatttaccaaaaccattgtagacagaccaacaatgttctttgaagtcattcagcgtaaaggcgcacaatcatttggagtaggaaactttaaagctttatttgaagcgatagaaagagaacaagctgctcgcggaacattgtaa

SEQ ID NO: 17 - protein, 387 aa, Kordia algicida
MAAEIKNLKDLQNTEYGLKKLFDEAEDFLPLLGTDYVELYVGNAKQSAHFYKTAFGFQSEAYAGLETGLTDRVSYVLKQDKIRLVLTTPLGKGGEINEHIDLHGDGVKVVALWVEDATKAFEETTKRGAKPYMEPTKEEDENGYVIRSGIYTYGETVHVFVERKNYNGVFLPGYQRWESHYNPEPVGLKFIDHMVGNVGWGEMKEWCEFYAKVMGFAQIISFTDDDISTDFTALMSKVMSNGNGRIKFPINEPAEGKKKSQIEEYLDFYNGSGVQHIAVATDNIIDTVSQMRERGVEFLYVPDTYYDDLLERVGDIDEDVEELKKHGILIDRDEEGYLLQLFTKTIVDRPTMFFEVIQRKGAQSFGVGNFKALFEAIEREQAARGTL

SEQ ID NO: 18 - DNA, 1056 bp, Artificial Sequence
  Nucleic acid sequence encoding Synechococcus sp. HPPD optimized for the expression in soybean and cotton
atggctaacccatccattaggatcgttcagggaatccatcaccttcacttctacctttgggatcttccaaggtggagagagcatttctgtagagtttggggattcagagttgcttctgatgctggaaacactcttgaacttgagcaaggatctcttaggcttaggctttctcaaccagctagagctggtgatgaagttgataggcatcttcaaagacatggaccaggtgttgttgatgttgctcttgctgttggagaacaagaacttccagctcttgctgaacttcttagaggaaggggtgctcaacttgcttggattccagctgctgctgctctttgccttcatactccatacggaattaggcactcccttattccaggaccacttgatgctgctccagctgaggctggacttttttctcattgggatcacgttgttcttaatgtggagcagggatctcttcaagctgctgctgattggtatggaagagttcttggatggcgtagactttaccgttactccatcggaactgctacttcaggacttgagtctgttgttgttggagatccagaggctggcattcaatgggctatcaacgaacctacttgcgctgcttctcagattcaagagttccttcatgctcatggtggaccaggtattcaacatgctgctctccactcttcagatattgtggcttctcttagaaggcttaggcaaggtggagttgatttccttcaagtggctccacagtactatacttctcttgagagagagcttggacttgctcttagatctgctcttggacaggctatttcttggcaggatcttgttgagcagcagattcttcttgatgctactcttccagcttctgatggacaagataggccacttttgctccaaactttcactcaaccacttttcggaaggccaacattcttcttcgaagtgattcaaagacttggaggtgctactggatttggagaggctaatttccaagctcttttcgaggctcttgaaaggcaacaaaggcaaaggcatcaagctcttactccatga

SEQ ID NO: 19 - DNA, 1152 bp, Artificial Sequence
  Nucleic acid sequence encoding Blepharisma japonicum HPPD optimized for the expression in soybean and cotton
atggctacttactacgataagcaagagactagaccagatcttggagagttctacggattccaccatgttaggttctacgtgtctaattctgagcaagctgcttctttctacacttcccgtttcggattttctccagttgcttacgaaggacttgagactggaaatcagaagttctgcactaacgttgttaggtctaaccacgtggtgattgcttttacttctgctctcactccagaggataatgaggttaacaggcatgttggaaagcactctgatggtgttcaggatattgctttctctgtgtctgatgctagaggaatgtacgagaaggctattgctaagggatgcaagtctttcagagagccacaagttcttcaagatcagttcggatcagtgattattgcttcccttcagacttacggtgatactgttcacactctcgttcagaacgttgattacactggaccattccttccaggtttcagggctatcactaaggatgatccacttaactctgctttcccacaggtgaactacgatatcattgatcacgttgtgggaaatcagccaggtggagatatgactccaactgttgagtggtacgagaagtaccttgagtttcacaggtattggagtgctgatgagtctgtgatccacactgattactctgctcttagatctgttgttgtggctgattgggatgaggttatcaagatgcctattaacgaaccagctgatggacttaggaagtcccagattcaagagtacgttgagtattatggtggagctggtgttcaacacattgctctcaaggtgaacgatatcatttccgtgatttccactcttagagctagaggagttgagtttcttgaagtcccaccaaagtactacgattctctcagaaagaggcttgctcattctgctgttcagatcgaagaggatcttaaacgtattgaggaccttcacatcctcgtggattttgatgataggggataccttctccagattttcactaagccagttgaggataggccaactttgttctacgagatcatccaaaggcataacaacaacggattcggaatcggaaatttcaaggctcttttcgagtctcttgagcaagaacaagagagaaggggaaacctcatctga

SEQ ID NO: 20 - DNA, 1209 bp, Artificial Sequence
  Nucleic acid sequence encoding Rhodococcus sp. (strain RHA1), isolate ro03041 HPPD optimized for the expression in soybean and cotton
atggctactattgagcagactctcactgataaggaaaggcttgctggacttgatcttggacaacttgagcagcttgttggacttgttgagtacgatggaactagggacccatttccagtttctggatgggatgctgttgtttgggttgtgggaaatgctactcaaactgctcactacttccaatctgctttcggaatgactcttgtggcttactctggaccaactactggaaatagggatcaccactctttcgttcttgaatctggtgctgtgagattcgttattaagggtgctgtgaacccagattctccacttattgatcaccataggactcatggtgatggtgttgtggatattgctcttgctgttccagatgtggataagtgcattgctcatgctagggctcaaggtgctactgttcttgatgagccacacgatgttactgatgatcacggaactgttaggcttgctgctattgctacttacggtgatacaaggcacactcttgttgataggtcacactacactggaccatatcttccaggatacactgctagaacttccggacacactaagagggatggtgctccaaagagacttttccaggctcttgatcacgttgttggaaacgttgagcttggaaagatggatcactgggtggacttctacaatagggtgatgggattcactaatatggctgagtttgtgggagaagatatcgctactgattactctgctctcatgtctaaggttgtgtctaatggaaaccacagggtgaagttcccacttaatgaaccagctctcgctaaaaaaaggtcacagatcgatgagtacctcgatttttatcgtggaccaggtgctcaacatcttgctctcgctactaacgatattctcactgctgtggatcaacttactgctgagggtgttgagtttcttgctactccagattcctattacgaggacccagaacttagagctaggatcggaaatgttagggctccaatcgctgaacttcagaagaggggaatactcgttgatagagatgaggatggataccttctccagatcttcactaagccattggttgataggccaactgttttcttcgagcttattgagaggcatggatctcttggattcggaatcggaaacttcaaggctcttttcgaggctattgagagagaacaagctgctaggggaaatttctga

SEQ ID NO: 21 - DNA, 1212 bp, Artificial Sequence
  Nucleotide sequence encoding Rhodococcus sp. (strain RHA1), isolate ro02040 HPPD optimized optimized for the expression in soybean and cotton
atggctactactgctgatattaggcttactccaagggaagttgctgctcatcttgagactgatgagcttaggcaacttgttggacttgttgagcacgatgatgcttcagatccattcccagttgttgctatggatgctgttgtttttgtttgcggaaacgctactcaatctactcagtacttcgtgtctacttggggaatgactcttgttgcttatgctggaccagaaactggacagagatctcacaagtctttcgtgcttgaatctggatctgctagattcgttcttcacggtgctgttgatccaaagtctccacttgctgatcatcatagggctcatggtgatggtgttgtggatcttgctatggaagtgcttgatgtggatagatgcattgctcatgctagatctcagggtgctactattcttgaagaacctcgtgatgtgactgatcagtttggaactgttaggcttgctgctattgctacttacggctccactaggcacactattgtggataggtccagatatgatggaccataccttccaggatttgttgctaggtcatctggatttgctgctagaccaggaaagccaccaagacttttccaagctcttgatcacgctgttggaaatgttgaaatgggaaggatggatcattgggtgaggttctacaatagggtgatgggattcactaatatggctgagttcgtgggtgatgatattgctactgagtactctgctcttatgtctaaggttgtggctaatggaaatcacagggtgaagttcccacttaatgaaccagctgtgggaaagaagaagtcccagatcgacgagtaccttgagttttacggtgaaccaggatgtcaacatcttgctctcgctactggtgatattcttgctactgtggatgctcttagagctgaaggtgttgagttcctcaatactccagatgcttactacgaggacccacaacttagagctaggattggaagagttagggttccagttgaggaacttcagaagaggggaatactcgttgatagagatgaggatggataccttctccagatcttcactaagccacttggagataggccaactgttttcttcgaagtgattgagaggcatggatctcttggatttggagcaggaaacttccaggcacttttcgagtctattgagagagaacaagctgctaggggaaatctttga

SEQ ID NO: 22 - DNA, 1110 bp, Artificial Sequence
  Nucleic acid sequence encoding Picrophilus torridus HPPD optimized for the expression in soybean and cotton
atggcttacggaaagaaccttatttctgagcttagagagaaagagatcttcaagaggcttcatcacgttgagttctacgtttcttccgctaagacttggtcctacttcatgaataggggactcggattcaagactgttgcttatgctggaccagaaactggaatcagggataagatctcctacgttatgtctcaaggtactgctaggatttctttcacttcctccatgaacgatgattcctacatttccaaccacgttaagaaacacggtgatggtgttaaggatatcgctctcgaagtggatgatcttgatgaggctaagtctctcattgagaagtacggaactaaggtgtccaagatcaacgagatcaaggatggaaacggaaagattaggactgctgagatcaagacttacggtgaaactgtgcacactcttatcgagactggtgattacaacggtgttttcatgccaggatacgaagagtctgagatcaactccaagaacactggtatcaaaaaaatcgatcacattgtgggaaatgtttacgagggtgaaatggattcttgggtgaacttctacattgagaagttgggattcgagcaccttatcactttcgatgataaggatatcaggactgattactctgctcttaggtctaaggtggtgaagtacaacgatgatatcgtgttccctattaacgaaccagctaagggacttaggaagtcccaaatcgaagagtacctcgattattaccgttctgagggtgttcaacacattgctttgctcacagacgatatcatcaagactgtgtccatgatggaagagaacggaattgagttccttaagactccaggatcttactacgagtctttgtcctctaggattggatctatcgatgaggatctcaacgaaatcgagaagcacaacattcttgtggatagggatgagaacggataccttctccagattttcactaagccagtgactgataggccaacattcttcttcgaagtgatccaaagaaagggtgctagatctttcggaaacggaaacttcaaggctcttttcgaggctattgagagagaacaagctaagaggggaaacctttga

SEQ ID NO: 23 - DNA, 1167 bp, Artificial Sequence
  Nucleic acid sequence encoding Kordia algicida HPPD optimized for the expression in soybean and cotton
atggctgctgctgagattaagaacctcaaggatctccagaatactgagtacggactcaagaaactttttgatgaggctgaggatttccttccacttctcggaactgattacgttgagctttatgtgggaaacgcaaagcaatctgctcacttctacaagactgctttcggatttcaatctgaggcttacgctggacttgaaactggacttactgatagggtttcctacgtgcttaagcaggataagattaggcttgtgctcactactccacttggaaagggtggagagattaacgagcacattgatcttcatggtgatggtgttaaggttgtggctctttgggttgaagatgctactaaggctttcgaagagactactaagagaggtgcaaagccttatatggaacctacaaaagaagaggacgagaacggatacgtgattagatccggaatctacacttacggtgagactgttcacgttttcgtggagaggaagaactacaacggagtctttcttcctggataccaacgatgggagtctcattacaatccagagccagtgggacttaagttcatcgatcacatggtgggtaatgttggatggggagagatgaaggaatggtgcgagttttacgctaaggttatgggattcgctcagatcatttccttcactgatgatgatatctccactgatttcactgctcttatgtccaaggtgatgtctaatggaaacggaaggatcaagttccctattaacgaaccagctgagggaaagaagaagtcccagatcgaagagtacctcgatttctacaacggatctggtgttcagcatattgctgtggcaactgataacatcatcgatactgtgtctcaaatgagagaaaggggagtggagtttctttacgtcccagatacttactacgatgatctccttgagagagtgggagatattgacgaggatgtggaggaacttaagaagcacggaatcctcattgatagagatgaagagggataccttctccagcttttcactaagactatcgtggataggccaactatgttcttcgaagtgatccaaagaaagggtgctcaatctttcggagtgggaaacttcaaggctcttttcgaggctattgagagagaacaagctgctagaggaactctttga